(19) United States
(12) Patent Application Publication
(10) Pub. No.: US 2024/0361454 A1
(43) Pub. Date: Oct. 31, 2024

(54) TRILATERATION-BASED ULTRASONIC SENSOR SYSTEM WITH KALMAN FILTERING AND SOLUTION CLUSTERING

(71) Applicant: ELMOS Semiconductor SE, Dortmund (DE)

(72) Inventors: Hannes Klus, Münster (DE); Rainer Kralj, Schwerte (DE)

(73) Assignee: ELMOS Semiconductor SE, Dortmund (DE)

(21) Appl. No.: 18/682,909

(22) PCT Filed: Dec. 16, 2021
(86) PCT No.: PCT/DE2021/101013

§ 371 Date: Feb. 10, 2024

(30) Foreign Application Priority Data
Aug. 13, 2021 (DE) DE102021121154.9

(51) Int. Cl. G01S 15/931; G01S 7/539; G01S 15/46; G01S 15/87

(52) U.S. Cl. CPC G01S 15/931; G01S 7/539; G01S 15/876; G01S 2015/465

(57) ABSTRACT

The invention relates to an ultrasonic sensor system (USSS), in which the ultrasonic sensor system (USSS) ascertains distance values on the basis of ultrasonic echoes, which are sensed by at least four ultrasonic sensors, and the ultrasonic sensor system (USSS) ascertains solutions from these distance values by means of a trilateration method and filters each of these solutions by means of a respective Kalman filtering method to form filtered solutions and clusters the filtered solutions by means of a clustering method to form accepted solutions and discards unaccepted unaccepted filtered solutions.

### FIELD OF THE INVENTION

The invention is aimed at an ultrasonic sensor system for use in autonomous vehicles.

### INTRODUCTION

The importance of sensor technology in the area of mobility has increased in recent years. In addition to an ultrasonic sensor system within a vehicle, e.g., gesture control, the complexity of sensor technology outside of the vehicle is continually evolving. These ultrasonic sensors provide information about the environment of the vehicle. Vehicle manufacturers use this information in various applications in the vehicles. The most difficult stage of in-vehicle application at this time is autonomous driving. Many researchers and developers are working on this task /1/, /2/. In order to implement methods for an autonomous vehicle, the evaluation systems of such vehicles require highly processed ultrasonic sensor data. In addition to the technical challenges of autonomous driving, there are also ethical aspects. The fact that intelligent systems decide in every traffic situation is often critically discussed in public /3/. The use of autonomous vehicles at the time of application of this document is still limited to specific tasks. In the case of automobility, the autonomous automatic parking of a vehicle into a parking space is an example of an autonomous task that has already found its way into mass production. In addition, secondary systems are widely used. One example in this respect is lane departure warning systems. They enable partially automated driving with the relevant vehicle, which comprises such a lane departure warning system. The most widely used low-level systems at the time of application of this document are said parking assistants for autonomously automatically parking a vehicle into a parking space. They provide support by transmitting environmental data to the driver. Most parking assistants are based on ultrasonic parking sensors as ultrasonic sensors mounted in the bumper of a car. The simplest way to communicate data is by a so-called beeper. Upon detection of an object in the surroundings of the vehicle and in the detection range of the ultrasonic sensor system, the so-called beeper generates a typically pulsed, modulated beep at a range-dependent pulse frequency. More advanced systems use cameras to visualize the environment. Preferably, these systems combine the image data of the camera with the sensor data of the ultrasonic sensors since the camera's view does not capture the entire area /2/.

However, applications in the market use ultrasound-based obstacle recognition systems not only in parking applications but also in other areas. Today, drone and robot applications are very common /4/ /5/. These applications often utilize the ultrasonic echoes of ultrasonic sensor systems for orientation in their surroundings. The relevant ultrasonic sensor systems typically comprise a plurality of ultrasonic sensors that emit ultrasonic signals in the form of ultrasonic bursts and receive the reflected ultrasonic echoes from objects in the surroundings of the ultrasonic sensor system. Based on the ultrasound data extracted from the received, reflected ultrasonic echoes of the ultrasonic signals of the ultrasonic sensors of the ultrasonic sensor system, these ultrasonic sensor systems generate, for example, a map of the surroundings in the form of a point cloud, which the application devices, i.e., the robots and/or vehicles, use for orientation. Based on the specific work order, the control computers of these application devices then, for example, ascertain, on the basis of the map of the surroundings of the ultrasonic sensor system, a target path through the terrain symbolized by the map of the surroundings. As a result, the control computers of the application devices are able to appropriately change their current path in response to changes in their surroundings and respond to obstacles in their surroundings, thus compensating for such changes or preventing safety-relevant events. To this end, their ultrasonic sensor system emits an ultrasonic signal with preferably a plurality of ultrasonic pulses and calculates the distance to an obstacle based on the first received echo. Prior-art ultrasonic sensor systems for parking sensor technology use the same principle. For example, a parking system having an ultrasonic sensor system according to the typical market condition at the time of application of this document uses four ultrasonic sensors to recognize obstacles in a large area around the application device. Within one measurement cycle, an ultrasonic sensor of the ultrasonic sensor system emits an ultrasonic burst having a plurality of ultrasonic pulses. A plurality of ultrasonic sensors of the ultrasonic sensor system receive reflections of this ultrasonic burst, which obstacles as objects in the surroundings of the vehicle reflect toward these ultrasonic sensors of the ultrasonic sensor system. These reflections thus represent ultrasonic echoes of the ultrasonic burst. Due to their ultrasonic burst time of flight between the emission of the ultrasonic burst and the reception of the ultrasonic echo, the received ultrasonic echoes enable the position of the obstacle that generated the ultrasonic echo to be calculated /6/. Ultrasonic echo-based position calculation is referred to as trilateration /7/. The document presented herein deals with various trilaterations between, by way of example, four ultrasonic sensors of the proposed ultrasonic sensor system. The proposed ultrasonic sensor system causes an ultrasonic sensor of its ultrasonic sensors to emit an ultrasonic burst. The ultrasonic sensors of the ultrasonic sensor system receive the reflections of the ultrasonic burst and convert the received reflections of the ultrasonic burst into a respective ultrasonic reception signal of the respective ultrasonic sensor. Since the ultrasonic sensor system comprises a plurality of ultrasonic sensors, a plurality of scenarios are conceivable in which exactly one of the ultrasonic sensors transmits and the other ultrasonic sensors of the ultrasonic sensor system receive. Thus, four ultrasonic sensors of an ultrasonic sensor system result in four scenarios, hereinafter referred to as channels. A central control unit of the ultrasonic sensor system performs a trilateration method in a very specific manner on the basis of the ultrasonic reception signals, taking into account the multiple echoes where applicable. A subsequent Kalman filter of the ultrasonic sensor system or another suitable estimation filter of the ultrasonic sensor system filters the result of the trilateration by means of a Kalman filtering method or an estimation filtering method. A classifier downstream of the Kalman filter or estimation filter in the signal path further improves the recognition result by means of a classification method. This basic principle is explained further and in more detail in the following text.

A parking system for autonomously parking a vehicle into a parking space on the basis of such an ultrasonic sensor system differs from other prior-art parking systems in that a proposed ultrasonic sensor system comprises a control computer that calculates trilaterations on the basis of a plurality of received ultrasonic echoes of a plurality of ultrasonic sensors during a measurement via a plurality of channels. A second and a third ultrasonic echo contribute more information about the environment and therefore result in higher resolution and better recognition and classification of obstacles and objects in the surroundings of the vehicle. The method presented herein and preferably carried out by the control computer of the ultrasonic sensor system typically compares trilateration solutions of various perspectives. This enables the control computer to avoid misinterpretations of ultrasonic echoes. This document provides a method that enables the control computer of the proposed ultrasonic sensor system to calculate and compare these multiple trilaterations based on the temporally first three incoming ultrasonic echoes of each ultrasonic sensor during a measurement via the various channels. The challenge of the method carried out by the control computer is to map the ultrasonic echoes sensed by the ultrasonic sensors in the ultrasonic sensor signals to the correct obstacles and objects in the surroundings of the vehicle. The temporally first arriving ultrasonic echoes of the ultrasonic sensors are most important since, in parking situations, they typically represent the objects closest to the ultrasonic sensors and thus to the ultrasonic sensor system and thus to the vehicle. Moreover, the control computer preferably uses the temporally second and third arriving ultrasonic echoes of the ultrasonic sensors in order to ascertain an overview of a parking scene. Sometimes, the temporally first ultrasonic echoes arise due to ground reflections or other effects in the surroundings of the vehicle. In this case, the temporally second arriving ultrasonic echoes are important in order to still recognize the obstacles and objects in the surroundings of the vehicle.

The aim of the method presented herein and of the apparatus presented herein is to provide a safe and robust obstacle recognition system on the basis of an ultrasonic sensor system to the driver of the vehicle or the control apparatus for autonomous automatic driving. Further processing of the data is necessary to ensure high reliability of this ultrasonic sensor system. A desired property of the obstacle recognition system based on the ultrasonic sensor system presented herein is the stability of the recognition result despite the possible multitude of other ultrasonic signals in the surroundings of the vehicle. This is necessary since the vehicles cannot readily distinguish incoming ultrasonic echo pulses according to their origin. This problem is in particular important when the ultrasonic sensor systems of two vehicles emit ultrasonic bursts at the same ultrasonic pulse frequency. In such a situation, for example, a closed building, for example a parking garage, can further worsen the difficulty of the recognition situation due to additionally occurring interference signals. The second focus of this document is therefore on the noise behaviour of the ultrasonic sensor systems. Within the framework of developing this document, the proposers tested various filter types in order to reduce the influence of other parking vehicles. For the customer interface, the proposers have chosen and implemented a Kalman filtering method and a clustering method in the course of the development of the proposal presented herein and have tested them for filtering the ultrasonic echo signals and filtering the resulting 2D points after the trilaterations. The biggest challenge in filtering the ultrasonic sensor signals is that the filter used must be fast in order to ensure a short time between the arrival of the ultrasonic echo and the provision of the relevant information for control of the vehicle. This dead time must be minimized in order to minimize the likelihood of an accident. Particularly in dynamic scenarios, the filter delay is thus a particularly important property. The aim of the project for the development of the proposal was for the filter output of the ultrasonic sensor system to provide the position of an obstacle with a maximum delay of 500 ms after the obstacle appears in the area of the ultrasonic sensors of the ultrasonic sensor system. Another requirement is that the recognition system of the ultrasonic sensor system must reliably recognize obstacles at a lower speed in the range of a maximum speed of 2 m/s.

### Ultrasound Basics

### Definitions and Terms

In the sense of this document, ultrasonic waves are acoustic waves that operate in a defined frequency range. The working range starts at 20 kHz as the lower frequency limit of the ultrasound, the threshold value of human hearing. Humans hear sound waves between 16 Hz and 20 kHz. Ultrasonic waves are transferred in materials having different aggregate states. Depending on the frequency, ultrasound is used in different applications, e.g., in cleaning, in medicine or in industry. These are destructive applications. In contrast, there are non-destructive applications, such as distance measurement. This document covers distance measurement as an application of emphasis /8/.

### Ultrasound Generation

The basis for the generation of ultrasonic signals is typically the exploitation of the piezoelectric effect. The effect describes that deformation of piezoelectric materials causes an electric field. This effect acts bi-directionally. Conversely, an electric field can deform a piezoelectric material. A piezoelectric crystal is mounted such that it can vibrate mechanically and electrically. Typically, it is mechanically coupled to a membrane or functionally equivalent oscillating body. By applying an alternating voltage, an electric actuating apparatus may vibrate the crystal and thus the oscillating body, whereby the oscillating body periodically compresses and decompresses the air in its environment and thus generates an ultrasonic signal. Typically, in cooperation with the oscillating body, the crystal has an electrical and mechanical resonance frequency. The voltage frequency of the AC voltage actuation of the crystal should be close to this resonance frequency in order to achieve a high sound pressure level (SPL) /8/.

After generating the ultrasonic wave, it is critical for the ultrasonic sensor system of a parking system which portion of the ultrasonic wave is reflected back by the objects in the surroundings of the ultrasonic sensor system. This provides information about the environment of the vehicle to the control computer of the ultrasonic sensor system. The surfaces of the objects are critical as to which portion of the ultrasonic wave is reflected back by this surface of the object to the ultrasonic sensor system. FIG. 1 describes various behaviours of the ultrasonic wave as a function of the surface of the object. The left side of FIG. 1 illustrates the diffraction of the wave. FIG. 1 shows the ultrasound behaviour on various surfaces /8/. The rough surface breaks the wave into smaller portions of lower amplitude. In comparison, a smooth surface results in a single reflection. The surface reflects the wave according to the angle of incidence. In addition, there may also be material-dependent, refracting portions. For example, a technically trained or experienced person (skilled person) may determine the angle of refraction using Snell's law /8/.

### Propagation of Ultrasonic Waves

Another important property is the propagation of ultrasonic waves. An ultrasonic wave may approximately be considered as a circular wave that propagates at the respective ultrasonic velocity after generation by a sound transducer as part of an ultrasonic sensor. The wave propagates in a particular range that depends on the type of sound transducer of the ultrasonic sensor. The working range depends on the angle and the distance to the ultrasonic transducer position and thus to the ultrasonic sensor position. However, the document presented herein shows only one dimension of the wave propagation for reasons of simplicity and clarity of presentation. In addition to a horizontal portion, there is also a vertical portion of the wave. FIG. 2 shows an example. It illustrates the ultrasonic transducer characteristic of an exemplary ultrasonic sensor that the proposers of the document presented herein used for a laboratory prototype of the proposed parking system in the course of the development of the technical teaching of this document. FIG. 2 shows, by way of example, the horizontal and vertical propagation of ultrasonic waves from an exemplary sound transducer. In the example of FIG. 2, the sound transducer operated at approximately 58 kHz and provided a maximum sound pressure level (SPL) of approximately 95.24 dB. FIG. 2 also shows the attenuation of the SPL relative to P₀, the reference sound pressure (SPL) of 95.24 dB at a 0° angle. The damping increases with increasing angle. The dashed line in FIG. 2 shows the damping of the vertical wave. The solid line is the damping of the horizontal portion. The horizontal portion propagates more than the vertical portion. The vertical wave reaches the 6 dB limit in an angular range of between 15 and 20 degrees. This means that the SPL is reduced by 50% at this angle. In comparison, the horizontal wave intersects the 6 dB limit only at an angular range of between 40 and 45 degrees. The sound transducer with the ultrasonic radiation characteristic of FIG. 2 has been developed for parking area applications. The vertical propagation is less spread than the horizontal propagation in order to avoid ground reflections. Such sound transducers are particularly preferred for proposed ultrasonic sensor systems. The construction of the sound transducer spreads the horizontal sound field more strongly than the vertical sound field since the ultrasonic sensor that is to comprise the sound transducer is to recognize obstacles in a 2D plane parallel to the surface of a planar vehicle environment. A maximum angle for obstacle recognition is an essential parameter of the proposed ultrasonic sensor system. The damping value at 60 degrees could therefore be characterising. At a 60 degree angle, the SPL is about one fifth of P₀. Thereafter, the SPL converges to zero /8/.

The diagram considers the raw signal. Various sub-apparatuses of the ultrasonic sensor system process the signals sensed by the ultrasonic sensors, on the proposed sensor board. The sensor board is explained in more detail after the following explanation of the communication concept.

### Object

The proposal is therefore based on the object of specifying an ultrasonic sensor system for a vehicle or for a mobile apparatus for ascertaining a map of the surroundings with coordinates of objects in the environment of the ultrasonic sensor system in the form of accepted solutions that has a reduced error rate in the form of a lower spread of the results and a more complete recognition of all relevant obstacles in the surroundings of the vehicle.

This object is achieved by an apparatus according to claim 1. Further embodiments are the subject matter of the sub-claims.

### Achievement of the Object

### Summary of the Invention

The invention relates to an ultrasonic sensor system, in which the ultrasonic sensor system ascertains distance values on the basis of ultrasonic echoes, which are sensed by at least four ultrasonic sensors, and the ultrasonic sensor system ascertains solutions from these distance values by means of a trilateration method and filters each of these solutions by means of a respective Kalman filtering method or by means of an estimation filtering method to form filtered solutions and clusters the filtered solutions by means of a clustering method to form accepted solutions and discards unaccepted unaccepted filtered solutions.

### Communication Concept

### General Information on the Communication Concept

This chapter provides an overview of the communication between the various components used by the exemplary parking system. FIG. 3 shows these components. In the exemplary development of the invention presented herein, a USB host is connected to an NXP board in order to send commands and to visualize incoming data. The USB host provides the voltage supply for the NXP board. An adapter board in this example forms the interface between the NXP board and the sensor board. An external 12V power-supply unit is, by way of example, connected to the adapter board and supplies the board and the sensors. The exemplary parking system contains three further sensors, which are connected to the three other channels of the adapter board. They are not taken into account in FIG. 3.

If this document mentions that the ultrasonic sensor system performs a method, it is usually the control device of the ultrasonic sensor system that performs the relevant method.

### Processor

The exemplary processor of the exemplary NXP board is the ARM Cortex-M4F. This processor is a highly efficient embedded processor. The ARM Cortex-M family follows the ARM-7 architecture in the field of microcontrollers. The exemplary ARM Cortex-M4 has a single-precision floating-point unit (FPU). The FPU increases performance in floating-point-intensive calculations. It is an optional feature. /9/.

### Board Communication

The exemplary main component of the exemplary communication concept is the exemplary NXP development board S32K144EVB. Instead, other functionally equivalent boards may also be used. The board enables fast prototype set-up of automotive test applications. It provides simple access to the MCU M4F via the I/O header pins. It is equipped with on-chip connectivity for CAN, LIN and UART/SCI. A potentiometer enables the precision of voltage and analogue measurements. There are two options for the voltage supply. On the one hand, there is an external 12V power-supply unit. On the other hand, there is a micro-USB port via which communication with the board also takes place. FIG. 4 illustrates the structure of the board communication. The board contains an open standard serial debug adapter (OpenSDA) as a bridge between the target processor and the USB host. OpenSDA has a mass storage (MSD boot loader). The MSD boot loader provides a simple interface for loading various OpenSDA applications /10/.

The standard application offered by Freescale is the P&E debug application. The P&E debug application provides a virtual serial interface and debugging. It provides a run control unit that controls the JTAG debug interface to the processor. Moreover, a USB-CDC interface (communications device class) bridges the serial communication between the USB host and a serial UART interface of the processor. The USB-CDC interface is automatically assigned a COM number that works with a Windows host operating system /10/.

### Ultrasonic Sensor Communication

An adapter board forms the interface between the NXP board and the sensors. In the example presented here, it is connected to the NXP board by inserting the pins into the sockets of the NXP board. The adapter board connects the IO header pins of the NXP MCU. The IO line realizes the communication between the MCU and the sensors. Moreover, the sensor also provides JTAG support. The adapter board contains a quad LIN transceiver IC in order to connect the IO line of the sensors to the MCU. The communication between the sensor and the MCU is time-based. An example of a basic device command is shown in FIG. 5 /11/.

FIG. 5 shows, by way of example, the serial inputs and outputs for the exemplary SendB and ReceiveB commands. The command forces the ultrasonic sensor to emit acoustic ultrasonic burst signals with the properties of exemplary profile B. This document explains the burst generation and the various profiles in a later section /11/.

The exemplary MCU in this example initializes the command here by pulling the IO line to a low potential for a low phase for the time T_{MEAS}. This is followed in this example by a high phase with a time duration of T_{D} and a bit sequence. In this example, the bit sequence “10” initializes the send command. In this example, the bit sequence “00” initializes the receive command. After this sequence, the ultrasonic sensor reports the received ultrasonic echoes by means of an IO line. In this example, the MCU receives this report via the reception line (Rx). In this example, transmitting the command realizes a transmission via the transmission line (Tx). The exemplary quad LIN transceiver IC in this example connects both lines to the IO line of the ultrasonic sensor. The exemplary MCU in this example uses an exemplary timer module for transmitting commands (Tx) and a further, exemplary timer module for receiving the sensor data (Rx). In this example, both timers operate at a frequency of 1 MHz, resulting in an exemplary resolution of 1 s. The exemplary operation of transmitting and receiving commands is visualized in FIG. 6. The first step of the exemplary transmission mode is loading the channel data. The exemplary MCU prepares the outTimeFrame event array on the basis of this command. This array contains time and value pairs. An exemplary interrupt service routine, which the exemplary MCU, by way of example, executes, initializes an output comparison timer. The exemplary timer module in this example updates the values from the prepared array in order to generate the command sequence.

Thereafter, in this example, the MCU switches to the receive mode. The flow of the exemplary receive mode of this example is also visualized in FIG. 6. In this example, the ultrasonic sensor reports the recognition of an echo by pulling down the IO line. After the echo report, the ultrasonic sensor in this example also puts time status information on this IO line. In this example, the timer module 0 captures the resulting frame (data frame) of echo and status information.

The exemplary MCU memory in this example this frame in the CHnCaptureResult array based on an interrupt service routine. The data of the exemplary MCU in this example are thus available in the controller for processing and evaluation steps. This document explains the sensor configurations of the ultrasonic sensors below, while the processing of the data is the focus of a later section.

### Ultrasonic Sensor Configurations

The exemplary ultrasonic sensor used in this parking assistance system is the exemplary sensor board on the basis of the integrated sensor evaluation circuit E524.09 from the company Elmos Semiconductor SE in Germany. The exemplary sensor board contains an exemplary driver unit that excites an ultrasonic transducer via a centre-tap transformer. The user can configure parameters, such as driver frequency or transmitted burst power, via a data interface. In this example, the user may store application-relevant settings in an EEPROM. In this example, apparatus portions of the board amplify the received echo signal, convert the received echo signal, and digitally process the thus converted echo signal further.

### Measurement Principle and Application

### Exemplary Ultrasonic Sensor Application

The exemplary ultrasonic sensor application in this parking assistance system is distance measurement. FIG. 7 shows the measurement principle. The principle is based on emitting a pulse and measuring the reflection time of the received pulse. The propagation speed of an ultrasonic pulse is essential for measuring the distance of an object from the ultrasonic sensor system. The speed of the ultrasonic signal in ambient air depends on the matter and temperature. It is =343 m/s in air at a temperature of 20° C. The user or the MCU can calculate the distance to a reflecting object using the formula L=V*T_{of}/2. The time of flight (T_{of}) is equal to the reflection time T. The exemplary sensor IC only requires one measuring transducer (ultrasonic transducer), which acts as transmitter and receiver. Two different circuits are connected to the ultrasonic transducer and the control circuit. They separate the transmission and receive pulses /8/.

### Basic Concept

In this example, an exemplary SEND or RECEIVE request starts the exemplary measurement cycle. The SEND command results in the generation of a burst signal for the ultrasonic transducer. The integrated circuit, the sensor IC, digitally amplifies the incoming pulses and compares the result to the threshold values. The RECEIVE command skips the burst generation.

In this example, if the echo pulse exceeds the threshold value, the sensor IC will trigger the IO line. The time difference between the ultrasonic transducer emitting the ultrasonic burst signal and the ultrasonic transducer receiving the echo is proportional to the distance of the reflected object from the ultrasonic transducer. Below, this document the various parts of the concept in more detail.

### Burst Mode

In this example, the exemplary burst mode generates an ultrasonic burst signal by using a centre-tap transformer and a transducer. The primary side of the transformer has two windings, which in this example are connected in the centre to a power source. The other sides of the two windings are alternately connected to earth. The arising current results in a changing magnetic flux. The secondary winding generates the burst pulse signal /11/.

The frequency of the switches connecting the windings to earth is equal to the frequency of the burst signal. FIG. 8 shows the exemplary time diagram of the exemplary driver of the ultrasonic transducer. The exemplary signals DRV1_ON and DRV2_ON represent the switches for the transformer windings. The diagram of FIG. 8 shows not only the exemplary time behaviour but also the exemplary burst signal itself. It illustrates that the exemplary ultrasonic burst signal consists of a defined number of ultrasonic pulses which the ultrasonic transducer emits directly one after the other as said ultrasonic burst and whose pulse widths depend on the ultrasonic burst frequency. In addition to the ultrasonic burst frequency and the number of ultrasonic pulses per ultrasonic burst, the power of the driver current is a configurable parameter when generating the ultrasonic pulses. Increasing the driver current implies a higher ultrasonic burst power of the radiated ultrasonic burst, which is radiated by the ultrasonic transducer.

### Profiles

The exemplary microelectronic circuit (IC) used in the development of the technical teaching presented herein provides access to three different profiles in this example: profiles A, B and C. The MCU calls these exemplary profiles through the three SEND and RECEIVE commands. The number of ultrasonic burst pulses, the measurement time and the scaling of the threshold value curve can be configured in each profile of the exemplary micro-integrated circuit. Table 1 shows the exemplary default values of the different exemplary profiles.

TABLE 1
Sensor profiles /11/:

| | Number of | Measurement Time | Scaling of the |
|---|---|---|---|
| Profile | Pulses | in ms | Threshold Values |
| A | 16 | 14.58 | 1 |
| B | 8 | 8.75 | 1 |
| C | 24 | 34.98 | 1 |

In general, an ultrasonic burst with fewer pulses will have better performance in short-range applications, while a burst with more pulses will have better performance in the case of longer ranges.

Profile B therefore has a measurement time of 8.75 ms, which corresponds to a maximum range of 1.5 m in the example presented here. However, this range is not sufficient for every parking situation. The ultrasonic sensor system may then apply profiles A and C. In the example presented here, profile A provides a maximum range of 2.5 meters. In the example presented here, profile C provides a maximum range of 6 meters, which is useful for long-range applications.

### Echo Recognition

The exemplary receive mode receives the ultrasonic burst signal reflected by the object. The centre-tap transformer is isolated from the supply current in order to avoid parasitic couplings. The ultrasonic sensor taps the echo signal as an ultrasonic reception signal near the ultrasonic transducer. The micro-integrated circuit of the ultrasonic sensor amplifies and digitizes the ultrasonic reception signal. The micro-integrated circuit of the ultrasonic sensor digitally filters and re-amplifies the ultrasonic reception signal. Hereinafter, this document refers to the resulting signal as an envelope signal. This envelope signal contains an amplitude for each distance value. The amplitude represents how strongly a surface reflects the ultrasonic burst signal. The envelope signal thus represents each reflection. The micro-integrated circuit of the ultrasonic sensor uses the envelope signal for echo detection. The basic principle of echo detection is the comparison between the envelope signal and the threshold value curve. If the envelope value exceeds the threshold value for a defined time, the micro-integrated circuit of the ultrasonic sensor detects this exceedance as an echo of the ultrasonic burst. FIG. 9 shows an example of an envelope signal with three recognized echoes.

The x axis represents the distance from the ultrasonic sensor to a reflecting object, which distance is calculated from the time of flight in the form of the reflection time t, of the ultrasonic burst echoes. The y axis shows the amplitude of each value.

The exemplary ultrasonic sensor applies the exemplary ReceiveA profile during the measurement in FIG. 9. In the example of FIG. 9, another ultrasonic sensor thus generates the received ultrasonic burst echoes. The solid line represents the resulting envelope signal. The dotted line represents the exemplary threshold value curve. The threshold value curve can be configured by some parameter settings in the micro-integrated circuit. In this example, the user can define thirteen threshold values. In the exemplary micro-integrated circuit used, these values have different mathematical relationships, from which the threshold value curve results in this example. In addition to static threshold value generation, the micro-integrated circuit used in the development of the invention also provides automatic threshold value generation. This automatic threshold value generation is a combination of static and dynamic generation in this example. The dynamic part adjusts the threshold value curve as a function of the time curve of the envelope signal after the ultrasonic burst has been emitted by the ultrasonic sensor. An exemplary, statically generated threshold value curve is shown in FIG. 9. The static values are increased in order to prevent echoes of small amplitude.

The dashed line in FIG. 9 represents the recognition result as a digital signal. This is also called IO line here. In the exemplary test set-up used for the development of the invention, the IO line was the data transfer medium between the sensor board and the control unit. The IO line is connected to the voltage supply of the sensor board via a pull-up resistor. If the time value of the envelope signal exceeds the threshold value curve, the IO line switches to a lower voltage level. The ultrasonic sensor thus signals the recognition of an ultrasonic echo signal to the control unit.

By way of example, a switch of the IO line from the high state to the low state is defined in this document as an ultrasonic echo. In the language of this document, it is thus a specific behaviour of the IO line. The IO line switches from the high state to the low state in this example if the level of the envelope signal exceeds the threshold value curve. In the figures, the emission of the ultrasonic burst at t=0 s is always assumed. With the emission of a new ultrasonic burst, time in the sense of this document again starts at 0.

The exemplary micro-integrated circuit used provides two different ways of recognising an ultrasonic echo. The first way of recognising an ultrasonic echo is echo width recognition. In this case, the IO line is pulled downward if the envelope signal exceeds the threshold value curve. The second way of recognising an ultrasonic echo is echo peak value recognition. After the envelope signal has crossed the threshold value curve, the first maximum of the envelope signal pulls down the IO line. Such an echo peak recognition is illustrated, by way of example, in the exemplary FIG. 9.

FIG. 10 shows the principle of ultrasonic echo recognition with the exemplary SendA profile in comparison to the exemplary ReceiveA command. The temporally first values of the envelope signal belong to the ultrasonic burst signal, including the ring time. The vibration of the sound transducer in the ultrasonic transducer induces this ring time after the actuated pulses. The sound transducer still vibrates when switching from transmission mode to receive mode. In this time of continued vibration, i.e., ring time, reception cannot take place. Typically, this results in a dead time and thus a blind zone in front of the ultrasonic sensor, in which the ultrasonic transducer cannot recognize any ultrasonic echoes. The width of this blind zone from the ultrasonic sensor depends on the parameters of the ultrasonic burst signal emitted by this ultrasonic transducer of this ultrasonic sensor.

FIG. 10 shows that a low threshold value curve results in a sensitive echo evaluation. The example presented in FIG. 10 applies the default values of the static threshold generation to the micro-integrated circuit used. If, for example, the ultrasonic sensor senses a mast, different reflections of this mast may result in different ultrasonic echoes. An object thus typically generates a plurality of temporally consecutive echoes. In this exemplary measurement, the ultrasonic sensor system senses three posts, which are reflected in the form of six echoes in the signal of the I/O line.

The third and fourth echoes are reflections of the same post as the second echo. The post reflects the echoes in different vertical positions. The echoes three and four therefore have lower amplitudes depending on the wave propagation characteristic of the sensor. In addition to multiple echoes, ground reflections can also result in echoes that do not belong to objects. The aim of the document presented herein is to disclose a system for obstacle recognition. In order to avoid undesired reflections and multiple reflections, correct interpretation of the echoes is therefore necessary. For this reason, the threshold value curve is shifted upward. FIG. 11 illustrates the effects of shifting the threshold value curve. In this case, the ultrasonic sensor system only recognizes the three echoes of the three posts. The technical teaching of this document therefore selects these threshold value settings for echo recognition in the method for obstacle recognition.

### Obstacle Recognition

The obstacle recognition proposed herein by way of example is aimed at recognising objects based on the echoes measured by four exemplary ultrasonic sensors with micro-integrated circuits of the type E524.09 from the company Elmos Semiconductor SE. An exemplary method provides the position of obstacles within a 2D space. For this purpose, the method takes into account the first three echoes of each ultrasonic sensor. The method ascertains the position of the object without amplitude information of the signals. The ultrasonic sensor system described herein by way of example uses the test set-up described herein by way of example to realize obstacle recognition.

### Stage 1: Generation and Reception of Ultrasonic Echoes

### Laboratory Set-Up

In the laboratory test set-up, presented herein by way of example, for the development of the technical teaching disclosed herein, the four ultrasonic sensors are mounted on a wooden board. This board is attached to the rear side of a car. The ultrasonic sensors are mounted in a similar position and height above the road surface as normal ultrasonic parking sensors in the bumper bar. FIG. 12 shows a rough outline of the exemplary test set-up.

The distance d=d1=d2=d3 between the individual ultrasonic sensors is 40 cm in the example. In practice, the distances between the ultrasonic sensors vary since they are mounted at different positions. The distance between the ground and each ultrasonic sensor should not vary too much since it is necessary to obtain correct solutions within the 2D plane. In the example presented, a fifth sensor is mounted on the board in order to simulate the impact of noise from other parking cars in the exemplary experiment presented herein. This ultrasonic sensor is considered in a later section of this document that deals with the filtering of the signals.

### Transmit and Receive Sequence

In the example presented herein, managing transmit and receive commands is essential. In this example, only one ultrasonic sensor emits one ultrasonic burst signal at a time. Otherwise, the ultrasonic waves would interfere with one another, which would require further actions. FIG. 13 shows that, for example, ultrasonic sensor 2 emits an ultrasonic burst signal. The ultrasonic sensors 1, 2 and 3 receive in this example. This transmit and receive sequence is referred to as channel 2. The echoes received by the first ultrasonic sensor are not taken into account in channel 2 in this example. In general, in this example, the measurement is distinguished into four channels.

In this example, an ultrasonic sensor transmits and receives an ultrasonic burst signal in each channel, and the two ultrasonic sensors closest to this ultrasonic sensor process the incoming data in order to recognize ultrasonic echoes. Table 2 summarizes the four channels.

TABLE 2
Transmit and Receive Sequence

| Channel | Transmitting Sensor | Receiving Sensor |
|---|---|---|
| 0 | 0 | 0, 1, 2 |
| 1 | 1 | 0, 1, 2 |
| 2 | 2 | 1, 2, 3 |
| 3 | 3 | 1, 2, 3 |

In this example, the state of the exemplary ultrasonic sensor system must change during the measurement time such that the ultrasonic measurement system utilizes at least in each channel at least once during the measurement time. This time in this example depends on the profile selected (Table 1). Moreover, in this example, there is a delay time configured in the source code of the NXP board NXPB. By way of example, this time is 30 ms within the framework of developing the technical teaching of this document. In the example presented herein, the ultrasonic sensor system processes the channels sequentially. When channel 3 is finished, channel 0 starts again. Below, this sequence is referred to as a cycle. The time for a cycle is 120 ms, by way of example, here.

### Stage 2: Trilateration of the Received Ultrasonic Echoes

### Trilateration by Two Sensors

The simplest way to find a 2D point by interpreting the first ultrasonic echoes recognized by two ultrasonic sensors is shown in FIG. 14. One of these ultrasonic sensors emits an ultrasonic burst, and both ultrasonic sensors receive ultrasonic echoes. The two circles in FIG. 14 represent the ultrasonic echoes. When the first ultrasonic sensor transmits, the ultrasonic sensor system can determine the distance d₀ to the reflecting object using the regular formula d₀=V*T_{of}/2. In this case, the ultrasonic sensor system can, for example, determine the distance d₁ using the formula d₁=V(T_{of1}-T_{of0}). The ultrasonic sensor system here, by way of example, subtracts the time-of-flight Toro from the time-of-flight T_{of1} in order to ascertain the time between the start of reflection and the measurement of the received signal. Wave propagation is assumed to be a perfect circular flow in this exemplary visualisation. The position of the object can therefore be visualized as a 2D intersection point of two circles. The radii of the two circles are equal to the distance of a reflecting surface.

The position of the object can be ascertained by the ultrasonic sensor system using the following formulae:
i) applying the cosine rule to the triangle of d₀, d₁, and x_{d}:

$$cos α = x / {d}_{0} = ( {d}_{0}^{2} + {x}_{d}^{2} - {d}_{1}^{2} ) / ( 2 * {d}_{0} * {x}_{d} )$$

ii) replacing the cosine in the right triangle in order to obtain the x position:

$$x = ( {d}_{0}^{2} + {x}_{d}^{2} - {d}_{1}^{2} ) / ( 2 * {x}_{d} )$$

iii) ascertaining the y position

$$y = root ( {d}_{0}^{2} - {x}^{2} ) = root ( {d}_{0}^{2} - {[ ( {d}_{0}^{2} + {x}_{d}^{2} - {d}_{1}^{2} ) / ( 2 * {x}_{d} ) ]}^{2} )$$

The determination of an intersection point is referred to as trilateration in the following chapters.

In contrast, the general 2D space trilateration is based on the intersection points of three circles. The third circle determines which intersection point of the two circles results in the sought position. The ultrasonic sensor of the exemplary test set-up generates a semi-circle in a positive direction. There is therefore only one intersection point of the two circles. A third circle is thus not required /12/.

### Problems Due to a Plurality of Objects

The trilateration of two ultrasonic sensors enables the calculation of the position of an object. However, if there is a plurality of objects in the area of the two ultrasonic sensors, misinterpretation of ultrasonic echoes can result in false solutions. FIG. 15 shows a possible scenario. The ascertainment in FIG. 15 assumes that the first ultrasonic echoes of the two ultrasonic sensors are reflected by an obstacle in the form of an object and the second ultrasonic echoes are reflected by another obstacle in the form of another object.

The left portion of FIG. 15 demonstrates the measurement of two objects using two ultrasonic sensors. The first ultrasonic sensor emits an ultrasonic burst signal. Both ultrasonic sensors receive a first and a second ultrasonic echo.

The reflection of the first object results in the first ultrasonic echo that the first ultrasonic sensor receives. The reflection of the second object results in the second ultrasonic echo that the first ultrasonic sensor receives.

The reflection of the second object results in the first ultrasonic echo that the second ultrasonic sensor receives. The reflection of the first object results in the second ultrasonic echo that the second ultrasonic sensor receives.

The right portion of FIG. 15 shows the solutions of the measured ultrasonic echoes. Two trilaterations calculate these solutions. The trilateration of the two first ultrasonic echoes results in the solution of the first ultrasonic echo. The arguments of the trilateration function are two distances that the ultrasonic sensor system can ascertain by means of the echo functions d0_first=V*First Echo 0 and d1_first=V*(First Echo 1−First Echo 0).

The time of flight of the first ultrasonic echo that the ultrasonic sensor 0 senses is subtracted from the time of flight of the first ultrasonic echo that the first ultrasonic sensor senses, since it is assumed that the same object generates both ultrasonic echoes. It is thus assumed that the reflection of the ultrasonic burst on object 2 generates the two second ultrasonic echoes. In this case, the ultrasonic sensor system can ascertain the distances for the trilateration using formulae d_{0_second}=V*Second Echo 0 and d_{1_second=V}*(Second Echo 1-Second Echo 0). FIG. 15 represents the problem that may arise due to the incorrect mapping of the ultrasonic echoes to the objects. The ultrasonic echoes of the two ultrasonic sensors that first arrive at the ultrasonic sensors do not belong to the same object. The trilateration of the two first ultrasonic echoes therefore results in an incorrect calculation of a position of the relevant objects. The same happens with the second ultrasonic echoes that arrive second.

In this case, the trilateration of the first ultrasonic echo that the first ultrasonic sensor senses and of the second echo that the second ultrasonic sensor senses would result in the correct recognition of object one. However, the mapping of the ultrasonic echoes depends on the scenario, the number and the properties of the obstacles. In order to avoid false solutions and to correctly recognize a plurality of objects, the exemplary laboratory set-up uses the exemplary method now described below.

### Method for Recognising a Plurality of Objects

The method for recognising a plurality of objects uses, in each channel, the first three ultrasonic echoes of an ultrasonic sensor that temporally arrive first. In the example discussed herein, nine ultrasonic echoes in each channel (Table 2) and 36 ultrasonic echoes per cycle are taken into account by way of example. For better understanding of the explanation, the following initially takes into account only the first ultrasonic echoes for simplification purposes. The example is thus only a very crude simplified example.

The idea of the method is to ascertain the 2D points of various perspectives. The method is based on the trilateration of two ultrasonic sensors. When an ultrasonic sensor emits an ultrasonic burst, the trilateration solutions of the two other ultrasonic sensors of this channel are ascertained. If, for example, the ultrasonic sensor 0 emits the ultrasonic burst, the ultrasonic sensor 0, the ultrasonic sensor 1, and the ultrasonic sensor 2 receive. The ultrasonic sensor system ascertains the first trilateration from the first ultrasonic echo that the ultrasonic sensor 0 receives, and the first ultrasonic echo that the ultrasonic sensor 1 receives.

The ultrasonic sensor system ascertains the second trilateration from the first ultrasonic echo that the ultrasonic sensor 0 receives, and the first ultrasonic echo that the ultrasonic sensor 2 receives.

These two trilaterations thus result in two solutions from different perspectives. Thereafter, the ultrasonic sensor system compares these 2D points in order to check whether they belong to the same object. To this end, the ultrasonic sensor system compares the x and y coordinates. If the coordinates of the second 2D solution of the first trilateration are close enough to the first 2D solution of the first trilateration, the ultrasonic sensor system accepts the first solution as a valid 2D solution and thus as a valid 2D point.

By way of example, FIG. 16 illustrates the idea of the method. The exemplary ultrasonic sensor system reconstructs the scenario in the surroundings of the sensor system by using the measured ultrasonic echoes of channel 0. The black line symbolizes the temporally first ultrasonic echo that the first ultrasonic sensor senses as Echo First 0 after the ultrasonic burst has been emitted. The short-dashed line symbolizes the temporally first ultrasonic echo that the second ultrasonic sensor senses as Echo First 1 after the ultrasonic burst has been emitted. The long-dashed line symbolizes the temporally first ultrasonic echo that the third ultrasonic sensor senses as Echo First 2 after the ultrasonic burst has been emitted. The trilateration of Echo First 0 and Echo First 1 results in solution 1 (Soil). The trilateration of Echo First 0 and Echo First 2 results in solution 2 (Sol2). After calculating the two trilaterations, the proposed method carried out by the ultrasonic sensor system compares the two solutions. As part of this method, the ultrasonic sensor system checks whether the second solution is within a typically specified, programmed, or ascertained, defined rectangle of the first solution. In FIG. 16, this (short-dashed) rectangle is drawn as a square since the limit values are the same in all directions.

In the exemplary scenario of FIG. 16 Scenario, solution 2 is within the defined area of solution 1. The solution is therefore a valid solution and the ultrasonic sensor system accepts this solution as a valid 2D point where an obstacle may be located. The likelihood of the ultrasonic sensor apparatus misinterpreting solutions as objects decreases in this way.

The recognition of a single, isolated post, i.e., an isolated rod or another perpendicularly standing, narrow object, could work by the ultrasonic sensor apparatus using only the first echoes. Such posts were used in the development of the technical teaching of this document to assess the quality of recognition of the ultrasonic sensor system. A post in the sense of this document is a perpendicularly standing object that is preferably round and has a height in the range of approximately 1 m. Although these objects in the form of posts were used in the development of the technical teaching of this document, the findings still relate to general objects that may be located in the surroundings of a vehicle with the ultrasonic sensor system. However, a plurality of objects can likewise be recognized in some scenarios. The critical fact is, however, that any object to be recognized in this example with three ultrasonic sensors must generate three first ultrasonic echoes, which the three ultrasonic sensors here, by way of example, do sense. All three ultrasonic sensors here, by way of example, must thus “see” the object. For example, in one example, a post is placed in front of the first ultrasonic sensor and a post is placed in front of the third ultrasonic sensor in a symmetric manner. Channel 0 would “see” the first object and channel 2 would “see” the second object. This example shows that recognition of a plurality of objects by means of the first echoes only works in the case of particular constellations of obstacles. The method presented herein therefore also takes into account the temporally second ultrasonic echoes and the temporally third ultrasonic echoes to increase the chance of seeing a plurality of objects or of obtaining a better resolution of the surface of one object.

FIG. 17 illustrates the principle of the method. The method differs in the search for solutions for the first ultrasonic echo, second ultrasonic echo, and third ultrasonic echo of the firing ultrasonic sensor in each channel.

FIG. 17 visualizes the principle of finding a solution for the first ultrasonic echo that the transmitting ultrasonic sensor 0 receives. The ultrasonic sensor apparatus ascertains the solutions for the second ultrasonic echo and the third ultrasonic echo that the ultrasonic sensor 0 receives in the same manner.

The method that the ultrasonic sensor system typically carries out starts with initialising the “diff” value. This value represents the permissible tolerance of the different 2D solutions. The ultrasonic sensor system initially sets the “diff” value to the value “i_step”, which means the iteration step. If the ultrasonic sensor system does not find a solution, the ultrasonic sensor system increases the difference value by the iteration step value. After initialising the difference value, the ultrasonic sensor system compares the first echo solution of the first ultrasonic sensor and the second ultrasonic sensor with the first echo solution of the second ultrasonic sensor and the third ultrasonic sensor. For example, if these solutions are within the defined square relative to one another, the ultrasonic sensor system accepts the solution of the first ultrasonic sensor and second ultrasonic sensor. The search for a first echo solution is then ended. However, if the two solutions do not match, the ultrasonic sensor system compares the first solution with the trilateration from the first ultrasonic echo that the ultrasonic sensor 0 receives, and the second ultrasonic echo that the ultrasonic sensor 2 receives. If these solutions are not close enough together, the ultrasonic sensor apparatus repeats this comparison with the first ultrasonic echo and the third ultrasonic echo.

The ultrasonic sensor system thus compares, on the first side of the comparison, the first solution, which results from the first ultrasonic echo that the ultrasonic sensor 0 receives, and the first ultrasonic echo that the ultrasonic sensor 1 receives, to, on the other side of the comparison, any possible second solution, which pairwise from firstly, as the first element of this pairwise combination, the first ultrasonic echo that the ultrasonic sensor 0 receives, or the first ultrasonic echo that the ultrasonic sensor 1 receives, and secondly, as the second element of this pairwise combination, in each case an ultrasonic echo from the set of the first ultrasonic echo and the second ultrasonic echo and the third ultrasonic echo that the ultrasonic sensor 2 receives. If the ultrasonic sensor system does not find an accepted 2D point, the ultrasonic sensor system again compares the solution of the first and second ultrasonic echoes of ultrasonic sensor 0 and 1 with the three solutions. If the ultrasonic sensor system finds a solution, the ultrasonic sensor system accepts the trilateration value of the first and second ultrasonic echoes as a possible obstacle position. Otherwise, the ultrasonic sensor system carries out three further comparisons. The ultrasonic sensor system again compares the solution of the first ultrasonic echo of the ultrasonic sensor 0 and of the third ultrasonic echo of the ultrasonic sensor 1 with the three solutions of the ultrasonic sensor 2. If the ultrasonic sensor system does not accept a 2D point, the ultrasonic sensor system does not find a solution for the first ultrasonic echo of the first ultrasonic sensor in this iteration. Thus, the next iteration starts. Beforehand, the ultrasonic sensor system increases the range of solution by a higher differential parameter. The iteration step variable indicates the step width of the solution range.

The ultrasonic sensor system ends the search for the first ultrasonic echo solution if the ultrasonic sensor system has found a valid 2D point or the value of the “diff” variable reaches a defined limit value. FIG. 17 considers a first echo solution. The ultrasonic echo system applies the same flow for second and third echo solutions for the transmitting ultrasonic sensor in each channel. Ultrasonic echoes that the ultrasonic sensor system uses for an accepted solution are blocked by the ultrasonic sensor system from further calculation in the same channel. The ultrasonic sensor system thereby prevents multiple use of ultrasonic echoes from resulting in false solutions. Each cycle contains 12 solution-finding processes resulting in a theoretical maximum of 12 different objects.

### Solutions and Parameters

Using the method described above by way of example, the ultrasonic sensor system can recognize a maximum of three obstacles in each channel by the ultrasonic sensor system applying the method to the first, second, and third ultrasonic echoes. FIG. 18 shows an example. By way of example, FIG. 18 shows exemplary solutions of the method by measuring six different, exemplary posts.

FIG. 18 visualizes the four ultrasonic sensors as points on the x axis. Figure plots the solutions as 2D points. The dashing of the circles of the solutions corresponds to the dashing of the semi-circles of the relevant ultrasonic sensor that in each case emits the ultrasonic burst signal in this channel. If the marking of the circle is a solid circular circumferential line, the solution from the ultrasonic echoes of the channel 0 is calculated. Only the first channel captures the left object. FIG. 18 therefore shows all solutions belonging to the first object as an uninterrupted continuous circular line. The second object on the left side that the first channel and the second channel capture results in solution plots with solid circular lines and interrupted circular lines in FIG. 18. The number of points with a solid circular line is lower in comparison to the first object. This means that the first channel does not recognize the obstacle in each cycle. The first channel and the third channel recognize the furthest obstacle. The first channel thus detects an obstacle in each echo. The second and third ultrasonic echoes result in multiple obstacle recognition.

The recognition depends on the number, position and properties of the obstacles relative to the ultrasonic sensors. If, for example, an ultrasonic burst signal does not reach an object because another object shadows it when one channel is used, this object cannot be recognized in the relevant channel. The properties, in particular the surface of an obstacle, play an important role in the parking system. In addition to the angle of the arriving waves, the size and shape of the surface is also critical. For example, recognising a wide surface, such as a wall, requires more iterations than recognising a small post. FIG. 19 illustrates this. The left diagram (FIG. 19a) in FIG. 19 relates to the measurement of a small post; the right diagram (FIG. 19b) relates to the measurement of a wall. Both diagrams visualize a solution of the first ultrasonic echo of the channel 0. The solid line represents the first ultrasonic echo of the ultrasonic sensor 0 of the first sensor board SNSB1. The short-dashed line symbolizes the first ultrasonic echo of the ultrasonic sensor 1 of the second ultrasonic sensor board SNSB2, while the long-dashed line symbolizes the first ultrasonic echo of the ultrasonic sensor 2 of the third ultrasonic sensor board SNSB3. The parameters in FIG. 19 are set, by way of example, to the default parameters. The iteration step is 60 us, which corresponds to about 2 cm. The difference limit is 800 us, which corresponds to approximately 27 cm. The solution of the location of the post is already ascertained in the example of FIG. 19 in the first iteration. The difference between the two solutions is about 1.4 cm, which corresponds to the time of 40 us. The two intersection points with the solid line are very close together. In comparison, the distance between the two solutions in the wall measurement is about 9 cm. This only results in the 5th iteration in a solution accepted by the ultrasonic sensor system at a resolution of 60 us.

The difference between wall and post sensing increases in channel 1. FIG. 20 visualizes the ultrasonic echoes of a wall measurement. The ultrasonic sensor 1 (solid line) transmits in this case. The two intersection points with the first ultrasonic echo of ultrasonic sensor 1 differ by 33 cm. The ultrasonic sensor system would not accept the solution as a valid value, although the ultrasonic echoes belong to the wall obstacle. The ultrasonic sensor system therefore increases the difference limit to 1166 μs, which corresponds to the distance a of 40 cm. This results in solutions in channel 1 and channel 2 during the wall measurement. Increasing the difference value can result in false solutions by misinterpreting echoes and their relationships. The ultrasonic system therefore preferably checks each solution for the theoretically achievable positions of the current channel in order to rule out false solutions. The following chapter deals with these positions.

### Solution Ranges

The range of possible solutions depends on the range of the respective ultrasonic sensor itself. The sensor used on the basis of the Elmos sensor IC E524.09 has the characteristic of the ultrasonic transducer, which is shown in FIG. 2. According to this FIG. 2, the maximum viewing angle of each ultrasonic sensor is assumed to be approximately 120 degrees. This angle was practically tested in the development of the technical teaching of this document. To this end, a small post was moved on a semicircle in front of a transmitting ultrasonic sensor. The post can no longer be reliably detected beyond a 120 degree angle to a viewing axis of the ultrasonic sensor.

The limit value curve is configured with the obstacle recognition parameters in order to create identical conditions. In addition to the limit angle to the viewing axis of the ultrasonic sensor, the distance to the post is also relevant.

A spherical surface function (see also https://de.wikipedia.org/wiki/Kugelfl%C3%A4chenfunktionen)) typically describes a radiation lobe and/or reception sensitivity lobe of each ultrasonic sensor. Preferably, such a lobe has an elliptical cross-section with a cross-sectional ellipse. The intersection points of the major axes of these cross-sectional ellipses form the viewing axis of the relevant ultrasonic sensor. In the case of more complicated cross-sectional areas of the radiation lobe or of the reception sensitivity lobe, the respective centres of gravity of the respective cross-sectional areas form the viewing axis of the relevant ultrasonic sensor in the sense of the document presented herein.

FIG. 21 shows the exemplary ranges of the four exemplary ultrasonic sensors. Each ultrasonic sensor recognizes the exemplary post object about 80 cm to the left and 80 cm to the right in front of the ultrasonic sensor, taking into account the viewing angle. This limit is not absolute in practical measurements. Objects beyond this area may likewise be perceived, but the likelihood decreases as a function of the surface of the object. The method used by the proposed ultrasonic sensor system operates at these limits in order to minimize incorrect positions that may not belong to an object. Moreover, it is not necessary to extend the areas because if the solution of one channel is very far away, another channel will recognize this object.

The trilaterations of each channel require three ultrasonic sensors. An object must therefore be “seen” by three ultrasonic sensors. Objects should thus preferably be placed between the first and fourth ultrasonic sensors. The numbers in FIG. 21 show which ultrasonic sensor receives ultrasonic echoes from this area. The first two channels recognize objects in the x range between 0 and 80 cm. The second two channels recognize obstacles with an x position between 40 cm and 120 cm. Not every y position in the range between 0 cm and 120 cm can be sensed. If objects are too close to the ultrasonic sensor system, the outer sensor does not receive an echo from this object. The same problem occurs with objects having an x position next to the four ultrasonic sensors. Both problems could result in some bad scenarios in parking situations. The following fallback is an implemented part of the method in order to prevent these bad scenarios. The term fallback may be understood herein as an emergency operation or emergency operation rule.

### Fallback

The method preferably contains a fallback in order to recognize objects with fewer ultrasonic sensors in the outer and the closer areas. Fallback means that the method does not compare the solution of two ultrasonic sensors to a third sensor solution. The ultrasonic sensor system then accepts a solution of two ultrasonic sensors without further proof. In the laboratory prototype of the ultrasonic sensor system used for the development of the technical teaching of this document, this fallback is implemented only for near and outer field recognition. It takes into account only the first ultrasonic echoes of the ultrasonic sensors. Taking into account second and third ultrasonic echoes could result in false solutions due to incorrect echo mappings. Multiple object recognition is also possible in the fallback area. Each channel may recognize an object by the first ultrasonic echo and two further objects by the second and third ultrasonic echoes. The fallback increases the detection range and reliable object recognition at small distances. FIG. 22 shows the various operating ranges.

The bold rectangle shows the range of the sensor solutions on the basis of three ultrasonic sensors without fallback. The rectangle is open in the positive y direction since FIG. 22 focuses on near field recognition and does not show the full range in the y direction. The solid line symbolizes that the boundary of the rectangle is rigid. The ultrasonic sensor apparatus only accepts solutions from three ultrasonic sensors within this rectangle. This area is referred to as a three-sensor area. In contrast, by using the fallback, the ultrasonic sensor apparatus accepts solutions from two ultrasonic sensors even around the bold rectangle. This area is the fallback area. This document refers to the area marked with dashes in FIG. 22 minus the three-sensor area as the fallback area. It means that solutions resulting from fewer than three ultrasonic sensors can result in accepted points in this area. Two-sensor solutions are generally accepted anywhere in the fallback area, depending on the ultrasonic sensor currently transmitting. The ultrasonic sensor system accepts solutions having an x position between the first and third ultrasonic sensors within channel 1. Channel 2 accepts solutions between the second and fourth ultrasonic sensors. The two middle ultrasonic sensors calculate points by means of their first ultrasonic echo and the first ultrasonic echo of the two ultrasonic sensors next to them. For example, channel 1 calculates a trilateral with the first ultrasonic echo of ultrasonic sensor 1 and ultrasonic sensor 0 first. If this does not result in a solution, the ultrasonic sensor system carries out a trilateration of the first ultrasonic echo of ultrasonic sensor 1 with the first ultrasonic echo of ultrasonic sensor 2. In channel 2, the calculation is analogous for the ultrasonic echoes of ultrasonic sensor 3 and ultrasonic sensor 1. As a result, the ultrasonic sensor system always recognizes objects that are located in front of the four ultrasonic sensors, in two channels. This results in greater safety in the close range.

Channel 0 and channel 3 measure obstacles in the lateral range. Redundant object recognition is not possible since only the two outer ultrasonic sensors can receive ultrasonic echoes from objects next the ultrasonic sensors. In each channel, the ultrasonic sensor system therefore ascertains only one trilateration of the two first ultrasonic echoes. If this trilateration does not result in a solution, the method that the ultrasonic sensor system carries out also contains a fallback to a single ultrasonic sensor. The method notices an obstacle in this outer area if only the transmitting ultrasonic sensor gets an ultrasonic echo back. It first checks whether the ultrasonic echo does not belong to another object by comparing the ultrasonic echo with the distance, calculated by the other channel, to objects.

FIG. 23 illustrates why this implementation is necessary. The left side shows the ultrasonic echoes of channel 0 and channel 1. Channel 1 detects an obstacle by means of three first ultrasonic echoes. In contrast, the ultrasonic transmit burst of ultrasonic sensor 0 is only measured by ultrasonic sensor 0. According to the fallback to one ultrasonic sensor, the method would accept the ultrasonic echo of sensor 0 as a solution. In channel 1, the distance between sensor 0 and the object is calculated. This distance is compared to the distance calculated by channel 0 in order to prevent a false solution. If the echo distance is close to the object distance, the ultrasonic sensor system does not accept the ultrasonic echo as a permissible one-sensor solution. The ultrasonic sensor system thus reduces the likelihood of false solutions due to misinterpretation of ultrasonic echoes. In particular in the case of objects with irregular and angled surfaces, scenarios may occur as shown in FIG. 23.

The ultrasonic sensor system preferably also applies the fallback to one ultrasonic sensor in channels 1 and 2 in order to recognize, in the very close range, obstacles that can only be sensed by one ultrasonic sensor. FIG. 22 symbolizes this area by the dashed bold line.

The last implemented boundary, regardless of the fallback, is explained using FIG. 24. Practical measurements resulted in some false solutions without limiting the solution range for channel 0 and channel 3. The ultrasonic sensor system checks solutions from these channels for an angle to the viewing axis of the ultrasonic sensor. If the solution is further inward than the angle “alpha_lim” α₈ₘ, the ultrasonic sensor system does not accept it as a valid point. “Alpha_lim” αₗᵢₘ is set at exemplary 450 degrees in the laboratory prototype used for the development of the invention.

### Exemplary Implementation

An exemplary implementation of the trilateration method was very complex. In addition to the echo mapping for the first three ultrasonic echoes in each channel, the source code included many manual parts and implemented “if” instructions to optimize the method. The method provides many parameters. These parameters are initialized in a structure. Various values are parameterized for the method in order to realize a simple adaptation of the method. The positions of the ultrasonic sensors are an example in this respect. As the set-up changes, they can simply be set to different values.

The method was implemented in the example implementation in the trilateration function: The trilateration function is called in the wave evaluation file. The function obtains the current channel as a parameter and provides the resulting 2D solutions and an iteration counter. This counter represents the distance between the two 2D positions resulting in an accepted solution. Moreover, the counter enables distinguishing between three-, two- and one-sensor solutions. The method calculates its solutions on the basis of a plurality of trilaterations of two ultrasonic echoes. Each channel calculates 16 trilaterations (trilateration2) per cycle. A trilateration2 function is therefore called. This function obtains two echo values and the distance between two ultrasonic sensors. It interprets the echo values as semicircles and provides the intersection point of the semicircles. The exemplary trilateration2 function requires a maximum of 2.4 μs to calculate the solution. The complete trilateration method thus does not take much time to calculate the solutions. The change in the runtime of a cycle is not visible in the millisecond range. The time remains constant at about 120 ms.

### Stage 4 Filtering

### Introduction of Filtering

The next two sections of this document deal with the signal processing of ultrasonic signals. They distinguish the processing of raw ultrasonic echo signals and the processing of resulting 2D points. Two different filter types are introduced and implemented. The first is the Kalman filter or estimation filter. The filter affects the output of the trilateration method by filtering the input echo signals. The second filter used is a clustering filter. In contrast to the Kalman filter or estimation filter, the clustering filter filters the solutions of the trilaterations. Stage 3 of a plausibility check preceding filtering will be discussed later.

Because of the different environments in parking situations, the filter implementations have a plurality of challenges. The biggest challenge is improving noise behaviour. The noisy influence of other parking car sensors must be suppressed. Another challenge is that the filters must adapt to changes very quickly. This is due to the assumption of a maximum speed of 2 m/s. In addition to this maximum speed, the echo values may jump according to abrupt changes in the environment. For example, when a pedestrian suddenly enters the range of sensitivity of the ultrasonic sensors during a parking operation. The requirements for an ultrasonic sensor system require that the ultrasonic sensor system recognizes the pedestrian within a maximum time of 500 ms. The filter outputs should therefore not be delayed in time from the filter inputs for too long by too many in-filter iterations.

### Stage 4a Kalman Filter or Estimation Filter

### Kalman Filter Overview

This section of this document describes the filtering of measured ultrasonic echoes by Kalman filters as an exemplary estimation filter. Various filtering method types and thus filter types were tested within the framework of developing this document and compared to the Kalman filter or Kalman filtering method. The filtering of the ultrasonic echo signal must be very fast in order to follow the vehicle movements and measured obstacles. In the laboratory set-up that served to test the technical teaching used herein, the ultrasonic sensor system refreshed the ultrasonic echo signal every 120 ms, which corresponds to the cycle time. This cycle time results from the measurement with a delay of 30 ms per channel. A filter should follow the real value in a minimum number of iterations in order to have a small delay. This is the problem with the adaptive filters tested in this context. They typically require a plurality of iterations in order to follow the measured value by adjusting their parameters.

Another filter tested is the αβγ filter using the αβγ filtering method, which filter also comes into consideration as an exemplary estimation filter using an exemplary estimation filtering method. Similarly to the Kalman filter, this filter is based on a mathematical system. Both filters predict their current values by means of the system, measurement, and past values. The output of both filter types is therefore similar. The main difference between both filter types is that the Kalman filter has, in its Kalman filtering method, an iterative portion that calculates the optimal prediction. For this reason, the Kalman filter using the Kalman filtering method was chosen for the laboratory set-up in order to filter the ultrasonic echo signals for the parking assistance system.

Each filter has its filter characteristic depending on the aim of the filtering. For example, a low pass filters high frequencies. Low frequencies pass through the filter. In comparison to the low pass, the Kalman filter using the Kalman filtering method aims at filtering out noisy or unreliable signal portions. This property is desired in many different applications, such as autonomous or assisted navigation /13/. The Kalman filter using the Kalman filtering method is therefore widely used. The filtering principle of the Kalman filter using the Kalman filtering method is more complex than other basic filter types. The filter is based on a set of differential equations. The Kalman filter using the Kalman filtering method uses these equations to estimate the next state in that the Kalman filter to the Kalman filtering method compares the current state and the previous state. The principle of minimising the mean squared error is implemented in the Kalman filter and thus in the Kalman filtering method in order to realize this estimation. A normal distribution is required for the application of the Kalman filter and thus the Kalman filtering method to the measured values. Otherwise, the method is unable to find an optimal state prediction /14/.

### System Description

The Kalman filtering method of the Kalman filter is based on systems in the linear state space format. The raw format of these systems in the continuous time space is given here:

$$\dot{x} ( t ) = F ( t ) * x ( t ) + G ( t ) * u ( t ) \\ y ( t ) = H ( t ) * x ( t )$$

where
x(t): state vector
F(t): system matrix state
G(t): system matrix input
U(t): input vector
Y(t): output vector
H(t): observation matrix

The first equation determines the coherence between the derivation of the states, the states themselves, and the input. The second relates the output vector to the states. The transfer from the continuous time space to the discrete time space results in the following description:

$${x}_{k + 1} = {F}_{k} * {x}_{k} + {G}_{k} * {u}_{k} \\ {y}_{k} = {H}_{k} * {x}_{k}$$

The index k stands for the current iteration. k+1 symbolizes the next iteration. The complexity of the system determines the dimension of the system description. In the case of the filtering of ultrasonic signal, there are two options. The first is a 2D system description with two states. The echo time of flight e(t) measured by an ultrasonic sensor is the first state. It represents the transit time of an ultrasonic pulse. The speed v(t) of the vehicle represents the second state. It is measured by the movement of the vehicle. The second option is a 1D system containing only the state e(t). The speed v(t) affects the system as input /14/.

### 2D System

The ratio between the past and the current value is ascertained in the following manner:

$$\dot{e} ( t ) = \frac{e ( t ) - e ( t - Δ t )}{Δ t}$$

The distance to an obstacle is calculated analogously:

$$\begin{matrix}\dot{d} ( t ) = \frac{d ( t ) - d ( t - Δ t )}{Δ t} = v ( t - Δ t ) \\ \text{=>} d ( t ) = d ( t - Δ t ) + Δ t * v ( t - Δ t )\end{matrix}$$

The conversion into the discrete time space results in the following state equations:

$$\begin{matrix}d ( t - Δ t ) = d ( k * Δ t - Δ t ) = d ( Δ t ( k - 1 ) ) = {d}_{k - 1} \\ v ( t - Δ t ) = v ( k * Δ t - Δ t ) = v ( Δ t ( k - 1 ) ) = {v}_{k - 1} \\ \text{=>} {x}_{1 k} = {d}_{k} = {d}_{k - 1} + Δ t * {v}_{k - 1}\end{matrix}$$

The speed value is measured. A constant speed results in the relationship:

$$\text{=>} {x}_{2 k} = {v}_{k} = {v}_{k - 1}$$

Both state variables result in the following system description:

$${x}_{k} = {\underbrace{[ \begin{matrix}1 & Δ t \\ 0 & 1\end{matrix} ]}}_{{F}_{k}} {x}_{k - 1} \qquad y = {\underbrace{[ \begin{matrix}1 & 0\end{matrix} ]}}_{{H}_{k}} {x}_{k}$$

The distance dₖ is predicted by means of the last distance and the speed of the vehicle multiplied by the time difference between both measurements. The system is not influenced by input variables. The system description therefore does not contain an input vector /14/.

### 1D System

In comparison to the 2D system, the 1D system interprets the speed of the vehicle as an input variable. As a result, the system description reduces its dimension. The measured distance is the only state in the following 1D description.

$$\text{=>} {d}_{k} = {x}_{k} = {\underbrace{1}}_{{F}_{k}} * {x}_{k - 1} + {\underbrace{Δ t}}_{{G}_{k}} * {v}_{k - 1} \qquad {y}_{k} = {x}_{k}$$

The resulting equations show that the system is less complex. There is no relationship between the past and the current value. The predicted state depends on the historical value and a speed specification. If the speed of the vehicle is not available to the parking system, the state equation is simplified xₖ=xₖ₋₁.

### Kalman Filtering Method

The Kalman filtering method is based on the system description and stochastic relationships. In the case of a one-dimensional system, the equations consist of one-dimensional values. This results in the below equations. These equations are calculated at each time step of the filter. The index k stands for the current iteration. k−1 symbolizes the last iteration.

$${K}_{k} = \frac{{P}_{k - 1} + Q}{{P}_{k - 1} + Q + R} \\ {\hat{x}}_{k} = {\hat{x}}_{k - 1} + {K}_{k} * ( {z}_{k} - {\hat{x}}_{k - 1} ) \\ {P}_{k} = ( 1 - {K}_{k} ) * ( {P}_{k - 1} + Q )$$

The basic principle of the method is to predict the current value. Equation 2 shows the calculation. It predicts the value \hat{x}ₖ in that it adds the last predicted value \hat{x}ₖ₋₁ to the weighted difference of the measured value zₖ and \hat{x}ₖ₋₁. The factor Kₖ determines the influence of this difference. Kₖ is referred to as Kalman gain, which is calculated iteratively. The equation indicated above updates the parameter in each iteration k. This equation contains the value Pₖ₋₁, which is iteratively calculated by the equation likewise given above.

The equations show that the method differs between the calculation of the Kalman gain and the prediction of the next state by this factor. The Kalman gain is independent of the measurement. It only depends on the parameters Q, R and an initial value P₀. The calculation of the amplification is the essential idea and complexity of the Kalman filter. The following section helps to gain a deeper understanding of it /14/.

### Parameters

The idea of the Kalman filter and thus of the Kalman filtering method is to eliminate unreliable signal portions. The filter therefore needs some information about the measurement. The parameters Q and R provide this information. Q describes the variance value of the process noise. In multi-dimensional systems, it would be a matrix. Q determines how the system affects the output of the filter. A high Q means a high standard deviation of the state prediction by the system. In that case, the filter has more confidence in the measurement than in the prediction of the system. The parameter R stands for the covariance of the measurement noise. It describes how the measured value affects the state prediction. If R is high, the variance of the measurement is also high. The method therefore trusts the measurement less than the prediction of the system. FIG. 25 visualizes how the Kalman filter predicts the next state through the influence of the two parameters by means of the Kalman filtering method.

FIG. 25 shows, by way of example, the measurement of a position of a vehicle or movable object. The solid curve symbolizes the probability density function (PDF) of the prediction by the system. The long-dashed curve represents the probability density function (PDF) of the measurement. In this scenario, the standard deviation of the measurement is lower compared to the prediction. This means that the parameter Q is higher than R. The short-dashed curve describes the resulting position calculated by the Kalman filter using the Kalman filtering method. The curve is calculated by multiplying the two other bell curves. It is scaled up to obtain the integral value one. The exact relationship between the parameter and the standard deviations of the bell curves can be described by the following two formulae:

$$R = {σ}_{meas}^{2} , Q = {σ}_{pred}^{2} - {P}_{k - 1}$$

R represents the square of the standard deviation, the variance. The coherence between Q and the prediction variance is ascertained iteratively. The resulting variance of the short-dashed curve of the calculated position is likewise determined iteratively by means of the following formula:

$${σ}_{result =}^{2} {σ}_{pred}^{2} - K * {σ}_{pred}^{2}$$

FIG. 25 shows that the variance of the measurement and the prediction determine the filter behaviour. The filter output is closer to the value with a smaller distribution. The Kalman filtering method of the Kalman filter obtains the information about the distributions through the parameters. A good choice of R and Q is therefore essential /15/, /16/.

For the 1D system, the process noise variance Q could be equal to zero since there is no prediction through a system relationship. However, if Q is set to zero, the flexibility of “tuning” the filter decreases. One possible solution is therefore to set Q to a small value, such as 1e-5, and to adjust R in order to obtain the desired filter performance. The behaviour of the Kalman filtering method of the Kalman filter, and in particular the method for the amplification factor, depends on the ratio between Q and R. The measurement noise variance R can therefore be adjusted first. Q may be used to subsequently set the filter.

FIG. 26 compares two different exemplary filter parameters. The solid line in FIG. 26 represents a distance measurement. The signal is a constant value of 2.5 meters superimposed on a normally distributed noisy signal portion. The standard deviation of the noise signal is meas=50. R is therefore defined as meas²=250. FIG. 26 shows the output of the exemplary Kalman filtering method of the exemplary Kalman filter for two different exemplary selections of Q. The higher value of Q (75) results in a higher confidence in the measurement. The short-dashed line is therefore less smooth in comparison to the long-dashed line. A smaller Q would therefore be better to smooth a measured value during a static measurement.

FIG. 27 applies the same parameters to a dynamic measurement. The standard deviation is again selected to be 50. The movement between the 20th and 50th iteration corresponds to a velocity of ±2.67 m/s at an iteration increment of 50 ms.

FIG. 27 shows that the Kalman filtering method of the Kalman filter with the smaller Q cannot follow the dynamic portion of the measurement. The smaller Q is selected, the more iterations are necessary for the Kalman filtering method of the Kalman filter to be able to follow the movements. The filter requires information about the movements in order to improve the filter behaviour in dynamic measurements. In the case of a parking system, the speed of a car is to be included in the filter. For one-dimensional filtering, the speed is configured as an input. FIG. 28 compares the output of the Kalman filtering method of the Kalman filter with and without speed information.

The long-dashed curve illustrates the behaviour of the Kalman filtering method of the Kalman filter without speed information. The short-dashed line demonstrates the advantage of the speed input. The filter does not require any iterations in order to follow the value, since the speed directly influences the calculation of the next state.

Another way to integrate speed is to extend the system by one dimension. This results in the explained system description. In this case, the speed is configured as a state of the system. The main difference between the 1D filter with speed input and the 2D filter with the speed as a state is that the 2D filter is capable of filtering the speed. In this case, the variance parameters Q and R are multi-dimensional values. Filtering both the position and the speed reduces the dynamics of the system. An example in which the 2D description should be applied is the position determination during a freefall scenario. In this case, the explained 2D system description would be extended by the earth acceleration, which is configured as an input to the system.

### Practical Measurements

The exemplary laboratory system of the proposed ultrasonic sensor system used the Kalman filtering method of the Kalman filter to filter the echo signals of the ultrasonic parking system. Each cycle of the measurement consisted, by way of example, of 36 echoes. 36 ultrasonic echoes therefore have to be filtered by separate Kalman filters using the Kalman filtering method. The filtering of the first 12 ultrasonic echoes is implemented in order to simplify the evaluation and testing of the filter. Before applying the filter, it is checked whether the echoes are normally distributed. FIG. 29 shows the distribution of the first ultrasonic echo from sensor 0 in channel 0 during an exemplary wall measurement.

The distribution contains 225 ultrasonic echoes. The mean value is 4871 μs, which corresponds to 1.67 meters. The standard deviation is about 10 μs. FIG. 29 illustrates that the echo signal is normally distributed. Other measurements also showed that the ultrasonic echoes are normally distributed. The Kalman filtering method of the Kalman filters can therefore be applied to ultrasonic echoes.

The configuration of the parameters for the Kalman filtering method of the Kalman filter depends on the ultrasonic echo signal. The standard deviation of the ultrasonic echoes differs by different surfaces and different environments. For example, the simulation of a parking situation results in significant differences in the standard deviation. FIG. 30 shows the first ultrasonic echo of ultrasonic sensor 1 in channel 1 and the first ultrasonic echo of ultrasonic sensor 3 in channel 3. A Kalman filter filters both echoes by means of a Kalman filtering method by applying the same parameters.

The ultrasonic echo signal of channel 3 has a standard deviation of 10 μs. The ultrasonic echo signal of channel 0 has a standard deviation of 63 μs. The parameter Q is set to the value 100. R is 3600, which is about the variance of the first echo of channel 0. FIG. 30 shows that the distributions of ultrasonic echoes differ in the same scenario. For static measurements, the parameters could be selected taking into account the ultrasonic echo with the greatest spread. In comparison, filtering dynamic measurements have the already explained problem of following the measured value. The integration of the speed of the vehicle would improve the behaviour of the dynamic filter. However, this integration would not provide the proper ultrasonic echo signal in many parking situations. One problem is that the speed of the vehicle does not represent the change of the echo path in every situation. For example, if the car parks at a slow speed and the driver quickly steers in one direction. The signal would change very quickly.

Because it would get ultrasonic echoes from obstacles that were previously not within the range of the ultrasonic sensor. The same problem occurs when the vehicle measures a wall and a pedestrian walks between the wall and the vehicle. The parameters of the Kalman filtering method of the Kalman filter must be adjusted in order to correctly recognize dynamic ultrasonic echoes.

FIG. 31 compares two different parameters for R by means of a dynamic measurement. In this scenario, the recognized obstacle is the plant depicted. The image is taken in the 100th cycle. The irregular surface of the plant results in very high spread of the ultrasonic echo signal. The speed of the vehicle is not available due to the measurement set-up. It is therefore not integrated into the system description.

The diagram shows two different choices for parameter R. The first Kalman filtering method of the first Kalman filter (solid line) smoothes the curve better. In comparison, the Kalman filtering method of the second Kalman filter (dashed line) follows the measurement faster. The maximum speed of the measurement shown is about 0.3 m/s. A measurement at a higher speed would increase the difference between the two curves. The fact that parking situations are dynamic measurements resulted in the application of the exemplary parameters Q=100 and R=200 in the preliminary tests in the development of the technical teaching of this document. The quick response to a changing environment is more important than the smoothing of the curve.

### Stage 3: Plausibility Checks

The plausibility checks are preferably performed by the ultrasonic sensor system prior to filtering using the Kalman filtering method in the Kalman filter of the ultrasonic sensor system.

### Manual Filter Parts

The Kalman filtering method of the Kalman filter of the ultrasonic sensor system that was implemented in the preliminary tests contains some manual queries for improving the filtering method of the filter. In particular, the noise behaviour and the response to rapid echo changes are implemented. The term “manual” in this respect relates to the properties of the “if” queries performed by the processor of the ultrasonic sensor system being empirically determined at the time of construction. It thus explicitly does NOT mean that human intervention is necessary here.

### Noise

An essential feature of filtering the ultrasonic signals is the noise behaviour. Ultrasonic sensors from other parking cars should not affect the echoes. In order to simulate these noisy signals, the test set-up comprises a fifth ultrasonic sensor. A further sensor board controls this fifth ultrasonic sensor. The fifth ultrasonic sensor of the test set-up fires pulses of the same frequency (58 kHz) and profile (SendA) as the ultrasonic sensors used for the parking operation. The Kalman filtering method of the Kalman filter is extended by a manual query in order to improve the noise behaviour. FIG. 32 illustrates this. FIG. 32 shows an ultrasonic echo signal of a static measurement. The noise sensor affects the measured value (solid line). The dashed line represents the standard Kalman filtering method of the Kalman filter. Due to the parameters, the filter reacts quickly to refreshed values. The dotted line in FIG. 32 shows the output of the Kalman filtering method of the Kalman filter with an “if” instruction for eliminating a noise value. This instruction does not accept a value greater than the last value plus 1400 μs. The limit for this query results from assuming maximum system dynamics. According to this assumption, the maximum speed of an object in the parking space or the speed of the car is 2 m/s. The parking system should be able to recognize obstacles at lower speeds. The ultrasonic sensor system can calculate the manual limit as follows:

$$Δ {e}_{max} = {\underbrace{120 ms}}_{cycle time} * {\underbrace{2 \frac{m}{s}}}_{{v}_{max}} * {\underbrace{\frac{1}{343 \frac{m}{s}}}}_{{v}_{us}} * {\underbrace{2}}_{ways} = 1400 µs .$$

The formula calculates the maximum difference of an ultrasonic echo signal per cycle. If the measured value for the speed is greater than the last measured value for the speed plus 1400 μs, the current value is replaced by the last one since the ultrasonic sensor system must assume that the measurement is a faulty measurement. That is to say, the proposed ultrasonic sensor system is characterized in that it firstly uses a Kalman filtering method of a Kalman filter in order to filter at least the ultrasonic reception signal of at least one ultrasonic sensor, and in that the ultrasonic sensor system performs a plausibility check of the input values of the Kalman filtering method of the Kalman filter, and in that the ultrasonic sensor system replaces input values of the Kalman filtering method of the Kalman filter that are not plausible with old, plausible values.

### Zero Jumps

A further manual query to improve filter behaviour is the jump between an ultrasonic echo value and no recognized echo. Obstacles, such as the plant object (FIG. 31), can result in very unstable echoes. The sensor is not able to recognize an ultrasonic echo in each cycle. One way to handle this situation is for the ultrasonic sensor system to set the current value to the maximum measurement time of the profile (14.58 ms for profile A). However, this would result in solutions by the method. Each cycle without solution would provide solutions through the maximum values of the echoes. In order to enable these solutions, the echo values are set to zero. FIG. 33 shows an unstable echo during a dynamic measurement of the plant obstacle (FIG. 31). The echo belongs to the third sensor of channel 0. If the sensor does not recognize an echo, the ultrasonic sensor system sets the value to zero. The Kalman filtering method of the Kalman filter without the zero balance requires iterations in order to follow the jump between zero and an echo value. This results in false echo signals and false solutions by the trilateration method. The Kalman filtering method of the Kalman filter, extended by the zero-jump query, jumps directly between a valid value of an ultrasonic echo and zero, thus permitting false echoes and false solutions.

Jumps between Echoes

A further manual adjustment of the Kalman filtering method of the Kalman filter is a further query for jumping values. The problem with jumping between echo values and zero also occurs between two echo values.

FIG. 34 illustrates a scenario. The ultrasonic sensors measure four post obstacles. A pedestrian passes between the posts and the sensors while the vehicle is not moving. FIG. 34b on the right side shows the 40th cycle of the measurement. FIG. 34a shows the corresponding first ultrasonic echo of ultrasonic sensor 1 in channel 1.

The echo signal jumps between approximately 9000 μs and 3000 μs. The regular Kalman filtering method of the Kalman filter (short-dashed line) requires a plurality of iterations in order to follow the measurement. In comparison, the manual Kalman filtering method of the Kalman filter jumps to the measured value after a delay of one iteration(long-dashed line). This delay occurs due to noise filtering. The first value with a greater change than Δeₘₐₓ(1400 μs) is interpreted as noise. After a noise value, the manual query checks whether the current measured value deviates by more than Δeₘₐₓ relative to the last predicted value. If this is true, the current measured value replaces the current predicted value. The query is activated three times during the example of this scenario. The first time in the 38th iteration when the echo signal drops to a lower value. The second and third times in the 46th and 48th iterations. The query is activated two times as the pedestrian leaves the sensor area. This happens because the echo switches twice between the posts and the pedestrian. Two measured values belonging to the posts are thus interpreted as noise. This results in two accepted jump values.

### Maximum Speed

The last manual part of the Kalman filtering method of the Kalman filter implemented in the preliminary tests is the switching off of the Kalman filtering method and thus of the Kalman filter if the dynamics are too high. In comparison to echo jumps as a result of object changes, this part deals with rapid echo changes without object change. These changes may be caused by a high speed during parking or by obstacles that move in the area of the sensor. In order to simulate this scenario at a defined speed, the ultrasonic echoes were measured in an ultrasonic laboratory during the preliminary tests. A post was mounted on a rail as a test object. The post could be moved at constant speeds. The maximum speed was 1 m/s. FIG. 35 shows the ultrasonic echo of the ultrasonic sensor 1 in channel 1 during the measurement of a moving post. The post moved at a constant speed of 1 m/s toward the viewing axis of the ultrasonic sensors, the viewing axis being vertical relative to the board on which the ultrasonic sensors were mounted.

First, the post moves away from the ultrasonic sensors. Thereafter, the position remains constant for approximately 15 cycles. At the end, the post returns to the start position. The chart compares the normal Kalman filtering method of the Kalman filter to the manual Kalman filtering method of the manual Kalman filter. The manual Kalman filtering method of the manual Kalman filter deactivates the filtering of the echo signal if the speed is greater than v_{filter_max}. Based on the post measurements and other dynamic measurements, the maximum speed is selected as v_{filter_max}=0.75 m/s.

In this example, the selected maximum speed results in a maximum echo difference of:

$$Δ {e}_{filter \_ max} = {\underbrace{120 ms}}_{cycle time} * {\underbrace{0.75 \frac{m}{s}}}_{{v}_{filter \_ max}} * {\underbrace{\frac{1}{343 \frac{m}{s}}}}_{{v}_{us}} * {\underbrace{2}}_{ways} = 525 µs \approx 500 µs$$

The filter is deactivated if the signal changes by more than Δe_{fiter_max} or by Δe_{filter_max} in two consecutive iterations.

A first jump therefore does not result in a deactivation since it could also be a noise signal. If the signal jumps in the second iteration, the current predictive value is replaced by the current measured value.

A further positive effect of this query is the noise behaviour (FIG. 36). The measured signal is influenced by the noise sensor. This sensor causes a signal jump in the 11th cycle. The difference between the noise value and the actual value is less than Δeₘₐₓ(1400 μs).

The Kalman filtering method of the Kalman filter therefore does not interpret the value as noise. The regular Kalman filtering method of the regular Kalman filter responds to this jump and requires some iterations in order to return to the real value. In comparison, the manual filter jumps directly back to the real measured value. This happens because the signal jumps in the first iteration to the noise and returns to the real value in the next iteration. As a result two jumps are registered and the filter is deactivated in the second iteration.

### Resulting 2D Output

The aim of filtering echo signals is to positively influence the resulting 2D positions. Better noise behaviour and smoother positions with lower spread are intended. FIG. 37 compares the solutions without and with Kalman filtering. All manual parts of the Kalman filtering method and thus of the Kalman filter are activated. The parameters are set to their default values (Q=100, R=200). The solutions are among the first echoes of the dynamic wall measurement. The noise sensor interferes with the measurement. FIG. 37 shows the last 25 solutions of each channel in order to illustrate the course of the solutions. It is clear that the path of the solutions is smoothed by the application of the Kalman filtering method of the Kalman filter. Moreover, two interference values of channel 2 and one interference value of channel 3 are eliminated.

### Exemplary Implementation

Filtering all echo signals in one cycle requires a plurality of Kalman filters with associated Kalman filtering methods. Above all, the first ultrasonic echoes are not to provide false information about the environment since they recognize the closest obstacles. Filtering of the 12 first echoes is therefore performed first. For the exemplary application of 12 different Kalman filters with separately parameterized Kalman filtering methods, structures are implemented in the exemplary source code of the programme of the MCU. A structure contains the various variables for the filter. A further structure initializes these variables for 12 different states. Each state stores the current values of the variables for a Kalman filtering method of a Kalman filter. The Kalman filtering method is implemented in the Kalman function. The trilateration function preferably calls this function prior to calculating the trilaterations in the trilateration method. In addition to the current value of the currently processed ultrasonic echo, the Kalman filter, in the form of the Kalman filtering method performed by the ultrasonic sensor system, expects a state parameter in order to associate the raw value with the proper filter state. The filter characteristic is in a further structure. There, the parameters Q, R and two limit values are set for the manual queries. These parameters are the same for all filter states. In addition to the parameters, the manual queries affect the filter behaviour. They are preferably part of the Kalman filtering method that is the same every time the ultrasonic sensor system call the Kalman function. The manual parts can be activated and deactivated separately. This may be helpful if there are filter output issues. The implementation was tested by practical measurements in the development of the proposal presented herein. However, the queries could result in incorrect outputs, which did not occur in the measurements during the preliminary tests.

The runtime of the Kalman filtering method in the Kalman filter is very short, similarly to the trilateration method. The maximum runtime for each filter is 2.7 μs. It therefore has a minimum impact on the cycle runtime of 120 ms.

### Stage 4b Clustering

This section deals with the filtering of resulting 2D solutions of the trilateration method. For this purpose, a clustering method was implemented and tested, by way of example, in the development of the proposal presented herein. The aim of the clustering is to improve noise behaviour.

For information technology systems, a cluster is a group of data ascertained by a clustering method. The data points of a cluster are similar to one another due to their relationship to the surrounding data points. A clustering method obtains a lot of input data in order to determine various clusters. Clustering is part of unsupervised machine learning. The word “unsupervised” is to be understood as “not supervised”. This means that the clustering methods themselves have to find structures in their input data. The methods are not given any labels /18/.

The most common is the K-means clustering method. It is the simplest unsupervised learning method. The method separates the data points based on a plurality of centroids in the data. The data points are assigned to a cluster based on the squared distances to the centroids. In addition to centroid-based methods, there are also density-based methods. Density-based methods determine their clusters by the concentration of the data points. A common density-based method is the DBSCAN method (density-based spatial clustering of applications with noise). In comparison to the K-means method, the DBSCAN method is capable of finding outliers in the data. This property is the reason for the application of the DBSCAN method for filtering the 2D positions /18/.

### DBSCAN

The DBSCAN method determines the cluster by taking into account the density of the 2D data points. The distances between the data points are calculated for this purpose. The method distinguishes between “core values” and “non-core values”. FIG. 38 shows the difference between the two. The points with uninterrupted circles represent the core values of a cluster. The dots with short-dashed circles belong to the cluster but not to the core of the cluster. Using the DBSCN method, the proposed apparatus interprets the point with a long-dashed circle as noise. The apparatus preferably carries out the DBSCAN method on one of its processors, e.g., the MCU of the NXP board NXPB. The respective circles around the respective data points visualize the distance E which is a parameter of the method. The dashing of these circles corresponds to the dashing of the points. The other parameter is the inPts parameter. This parameter defines the minimum number of data points that should be within the circle of a point in order to interpret this point as a member of a cluster. FIG. 38 shows a scenario with the parameter minPts=3 or minPts=4. Each data point with a solid circular line as a border has three different values within its circle. Circle 3101 is also called the neighbourhood of the data point. For the sake of clarity, only one exemplary data point A and only the threshold value circle 3801 associated with it is provided with a reference sign in FIG. 38. The other reference signs of these data points A are omitted for the sake of clarity. The points with a short-dashed circular line have only one further value in their neighbourhood. They are therefore not a core value of the cluster. However, they still belong to the cluster as non-core values since the neighbours of the points with a short-dashed circular line belong to the core values. The point with the long-dashed circular line has no neighbours and is interpreted as noise value /19/.

The DBSCAN method provides different clusters depending on the parameters selected. FIG. 39 illustrates the output of the method based on the generated data. The method divides the data into three clusters. It associates the values with a cluster by storing them with a cluster label. Furthermore, the method distinguishes between core and non-core values. Core values are visualized with larger points than non-core values are.

The parameters of this representation were set to minPts=10 and ε=0.3. The black points visualize the noise values /19/.

### Clustering Methods

The application of the clustering method in the development of the proposal presented herein is to filter out noisy 2D data positions. The idea is that the clustering method generates clusters that belong to obstacles in the 2D space of the ultrasonic sensors. Solutions that are far from the clusters are to be eliminated. The DBSCAN method explained distinguishes between noise and cluster values. Each data point is assigned to a cluster. However, this association is not necessary for the filtering of the solutions. In order to filter out noise signals, the clustering method has been simplified for use in the ultrasonic sensor system presented herein. Based on the DBSCAN method, a proprietary, new clustering method is developed, implemented and tested.

FIG. 40 shows the flow chart of the new proposed clustering method. The method steps of this clustering function are performed after the trilaterations.

Whenever there is a solution in a channel, the ultrasonic sensor system calls the function of the clustering method with this solution as a parameter (sol). First, the ultrasonic sensor system initializes the cluster index k and the neighbour counter. Thereafter, the ultrasonic sensor system calculates the distance between the solution and the first element of the cluster array. The cluster array contains the latest solutions. The default value for the array size is 25, which means that the method forms clusters based on the last 25 points. The ultrasonic sensor system uses the method to calculate the square of the distance between the current solution and the first element of the cluster array. Thereafter, the ultrasonic sensor system compares the distance thus ascertained with the square of the neighbourhood². The idea of using the square of the distance and ² is that there is thus no need to calculate the square root in order to ascertain the correct distance. The square of the neighbourhood 2 may be pre-calculated here prior to applying the method.

If the distance between the current solution and the cluster array element is less than the neighbourhood, the ultrasonic sensor system increments the neighbour counter. Then, the index is incremented and the calculation starts again with the next element of the cluster array. After checking the distance between the current solution and each element, the ultrasonic sensor system compares the number of neighbours to the parameter minPts. For minPts=3, the ultrasonic sensor system accepts the solution if there are two or more neighbours. If there is only one neighbour, the function returns a boolean true-noise value. Before this boolean is returned, the current value is added to the cluster array for the next call of the function.

The clustering function was tested based on generated data and was compared to the DBSCAN method. The function provides the same clusters as the DBSCAN method. However, in contrast to the DBSCAN method, the method explained above only takes into account the core values of a cluster. The laboratory prototype of the apparatus included a function for finding the non-core values on a test bench. The application of the clustering method to practical measurements shows that non-core values only occur in some scenarios and do not provide any further information about the environment. Non-core values are therefore not implemented in the source code for the programme of the MCU of the ultrasonic sensor system.

### Parameters

The configuration of the minPts and E parameters is essential. The maximum speed of the ultrasonic sensor system, i.e., of the vehicle, is assumed to be 2 m/s. This means that the maximum difference from a position is

$$Δ {p}_{max} = {\underbrace{120 ms}}_{cycle time} * {\underbrace{2 \frac{m}{s}}}_{{v}_{filter \_ max}} = 24 cm$$

per cycle. In order to recognize an obstacle at the maximum speed, especially if it is only recognized in one case, E must be selected such that ϵ=(minPts−1)*Δpₘₐₓ. This results in a 48 cm neighbourhood with a minimum sampling size of minPts=3. If two channels recognize a fast obstacle, the neighbourhood may be reduced to 24 cm. If three or four channels detect an obstacle, the time delay between the channels is critical as the cluster is being built within one cycle. In order to reliably recognize obstacles at maximum speed, E in this example must be equal to or greater than 48 cm.

FIG. 41 shows an exemplary output of the clustering method. The visualized solutions belong to a static vehicle measurement (FIG. 30). The fifth noise sensor interferes with the measurement. The clustering method uses a 50 cm neighbourhood in order to be able to handle high speeds. The size of the cluster array is 25, and the minimum points of a cluster are selected as 3 (minPts=3). The noise values of the method are plotted as dotted circles in FIG. 41. FIG. 41 shows two noise values. Two other false solutions (channel 1 and channel 3) are not filtered by the clustering method.

In static scenarios, similarly to the Kalman filter, the filter operates without delay. In dynamic scenarios, the filter requires iterations in order to accept new solutions. The scenario of the moving pedestrian (FIG. 34) is only one example in this respect. Depending on the minPts parameter, the method interprets the first values of new objects as noise. For minPts=3, the first two solutions, which can be attributed to the entry of the pedestrian, are not accepted since the cluster requires three solutions. The worst case for minPts=3 is when only one channel recognizes the pedestrian. This causes a delay of two cycles.

### Implementation

The implementation of the clustering method is less complex than the implementation of the Kalman method. The process of the filter can be explained by a short flow chart (FIG. 40). The method is implemented in the preliminary tests in a clustering function. The three parameters are initialized in a structure that the ultrasonic sensor system calls in the trilateration function. The ultrasonic sensor system calls it every time the trilateration calculates a solution. In comparison to the Kalman filtering method of the Kalman filter, the ultrasonic sensor system applies the method to the first, second and third echo solutions. The clustering method of the clustering filter, like the trilateration method and the Kalman filtering method of the Kalman filter, may preferably be activated separately, for example by a definition instruction in the source code. The runtime of the clustering function is minimal. It does not affect the runtime of a cycle.

### Filtering in Phases 3 to 4—Summary

In the final sections, this document deals with two different ways of improving the reliability of the ultrasonic sensor system by filtering the echoes and solutions. The Kalman filtering method of the Kalman filter reduces the spread of the 2D positions. Moreover, the manual parts enable filtering of noise values, quickly following the measurement. FIG. 38 illustrates this. However, there are also scenarios that result in false solutions by the Kalman filtering method of the Kalman filter. FIG. 42 shows an example.

Both visualisations belong to a dynamic wall measurement. A Kalman filtering using a Kalman filtering method and then a clustering are applied to the ultrasonic echoes. The left visualisation shows solutions during the measurement. A false solution is produced by the application of the Kalman filtering method of the Kalman filter. The clustering method filters this solution. It is therefore drawn circular as a dotted point at the bottom right of FIG. 42a. FIG. 42b shows a few cycles of the first ultrasonic echo of the ultrasonic sensor 3 in channel 3, which is the reason for the false solution. The measured ultrasonic echo has two noise signals in three consecutive cycles. The first jump (cycle=174) is not interpreted as noise because the jump is less than

Δeₘₐₓ=1400 μs. However, the return jump (cycle=175) to the real value is misunderstood as noise. The third jump (cycle=176) to the noise signal is therefore interpreted as a valid event and the jump back to the measurement (cycle=177) is interpreted as noise. This misinterpretation results in the black 2D point in FIG. 42. The solution results from the fallback to a one-sensor scenario. The trilateration finds no solution for the first ultrasonic echo in cycles 176 and 177. The example illustrates the advantage of applying the clustering method to 2D solutions. The disadvantage of applying the method is that the solutions are delayed in rapidly changing environments. Selecting the parameter minPts=2 could result in a delay of one cycle.

In general, three reasons for a delayed filter output are to be distinguished. The first is the delay produced by the trilateration method. For example, if a pedestrian moves from the right to the left side. Channel 3 would recognize the pedestrian in the first cycles. However, if the pedestrian moves into the area of channel 3 after ultrasonic sensor 3 has transmitted and received its echoes, the first solution for the pedestrian would be delayed by the runtime of the first three channels. With a cycle time of 120 ms and a channel delay of 30 ms, this delay would be about 90 ms. The second delay that would occur in the pedestrian scenario is the delay caused by the Kalman filtering method of the Kalman filter. The first jump would be interpreted as noise in the first cycle. The third delay is caused by clustering, depending on the selection of the parameters minPts. The following equation summarizes the three different delays:

$${Delay}_{max} = {\underbrace{{t}_{ch}}}_{trilateration} + {\underbrace{{t}_{cycle}}}_{Kalman} + {\underbrace{( min Pts - 1 ) * {t}_{cycle}}}_{clustering}$$

Assuming the worst timing of the pedestrian and a clustering parameter minPts=2, the delay would be 330 ms. The requirement of the system for a maximum response time of 500 ms is thus ensured.

The practical measurements in the preliminary tests for the development of this proposal show the best filter behaviour if the ultrasonic sensor system first applies a Kalman filtering method of a Kalman filter to the results of the trilateration method in the signal path and the ultrasonic sensor system thereafter applies the clustering method in the signal path, in particular with the parameters of FIG. 42.

### Discussion

The trilateration method aims at obtaining as much information as possible about the environment.

Three ultrasonic echoes per ultrasonic sensor are therefore taken into account. The method maps the echoes by comparing a plurality of trilateration solutions from two ultrasonic sensors. This mapping is the biggest challenge of obtaining correct obstacle positions. In the preliminary tests for the development of the content of the technical teaching of this document, the method was developed and tested with small rod objects (posts) in order to obtain a clear separation of the ultrasonic echoes. During the development, false solutions resulted from incorrect echo mappings. The method was adjusted step by step to avoid these false solutions. However, not every scenario with a plurality of posts as objects can be correctly represented. One example is if two posts are positioned at the same distance from an ultrasonic sensor. The method applies the first ultrasonic echo only once in order to avoid false solutions. The position of the second post therefore cannot be ascertained with the correct echo mapping. Taking the first ultrasonic echo into account more than once would result in false solutions in other scenarios. The correct echo mapping by taking into account three ultrasonic echoes per ultrasonic sensor is complicated and required a lot of time to test with the exemplary posts as objects in the development of the proposal presented herein. A practical example of a complicated echo mapping is the plant obstacle (FIG. 31). The irregular surface results in a high spread of the solutions. In contrast, other scenarios are less complicated. The wall and the auto object are primarily recognized by the first ultrasonic echoes without high spread of the solutions (FIG. 37).

The method compares solutions based on distances in the x and y directions. A square is formed around a solution and enlarged in each iteration until another solution is located in this square or the limit value is reached. This method could also be implemented in a circular fashion. In this case, the distance between the solutions would decide on the acceptance of the current solution. However, this would require more computing power. Another reason for selecting the square-based comparison is the possibility of dividing the square into x and y iterations. This means that the method would provide two counters, one for the distance of the solutions in the x direction and one for the distance of the solutions in the y direction. This information would provide more detail about the environment. A measured wall would, for example, have large differences between the x and y distances of the solutions.

A very important feature of the method is the fallback to solutions with fewer than three ultrasonic sensors. This enables reliable object recognition for short distances. The ranges for solutions from two ultrasonic sensors overlap in order to increase reliable recognition. A further feature of the two-sensor fallback is that a solution based on two ultrasonic sensors in the fallback area is accepted before checking possible three-sensor solutions. This ensures that a first echo solution of a trilateration between two ultrasonic sensors is always accepted in the fallback area. If the method were to first check three sensor solutions, it could incorrectly map the echoes. It could provide solutions with a first ultrasonic echo and further second and third ultrasonic echoes not belonging to the same object. It is therefore important to first check the trilaterations of two ultrasonic sensors in the fallback area and to find three sensor solutions thereafter.

The second part of this document covered the filtering of the ultrasonic echo signals and the solutions. The first filter described is the Kalman filter using a Kalman filtering method. The selection of parameters Q and R is essential to the result of the filtering. The parameters of the Kalman filtering method iteratively determine the Kalman gain. The Kalman gain is calculated independent of the measurement. The amplification factor converges to a value in a plurality of iterations depending on the parameters Q and R. If the parameters Q and R are not changed during the measurement, it is possible to calculate the amplification factor beforehand and to replace the Kalman gain with a constant factor. The filter with a constant amplification factor is also referred to as the αβγ filter /20/. The opposite of constant amplification is changing the parameters Q and R in order to obtain an adaptive filter according to the different deviations of the different environments. However, the adjustment of the two parameters is very difficult since the variances of the ultrasonic echoes can be very different in the same scenario (FIG. 30). The replacement of the amplification calculation and the adaptation of the parameters were not implemented in the development of the proposal presented herein. They are ideas for improving the implementation. In addition to the parameters, the manual parts are also important for the filter behaviour. They increase the reliability and speed of the system. The selection of manual limits is essential to the filter output.

The second filter described here is the clustering filter. The output of the clustering filter is determined by the selection of its parameters. The parameter for the neighbourhood was chosen, by way of example, in the development of the proposal as ε=25 cm in order to detect obstacles at a maximum speed of 2 m/s. This results in acceptance of false solutions. An idea is thus to adjust the neighbourhoods as a result of the dynamics of a scene. For static measurements, the neighbourhood should be very small (ε=5 to ε=10 cm). Dynamic measurements should result in larger neighbourhoods up to a maximum value of ε=50 cm. One idea is to calculate a vector between the last two first ultrasonic echo solutions in each channel in order to obtain a value for the maximum dynamics of a scene. One problem is that noise would increase the length of this vector and thus also E. The vector itself therefore needs to be filtered appropriately. Depending on the filter, this results in a reduction in the speed of the system. Based on the practical measurements, an adaptation with a vector in channel 0 was tested in the development of the proposal. The vector is filtered with a simple mean value filter. In particular, obstacles, such as the plant, result in an undesired filter output signal.

The combination of a Kalman filtering method followed by the clustering method shows the best overall filtering effect for the results of the trilateration method. The two conditions, dynamics of 2 m/s and rapid recognition of new obstacles within 500 ms, are met by correctly choosing the filter parameters. The Kalman filtering method of the Kalman filter and its manual parts filter most noise signals and smooth the 2D points. The clustering method provides support for the Kalman filtering method of the Kalman filter since it can filter out a further interference value using the default parameters (FIG. 42). The noise behaviour was tested with an interfering noise sensor in the development of the proposal presented herein. Further measurements could help assess the reliability of the system with respect to interferences in parking scenes with a plurality of interference sensors.

### Summary

The aim of the preparatory work for this document was to develop a reliable ultrasound-based obstacle recognition system for parking applications. This preparatory work may be distinguished into two domains. The first describes implementation of the object recognition method. The second part explains two different filters for improving the reliability of the system. The document presented here starts with a small section for introducing the ultrasound basics. The hardware components and the communication concept are then explained. The focus of the communication concept is on the configurations of the ultrasonic sensor. The comparison of the envelope and threshold value curves provides the ultrasonic echoes for the subsequent method. A following section describes the comparison of various trilateration solutions of different views. At the end of this section, the fallback of three-sensor solutions to two- and one-sensor solutions is described. Thereafter, two filter concepts, namely the Kalman filtering method of the Kalman filter and the clustering method, are presented. The selection of the parameters and manual parts of the Kalman filtering method of the Kalman filter are the most important properties of the Kalman filtering method of the Kalman filter. A following section describes the clustering method. It shows the output of the filter as a function of various parameters. However, the desired overall filter behaviour is only achieved by combining both filtering methods. At the end of this document, some ideas are discussed that can improve the recognition system.

The ultrasonic sensor system comprises a processor which carries out the three methods described herein, the trilateration methods, Kalman filtering method, and clustering method, one after the other and thereby obtains a control signal for the control or for signalling to a driver. According to the technical teaching presented herein, during autonomous, automatic parking, at least one control parameter of the vehicle thus depends on an initial value of the clustering method that the computer of the ultrasonic sensor system carries out.

### Description of the Core of the Solution

### Apparatus

The technical teaching presented herein relates to an ultrasonic sensor system (USSS) for a vehicle or for a mobile apparatus, for ascertaining a map of the surroundings with coordinates of objects in the environment of the ultrasonic sensor system (USSS) in the form of accepted solutions. The ultrasonic sensor system (USSS) comprises at least n ultrasonic sensors (0,1,2,3), where n is a positive whole number with 3<n. The n ultrasonic sensors (0,1,2,3) are typically arranged along an intersection-free, straight or curved line. Typically, the ultrasonic sensors are preferably equidistantly installed at a height above ground, for example in a bumper bar of a vehicle. Equivalent arrangements are, for example, conceivable for robots. Vehicles in the sense of this document are all mobile apparatuses, viz., in particular, mobile apparatuses that can move independently. In the sense of this document, the ultrasonic sensors can thus be numbered by counting according to their position along this line. This means that, one of the two outermost ultrasonic sensors is the first ultrasonic sensor 0, the closest ultrasonic sensor thereto along this line is the second ultrasonic sensor 1, the closest, not-yet-numbered ultrasonic sensor to this second ultrasonic sensor 1 is the third ultrasonic sensor 2, the closest, not-yet-numbered ultrasonic sensor to this third ultrasonic sensor 2 is the fourth ultrasonic sensor 3, and so forth. The ultrasonic sensors are thus numbered consecutively from left to right or from right to left. The numbers of directly adjacent ultrasonic sensors on the line thus differ by a value of exactly 1. This numbering is only used for guidance within this document. This expressly does not mean that the ultrasonic sensors must be numbered with a number, for example in printed form. The word “may” in the claims is therefore to be understood such that this numbering is only used for guidance and clear denotation of the ultrasonic sensors within the claims and within this text. For the ultrasonic sensors to operate as such, each of the n ultrasonic sensors 0,1,2,3 preferably comprises at least one ultrasonic transmitter or one ultrasonic transducer UTR for emitting ultrasonic bursts as ultrasonic waves USW and at least one ultrasonic receiver or ultrasonic transducer UTR for receiving the reflected ultrasonic burst as reflected ultrasonic waves (USR). For further processing within the ultrasonic sensor system USSS, each ultrasonic sensor of the n ultrasonic sensors 0,1,2,3 preferably in each case generates a respective ultrasonic reception signal of this ultrasonic sensor with respective echo signalling erm. An exemplary echo signalling erm of the ultrasonic echoes ec1, ec2, ec3, ec4, ec5, ec6 is shown, for example, in FIG. 5. In this context, we also refer, for example, to the documents DE 10 2018 106 244 B3, WO 2020 182 963 A1 and WO 2018 219 966 A1. The ultrasonic echoes that arrive at one of these n ultrasonic sensors 0,1,2,3 are numbered consecutively in the sense of this document from 1 to k, with kr as the positive whole number. The consecutive numbering of the ultrasonic echoes is carried out separately in the sense of this document for each of the ultrasonic sensors of these n ultrasonic sensors 0,1,2,3 and for each measurement cycle. A measurement cycle in the sense of this document starts with the emission of the ultrasonic wave USW of the ultrasonic burst by one of the ultrasonic sensors of these n ultrasonic sensors 0,1,2,3 and ends with the new emission of a subsequent further ultrasonic burst by one of these n ultrasonic sensors 0,1,2,3 of the ultrasonic sensor system USSS. When considering one of the ultrasonic sensors of these n ultrasonic sensors 0,1,2,3, which is, by way of example, to be the r-th ultrasonic sensor of these n ultrasonic sensors 0,1,2,3 with 1≤r≤n, the respective echo signalling erm of this r-th ultrasonic sensor of the n ultrasonic sensors 0,1,2,3 with 1≤r≤n thus in each case comprises the temporally consecutive signalling from 0 to kr ultrasonic echoes ec1, ec2, ec3, ec4, ec5, ec6 after the emission of an ultrasonic burst by the ultrasonic sensor system USSS, wherein kr is a positive whole number greater than or equal to 0. In the case of kr=0, the r-th ultrasonic sensor did not receive any ultrasonic echo in the relevant measurement cycle. Preferably, the ultrasonic sensor system USSS has at least 2 channels, better more channels. Preferably, the ultrasonic sensor system has at least a u-th channel and a u+1-th channel of measured values of its surroundings, with 1<u<n−1 and u being a positive whole number. In the case of n=4, the ultrasonic sensor system thus has at least a second channel and a third channel. The first channel and the fourth channel are edge channels in the case of n=4. Edge channels are special cases, which this document covers in detail above.

The generation of measured values via a j-th of the n−2 possible channels with j>1 and j<n means in each case that the j-th ultrasonic sensor 1,2 of the n ultrasonic sensors 0,1,2,3 emits an ultrasonic burst into the surroundings of the vehicle, and that the (j−1)-th ultrasonic sensor 0,1 of the ultrasonic sensors 0,1,2,3 receives the reflected ultrasonic burst, and that the j-th ultrasonic sensor 1,2 of the ultrasonic sensors 0,1,2,3 receives the reflected ultrasonic burst after the ultrasonic burst has been emitted, and that the (j+1)-th ultrasonic sensor 2,3 of the ultrasonic sensors 0,1,2,3 receives the reflected ultrasonic burst.

Furthermore, the generation of measured values via a j-th of the n−2 possible channels with j>1 and j<n means in each case that the (j−1)-th ultrasonic sensor 0,1 of the ultrasonic sensors 0,1,2,3 signals a first distance value corresponding to a first ultrasonic echo ec1 of the (j−1)-th ultrasonic sensor 0,1 if such an ultrasonic echo occurs, and that the (j−1)-th ultrasonic sensor 0,1 of the ultrasonic sensors 0,1,2,3 signals a second distance value corresponding to a second ultrasonic echo ec2 of the (j−1)-th ultrasonic sensor 0,1 if such an ultrasonic echo occurs, and that the (j−1)-th ultrasonic sensor 0,1 of the ultrasonic sensors 0,1,2,3 signals a third distance value corresponding to a third ultrasonic echo ec3 of the (j−1)-th ultrasonic sensor 0,1 if such an ultrasonic echo occurs, and that the j-th ultrasonic sensor 1,2 of the ultrasonic sensors 0,1,2,3 signals a first distance value corresponding to a first ultrasonic echo ec1 of the j-th ultrasonic sensor 1,2 if such an ultrasonic echo occurs, and that the j-th ultrasonic sensor 1,2 of the ultrasonic sensors 0,1,2,3 signals a second distance value corresponding to a second ultrasonic echo ec2 of the j-th ultrasonic sensor 1,2 if such an ultrasonic echo occurs, and that the j-th ultrasonic sensor 1,2 of the ultrasonic sensors 0,1,2,3 signals a third distance value corresponding to a third ultrasonic echo ec3 of the j-th ultrasonic sensor 1,2 if such an ultrasonic echo occurs, and that the (j+1)-th ultrasonic sensor 2,3 of the ultrasonic sensors 0,1,2,3 signals a first distance value corresponding to a first ultrasonic echo ec1 of the (j+1)-th ultrasonic sensor 2,3 if such an ultrasonic echo occurs, and that the (j+1)-th ultrasonic sensor 2,3 of the ultrasonic sensors 0,1,2,3 signals a second distance value corresponding to a second ultrasonic echo ec2 of the (j+1)-th ultrasonic sensor 2,3 if such an ultrasonic echo occurs, and that the (j+1)-th ultrasonic sensor 2,3 of the ultrasonic sensors 0,1,2,3 signals a third distance value corresponding to a third ultrasonic echo ec3 of the (j+1)-th ultrasonic sensor 2,3 if such an ultrasonic echo occurs.

In the case of exemplary n=4, the ultrasonic sensor system USSS only has two channels that are not edge channels of the ultrasonic sensor system. For n=4, these are the second channel 1 and the third channel 2. The first channel 0 and the fourth channel 3 are edge channels.

The generation of measured values via the second channel 1 of the two possible channels means in each case that the second ultrasonic sensor 1 of the 4 ultrasonic sensors 0,1,2,3 emits an ultrasonic burst into the surroundings of the vehicle, and that the first ultrasonic sensor 0 of the ultrasonic sensors 0,1,2,3 receives the reflected ultrasonic burst, and that the second ultrasonic sensor 1 of the ultrasonic sensors 0,1,2,3 receives the reflected ultrasonic burst after the ultrasonic burst has been emitted, and that the third ultrasonic sensor 2 of the ultrasonic sensors 0,1,2,3 receives the reflected ultrasonic burst.

Furthermore, the generation of measured values via the second channel 1 of the four possible channels, in this example n=4, means in each case
that the first ultrasonic sensor 0 of the ultrasonic sensors 0,1,2,3 signals a first distance value corresponding to a first ultrasonic echo ec1 of the first ultrasonic sensor 0 if such an ultrasonic echo occurs, and that the first ultrasonic sensor 0 of the ultrasonic sensors 0,1,2,3 signals a second distance value corresponding to a second ultrasonic echo ec2 of the first ultrasonic sensor 0 if such an ultrasonic echo occurs, and that the first ultrasonic sensor 0 of the ultrasonic sensors 0,1,2,3 signals a third distance value corresponding to a third ultrasonic echo ec3 of the first ultrasonic sensor 0 if such an ultrasonic echo occurs, and that the first ultrasonic sensor 0 of the ultrasonic sensors 0,1,2,3 signals further distance values corresponding to further ultrasonic echoes of the first ultrasonic sensor 0 if such an ultrasonic echo occurs, and
that the second ultrasonic sensor 1 of the ultrasonic sensors 0,1,2,3 signals a first distance value corresponding to a first ultrasonic echo ec1 of the second ultrasonic sensor 1 if such an ultrasonic echo occurs, and that the second ultrasonic sensor 1 of the ultrasonic sensors 0,1,2,3 signals a second distance value corresponding to a second ultrasonic echo ec2 of the second ultrasonic sensor 1 if such an ultrasonic echo occurs, and that the second ultrasonic sensor 1 of the ultrasonic sensors 0,1,2,3 signals a third distance value corresponding to a third ultrasonic echo ec3 of the second ultrasonic sensor 1 if such an ultrasonic echo occurs, and that the second ultrasonic sensor 1 of the ultrasonic sensors 0,1,2,3 signals further distance values corresponding to further ultrasonic echoes of the second ultrasonic sensor 1 if such an ultrasonic echo occurs, and
that the third ultrasonic sensor 2 of the ultrasonic sensors 0,1,2,3 signals a first distance value corresponding to a first ultrasonic echo ec1 of the third ultrasonic sensor 2 if such an ultrasonic echo occurs, and that the third ultrasonic sensor 3 of the ultrasonic sensors 0,1,2,3 signals a second distance value corresponding to a second ultrasonic echo ec2 of the third ultrasonic sensor 2 if such an ultrasonic echo occurs, and that the third ultrasonic sensor 2 of the ultrasonic sensors 0,1,2,3 signals a third distance value corresponding to a third ultrasonic echo ec3 of the third ultrasonic sensor 2 if such an ultrasonic echo occurs.

The generation of measured values via the third channel 3 of the two possible channels means in each case that the third ultrasonic sensor 2 of the 4 ultrasonic sensors 0,1,2,3 emits an ultrasonic burst into the surroundings of the vehicle, and that the second ultrasonic sensor 1 of the ultrasonic sensors 0,1,2,3 receives the reflected ultrasonic burst, and that the third ultrasonic sensor 2 of the ultrasonic sensors 0,1,2,3 receives the reflected ultrasonic burst after the ultrasonic burst has been emitted, and that the fourth ultrasonic sensor 3 of the ultrasonic sensors 0,1,2,3 receives the reflected ultrasonic burst.

Furthermore, the generation of measured values via the third channel 2 of the four possible channels, in this example n=4, means in each case
that the second ultrasonic sensor 1 of the ultrasonic sensors 0,1,2,3 signals a first distance value corresponding to a first ultrasonic echo ec1 of the second ultrasonic sensor 1 if such an ultrasonic echo occurs, and that the second ultrasonic sensor 1 of the ultrasonic sensors 0,1,2,3 signals a second distance value corresponding to a second ultrasonic echo ec2 of the second ultrasonic sensor 1 if such an ultrasonic echo occurs, and that the second ultrasonic sensor 1 of the ultrasonic sensors 0,1,2,3 signals a third distance value corresponding to a third ultrasonic echo ec3 of the second ultrasonic sensor 1 if such an ultrasonic echo occurs, and that the second ultrasonic sensor 1 of the ultrasonic sensors 0,1,2,3 signals further distance values corresponding to further ultrasonic echoes of the second ultrasonic sensor 1 if such an ultrasonic echo occurs, and
that the third ultrasonic sensor 2 of the ultrasonic sensors 0,1,2,3 signals a first distance value corresponding to a first ultrasonic echo ec1 of the third ultrasonic sensor 2 if such an ultrasonic echo occurs, and that the third ultrasonic sensor 3 of the ultrasonic sensors 0,1,2,3 signals a second distance value corresponding to a second ultrasonic echo ec2 of the third ultrasonic sensor 2 if such an ultrasonic echo occurs, and that the third ultrasonic sensor 2 of the ultrasonic sensors 0,1,2,3 signals a third distance value corresponding to a third ultrasonic echo ec3 of the third ultrasonic sensor 2 if such an ultrasonic echo occurs, and
that the fourth ultrasonic sensor 3 of the ultrasonic sensors 0,1,2,3 signals a first distance value corresponding to a first ultrasonic echo ec1 of the fourth ultrasonic sensor 3 if such an ultrasonic echo occurs, and that the fourth ultrasonic sensor 4 of the four ultrasonic sensors 0,1,2,3 signals a second distance value corresponding to a second ultrasonic echo ec2 of the fourth ultrasonic sensor 3 if such an ultrasonic echo occurs, and that the fourth ultrasonic sensor 3 of the ultrasonic sensors 0,1,2,3 signals a third distance value corresponding to a third ultrasonic echo ec3 of the fourth ultrasonic sensor 3 if such an ultrasonic echo occurs, and that the fourth ultrasonic sensor 3 of the ultrasonic sensors 0,1,2,3 signals further distance values corresponding to further ultrasonic echoes of the fourth ultrasonic sensor 3 if such an ultrasonic echo occurs.

Below, this document looks more closely at one of the at least two channels via which object recognition takes place. This channel is the u-th channel. Again, u is a positive whole number with 1<u<n.

According to the proposal, after the emission and reception of the ultrasonic burst, the ultrasonic sensor system USSS now ascertains, from the first ultrasonic echo ec1 of the (u−1)-th ultrasonic sensor in the measurement via the u-th channel if present, a distance value of the first ultrasonic echo ec1 of the (u−1)-th ultrasonic sensor of the u-th channel.

After the emission and reception of the ultrasonic burst, the ultrasonic sensor system USSS ascertains, from the first ultrasonic echo ec1 of the u-th ultrasonic sensor in the measurement via the u-th channel if present, a distance value of the first ultrasonic echo ec1 of the u-th ultrasonic sensor of the u-th channel.

After the emission and reception of the ultrasonic burst, the ultrasonic sensor system USSS ascertains, from the first ultrasonic echo ec1 of the (u+1)-th ultrasonic sensor in the measurement via the u-th channel if present, a distance value of the first ultrasonic echo (ec1) of the (u+1)-th ultrasonic sensor of the u-th channel.

After the emission and reception of the ultrasonic burst, the ultrasonic sensor system USSS ascertains, from the first ultrasonic echo ec1 of the u-th ultrasonic sensor in the measurement via the (u+1)-th channel if present, a distance value of the first ultrasonic echo ec1 of the u-th ultrasonic sensor of the (u+1)-th channel.

After the emission and reception of the ultrasonic burst, the ultrasonic sensor system USSS ascertains, from the first ultrasonic echo ec1 of the (u+1)-th ultrasonic sensor in the measurement via the (u+1)-th channel if present, a distance value of the first ultrasonic echo ec1 of the (u+1)-th ultrasonic sensor of the (u+1)-th channel.

After the emission and reception of the ultrasonic burst, the ultrasonic sensor system USSS ascertains, from the first ultrasonic echo ec1 of the (u+2)-th ultrasonic sensor in the measurement via the (u+1)-th channel if present, a distance value of the first ultrasonic echo ec1 of the (u+2)-th ultrasonic sensor of the (u+1)-th channel.

After the ultrasonic sensor system USSS has thus ascertained the raw data in the form of distance values in this way, the extraction of possible object coordinates of the possibly existing objects O from these raw data now follows.

For this purpose, the ultrasonic sensor system USSS preferably performs a trilateration method by means of its control device ECU, viz., preferably by means of a microcomputer MCU.

The ultrasonic sensor system USSS ascertains by means of this trilateration method, from the possibly ascertained distance value of the first ultrasonic echo ec1 of the (u−1)-th ultrasonic sensor of the u-th channel and from the possibly ascertained distance value of the first ultrasonic echo ec1 of the u-th ultrasonic sensor of the u-th channel and from the possibly ascertained distance value of the first ultrasonic echo ec1 of the (u+1)-th ultrasonic sensor of the u-th channel, u-th solutions in the form of Y/Y coordinates of potential objects O) in the surroundings of the vehicle. The u-th solutions are typically a plurality of solutions in the form of x/y coordinates.

The ultrasonic sensor system USSS ascertains by means of this trilateration method, from the possibly ascertained distance value of the first ultrasonic echo ec1 of the u-th ultrasonic sensor of the (u+1)-th channel and from the possibly ascertained distance value of the first ultrasonic echo ec1 of the (u+1)-th ultrasonic sensor of the (u+1)-th channel and from the possibly ascertained distance value of the first ultrasonic echo ec1 of the (u+2)-th ultrasonic sensor of the (u+1)-th channel, (u+1)-th solutions in the form of Y/Y coordinates of potential objects O in the surroundings of the vehicle. The (u+1)-th solutions are typically a plurality of solutions in the form of x/y coordinates.

From these u-th solutions and the (u+1)-th solutions, the ultrasonic sensor system USSS then ascertains the object coordinates of the objects in the surroundings of the vehicle. With more than 4 ultrasonic sensors, the ultrasonic sensor system USSS has more than two channels that are not edge channels of the ultrasonic sensor system USSS. In this case, the ultrasonic sensor system USSS treats and operates the additional channels, which are not edge channels, in an analogous manner. Preferably, the ultrasonic sensor system USSS treats the additional solutions of these additional channels in the manner described below for two channels.

Initially, we assume here that the preferred and recommended plausibility check does not take place at first, in order to keep the description simple. It is therefore initially skipped for simplification purposes.

Preferably, the ultrasonic sensor system USSS filters, by means of a respective Kalman filtering method, each of the u-th solutions to form filtered u-th solutions and filters, by means of a respective Kalman filtering method, each of the (u+1)-th solutions to form filtered (u+1)-th solutions. In general, the ultrasonic sensor system USSS preferably filters, by means of a respective estimation filtering method, each of the u-th solutions to form filtered u-th solutions and filters, by means of a respective estimation filtering method, each of the (u+1)-th solutions to form filtered (u+1)-th solutions.

Preferably, the ultrasonic sensor system USSS clusters, by means of a clustering method, the u-th solutions and the (u+1)-th solutions to form accepted solutions or discards unaccepted u-th solutions and unaccepted (u+1)-th solutions that it does not cluster into clusters since they do not satisfy the requirements as described above.

In a first further embodiment of the ultrasonic sensor system USSS, which builds on the previously described embodiment of the ultrasonic sensor system USSS, the ultrasonic sensor system USSS additionally also evaluates the second ultrasonic echoes ec2. For this purpose,
after the emission and reception of the ultrasonic burst, the ultrasonic sensor system USSS additionally preferably ascertains, from the second ultrasonic echo ec2 of the (u−1)-th ultrasonic sensor in the measurement via the u-th channel if present, a distance value of the second ultrasonic echo ec2 of the (u−1)-th ultrasonic sensor of the u-th channel, and
after the emission and reception of the ultrasonic burst, the ultrasonic sensor system USSS additionally preferably ascertains, from the second ultrasonic echo ec2 of the u-th ultrasonic sensor in the measurement via the u-th channel if present, a distance value of the second ultrasonic echo ec2 of the u-th ultrasonic sensor of the u-th channel, and
after the emission and reception of the ultrasonic burst, the ultrasonic sensor system USSS additionally preferably ascertains, from the second ultrasonic echo ec2 of the (u+1)-th ultrasonic sensor in the measurement via the u-th channel if present, a distance value of the second ultrasonic echo (ec2) of the (u+1)-th ultrasonic sensor of the u-th channel, and
after the emission and reception of the ultrasonic burst, the ultrasonic sensor system USSS additionally preferably ascertains, from the second ultrasonic echo ec2 of the u-th ultrasonic sensor in the measurement via the (u+1)-th channel if present, a distance value of the second ultrasonic echo (ec2) of the u-th ultrasonic sensor of the (u+1)-th channel, and
after the emission and reception of the ultrasonic burst, the ultrasonic sensor system USSS additionally preferably ascertains, from the second ultrasonic echo ec2 of the (u+1)-th ultrasonic sensor in the measurement via the (u+1)-th channel if present, a distance value of the second ultrasonic echo ec2 of the (u+1)-th ultrasonic sensor of the (u+1)-th channel, and
after the emission and reception of the ultrasonic burst, the ultrasonic sensor system USSS ascertains, from the second ultrasonic echo ec2 of the (u+2)-th ultrasonic sensor in the measurement via the (u+1)-th channel if present, a distance value of the second ultrasonic echo ec2 of the (u+2)-th ultrasonic sensor of the (u+1)-th channel.

Thus, additional raw data are now available, which the ultrasonic sensor system USSS additionally evaluates accordingly.

For this purpose, the ultrasonic sensor system USSS ascertains, by means of a trilateration method, from the possibly ascertained distance value of the first ultrasonic echo ec1 of the (u−1)-th ultrasonic sensor of the u-th channel and from the possibly ascertained distance value of the first ultrasonic echo ec1 of the u-th ultrasonic sensor of the u-th channel and from the possibly ascertained distance value of the first ultrasonic echo ec1 of the (u+1)-th ultrasonic sensor of the u-th channel and from the possibly ascertained distance value of the second ultrasonic echo ec2 of the (u−1)-th ultrasonic sensor of the u-th channel and from the possibly ascertained distance value of the second ultrasonic echo ec2 of the u-th ultrasonic sensor of the u-th channel and from the possibly ascertained distance value of the second ultrasonic echo ec2 of the (u+1)-th ultrasonic sensor of the u-th channel, u-th solutions in the form of Y/Y coordinates of potential objects (0) in the surroundings of the vehicle.

If the ultrasonic sensor system USSS ascertains further solutions, e.g., due to n>4, the ultrasonic sensor system USSS preferably evaluates these further solutions in an analogous manner and preferably includes them in an analogous manner in the further processing.

In this further embodiment, the ultrasonic sensor system (USSS) ascertains, by means of a trilateration method, from the possibly ascertained distance value of the first ultrasonic echo (ec1) of the u-th ultrasonic sensor of the (u+1)-th channel and from the possibly ascertained distance value of the first ultrasonic echo (ec1) of the (u+1)-th ultrasonic sensor of the (u+1)-th channel and from the possibly ascertained distance value of the first ultrasonic echo (ec1) of the (u+2)-th ultrasonic sensor of the (u+1)-th channel and from the possibly ascertained distance value of the second ultrasonic echo (ec2) of the u-th ultrasonic sensor of the (u+1)-th channel and from the possibly ascertained distance value of the second ultrasonic echo (ec2) of the (u+1)-th ultrasonic sensor of the (u+1)-th channel and from the possibly ascertained distance value of the second ultrasonic echo (ec2) of the (u+2)-th ultrasonic sensor of the (u+1)-th channel, (u+1)-th solutions in the form of Y/Y coordinates of potential objects (0) in the surroundings of the vehicle.

In this first further embodiment, the ultrasonic sensor system USSS also preferably clusters, by means of a clustering method, the u-th solutions and the (u+1)-th solutions to form accepted solutions or discards unaccepted u-th solutions and unaccepted (u+1)-th solutions that it does not cluster into clusters since they do not satisfy the requirements as described above.

Due to the increased amount of raw data, the number of objects O that the ultrasonic sensor system USSS can recognize is increased compared to the simplified form.

In a second further embodiment of the ultrasonic sensor system USSS, which builds on the basic embodiment and the further embodiment of the ultrasonic sensor system USSS, the ultrasonic sensor system USSS additionally also evaluates the second ultrasonic echoes ec3. For this purpose,
after the emission and reception of the ultrasonic burst, the ultrasonic sensor system USSS additionally preferably ascertains, from the third ultrasonic echo ec3 of the (u−1)-th ultrasonic sensor in the measurement via the u-th channel if present, a distance value of the third ultrasonic echo ec3 of the (u−1)-th ultrasonic sensor of the u-th channel, and
after the emission and reception of the ultrasonic burst, the ultrasonic sensor system USSS additionally preferably ascertains, from the third ultrasonic echo ec3 of the u-th ultrasonic sensor in the measurement via the u-th channel if present, a distance value of the third ultrasonic echo ec3 of the u-th ultrasonic sensor of the u-th channel, and
after the emission and reception of the ultrasonic burst, the ultrasonic sensor system USSS additionally preferably ascertains, from the third ultrasonic echo ec3 of the (u+1)-th ultrasonic sensor in the measurement via the u-th channel if present, a distance value of the third ultrasonic echo ec3 of the (u+1)-th ultrasonic sensor of the u-th channel, and
after the emission and reception of the ultrasonic burst, the ultrasonic sensor system USSS additionally preferably ascertains, from the third ultrasonic echo ec3 of the u-th ultrasonic sensor in the measurement via the (u+1)-th channel if present, a distance value of the third ultrasonic echo ec3 of the u-th ultrasonic sensor of the (u+1)-th channel, and
after the emission and reception of the ultrasonic burst, the ultrasonic sensor system USSS additionally preferably ascertains, from the third ultrasonic echo ec3 of the (u+1)-th ultrasonic sensor in the measurement via the (u+1)-th channel if present, a distance value of the third ultrasonic echo ec3 of the (u+1)-th ultrasonic sensor of the (u+1)-th channel, and
after the emission and reception of the ultrasonic burst, the ultrasonic sensor system USSS additionally preferably ascertains, from the third ultrasonic echo ec3 of the (u+2)-th ultrasonic sensor in the measurement via the (u+1)-th channel if present, a distance value of the third ultrasonic echo ec3 of the (u+2)-th ultrasonic sensor of the (u+1)-th channel.

Thus, additional raw data are now again available, which the ultrasonic sensor system USSS additionally evaluates accordingly.

For this purpose, the ultrasonic sensor system USSS preferably ascertains, by means of a trilateration method, from the possibly ascertained distance value of the first ultrasonic echo ec1 of the (u−1)-th ultrasonic sensor of the u-th channel and from the possibly ascertained distance value of the first ultrasonic echo ec1 of the u-th ultrasonic sensor of the u-th channel and from the possibly ascertained distance value of the first ultrasonic echo ec1 of the (u+1)-th ultrasonic sensor of the u-th channel and from the possibly ascertained distance value of the second ultrasonic echo ec2 of the (u−1)-th ultrasonic sensor of the u-th channel and from the possibly ascertained distance value of the second ultrasonic echo ec2 of the u-th ultrasonic sensor of the u-th channel and from the possibly ascertained distance value of the second ultrasonic echo ec2 of the (u+1)-th ultrasonic sensor of the u-th channel, from the possibly ascertained distance value of the third ultrasonic echo ec3 of the (u−1)-th ultrasonic sensor of the u-th channel and from the possibly ascertained distance value of the third ultrasonic echo ec3 of the u-th ultrasonic sensor of the u-th channel and from the possibly ascertained distance value of the third ultrasonic echo ec3 of the (u+1)-th ultrasonic sensor of the u-th channel, u-th solutions in the form of Y/Y coordinates of potential objects (0) in the surroundings of the vehicle.

Furthermore, the ultrasonic sensor system USSS preferably ascertains, by means of a trilateration method, from the possibly ascertained distance value of the first ultrasonic echo ec1 of the u-th ultrasonic sensor of the (u+1)-th channel and from the possibly ascertained distance value of the first ultrasonic echo ec1 of the (u+1)-th ultrasonic sensor of the (u+1)-th channel and from the possibly ascertained distance value of the first ultrasonic echo ec1 of the (u+2)-th ultrasonic sensor of the (u+1)-th channel, from the possibly ascertained distance value of the second ultrasonic echo ec2 of the u-th ultrasonic sensor of the (u+1)-th channel and from the possibly ascertained distance value of the second ultrasonic echo ec2 of the (u+1)-th ultrasonic sensor of the (u+1)-th channel and from the possibly ascertained distance value of the second ultrasonic echo ec2 of the (u+2)-th ultrasonic sensor of the (u+1)-th channel and from the possibly ascertained distance value of the third ultrasonic echo ec3 of the u-th ultrasonic sensor of the (u+1)-th channel and from the possibly ascertained distance value of the third ultrasonic echo ec3 of the (u+1)-th ultrasonic sensor of the (u+1)-th channel and from the possibly ascertained distance value of the third ultrasonic echo ec3 of the (u+2)-th ultrasonic sensor of the (u+1)-th channel, (u+1)-th solutions in the form of Y/Y coordinates of potential objects O in the surroundings of the vehicle.

In this second further embodiment, the ultrasonic sensor system USSS also preferably clusters, by means of a clustering method, the u-th solutions and the (u+1)-th solutions to form accepted solutions or discards unaccepted u-th solutions and unaccepted (u+1)-th solutions that it does not cluster into clusters since they do not satisfy the requirements as described above.

In a third further embodiment of the ultrasonic sensor system USSS, which builds on the basic embodiment and/or the first and/or second further embodiment of the ultrasonic sensor system USSS, the ultrasonic sensor system USSS additionally performs plausibility checks prior to performing the Kalman filtering methods or the estimation filtering methods.

For this purpose, the ultrasonic sensor system USSS filters, by means of methods for plausibility checking, each of the u-th solutions to form plausibility-checked u-th solutions or discards them if they do not satisfy specified conditions.

Furthermore, the ultrasonic sensor system USSS filters, by means of methods for plausibility checking, each of the (u+1)-th solutions to form plausibility-checked (u+1)-th solutions or discards them if they do not satisfy specified conditions.

Thereafter, the ultrasonic sensor system USSS processes these data by applying the Kalman filtering methods or estimation filtering methods to these data. The ultrasonic sensor system (USSS) thus now filters, by means of a respective Kalman filtering method or by means of an estimation filtering method, each of the plausibility-checked u-th solutions to form filtered u-th solution and, by means of a respective Kalman filtering method or by means of a respective estimation filtering method, each of the plausibility-checked (u+1)-th solutions to form filtered (u+1)-th solutions.

In this third further embodiment, the ultrasonic sensor system USSS also preferably clusters, by means of a clustering method, the u-th solutions and the (u+1)-th solutions to form accepted solutions or discards unaccepted u-th solutions and unaccepted (u+1)-th solutions that it does not cluster into clusters since they do not satisfy the requirements as described above.

This plausibility check has the advantage that obvious interferences have a significantly lesser effect.

In a fourth further embodiment of the ultrasonic sensor system USSS, which builds on the basic embodiment and/or the first and/or second and/or third further embodiment of the ultrasonic sensor system USSS, the ultrasonic sensor system USSS additionally replaces solutions by alternative solutions. In so doing, the ultrasonic sensor system USSS replaces the u-th solutions, discarded, for example, by means of a method for plausibility checking, with the respective, most recently accepted u-th solutions and then uses them further as plausibility-checked u-th solutions. In an analogous manner, the ultrasonic sensor system USSS replaces the (u+1)-th solutions, discarded by means of a method for plausibility checking, with the respective, most recently accepted (u+1)-th solutions and then uses them further as plausibility-checked (u+1)-th solutions.

This has the advantage that the deletion of non-plausible solutions does not result in interferences that are greater than the interference caused by the deleted non-plausible solution.

Below, the document presented herein now lists a few examples of plausibility checks. The ultrasonic sensor system USSS may perform plausibility checks that only relate to distances, before and after the trilateration processing. Both variants are an express part of what is claimed in this document. Such plausibility checks that evaluate x/y coordinates, i.e., locations or directions of solutions, are preferably performed by the ultrasonic sensor system USSS prior to the application of the Kalman filtering methods or the estimation filtering methods.

In a fifth further embodiment of the ultrasonic sensor system USSS, which builds on the basic embodiment and/or the first and/or second and/or third and/or fourth further embodiment of the ultrasonic sensor system USSS, the ultrasonic system USSS evaluates whether the measured value of the distance from the ultrasonic sensor system USSS is greater than an allowed maximum distance. This prevents measured values beyond a maximum range of the ultrasonic sensor system USSS verified in a qualification as reliable and safe.

For this purpose, the method for plausibility checking, which the ultrasonic sensor system USSS carries out, preferably discards those of the u-th solutions that correspond to a time of flight of the ultrasonic burst from its emission to the reception by at least one of the ultrasonic sensors that is greater than a maximum allowed time of flight tₘₐₓ, in particular greater than a time of flight of 1.4 ms. For this purpose, the method for plausibility checking, which the ultrasonic sensor system USSS carries out, preferably also discards those of the (u+1)-th solutions that correspond to a time of flight of the ultrasonic burst from its emission to the reception by at least one of the ultrasonic sensors that is greater than the maximum allowed time of flight Δeₘₐₓ, in particular greater than a time of flight of Δeₘₐₓ>1.4 ms.

In a sixth further embodiment of the ultrasonic sensor system USSS, which builds on the basic embodiment and/or the first and/or second and/or third and/or fourth and/or fifth further embodiment of the ultrasonic sensor system USSS, the ultrasonic system USSS evaluates how many ultrasonic echoes of different ultrasonic sensors of one channel detect the object.

The method for plausibility checking, which the ultrasonic sensor system (USSS) carries out, discards those of the (u+1)-th solutions or u-th solutions that are not to at least exactly one ultrasonic echo of an associated ultrasonic sensor and exactly one further ultrasonic echo of an associated further ultrasonic sensor and exactly one additional ultrasonic echo of an associated additional ultrasonic sensor, thus to three ultrasonic echoes of three different ultrasonic sensors.

This results in the ultrasonic sensor system USSS only passing on only objects O recognized reliably with a very high certainty. At least, the ultrasonic sensor system can thus indicate quantitative reliability information for the existence and location of the object O.

In a seventh further embodiment of the ultrasonic sensor system USSS, which builds on the basic embodiment and/or the first and/or second and/or third and/or fourth and/or fifth and/or sixth further embodiment of the ultrasonic sensor system USSS, the ultrasonic system USSS deactivates the Kalman filtering method or the estimation filtering method for measurements in a particular channel and for a particular ultrasonic echo of a particular ultrasonic sensor in order to suppress artefacts and thus further improve the recognition result.

For this purpose, the method for plausibility checking, which the ultrasonic sensor system (USSS) carries out, deactivates the Kalman filtering method or the estimation filtering method of the relevant channel and ultrasonic echo of the relevant ultrasonic sensor if the signal of the value of the arrival time of the relevant ultrasonic echo of the relevant ultrasonic sensor, i.e., of a u-th solution or a (u+1)-th solution in two consecutive iterations changes by more than Δe_{filter_max} or by Δe_{filter_max}, with Δe_{filter_max} preferably Δe_{filter_max}≥500 μs. “Deactivate” means that the ultrasonic sensor system USSS uses all or several or individual ones of the plausibility-checked u-th solutions as filtered u-th solutions and/or directly uses all or several or individual ones of the plausibility-checked (u+1)-th solutions as filtered (u+1)-th solutions for the time of deactivation. The Kalman filtering method or estimation filtering method is thus bridged for this ultrasonic echo of this relevant ultrasonic sensor in a measurement via this channel for a specified number of measurement cycles, e.g., one or two measurement cycles.

Typically, the ultrasonic sensor system USSS cancels such a deactivation of the Kalman filtering method or estimation filtering method for measurements of the arrival time of an ultrasonic echo of an ultrasonic sensor in measurements via a single channel after a predetermined number of measurement cycles.

This has the advantage that the above-described artefacts do not occur or occur only to a lesser extent.

In an eighth further embodiment of the ultrasonic sensor system USSS, which builds on the basic embodiment and/or the first and/or second and/or third and/or fourth and/or fifth and/or sixth and/or seventh further embodiment of the ultrasonic sensor system USSS, the ultrasonic system USSS checks the angle between the line of sight of the relevant ultrasonic sensor and the solution the ultrasonic sensor system USSS has ascertained from the measured value of the ultrasonic sensor.

For this purpose, the method for plausibility checking, which the ultrasonic sensor system USSS carries out, discards the possibly filtered u-th or possibly filtered (u+1)-th solutions for which the line from the location of the possibly filtered u-th or possibly filtered (u+1)-th solution to the location of the u-th or (u+1)-th ultrasonic sensor has an angle α to this viewing axis SA of the u-th or (u+1)-th ultrasonic sensor whose magnitude is greater than the magnitude of a maximum angle αₗᵢₘ.

This has the advantage that solutions in which the ultrasonic sensor is not at all sensitive can be eliminated in the evaluation method carried out by the ultrasonic sensor system USSS and cannot cause any interferences.

Even in the ultrasonic sensors 0,1,2,3 themselves, the ultrasonic sensor system USSS can perform optimisations. Preferably, the threshold value curve SWK of the ultrasonic sensors 0,1,2,3 can be set. As described above, the ultrasonic sensors 0,1,2,3 of the ultrasonic sensor system USSS each preferably extract an envelope signal HK of the respective ultrasonic sensor 0,1,2,3 from the signal of the reflected ultrasonic wave USW, which signal reaches the respective ultrasonic sensor 0,1,2,3. Using a preferably ultrasonic sensor-specific threshold value curve SWK, the respective ultrasonic sensor of the ultrasonic sensors 0,1,2,3 extracts its ultrasonic echoes ec1, ec2, ec3, ec4, ec5, ec6 for the respective measurement cycle from its envelope signal (HK) and signals it to the control device ECU. According to the proposal and according to this further new embodiment of the ultrasonic sensor system, the threshold value curve SWK of an ultrasonic sensor, better of a plurality of or even better of all ultrasonic sensors, depends, for one measurement cycle, on the clustered and accept solutions previously ascertained by the ultrasonic sensor system USSS in the measurement cycles preceding this measurement cycle. This optimizes the number of fraudulent echoes.

For this purpose, the ultrasonic sensor system USSS makes a prediction of the number of ultrasonic echoes for the relevant ultrasonic sensor in measurements in the relevant channel. In so doing, preferably, the ultrasonic sensor system USSS preferably does not take into account objects that are obscured and/or too far away from this ultrasonic sensor system and that the ultrasonic sensor system USSS recognized in a preceding measurement cycle. If the number of recognized ultrasonic echoes is too low and one of the ultrasonic echoes that the ultrasonic sensor system USSS expects in a particular period of time after the ultrasonic burst has been emitted at the beginning of the measurement cycle is missing, the ultrasonic sensor system may, for example, selectively lower the threshold value curve SWK in this range to a typically specified minimum value. If the ultrasonic sensor finds ultrasonic echoes that the ultrasonic sensor system assesses as interferences based on, for example, plausibility checks, the ultrasonic sensor system USSS may cause the ultrasonic sensor to raise the threshold value curve SWK in this range, preferably slowly, measurement cycle by measurement cycle, to a maximum value.

The tenth, further embodiment of the ultrasonic sensor system USSS, which builds on the basic embodiment and/or the first and/or second and/or third and/or fourth and/or fifth and/or sixth and/or seventh and/or eighth and/or ninth further embodiment of the ultrasonic sensor system USSS, relates to a control for clustering by means of the distance between the solutions.

According to this tenth embodiment, the ultrasonic sensor system (USSS) clusters, by means of a clustering method, the possibly filtered u-th solutions and the possibly filtered (u+1)-th solutions to form accepted solutions and discards the unaccepted, possibly filtered u-th solutions or unaccepted, possibly filtered (u+1)-th solutions if the distances between at least one of the solutions of the cluster and at least e other solutions of the cluster are less than a threshold value distance s, wherein e is a positive whole number greater than 0, or better greater than 1 or better greater than 2, and wherein e=3 is particularly preferred.

This further improves the spread of the recognition result.

The eleventh, further embodiment of the ultrasonic sensor system USSS, which builds on the basic embodiment and/or the first and/or second and/or third and/or fourth and/or fifth and/or sixth and/or seventh and/or eighth and/or ninth and/or tenth further embodiment of the ultrasonic sensor system USSS, relates to a control for clustering as a function of the number of potential cluster members.

According to this eleventh embodiment, the ultrasonic sensor system USSS clusters, by means of a clustering method, the possibly filtered u-th solutions and the possibly filtered (u+1)-th solutions to form accepted solutions and discards unaccepted, possibly filtered u-th solutions or unaccepted, possibly filtered (u+1)-th solutions if the number of possibly filtered u-th solutions and the possibly filtered (u+1)-th solutions of a cluster is at least three.

Preferably, the ultrasonic sensor system USSS clusters, by means of a clustering method, u-th solutions and (u+1)-th solutions or filtered u-th solutions and filtered (u+1)-th solutions into an already existing cluster as accepted solutions and discards unaccepted, possibly filtered u-th solutions or unaccepted, possibly filtered (u+1)-th solutions if the number of the u-th solutions and the (u+1)-th solutions of the cluster that are in the neighbourhood of such a possibly filtered u-th solution or possibly filtered (u+1)-th solution is at least one.

These two measures, together or individually, further improve the spread of the recognition result.

In the twelfth, further embodiment of the ultrasonic sensor system USSS, which builds on the basic embodiment and/or the first and/or second and/or third and/or fourth and/or fifth and/or sixth and/or seventh and/or eighth and/or ninth and/or tenth and/or eleventh further embodiment of the ultrasonic sensor system USSS, the ultrasonic sensor system USSS comprises an ultrasonic sensor 5, which emits an ultrasonic noise signal having an at least partially random modulation at least in one parameter. This may, for example, be a random phase, amplitude, or frequency modulation.

This has the advantage that the ultrasonic sensor system USSS can sense the interferences of this ultrasonic sensor 5 and can make the threshold value curves SWK of the other ultrasonic sensors insensitive to these interferences.

In summary, the proposed ultrasonic sensor system USSS is thus an ultrasonic sensor system USSS in which the ultrasonic sensor system USSS ascertains distance values on the basis of ultrasonic echoes that at least four ultrasonic sensors sense, and the ultrasonic sensor system USSS ascertains solutions from these distance values by means of a trilateration method and filters, by means of a respective Kalman filtering method or by means of a respective estimation filtering method, each of these solutions to form filtered solutions and clusters, by means of a clustering method, the filtered solutions to form accepted solutions and discards unaccepted unaccepted filtered solutions.

In a further embodiment of the ultrasonic sensor system (USSS), the trilateration method, which the ultrasonic sensor system (USSS) carries out, first determines a solution on the basis of two ultrasonic echoes of two different ultrasonic sensors. The ultrasonic sensor system USSS accepts the solution if it is a solution from the fallback area, and does not accept the solution on the basis of two ultrasonic echoes of two different ultrasonic sensors if it is a solution from the three-sensor area. In the latter case, the trilateration method, which the ultrasonic sensor system USSS carries out, then determines a solution on the basis of three ultrasonic echoes of three different ultrasonic sensors. For this purpose, the trilateration method then possibly also utilizes other ultrasonic echoes of the relevant ultrasonic sensors in a possibly different combination.

Preferably, the trilateration method, which the ultrasonic sensor system USSS carries out, uses each ultrasonic echo only once for the determination of a solution in a measurement cycle. This prevents fraudulent objects.

In a further embodiment of the ultrasonic sensor system (USSS), the clustering depends on a threshold value distance E, and this threshold value distance E in turn depends on the change in accepted solutions of the clustering between at least two measurement cycles. That is to say, the threshold values may be selected such that the velocity and/or acceleration vectors of the recognized objects are ascertained and taken into account. As a result, the filtering adapts to the dynamics of the situation.

In a further embodiment of the ultrasonic sensor system (USSS), the ultrasonic system (USSS) ascertains the temporal changes of the accepted solutions from data of the accepted solutions of the last v measurement cycles, with v as a positive whole number greater than 1. The ultrasonic sensor system (USSS) then determines therefrom, for example, by means of a polynomial approximation, for one or more ultrasonic sensors of the ultrasonic sensor system (USSS), the respective time point of the expected next reception of the ultrasonic echoes belonging to the relevant solution, for these ultrasonic sensors. On this basis, the ultrasonic sensor system (USSS) modifies the threshold value curve SWK of one or more of these ultrasonic sensors as a function of the result of this prediction, in particular for a time range around the respective time point of the respectively expected next reception of the respective ultrasonic echoes belonging to the relevant solution, for these respective ultrasonic sensors. As a result, the ultrasonic sensor system adapts its sensitivity to the recognized surroundings.

### Method

According to the technical teaching of this document, this immediately previously described apparatus corresponds to a method for operating an ultrasonic sensor system USSS. Vehicles or mobile apparatuses can utilize this ultrasonic sensor system USSS. The method serves to ascertain a map of the surroundings with coordinates of objects in the environment of the ultrasonic sensor system USSS or of the vehicle that comprises the ultrasonic sensor system USSS. The coordinates of objects in the environment of the ultrasonic sensor system USSS or of the vehicle are preferably available in the form of accepted solutions in the form of x/y coordinates.

According to the proposal, the method ascertains distance values on the basis of ultrasonic echoes that at least four ultrasonic sensors sense, and solutions from these distance values by means of a trilateration method. Furthermore, the method filters, by means of a respective Kalman filtering method or estimation filtering method, each of these solutions to form filtered solutions. By means of a clustering method, the method then clusters the filtered solutions to form accepted solutions. The method discards unaccepted solutions and unaccepted filtered solutions.

The ultrasonic sensor system USSS preferably comprises at least n ultrasonic sensors (0,1,2,3), wherein n is a positive whole number with 3<n. At least four ultrasonic sensors (0,1,2,3) are typically arranged along an intersection-free, straight or curved line. In the sense of this document, the ultrasonic sensors can be numbered consecutively according to their position along this line by counting such that the numbers of directly adjacent ultrasonic sensors on the line differ by a value of exactly 1. This serves only for guidance within this document so that all ultrasonic sensors not located at the edge have one ultrasonic sensor as predecessor and one ultrasonic sensor as successor along the chain. A (u−1)-th ultrasonic sensor is here to be the predecessor of a u-th ultrasonic sensor. A (u+1)-th ultrasonic sensor is here to be the successor of a u-th ultrasonic sensor. In the sense of this document, the (u−1)-th ultrasonic sensor and the u-th ultrasonic sensor and the (u+1)-th ultrasonic sensor then form a u-th channel, with 1<u<n.

The method presented herein consists of a plurality of steps, wherein some steps are repeated, where applicable. These repeated steps then typically partially process different ultrasonic echoes than the previous steps.

A first step of the method presented is starting a measurement cycle of the u-th channel with the emission of an ultrasonic burst as an ultrasonic wave (USW) by the u-th ultrasonic sensor.

A second step of the method presented is receiving, by the (u−1)-th ultrasonic sensor, the ultrasonic burst reflected by one or more objects. The reception of the ultrasonic echoes takes place in the form of k₍ᵤ₋₁₎ ultrasonic echoes. Here, k₍ᵤ₋₁₎ is a positive whole number, which may also be zero. These ultrasonic echoes of the (u−1)-th ultrasonic sensor can now be numbered consecutively from 1 to k₍ᵤ₋₁₎ in the sense of this document according to the chronological order of their detection by the (u−1)-th ultrasonic sensor after the emission of the ultrasonic burst in the relevant measurement cycle. For each measurement cycle, the numbering of the ultrasonic echoes of the (u−1)-th ultrasonic sensor thus restarts again at 1 with the first ultrasonic echo arriving at this (u−1)-th ultrasonic sensor after the emission of the ultrasonic burst.

A third step of the method presented is receiving, by the u-th ultrasonic sensor, the ultrasonic burst reflected by one or more objects. The reception of the ultrasonic echoes takes place in the form of kᵤ ultrasonic echoes. Here, kᵤ is a positive whole number, which may also be zero. These ultrasonic echoes of the u-th ultrasonic sensor can now be numbered consecutively from 1 to kᵤ in the sense of this document according to the chronological order of their detection by the u-th ultrasonic sensor after the emission of the ultrasonic burst in the relevant measurement cycle. For each measurement cycle, the numbering of the ultrasonic echoes of the u-th ultrasonic sensor thus restarts again at 1 with the first ultrasonic echo arriving at this u-th ultrasonic sensor after the emission of the ultrasonic burst.

A second step of the method presented is receiving, by the (u+1)-th ultrasonic sensor, the ultrasonic burst reflected by one or more objects. The reception of the ultrasonic echoes takes place in the form of k₍ᵤ₊₁₎ ultrasonic echoes. Here, k₍ᵤ₊₁₎ is a positive whole number, which may also be zero. These ultrasonic echoes of the (u+1)-th ultrasonic sensor can now be numbered consecutively from 1 to k₍ᵤ₊₁₎ in the sense of this document according to the chronological order of their detection by the (u+1)-th ultrasonic sensor after the emission of the ultrasonic burst in the relevant measurement cycle. For each measurement cycle, the numbering of the ultrasonic echoes of the (u+1)-th ultrasonic sensor thus restarts again at 1 with the first ultrasonic echo arriving at this (u+1)-th ultrasonic sensor after the emission of the ultrasonic burst.

A fifth step of the method presented is determining in each case a respective distance value of the ultrasonic echo of the (u−1)-th ultrasonic sensor. In so doing, the method determines the distance value from the respective time of flight of the respective ultrasonic echo of the m₍ᵤ₋₁₎ first arriving ultrasonic echoes of the (u−1)-th ultrasonic sensor. The time of flight is measured between the time point of emission of the ultrasonic burst by the u-th ultrasonic sensor on the one hand and the time point of detection by the (u−1)-th ultrasonic sensor on the other hand. In this context of this method, m₍ᵤ₋₁₎ is a positive whole number, which may be equal to zero. It this respect, m₍ᵤ₋₁₎≤k₍ᵤ₋₁₎ is to apply.

A sixth step of the method presented is determining in each case a respective distance value of the ultrasonic echo of the u-th ultrasonic sensor. In so doing, the method determines the distance value from the respective time of flight of the respective ultrasonic echo of the mᵤ first arriving ultrasonic echoes of the u-th ultrasonic sensor. The time of flight is measured between the time point of emission of the ultrasonic burst by the u-th ultrasonic sensor on the one hand and the time point of subsequent detection by the u-th ultrasonic sensor on the other hand. In this context of this method, mᵤ is a positive whole number, which may be equal to zero. It this respect, mᵤ≤kᵤ is to apply.

A seventh step of the method presented is determining in each case a respective distance value of the ultrasonic echo of the (u+1)-th ultrasonic sensor. In so doing, the method determines the distance value from the respective time of flight of the respective ultrasonic echo of the m₍ᵤ₊₁₎ first arriving ultrasonic echoes of the (u+1)-th ultrasonic sensor. The time of flight is measured between the time point of emission of the ultrasonic burst by the u-th ultrasonic sensor on the one hand and the time point of detection by the (u+1)-th ultrasonic sensor on the other hand. In this context of this method, m₍ᵤ₊₁₎ is a positive whole number, which may be equal to zero. It this respect, m₍ᵤ₊₁₎≤k₍ᵤ₊₁₎ is to apply. An eighth step of the method presented is associating usage information in each case with each determined distance value. In so doing, this respective usage information of the respective distance value initially marks this distance value as unused in its usage information. Unused is the initialisation value for the distance values at the start of a measurement cycle.

An eighth step of the method presented is initialising a (u−1)-th echo counter p₍ᵤ₋₁₎ with 1.

An ninth step of the method presented is initialising a u-th echo counter pᵤ with 1.

A tenth step of the method presented is initialising a (u+1)-th echo counter p₍ᵤ₊₁₎ with 1.

The start of the eleventh step of the method presented is simultaneously a first return point of the method. This document refers to this first return point as a jump point below.

The execution of this eleventh step of the method presented depends on various conditions. A first condition is whether the p₍ᵤ₋₁₎-th distance value of the (u−1)-th ultrasonic sensor for its p₍ᵤ₋₁₎-th ultrasonic echo is marked as used or is not marked as used in its usage information. A second condition is whether the pᵤ-th distance value of the u-th ultrasonic sensor for its pᵤ-th ultrasonic echo is marked as used or is not marked as used in its usage information.

The first resultant case is that the p₍ᵤ₋₁₎-th distance value of the (u−1)-th ultrasonic sensor for its p₍ᵤ₋₁₎-th ultrasonic echo is not marked as used in its usage information, and
if the pᵤ-th distance value of the u-th ultrasonic sensor for its pᵤ-th ultrasonic echo is not marked as used in its usage information. In this first case, the eleventh step of the method presented is a trilateration of the distance value of the (u−1)-th ultrasonic sensor for its p₍ᵤ₋₁₎-th ultrasonic echo on the one hand with the distance value of the u-th ultrasonic sensor for its pᵤ-th ultrasonic echo and ascertainment on the other hand. This first trilateration then ascertains a first trilateration point in the form of a first x/y coordinate.

In a second case, the p₍ᵤ₋₁₎-th distance value of the (u−1)-th ultrasonic sensor for its p₍ᵤ₋₁₎-th ultrasonic echo is marked as used in its usage information, or the pᵤ-th distance value of the u-th ultrasonic sensor for its pᵤ-th ultrasonic echo is marked as used in its usage information. In this second case, the method treats this first trilateration as if the first trilateration point and the second trilateration point, which is not yet determined here, are not both within a fault tolerance range (FB). The method skips the following steps and continues with jump point 3. This skips the steps between jump point 2 and jump point 3. This document refers to this as skipping jump point 2.

### Jump Point 2:

A second condition is whether the p₍ᵤ₊₁₎-th distance value of the (u+1)-th ultrasonic sensor for its p₍ᵤ₊₁₎-th ultrasonic echo is marked as used or as not used in its usage information. If the p₍ᵤ₊₁₎-th distance value of the (u+1)-th ultrasonic sensor for its p₍ᵤ₊₁₎-th ultrasonic echo is marked as not used in its usage information, the eleventh step is a trilateration of the distance value of the (u+1)-th ultrasonic sensor for its p₍ᵤ₊₁₎-th ultrasonic echo on the one hand with the distance value of the u-th ultrasonic sensor for its pᵤ-th ultrasonic echo on the other hand. In this case, a second trilateration point in the form of a second x/y coordinate is ascertained.

However, if the p₍ᵤ₊₁₎-th distance value of the (u+1)-th ultrasonic sensor for its p₍ᵤ₊₁₎-th ultrasonic echo is marked as used in its usage information, the eleventh step is the treatment of the trilateration as if the first trilateration point and the second trilateration point are not both within a fault tolerance range (FB). The method then continues to continue with jump point 3.

The twelfth step then follows and is the comparison of the first trilateration point with the second trilateration point;

The start of the thirteenth step of the method is the jump point 3. The thirteenth step depends on whether the first trilateration point and the second trilateration point are not both within a fault tolerance range (FB), and whether p₍ᵤ₊₁₎<k₍ᵤ₊₁₎ and whether p₍ᵤ₋₁₎<k₍ᵤ₋₁₎ and whether pᵤ≤kᵤ apply.

If the first trilateration point and the second trilateration point are not both within a fault tolerance range (FB) and p₍ᵤ₊₁₎<k₍ᵤ₊₁₎ and p₍ᵤ₋₁₎≤k₍ᵤ₋₁₎ and pᵤ≤kᵤ apply, increasing p₍ᵤ₊₁₎ by 1 is the eleventh step.

After the eleventh step, the method performs a return jump to jump point 2. The repeating of the steps from jump point 2 then follows.

If the first trilateration point and the second trilateration point are not both within a fault tolerance range (FB) and p₍ᵤ₊₁₎≥k₍ᵤ₊₁₎ and p₍ᵤ₋₁₎<k₍ᵤ₋₁₎ and pᵤ≤kᵤ apply, initialising p₍ᵤ₊₁₎ with 1 and increasing p₍ᵤ₋₁₎ by 1 are the eleventh step. However, after the eleventh step, the method then performs a return jump to jump point 1. The repeating of the steps from jump point 1 follows.

If the first trilateration point and the second trilateration point are not both within a fault tolerance range (FB) and p₍ᵤ₊₁₎<k₍ᵤ₊₁₎ and p₍ᵤ₋₁₎≤k₍ᵤ₋₁₎ and pᵤ≤kᵤ apply, increasing p₍ᵤ₊₁₎ by 1 is the eleventh step. However, after the eleventh step, the method then performs a return jump to jump point 2. The repeating of the steps from jump point 2 follows.

If the first trilateration point and the second trilateration point are not both within a fault tolerance range (FB) and p₍ᵤ₊₁₎≥k₍ᵤ₊₁₎ and p₍ᵤ₋₁₎≤k₍ᵤ₋₁₎ and pᵤ<kᵤ apply, initialising p₍ᵤ₊₁₎ with 1 and initialising p₍ᵤ₋₁₎ with 1 and increasing pᵤ by 1 are the eleventh step. However, after the eleventh step, the method then performs a return jump to jump point 1. The repeating of the steps from jump point 1 follows.

If the first trilateration point and the second trilateration point are not both within a fault tolerance range (FB) and p₍ᵤ₊₁₎<k₍ᵤ₊₁₎ and p₍ᵤ₋₁₎≥k₍ᵤ₋₁₎ and pᵤ≥kᵤ apply, increasing p₍ᵤ₊₁₎ by 1 is the eleventh step. However, after the eleventh step, the method then performs a return jump to jump point 2. The repeating of the steps from jump point 2 follows.

If the first trilateration point and the second trilateration point are not both within a fault tolerance range (FB) and p₍ᵤ₊₁₎≥k₍ᵤ₊₁₎ and p₍ᵤ₋₁₎≥k₍ᵤ₋₁₎ and pᵤ≥kᵤ apply, initialising p₍ᵤ₊₁₎ with 1 and increasing p₍ᵤ₋₁₎ by 1 are the eleventh step. However, after the eleventh step, the method then performs a return jump to jump point 1. The repeating of the steps from jump point 1 follows.

If the first trilateration point and the second trilateration point are not both within a fault tolerance range (FB) and p₍ᵤ₊₁₎<k₍ᵤ₊₁₎ and p₍ᵤ₋₁₎≥k₍ᵤ₋₁₎ and pᵤ≥kᵤ apply, increasing p₍ᵤ₊₁₎ by 1 is the eleventh step.

However, after the eleventh step, the method then performs a return jump to jump point 2. The repeating of the steps from jump point 2 follows.

If, however, the first trilateration point and the second trilateration point are both within a fault tolerance range (FB), the following sub-steps are the eleventh step:
a) In this case, the first sub-step of the eleventh step is ascertaining a solution from the first trilateration point and the second trilateration point.
b) In this case, the second sub-step of the eleventh step is adding the thus ascertained solution to the set of solutions of this u-th channel of this measurement cycle.
c) In this case, the third sub-step of the eleventh step is marking the p₍ᵤ₋₁₎-th distance value of the (u−1)-th ultrasonic sensor for its p₍ᵤ₋₁₎-th ultrasonic echo as used in its usage information.
d) In this case, the fourth sub-step of the eleventh step is and marking the pᵤ-th distance value of the u-th ultrasonic sensor for its pᵤ-th ultrasonic echo as used.
e) In this case, the fifth sub-step of the eleventh step is marking the p₍ᵤ₊₁₎-th distance value of the (u+1)-th ultrasonic sensor for its p₍ᵤ₊₁₎-th ultrasonic echo as used in its usage information.
f) In this case, the sixth sub-step of the eleventh step is initialising the (u−1)-th echo counter p₍ᵤ₋₁₎ with 1.
g) In this case, the seventh sub-step of the eleventh step is initialising the u-th echo counter pᵤ with 1.
h) In this case, the eighth sub-step of the eleventh step is and initialising the (u+1)-th echo counter p₍ᵤ₊₁₎ with 1.

The repeating of the steps from jump point 3 then follows;

If the first trilateration point and the second trilateration point are not both within a fault tolerance range (FB) and p₍ᵤ₊₁₎≥k₍ᵤ₊₁₎ and p₍ᵤ₋₁₎≥k₍ᵤ₋₁₎ and pᵤ≥kᵤ apply, ending the measurement cycle is the eleventh step.

As the fourteenth step, influencing the vehicle as a function of the solutions in the set of the solutions of this u-th channel of this measurement cycle then follows.

This basic embodiment already enables a good identification of solutions. As described above, however, an entire assortment of improvements is still possible, which this document lists below.

A first further embodiment of the method comprises, as additional steps, clustering solutions in the set of the solutions of this u-th channel of one or more measurement cycles to form accepted u-th solutions and discarding unaccepted solutions of this u-th channel of these measurement cycles.

Experience has shown that this clustering enables suppression of only isolated interference solutions.

A first further embodiment of the method relates to the application to two adjacent channels of the ultrasonic sensor system USSS. According to the proposal, the method carries out a sub-method, for example for a u-th channel, said sub-method corresponding to the method described above. According to the proposal, in so doing, the method performs a further sub-method, for example for a (u+1)-th channel, said sub-method corresponding to the method described above. Of course, u<n−1 must now apply. The method thereby ascertains (u+1)-th solutions for the (u+1)-th channel. In so doing, the method furthermore ascertains u-th solutions for the u-th channel. As a subsequent step, the method then carries out the clustering described above. Now, this happens in a slightly modified manner. The clustering now has the form of clustering solutions in the union of the set of the solutions of this u-th channel and the set of the solutions of this (u+1)-th channel of one or more measurement cycles. The result of the clustering is again accepted u-th solutions. This first further embodiment of the method typically comprises discarding unaccepted u-th solutions of this u-th channel of these measurement cycles and unaccepted (u+1)-th solutions of this (u+1)-th channel of these measurement cycles. Using adjacent channels increases the robustness of the recognition and its completeness. As a result, the method also discovers objects that are obscured by other objects.

During the measurements, interferences occur. Measured values that are nonsensical or cannot be verified as real solutions with the required high probability occur for various reasons. Below, this document describes, by way of example, possible plausibility checks, each of which contributes to improving the recognition result. First, it is useful and recommended to perform such plausibility checks for the u-th and (u+1)-th channels.

A second further embodiment of the method therefore comprises the additional step of checking the plausibility of each of the u-th solutions. The method thereby forms plausibility-checked u-th solutions from the u-th solutions. The plausibility check forms these plausibility-checked u-th solutions by filtering u-th solutions and by discarding u-th solutions.

A third further embodiment of the method therefore also comprises the additional step of checking the plausibility of each of the (u+1)-th solutions. The method thereby forms plausibility-checked (u+1)-th solutions from the (u+1)-th solutions. The plausibility check forms these plausibility-checked (u+1)-th solutions by filtering u-th solutions and by discarding (u+1)-th solutions.

During the measurements, interferences occur. These may also be designed such that the plausibility checks do not recognize the resulting interference solutions as nonsensical. The proposed method must therefore sense and eliminate such potentially meaningful interference solutions differently. This preferably takes place by means of an estimation filter. Such an estimation filter is preferably a Kalman filter that carries out a Kalman filtering method. The proposers use a Kalman filtering method for the development of the technical teaching of this document. By way of example of the numerous literature, the document presented here refers to Hisashi Tanizaki, “Nonlinear Filters: Estimation and Applications”, Springer 2nd ed. 1996 edition (28 Dec. 2009), ISBN-13: 978-3642082535

A fourth further embodiment of the method therefore relates to the Kalman filtering or estimation filtering of a u-th solution and/or a plausibility-checked u-th solution of the u-th channel to form filtered u-th solutions or, in general, that of a u-th solution and/or a plausibility-checked u-th solution of the u-th channel by means of an estimation filtering method to form filtered u-th solutions.

A fifth further embodiment of the method relates to the Kalman filtering or estimation filtering of a (u+1)-th solution and/or a plausibility-checked (u+1)-th solution of the (u+1)-th channel or, in general, the filtering of a (u+1)-th solution and/or a plausibility-checked (u+1)-th solution of the (u+1)-th channel by means of an estimation filtering method to form filtered (u+1)-th solutions.

A sixth further embodiment of the method relates to the clustering. The clustering in this case now such that the method clusters filtered u-th solutions in the set of filtered u-th solutions of this u-th channel of one or more measurement cycles to form accepted u-th solutions. Moreover, the method discards unaccepted filtered u-th solutions of this u-th channel of these measurement cycles.

This clustering enables the recognition of individual, isolated solutions, whose accuracy is therefore less likely. A quantisation of this “isolation” is possible and enables the comprehensible identification of such island solutions, which, according to experience, are more likely to be pseudo solutions. Clustering by means of neural networks is expressly part of a possible implementation of such clustering methods. The method then comprises carrying out a neural network model. The list of the found filtered solutions and/or of the plausibility-checked solutions and/or of the solutions of the trilateration method serves as an input vector for the neural network model. The input vector may also comprise lists of the found filtered solutions and/or of the plausibility-checked solutions and/or of the solutions of the trilateration method from preceding measurement cycles. Where applicable, for carrying out the neural network model, the method may perform a feature extraction prior to the start. Usually, the feature extraction from the input vector then generates a so-called feature vector. In order to increase significance, if a neural network model carries out the proposed method, the proposed method typically performs a transformation by means of a vector polynomial to an intermediate vector, which then serves as the actual input vector for the neural network model that carries out the method. Typically, the vector polynomial is a linear transformation. In particular, this linear transformation typically only comprises multiplying the feature vector with a so-called LDA matrix to form the intermediate vector. In modern so-called machine learning methods, this pre-processing by means of feature extraction, feature vector, increase in significance, intermediate vector is no longer absolutely necessary. As a result of the constantly increasing computing power, the ultrasonic sensor system USSS can emulate increasingly complex neural network models. As a result, in the foreseeable future, the construction of the ultrasonic sensor system USSS may even dispense with the feature extraction and the increase in significance and use the input vector directly in the execution of the neural network model for clustering the various solutions.

A seventh further embodiment of the method relates to clustering. The method clusters filtered u-th solutions in the union of the set of filtered u-th solutions of this u-th channel and the set of filtered (u+1)-th solutions of this (u+1)-th channel of one or more measurement cycles to form accepted u-th solutions. In so doing, the method discards unaccepted filtered u-th solutions of this u-th channel and unaccepted filtered (u+1)-th solutions of this (u+1)-th channel of these measurement cycles. The above statements on neural networks apply correspondingly herein.

An eighth further embodiment of the method relates to the creation of replacement values for the discarded solutions. For this purpose, the method replaces discarded u-th solutions with the respective, most recently accepted u-th solutions. The method then uses these most recently accepted u-th solutions as plausibility-checked u-th solutions. Typically, the plausibility check discards the discarded solutions. Typically, the plausibility check replaces the discarded solutions with these replacement values. D

A ninth further embodiment of the method relates to the creation of replacement values for the discarded solutions. For this purpose, the method replaces discarded (u+1)-th solutions with the respective, most recently accepted (u+1)-th solutions. The method then uses these most recently accepted u-th solutions as plausibility-checked (u+1)-th solutions. Typically, the plausibility check discards the discarded solutions. Typically, the plausibility check replaces the discarded solutions with these replacement values.

The deletion of solutions has the disadvantage that it can result in jumps in the signal flow, which result in lasting disruptions of the subsequent method steps and thus in further artefacts that degrade the recognition result. Experiments have shown that the solution presented here prevents this.

A tenth further embodiment of the method relates to the plausibility check of the sensed times of flight of the reflected ultrasonic burst from the emission by the u-th and (u+1)-th ultrasonic sensor to the reception by the ultrasonic sensors of the u-th or (u+1)-th channel. In this embodiment, the plausibility check therefore discards those of the u-th solutions or (u+1)-th solutions that correspond to a time of flight of the ultrasonic burst from its emission to the reception by at least one of the ultrasonic sensors that is greater than a maximum allowed time of flight Δeₘₐₓ, in particular greater than a time of flight of Δeₘₐₓ>1.4 ms. Simply put, the plausibility check discards those of the u-th solutions or (u+1)-th solutions that correspond to a time of flight of the ultrasonic burst from its emission to the reception by at least one of the ultrasonic sensors that is greater than the maximum allowed time of flight Δeₘₐₓ, in particular greater than a time of flight of Δeₘₐₓ>1.4 ms. For example, this eliminates interference by other ultrasound sources or overshoots. The reception area is thereby modified to form a safer reception area. Experiments have shown that such a limitation improves the quality of the created map of the surroundings.

An eleventh further embodiment of the method relates to the plausibility check, which discards those of the (u+1)-th solutions or u-th solutions that cannot be attributed to at least three ultrasonic echoes of three different ultrasonic sensors. This means that the (u+1)-th solutions or the u-th solutions must be attributable at least to exactly one ultrasonic echo of an associated ultrasonic sensor and exactly one further ultrasonic echo of an associated further ultrasonic sensor and exactly one additional ultrasonic echo of an associated additional ultrasonic sensor. This document lists the advantages of the plausibility check above. They also apply here.

A twelfth further embodiment of the method relates to a plausibility check that deactivates the Kalman filtering method or the estimation filtering method if the signal of the value of the arrival time of the relevant ultrasonic echo, i.e., a u-th solution or a (u+1)-th solution, changes in two consecutive iterations by more than Δe_{fiter_max} or by Δe_{filter_max}, with Δe_{filter_max} preferably Δe_{filter_max}≥500 μs. In this context, “deactivate” means that the method uses all or several or individual ones of the plausibility-checked u-th solutions as filtered u-th solutions and/or directly uses all or several or individual ones of the plausibility-checked (u+1)-th solutions as filtered (u+1)-th solutions for the time of deactivation. This plausibility check therefore exploits the fact that changes in the surroundings of a vehicle typically do not occur arbitrarily quickly. The ultrasonic sensor system USSS therefore does not accept changes that are too fast.

A thirteenth further embodiment of the method relates to an embodiment in which the method cancels the deactivation of the Kalman filtering method or the estimation filtering method after a predetermined number of measurement cycles. This is in particular advantageous if the interference is only intermittent in nature. If the interference persists, the method and thus the ultrasonic sensor system USSS, the Kalman filtering method or the estimation filtering method will detect again. This has the advantage that the ultrasonic sensor system can always switch to the optimal configuration. Even if the Kalman filter is deactivated, the ultrasonic sensor system repeatedly checks whether the default configuration is once again better than the configuration with deactivation of the Kalman filtering method and thus of the Kalman filter or with deactivation of the estimation filtering method and thus of the estimation filter.

In a fourteenth further embodiment of the method, the plausibility check discards such u-th solutions or (u+1)-th solutions for which the line from the location of the possibly filtered u-th solution or (u+1)-th solutions to the location of the u-th ultrasonic sensor or (u+1)-th ultrasonic sensor has an angle α to this viewing axis SA of the u-th ultrasonic sensor or (u+1)-th ultrasonic sensor whose magnitude is greater than the magnitude of a maximum angle αₗᵢₘ. In this case, the method exploits that the ultrasonic sensors cannot receive ultrasonic echoes from certain angles. Only faulty operations can therefore result in such signals, for example through interferences. The plausibility check proposed herein filters out these obviously false solutions.

In a fifteenth further embodiment of the method, an ultrasonic sensor extracts a respective ultrasonic sensor-specific envelope signal (HK) from the signal of the reflected ultrasonic wave (USW) that this ultrasonic sensor receives. The ultrasonic sensor then extracts a series of ultrasonic sensor-specific ultrasonic echoes (ec1, ec2, ec3, ec4, ec5, ec6) using an ultrasonic sensor-specific threshold value curve (SWK) of this ultrasonic sensor from the ultrasonic sensor-specific envelope curve (HK) of this ultrasonic sensor. The particular proposal of this embodiment of the method is now that the ultrasonic sensor-specific threshold value curve (SWK) of this ultrasonic sensor depends on the clustered and accepted solutions of the ultrasonic sensor system that the method has previously ascertained. This has the advantage that the method of the ultrasonic sensor system can permanently optimize and adjust the compromise between sensitivity and fraudulent echoes that the relevant ultrasonic sensor extracts.

In a sixteenth further embodiment of the method, the method clusters, by means of a clustering method, the u-th solutions and the (u+1)-th solutions or the filtered u-th solutions and the filtered (u+1)-th solutions to form accepted solutions, if the distances between at least one of the solutions of the cluster and at least e other solutions of the cluster are less than a threshold value distance s. Here, e is a positive whole number greater than 0, or better greater than 1 or better greater than 2, and wherein e=3 is particularly preferred.

In other words, in this sixteenth further embodiment of the method, the method clusters, by means of a clustering method, the u-th solutions and the (u+1)-th solutions or the filtered u-th solutions and the filtered (u+1)-th solutions to form accepted solutions, if the number of the u-th solutions and the (u+1)-th solutions of a cluster is at least three. In this sixteenth further embodiment of the method, the method discards unaccepted, possibly filtered u-th solutions and/or unaccepted, possibly filtered (u+1)-th solutions.

Experimental experiences show that the method of the ultrasonic sensor system is highly likely to then advantageously achieve good results.

In an eighteenth further embodiment of the method, the method then clusters, by means of a clustering method, u-th solutions and (u+1)-th solutions or filtered u-th solutions and filtered (u+1)-th solutions to an already existing cluster as accepted solutions if the number of the u-th solutions and the (u+1)-th solutions of the cluster that are in the neighbourhood of such a possibly filtered u-th solution or possibly filtered (u+1)-th solution is at least one. In this eighteenth further embodiment of the method, the method discards unaccepted, possibly filtered u-th solutions or unaccepted, possibly filtered (u+1)-th solutions.

In a nineteenth further embodiment of the method, the method comprises the additional step of emitting an ultrasonic noise signal having an at least partially random modulation at least in one parameter.

In a twentieth further embodiment of the method, the method first determines a solution on the basis of two ultrasonic echoes of two different ultrasonic sensors. The method accepts the solution if it is a solution from the fallback area. The method does not accept the solution on the basis of only two ultrasonic echoes of two different ultrasonic sensors if it is a solution from the three-sensor area. For a solution to be accepted on the basis of only two ultrasonic echoes, two ultrasonic echoes in the three-sensor area (see FIG. 22) are, after all, expressly not sufficient. In this case, the method that the ultrasonic sensor system (USSS) caries out then ascertains a solution on the basis of three ultrasonic echoes of three different ultrasonic sensors. In this way, the method then obtains a solution on the basis of three ultrasonic echoes of three different ultrasonic sensors for the three-sensor area.

By this, the proposed method ensures that the confidence value of a solution is appropriate depending on the location of the detected solution.

In a twenty-first further embodiment of the method, the clustering depends on a threshold value distance E. In this twentieth embodiment of the method, the threshold value distance E depends on the change in accepted solutions of the clustering between at least two measurement cycles. This has the advantage that in the event that the vehicle is moving or that an object in the measurement range exhibits highly diverging velocities, the threshold value distance E is optimal. This enables, for example, the sensible treatment of ultrasonic echoes of complex moving objects. Such an object may, for example, be the leaves and branches of a plant, for example a bush, moved by the wind.

In a twenty-second further embodiment of the method, the method ascertains the temporal changes of the reception of an ultrasonic echo of an ultrasonic sensor from the reception data of this ultrasonic echo of this ultrasonic sensor of the last v measurement cycles. Here, v is a positive whole number greater than 1. The method then determines therefrom, by means of a polynomial approximation, the time point of the next reception of this ultrasonic echo by this ultrasonic sensor.

In a twenty-third further embodiment of the method, the method modifies the threshold value curve SWK of this ultrasonic sensor of the twentieth embodiment of the method as a function of the result of this prediction.

This has the advantage that the method in this way optimizes the compromise between sensitivity and the occurrence of fraudulent echoes for this ultrasonic sensor. The method that the ultrasonic sensor system USSS carries out thus continuously adapts to changing conditions.

In a twenty-fourth further embodiment of the method, the method ascertains the temporal changes of the accepted solutions from data of the accepted solutions of the last v measurement cycles. Again, v is a positive whole number greater than 1. The method then determines therefrom, in particular by means of a polynomial approximation, for one or more ultrasonic sensors, the respective time point of the expected next reception of the ultrasonic echoes belonging to the relevant solution, for these ultrasonic sensors. The method then modifies the threshold value curve SWK of one or more of these ultrasonic sensors as a function of the result of this prediction, in particular for a time range around the respective time point of the respectively expected next reception of the respective ultrasonic echoes belonging to the relevant solution, for these respective ultrasonic sensors.

This likewise has the advantage that the method in this way optimizes the compromise between sensitivity and the occurrence of fraudulent echoes for this ultrasonic sensor. The method that the ultrasonic sensor system USSS carries out thus continuously adapts to changing conditions.

In a twenty-fifth further embodiment of the method, the method applies a sub-method that identifies ultrasonic echoes of fraudulent objects in the distance values of the ultrasonic echoes of the ultrasonic sensors and removes them from the measurement data.

In a twenty-sixth further embodiment of the method, the input values of the Kalman filtering method or of the estimation filtering method are the recognized object positions in the form of the solutions of the trilateration method and/or the rate of change of the recognized object positions in the form of the solutions of the trilateration method on the one hand and the speed of the vehicle on the other hand.

In a twenty-sixth further embodiment of the method, the method sets distance values corresponding to measured values of a time of flight greater than a maximum allowed time of flight Δeₘₐₓ to zero or a very small number of equal effect. This typically results in clusters at the locations where the ultrasonic sensors are located. These are preferably removed by the proposed method of the ultrasonic sensor system USSS during the plausibility check.

### Advantage

The ultrasonic sensor system described herein enables the more robust recognition of objects in the surroundings of vehicles and the generation of a map of the surroundings of the vehicle.

### LIST OF FIGURES

FIG. 1

shows the ultrasound behaviour known from the prior art on various surfaces, here an exemplary first surface OF1 and an exemplary second surface OF2.

An incident ultrasonic wave USW strikes a first surface OF1. The first surface OF1 is not ideal. The first surface OF1 diffuses the incident ultrasonic wave USW into a diffuse ultrasonic wave DUSW by means of a diffusion process diff.

The technical teaching of FIG. 1 originates from the state of the art and is not claimed herein.

FIG. 2

illustrates the sound transducer characteristic of an exemplary ultrasonic sensor that the proposers of the document presented herein used for a laboratory prototype of the proposed parking system in the course of the development of the technical teaching of this document.

FIG. 3

shows the components and the interconnection of these components for enabling communication between these various components, which the laboratory parking system comprises, as the proposers of the document presented herein used for a laboratory prototype of the proposed parking system in the course of the development of the technical teaching of this document.

FIG. 4

illustrates the structure of the board communication as the proposers of the document presented herein used for a laboratory prototype of the proposed parking system in the course of the development of the technical teaching of this document.

FIG. 5

shows an example of a basic device command as the proposers of the document presented herein used for a laboratory prototype of the proposed parking system in the course of the development of the technical teaching of this document.

FIG. 6

visualizes an exemplary operation of sending and receiving commands as the proposers of the document presented herein used for a laboratory prototype of the proposed parking system in the course of the development of the technical teaching of this document.

FIG. 7

shows the measurement principle of the distance measurement of an exemplary ultrasonic sensor application of the parking assistance system that was used by the proposers of the document presented herein for a laboratory prototype in the course of the development of the technical teaching of this document and is proposed herein.

FIG. 8

shows the exemplary time diagram of the signals and of the state of the exemplary driver of an ultrasonic transducer.

FIG. 9

shows an example of an envelope signal with three recognized echoes.

FIG. 10

shows the principle of ultrasonic echo recognition with the exemplary SendA profile in comparison to the exemplary ReceiveA command.

FIG. 11

illustrates the effects of shifting the threshold value curve.

FIG. 12

shows a rough outline of the exemplary test set-up as the proposers of the document presented herein used for a laboratory prototype of the proposed parking system in the course of the development of the technical teaching of this document.

FIG. 13

illustrates a situation in which the ultrasonic sensor 2 of, by way of example, four ultrasonic sensors in the exemplary rear bumper bar of an exemplary vehicle sends a burst signal, while the, by way of example, other three ultrasonic sensors 1, 2, and 3 operate as ultrasonic receivers.

FIG. 14

illustrates the simplest way of finding a 2D point by interpreting, by means of trilateration, the first ultrasonic echo recognized by two ultrasonic sensors.

FIG. 15

shows a possible scenario for the trilateration of two ultrasonic sensors for calculating the position of an object, wherein a plurality of objects in the example of FIG. 15 are however located in the area of the two ultrasonic sensors, which can result in misinterpretations of the ultrasonic echoes and thus in false solutions.

FIG. 16

illustrates the idea of the proposed trilateration method.

FIG. 17

illustrates the flow of the proposed trilateration method.

FIG. 18

shows an example of how, using the method described above by way of example, the ultrasonic sensor system can recognize a maximum of three obstacles in each channel in that the ultrasonic sensor system applies the proposed trilateration method to the first, second and third ultrasonic echoes, wherein FIG. 18 shows, by way of example, exemplary solutions of the method in the measurement of six different, exemplary posts on a paved surface.

FIG. 19

illustrates that the recognition of a wide surface, such as a wall, requires, for example, more iterations than the recognition of a small post.

FIG. 20

visualizes the three exemplary distance values sensed using, by way of example, three ultrasonic sensors, via associated ultrasonic echoes of a wall measurement.

FIG. 21

shows exemplary ranges of, by way of example, four exemplary ultrasonic sensors.

FIG. 22

shows various exemplary operating ranges for the, by way of example, four exemplary ultrasonic sensors of FIG. 21.

FIG. 23

illustrates why the use of a fallback method to one ultrasonic sensor is necessary if the method notices an obstacle in the outer area and if only the transmitting ultrasonic sensor receives an echo back, wherein the method first checks whether the ultrasonic echo does not belong to another object, in that the method compares the ultrasonic echo to the distances, calculated by other channels, to objects.

FIG. 24

illustrates the prevention of false solutions without limiting the solution range for the outer channels, here, by way of example, the channels 0 and 3, wherein the ultrasonic sensor system checks solutions based on measured values of these channels for an angle to the viewing axis of the associated ultrasonic sensor of the relevant channel.

FIG. 25

visualizes how, according to the prior art, the Kalman filter and predicts the next state through the influence of the two parameters, the covariance R of the measurement noise and the variance value Q of the process noise.

FIG. 26

compares two different exemplary filter parameters of the Kalman filter.

FIG. 27

shows that the Kalman filter with the smaller Q cannot follow the dynamic portion of the measurement.

FIG. 28

compares the output of the Kalman filter with and without speed information.

FIG. 29

shows the distribution of the first ultrasonic echo from ultrasonic sensor 0 in channel 0 during an exemplary wall measurement.

FIG. 30

illustrates that the configuration of the parameters for the Kalman filter depends on the ultrasonic echo signal because the standard deviation of the ultrasonic echoes differs in the case of different surfaces and different environments, wherein the illustration takes place using the example of a simulation of a parking situation, which results in significant differences in the standard deviation, for example.

FIG. 31

compares two different parameters for R by a dynamic measurement using the example of a plant as a recognized obstacle.

FIG. 32

shows an exemplary ultrasonic echo signal of an exemplary static measurement in which the Kalman filter is extended by a manual query in order to improve the noise behaviour.

FIG. 33

shows, by way of example, an unstable echo during a dynamic measurement of the plant obstacle of FIG. 31.

FIG. 34

illustrates a scenario in which the ultrasonic sensors measure four post obstacles and a pedestrian passes between the posts and the sensors while the vehicle does not move, wherein FIG. 34a shows the 40th cycle of the measurement and the first ultrasonic echo of ultrasonic sensor 1 in channel 1, and FIG. 34b illustrates the measurement situation.

FIG. 35

shows the ultrasonic echo of the ultrasonic sensor 1 in channel 1 during the measurement of a post moving on a rail by means of a controllable carriage.

FIG. 36

shows the improvement of the noise behaviour as a result of a speed query.

FIG. 37

compares the solutions without and with Kalman filtering.

FIG. 38

shows the difference between “core values” and “non-core values” of the DBSCAN method.

FIG. 39

shows an exemplary output of the DBSCAN method based on generated data, in order to illustrate the provision of different clusters as a function of the selected parameters.

FIG. 40

shows the flow chart of the new, proposed clustering method.

FIG. 41

shows an exemplary output of the clustering method, wherein the visualized solutions belong to a static vehicle measurement (FIG. 30) and a fifth noise sensor interferes with the measurement.

FIG. 42

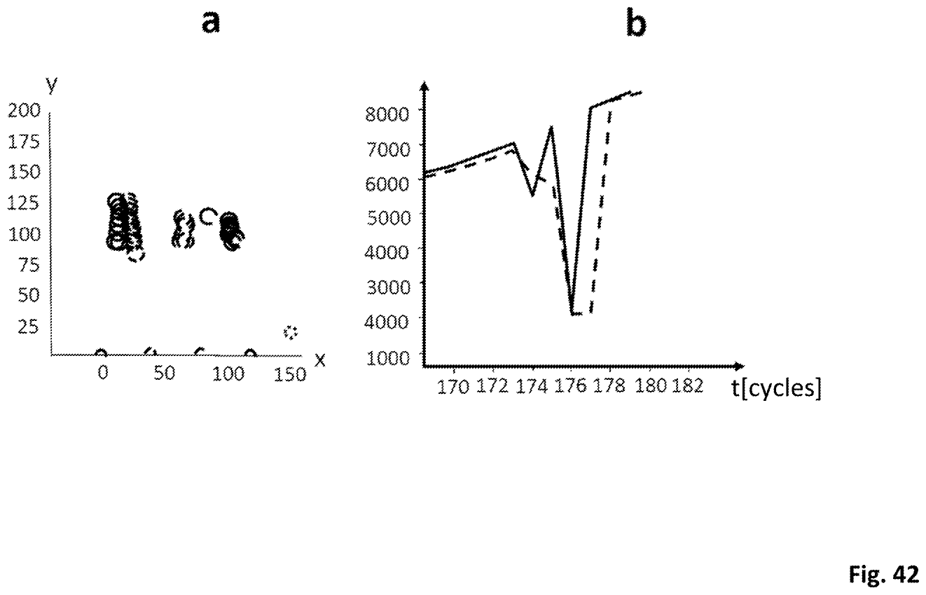

illustrates the reduction in the spread of the 2D positions as a result of the Kalman filter, which may still provide false 2D positions, and that the manual parts enable the filtering of noise values and the rapid following of the measurement, wherein FIG. 42 visualizes an exemplary dynamic wall measurement in which the method applies a Kalman filtering and subsequently a clustering to the ultrasonic echoes. The left visualisation (FIG. 42a) shows solutions during the exemplary measurement, wherein an exemplary false solution is produced by the application of the Kalman filter and the clustering method filters out this solution.

### DESCRIPTION OF THE FIGURES

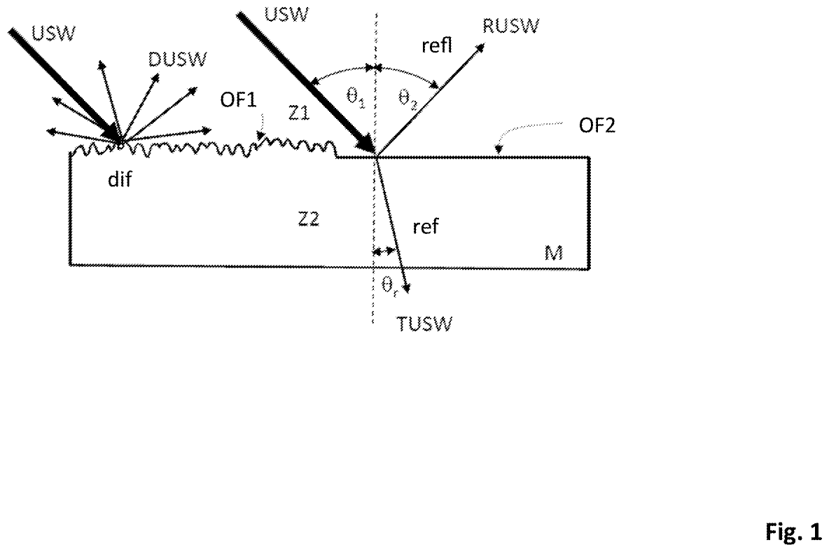

FIG. 1

FIG. 1 shows the ultrasound behaviour known from the prior art on various surfaces, an exemplary first surface OF1 and an exemplary second surface OF2.

A surface in the sense of this document is the extensive transition from a less dense medium, generally air in the sense of this document, with a first acoustic wave resistance Z1 to a second medium with a second acoustic wave resistance Z2 that deviates from the first wave resistance Z1 and is greater in magnitude.

In the first example of FIG. 1, an incident ultrasonic wave USW strikes the first surface OF1. The first surface OF1 has a roughness that is significant compared to the wavelength of the ultrasonic wave USW. The rough first surface OF1 therefore diffuses the ultrasonic wave USW into a diffuse ultrasonic wave DUSW by means of a diffusion process diff.

In the second example of FIG. 1, an incident ultrasonic wave USW strikes the smooth second surface OF2. The first surface OF2 has a roughness that is negligible compared to the wavelength of the ultrasonic wave USW. The rough first surface OF1 therefore reflects the ultrasonic wave USW into a reflected ultrasonic wave RUSW by means of a reflection process refl. The proportion of the ultrasonic wave USW that the second surface OF2 reflects as a reflected ultrasonic wave RUSW depends on the ratio of the first acoustic wave resistance Z1 to the second acoustic wave resistance Z2. The material M transmits the proportion of the ultrasonic wave USW that the second surface OF2 does not reflect as a reflected ultrasonic wave RUSW by means of a reflection process refl and that is not absorbed in the material M below the second surface OF2, by means of a refraction process ref as a transmitted ultrasonic wave TUSW. The angle of incidence θ₁ is in this case equal to the angle of emergence θ₂. The angle of emergence θᵣ depends on the angle of incidence θ₁ and the first acoustic wave resistance Z1 and the second acoustic wave resistance Z2.

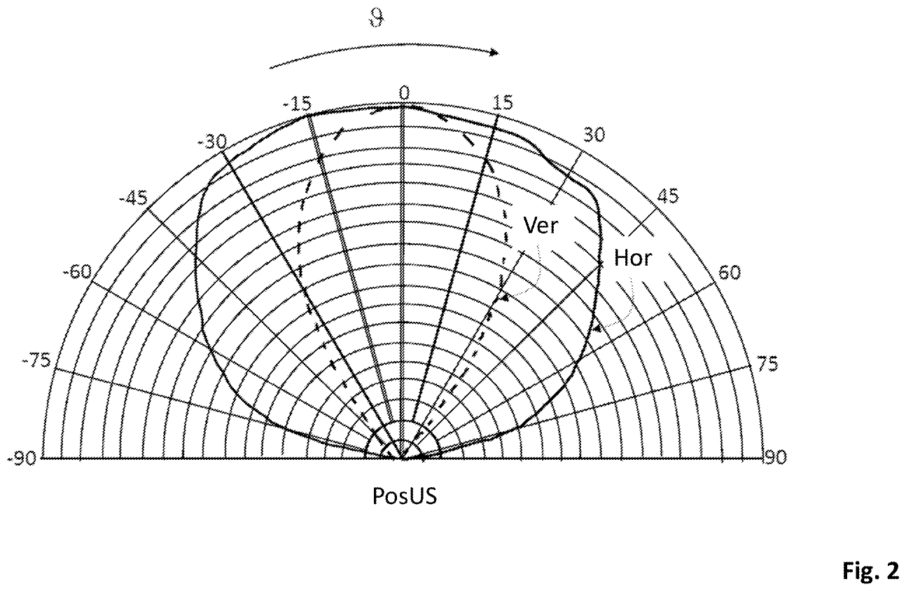

FIG. 2

illustrates the sound transducer characteristic of an exemplary ultrasonic sensor that the proposers of the document presented herein used for a laboratory prototype of the proposed parking system in the course of the development of the technical teaching of this document. In FIG. 2, the position of the ultrasonic sensor is at the position PosUS. FIG. 2 shows, by way of example, the horizontal propagation Hor of the ultrasonic wave of the ultrasonic sensor and vertical propagation Ver of the ultrasonic wave of the ultrasonic sensor from an exemplary ultrasonic transducer of the ultrasonic sensor. In the example of FIG. 2, the ultrasonic transducer of the ultrasonic sensor operated at approximately 58 kHz and provided an exemplary maximum sound pressure level (SPL) of approximately 95.24 dB. FIG. 2 also shows the attenuation of the maximum sound pressure level (SPL) relative to P₀, the reference sound pressure (SPL) of 95.24 dB at a 0° angle. The damping increases with increasing angle l. The angle l is the angle of the radiating direction to the axis of the radiation lobe of the ultrasonic transducer of the ultrasonic sensor. The dashed line in FIG. 2 shows the damping of the vertical propagation Ver of the ultrasonic wave USW. The dashed line in FIG. 2 shows the damping of the horizontal propagation Hor of the ultrasonic wave USW. The horizontal propagation Hor of the ultrasonic wave USW is stronger than the vertical propagation Ver of the ultrasonic wave USW. The vertical wave reaches the 6 dB limit in an angular range of the angle l of between 15 and 20 degrees. This means that the sound pressure level of the vertical propagation Ver of the ultrasonic wave USW at this angle l is already 50% less than the maximum of the sound pressure level (SPL) at an angle l of 0°. In comparison, the horizontal propagation Hor of the ultrasonic wave USW first intersects the 6 dB limit at an angular range of the angle l of between 40 and 45 degrees. The exemplary sound transducer of the ultrasonic sensor with the ultrasonic radiation characteristic of FIG. 2 has been developed for parking area applications. The vertical propagation Ver of the ultrasonic wave USW is less spread than the horizontal propagation Hor of the ultrasonic wave USW in order to avoid ground reflections. Such ultrasonic transducers are particularly preferred for proposed ultrasonic sensor systems. The construction of the ultrasonic transducer spreads the horizontal sound field more strongly than the vertical sound field since the ultrasonic sensor, which is to comprise the ultrasonic transducer, is to recognize obstacles in a 2D plane parallel to the surface of a planar vehicle environment. A maximum angle for obstacle recognition is thus an essential parameter of the proposed ultrasonic sensor system. The damping value at 60 degrees could therefore be characterising. At a 60 degree angle, the sound pressure level is about one fifth of the sound pressure P₀ at an angle l of 0°. Thereafter, the sound pressure level converges to zero /8/.

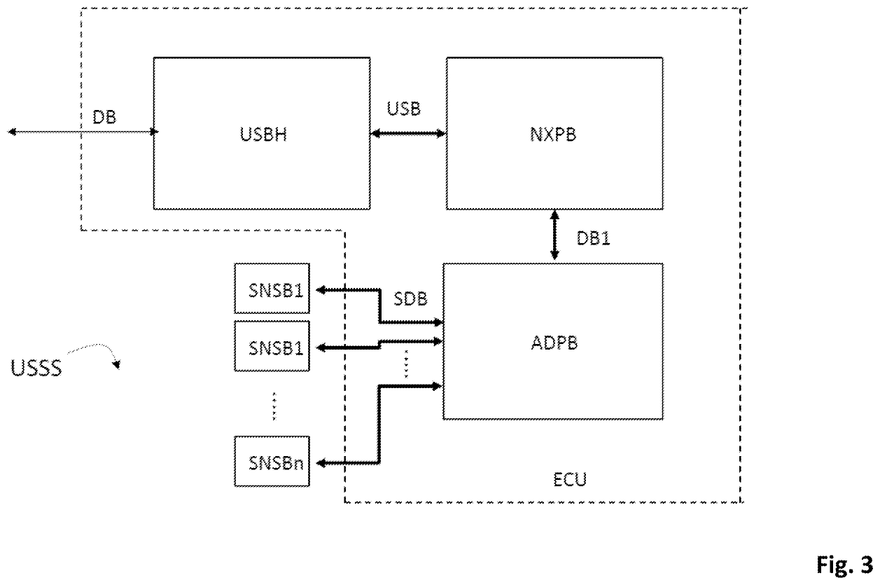

FIG. 3

FIG. 3 shows the components and the exemplary interconnection of these components for enabling communication between various components, which the exemplary laboratory parking system used for the development of the technical teaching of this document comprises, as the proposers of the document presented herein used for a laboratory prototype of the proposed parking system in the course of the development of the technical teaching of this document.

A laptop computer serves as a control computer and USB host USBH in the laboratory set-up. The control computer, in its role as a USB host USBH, is connected to an NXP board NXPB via an exemplary USB data bus USB. The NXP board NXPB comprises a microcomputer from the company NXP, with which the laboratory ultrasonic system used for the development of the technical teaching of the document presented herein was operated. An adapter board ADPB is connected to the NXP board NXPB via a first data bus DB1. In the example of FIG. 3, the adapter board ADPB represents the interface between the NXP board NXPB and the sensor board SNSB. Preferably, an external 12V power-supply unit (not shown) is connected to the adapter board ADPB and supplies the adapter board ADPB and the n sensor boards (SNSB1 to SNSBn) with their respective n ultrasonic sensors. Each of the sensor boards (SNSB1 through SNSBn) is connected to the adapter board ADPB via a sensor data bus SDB. Here, n in the sense of this document is to be a positive whole number greater than 2. In the example drawn here, the sensor data bus SDB is designed in a star configuration. In the experiments for the development of the technical teaching of the document presented herein, the proposers used a plurality of sensor data buses, viz., for each sensor board (SNSB1 to SNSBn), exactly one separate sensor data bus associated with the respective sensor board of the n sensor boards (SNSB1 to SNSBn), in a point-to-point connection.

If this document mentions that the ultrasonic sensor system performs a method, it is usually the control device ECU of the ultrasonic sensor system that performs the relevant method. In the example of the laboratory prototype of FIG. 3, the control device ECU of the experimental exemplary ultrasonic sensor system USSS comprises the USB host USBH, the NXP board NXPB and the adapter board ADPB.

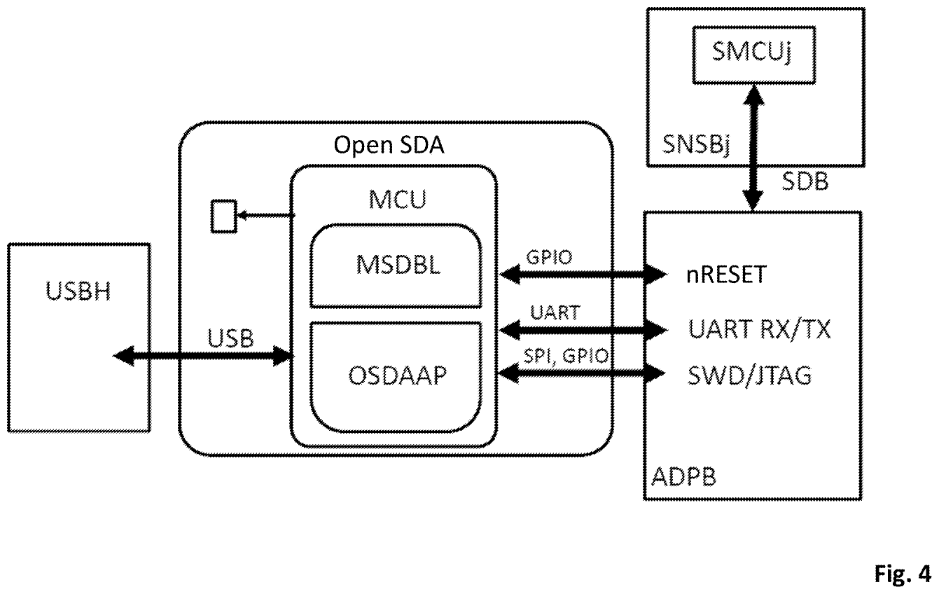

FIG. 4

shows an OpenSDA block diagram from the prior art. FIG. 4 illustrates the structure of the board communication as the proposers of the document presented herein used for a laboratory prototype of the proposed parking system in the course of the development of the technical teaching of this document. The USB host USBH communicates by means of the USB protocol via a USB data bus USB with the microcomputer MCU of the NXP board NXPB. In the development of the technical teaching of the document presented herein, the microcomputer MCU was a K20DX128Vxx5 microcomputer from the company NXP. The main component of the communication concept that the proposers used in the development of the technical teaching of the document presented herein is the NXP development board S32K144EVB, which served as NXP Board NXPB. The NXP board NXPB enabled the prototyping of automotive applications. It provides simple access to the microcomputer MCU M4F via the I/O header pins GPIO/ADC. The NXP board NXPB used was equipped with interfaces for CAN, LIN and UART/SCI. A potentiometer enables the precision of voltage and analogue measurements. The NXP board NXPB comprises an open standard serial debug adapter (OpenSDA) as a bridge between the target processor and the USB host. OpenSDA has a mass storage boot loader MSDBL. This mass storage boot loader MSDBL provides a simple interface for loading various OpenSDA applications OSDAAP /10/. The microcomputer MCU of the NXP board NXPB communicates with the aid of these components via an input/output line GPIO and serial interfaces UART, SPI via the adapter board ADPB with the respective target processor, the respective sensor processor SMCU of the respective ultrasonic sensor on the respective sensor board of the n sensor boards (SNSB1 to SNSBn). Where applicable, the microcomputer MCU of the NXP board NXPB can bring the relevant target processor, i.e., the respective sensor processor SMCUj of the respective ultrasonic sensor on the respective sensor board SNSBj of the n sensor boards (SNSB1 to SNSBn) to a predefined or settable start state by means of a reset line nRESET and restart it. The communication between the adapter board ADPB and the respective target processor, the respective sensor processor SMCU of the respective ultrasonic sensor on the respective sensor board of the n sensor boards (SNSB1 to SNSBn) takes place via the sensor data bus SDB.

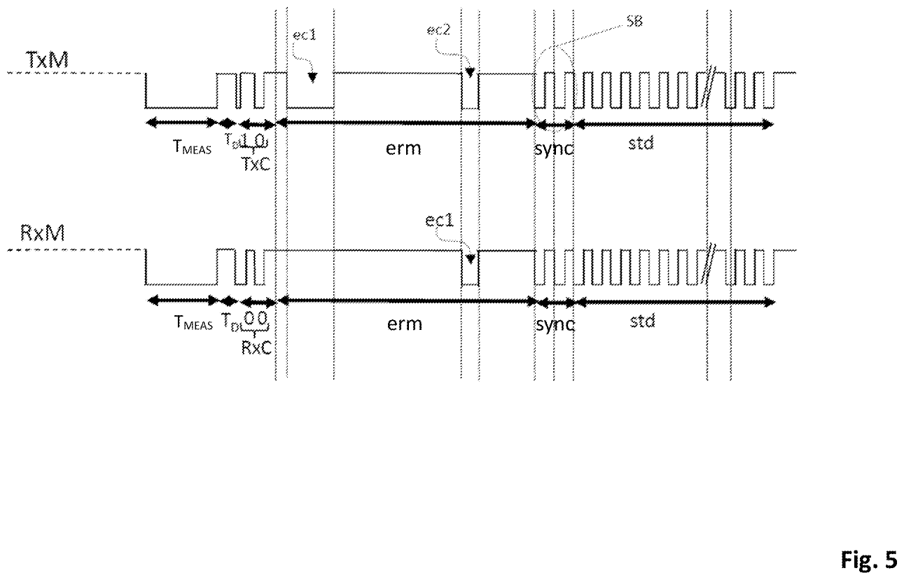

FIG. 5

FIG. 5 shows an example of a basic device command as the proposers of the document presented herein used for a laboratory prototype of the proposed parking system in the course of the development of the technical teaching of this document.

The adapter board ADPB is the interface between the NXP board NXPB and the sensor boards SNSB1 to SNSBn with the respective ultrasonic sensors on the n ultrasonic sensor boards SNSB1 to SNSBn. The sensor data bus SDB together with the adapter board ADPB enables the communication between the microcomputer MCU on the NXP board NXPB and the respective ultrasonic sensors on the respective ultrasonic sensor boards of the n ultrasonic sensor boards SNSB1 to SNSBn. Preferably, the access to the sensor processor SMCUj of an ultrasonic sensor of an ultrasonic sensor board SNSBj is possible via a hierarchical JTAG test bus. Preferably, the sensor data bus SDB is a LIN data bus or a DSI3 data bus or a PSI5 data bus. The proposers use a LIN data bus as the sensor data bus SDS in the development of the technical content of the document presented herein. For actuating the ultrasonic sensor boards SNSB1 to SNSBn, the adapter board ADPB used in the development comprised a quad LIN transceiver IC in order to connect the sensor data buses SDB of the sensor processors SMCU1 to SMCUs of the ultrasonic sensors to the microcomputer MCU of the NXP board NXPB via the adapter board ADPB. The communication between the respective sensor processor SMCUj and the microcomputer MCU of the NXP board NXPB is time-based in the laboratory parking system.

FIG. 5 shows the sensor data bus between the microcomputer of the NXP board NXPB and the sensor processor SMCU of an ultrasonic sensor on an ultrasonic sensor board SNSBj for the SendB and ReceiveB commands. The SendB command forces the relevant ultrasonic sensor to emit acoustic ultrasonic burst signals with the properties of a profile B. The ultrasonic burst generation and the various profiles have already been explained above.

The microcomputer MCU of the NXP board NXPB initializes the command by pulling down the sensor data bus SDB for the time TMEAS by means of the adapter board ADPB. After this initialisation, a high phase with a temporal length of TD follows. This is followed by the transmission of a bit sequence. The bit sequence “10” represents a transmission code TxC and initializes the send command in the example. The ultrasonic sensor receives this transmission code TxC and causes its ultrasonic transducer to emit an ultrasonic burst. The bit sequence “00” on the other hand represents a reception code RxC and initializes the receive command in the example. The ultrasonic transducer of the ultrasonic sensor that received the reception code RxC then in this example does not emit an ultrasonic burst and goes directly into the receive state. After the sensor computer SMCUj of the relevant ultrasonic sensor has received the respective sequence, the ultrasonic sensor reports the received ultrasonic echoes that this ultrasonic sensor receives, hereinafter also referred to as ultrasonic echoes of the sensor, on the sensor data bus SDB. This report of the ultrasonic echoes takes place in the time of echo signalling erm. The microcomputer MCU of the NXP board NXPB receives this report via the reception line Rx of the UART interface UART. In contrast, the transmission of the command takes place via the transmission line Tx of the UART interface UART. The quad LIN transceiver IC on the adapter board ADPB connects both lines, the reception line Rx and the transmission line Tx, to the sensor data bus SDB of the respective ultrasonic sensor. The microcomputer MCU of the NXP board NXPB uses a timer for sending commands via the transmission line Tx and a further timer for receiving the sensor data of the ultrasonic sensor via the reception line Rx. Both timers in the test set-up for the development of the technical teaching of the document presented herein ran at a frequency of 1 MHz, which results in a resolution of 1.

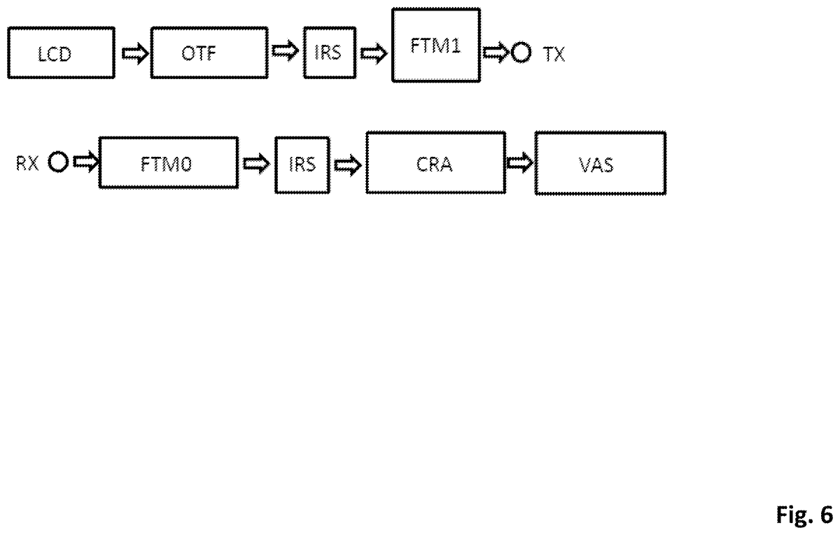

FIG. 6

FIG. 6 visualizes an exemplary operation of sending and receiving commands as the proposers of the document presented herein used for a laboratory prototype of the proposed parking system in the course of the development of the technical teaching of this document.

The flow of the exemplary transmission mode of this example is visualized in FIG. 6 as transmission mode TxM.

The first step LCD of the exemplary transmission mode is loading the channel data. The exemplary microcomputer MCU has a data storage. In this data storage, the exemplary microcomputer MCU prepares the outTimeFrame event array OTF on the basis of the send command. This event array OTF preferably contains time and value pairs in the form of corresponding data pairs. An exemplary interrupt service routine ISR, which the exemplary microcomputer MCU of the NXP board NXPB, by way of example, executes, initializes an output comparison timer FTM1. In this example, the exemplary timer module FTM1 updates the values from the prepared event array OTF in order to generate the command sequence for emitting the signals via the transmission port of the UART interface UART. In the exemplary transmission mode TxM of FIG. 6, the ultrasonic sensor reports first a first ultrasonic echo ec1 and, subsequently to this first ultrasonic echo ec1, a second ultrasonic echo ec2 via the sensor data bus SDB during the echo signalling erm. In this document, the first ultrasonic echo ec1 transmitted temporally first by an ultrasonic sensor is referred to as the first ultrasonic echo ec1 of this ultrasonic sensor, and the ultrasonic echo ec2 transmitted temporally second by an ultrasonic sensor is referred to as the second ultrasonic echo ec2 of this ultrasonic sensor, and so forth. This interface of the ultrasonic sensor communicates the arrival of the ultrasonic signal at the ultrasonic sensor in that the interface of the ultrasonic sensor pulls down the sensor data bus SDB and thus overrides the circuit that pre-loads the sensor data bus SDB to a high level.

Thereafter, in this example, the microcomputer MCU of the NXP board NXPB switches to receive mode RxM. The flow of the exemplary receive mode RxM of this example is likewise visualized in FIG. 6. This ultrasonic sensor in this example reports the recognition of a single echo, which is the first ultrasonic echo ec1 of this ultrasonic sensor in that the interface of the ultrasonic sensor pulls down the sensor data bus SDB and thus overrides the circuit that pre-loads the sensor data bus SDB to a high level. After the transmission of the ultrasonic echo reports in the time of echo signalling erm, the ultrasonic sensor in this example also puts time status information on this sensor data bus SDB subsequently to the echo signalling erm. In this example, a further timer module FTM0 captures the resulting frame (data frame) of echo and status information.

In this example, the exemplary microcomputer MCU of the NXP board NXPB stores the resulting frame (data frame) of echo and status information in the CHnCaptureResult array CRA in the data storage of the microcomputer MCU of the NXP board NXPB by means of an interrupt service routine ISR. The data are thus available to the exemplary microcomputer MCU of the NXP board NXPB in this example for processing and evaluation steps VAS as further method steps on the microcomputer MCU of the NXP board NXPB.

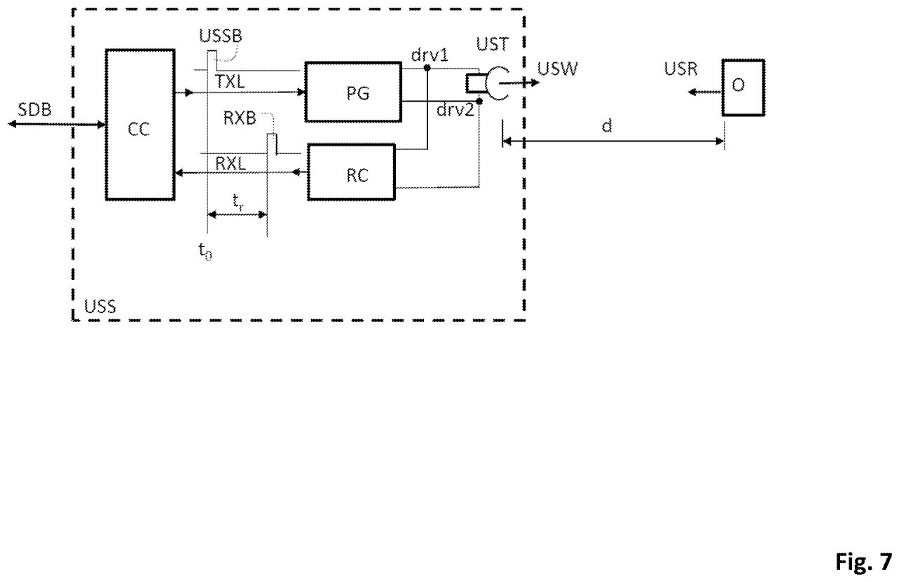

FIG. 7

FIG. 7 shows the measurement principle of the distance measurement within an exemplary ultrasonic sensor of the parking assistance system that was used by the proposers of the document presented herein for a laboratory prototype in the course of the development of the technical teaching of this document and is proposed herein. The ultrasonic sensor USS presented herein comprises, by way of example, a control circuit CC, a pulse generating apparatus PG, an ultrasonic transceiver UST, and a reception circuit RC. The control circuit CC of the ultrasonic sensor USS preferably comprises the sensor processor SMCU, which, in the example discussed here, establishes the connection to the microcomputer MCU of the NXP board NXPB via the sensor data bus SDA. Due to the reception of the transmission code TxC, the control circuit CC generates, by means of a transmission line TXL, a transmission signal with a pulse or burst USSB starting at a start time point to. The pulse generating apparatus PG drives the ultrasonic transducer UST by means of a first ultrasonic transducer connection line drv1 and a second ultrasonic transducer connection line drv2 and thus converts, using the ultrasonic transducer UST, the pulse or burst USSB on the transmission line TXL into an acoustic ultrasonic burst, which the ultrasonic transducer UST emits as an ultrasonic wave USW. The acoustic ultrasonic wave USW of this acoustic ultrasonic burst then preferably propagates in a spherical segment from the ultrasonic transducer UST to the space in front of the ultrasonic transducer UST. Objects struck by this acoustic ultrasonic wave USW reflect or deform this acoustic ultrasonic wave USW. The time point of the reflection depends on the distance of the reflecting object O to the ultrasonic transducer UST. A portion of the reflected ultrasonic wave USWR is reflected toward the ultrasonic transducer UST. The pulse generating apparatus PG stops emitting the ultrasonic burst after a short time. Preferably, the pulse generating apparatus PG dampens the typically occurring continued vibration of the typically piezoelectric vibrating element of the ultrasonic transducer UST so that the ultrasonic transducer UST can operate as ultrasonic receiver for the reception of the reflected ultrasonic wave USWR as shortly as possible after the ultrasonic burst, i.e., the ultrasonic wave USW, has been emitted. After the expiration of this dead time t_{damp} between the end of the emission of the ultrasonic burst during the ultrasonic burst transmission time tₜₓ and the sufficient decrease of the amplitude of the continued vibration of the piezoelectric vibrating element of the ultrasonic transducer UST, the ultrasonic transducer UST is able to receive an incoming reflected ultrasonic wave USWR and convert it into an ultrasonic reception signal RXL. The ultrasonic transducer UST converts the portion of the reflected ultrasonic wave USWR that strikes the ultrasonic transducer UST into a signal that the reception circuit RC taps between the first ultrasonic transducer connection line drv1 and the second ultrasonic transducer connection line drv2 at the ultrasonic transducer UST and converts into the ultrasonic reception signal RXL. The reception of the reflected ultrasonic burst of the reflected ultrasonic wave USWR can in this case be noticed as a reflected ultrasonic burst RXB in the time value curve of the ultrasonic reception signal RXL. Between the first edge of the pulse or burst USSB on the transmission line TXL and the first edge of the reflected ultrasonic burst RXB in the time value curve of the ultrasonic reception signal RXL is a delay, which is composed of the signal time of flight in the pulse generating apparatus PG and ultrasonic transducer UST in the transmission path plus the signal time of flight in the ultrasonic transducer UST and reception circuit RC in the reception path on the one hand and the signal time of flight of the ultrasonic wave USW radiated by the ultrasonic transducer UST, from the ultrasonic transducer UST to the object and from the object back to the ultrasonic transducer UST on the other hand. This signal time of flight is referred to in this document as reflection time t_{f}. As is easily understood, the spatial distance d between the ultrasonic transducer UST and the object can be concluded from the reflection time tᵣ by means of a linear transformation. The ultrasonic burst transmission time tₜₓ determines the length of the ultrasonic burst.

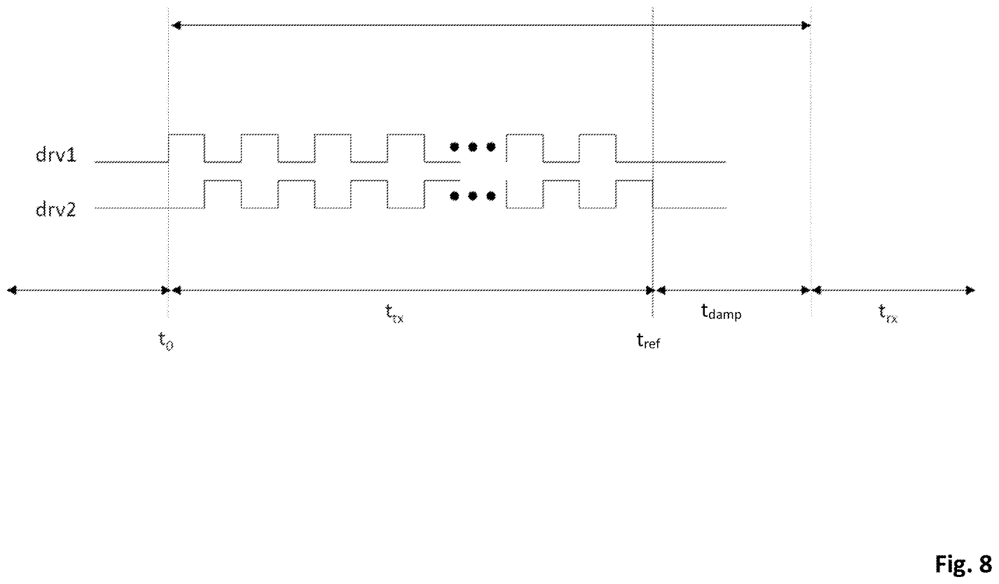

FIG. 8

shows the exemplary time diagram of the signals and of the state of the exemplary pulse generating apparatus PG, acting as a driver, of an ultrasonic transducer UST. The pulsed and push-pull actuation of the ultrasonic transducer UST via the first ultrasonic transducer connection line drv1 and the second ultrasonic transducer connection line drv2 starts with the start of the ultrasonic burst transmission time tₜₓ. After the vibrating element of the ultrasonic transducer UST has stopped vibrating in the dead time tₐₐₘₚ between the end of the emission of the ultrasonic burst in the ultrasonic burst transmission time tₜₓ and the sufficient decrease of the amplitude of the continued vibration of the piezoelectric vibrating element of the ultrasonic transducer UST, the ultrasonic transducer UST starts during the reception time tᵣₓ, to receive an incoming reflected ultrasonic wave USWR and convert it into an ultrasonic reception signal RXL. Preferably, the reception time tᵣₓ is substantially coincident with the time in which the echo signalling erm takes place.

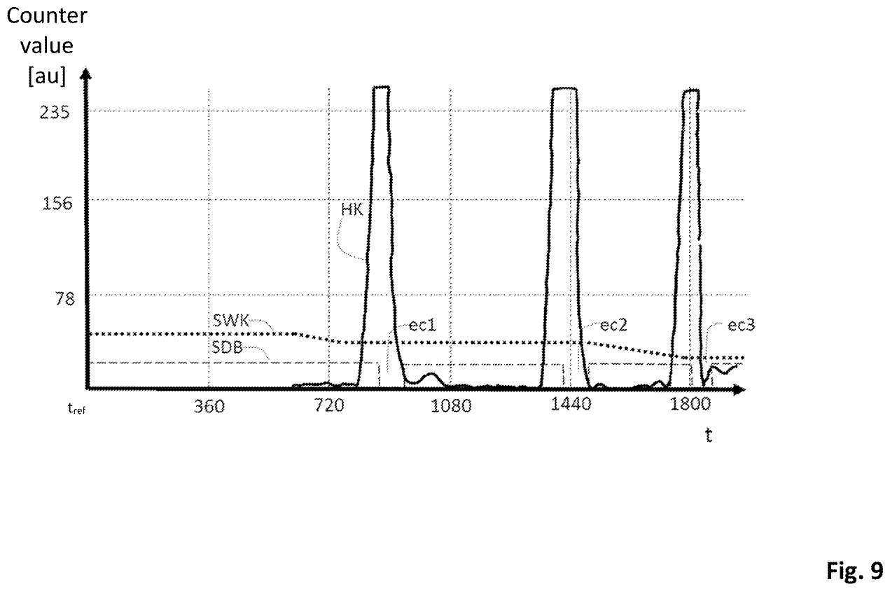

FIG. 9

shows an example of an envelope signal with three recognized echoes. The example is based on the profile for the exemplary ReceiveA command, in the case of which the ultrasonic transducer is exclusively operated as a receiver. The X axis represents the time of flight, the distance from the ultrasonic sensor to a reflecting object calculated from the time of flight in the form of the reflection time tᵣ of the ultrasonic burst echoes. The zero point of the X axis is to be the reference time point tᵣₑₜ, at which the drive of the vibrating element of the transmitting ultrasonic transducer is switched off and the decay phase, and thus the dead time t_{damp}, starts. This is also to apply to the following diagrams of the same type. In this case, the transmitting ultrasonic transducer is thus not the ultrasonic transducer whose envelope signal HK is shown here in FIG. 9. The y axis shows the amplitude of each value in arbitrary units. The dotted line represents the course of the threshold value curve SWK. The solid line represents the course of the envelope signal HK of the ultrasonic reception signal RXL. The thin-dashed curve represents the logical value on the sensor data bus SDA during echo signalling erm. (See also FIG. 5). In the example of FIG. 9, the value of the envelope signal HK exceeds the threshold value curve SWK at three locations in the time curve after the reference time point tᵣₑₜ. In the example of FIG. 9, the reception circuit RC, in cooperation with the control circuit CC, detects the time point of the maximum of the curve of the envelope signal HK and sets the sensor data bus SDA to a low level upon reaching the local time maximum of the envelope signal HK. In the example of FIG. 9, the ultrasonic sensor ascertains a first ultrasonic echo ec1, a second ultrasonic echo ec2, and a third ultrasonic echo ec3. The first ultrasonic echo ec1 is referred to in this document as the first ultrasonic echo of this ultrasonic sensor. The second ultrasonic echo ec1 is referred to in this document as the second ultrasonic echo of this ultrasonic sensor. The third ultrasonic echo ec3 is referred to in this document as the third ultrasonic echo of this ultrasonic sensor.

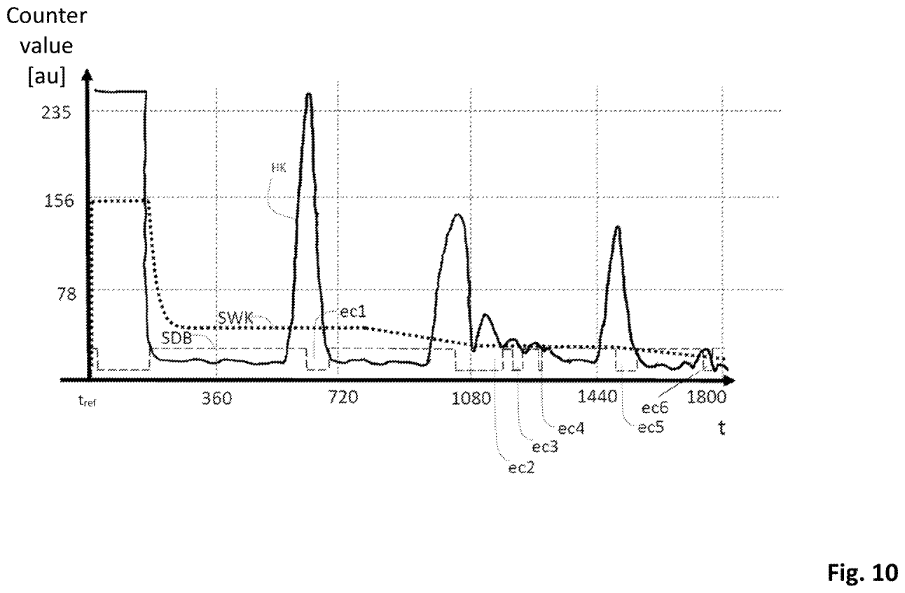

FIG. 10

FIG. 10 shows the principle of ultrasonic echo recognition with the exemplary SendA profile in comparison to FIG. 9 to the exemplary ReceiveA command. In the example of FIG. 10, the receiving ultrasonic transducer UST is also the transmitting ultrasonic transducer UST. In the initial phase immediately after the reference time t_{ref}, the ultrasonic sensor is therefore also overridden and reception is not possible. In contrast to FIG. 9, a low threshold value curve SWK results here in the reception of six ultrasonic echoes (ec1, ec2, ec3, ec4, ec5, ec6) of the ultrasonic sensor. The problem is that the test arrangement of the posts set up for test purposes comprised only three posts that were to be recognized.

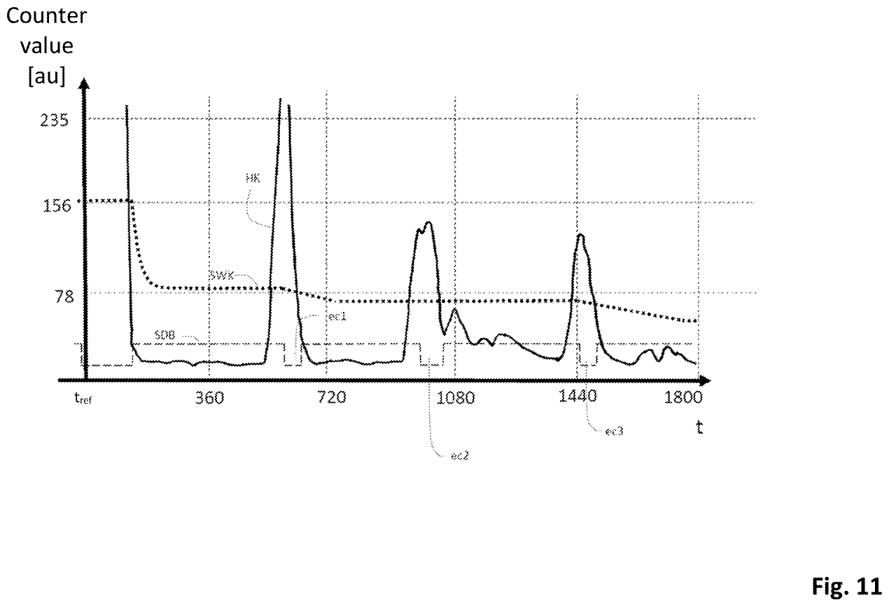

FIG. 11

illustrates the effects of shifting the threshold value curve SWK from FIG. 10 to higher values. This shifting reduces the number of recognized ultrasonic echoes in the signal of the sensor data bus SDB to three ultrasonic echoes (ec1, ec2, ec3).

The location and shape of the threshold value curve SWK depends on many factors of the respective application and should be ascertained experimentally by a DoE. Information on a DOE can be found by the implementing person skilled in the art at the time of application of this document, for example, under the link https://www.projektmagazin.de/methoden/Design-of-Experiments-DoE-Beispiel-Anwendung on the Internet.

The reduction to three essential ultrasonic echoes (ec1, ec2, ec3) simplifies the subsequent trilateration processing.

Thus far, the proposed method thus comprises the emission of an ultrasonic wave USW of an ultrasonic burst by an ultrasonic transmitter, which is generally one of a plurality of ultrasonic sensors that intermittently operates as an ultrasonic transmitter for the purpose of emitting an ultrasonic burst as an ultrasonic wave USW. Generally, for this purpose, the ultrasonic transmitter comprises an ultrasonic transducer UST. The reflection of the ultrasonic wave USW on one or more objects O follows. This reflection of the ultrasonic wave USW on one or more objects O generates one or more reflected ultrasonic waves USR. For example, the ultrasonic sensors receive the reflected ultrasonic wave USR by means of ultrasonic transducers UST. Each of the ultrasonic sensors converts the respective ultrasonic sensor-specific ultrasonic signal, respectively received by this ultrasonic sensor, of the reflected ultrasonic waves received by this respective ultrasonic sensor, into a respective ultrasonic sensor reception signal. In the case of an ultrasonic transducer UST as the receiving element of the ultrasonic sensor, the ultrasonic sensor reception signal is typically applied in the receiving phase of the ultrasonic sensor as a differential voltage signal between the first ultrasonic transducer connection line drv1 and the second ultrasonic transducer connection line drv2. Typically, the reception circuit RC removes said envelope signal HK from the ultrasonic sensor reception signal, for example by means of an envelope demodulator or envelope detector or incoherent demodulator. Preferably, the reception circuit RC thus comprises such an envelope demodulator generating the envelope signal HK from the ultrasonic sensor reception signal. Preferably, a threshold value curve generating apparatus generates a threshold value curve signal with a time value curve, starting with the emission of the ultrasonic burst but preferably at least in a fixed temporal relationship to the start or end of the emission of the ultrasonic burst. At the same time, an envelope structure recognition apparatus in the reception circuit RC monitors the structure of the envelope signal. For example, it may be defined that the sensor data bus SDB is at a logical 1 value during the echo signalling erm, if the envelope signal HK is below the threshold value curve SWK of the threshold value curve signal, and that the sensor data bus SDB changes to a logical value 0 during the echo signalling erm if the envelope structure recognition apparatus recognizes a local maximum of the envelope signal HK and the value of the envelope signal HK is at the same time above the instantaneous value of the threshold value curve SWK of the threshold value curve signal. By the edge from logical 1 to logical 0 on the sensor data bus SDB, the ultrasonic sensor signals a greater reflection at a temporal distance from the ultrasonic sensor.

This document proposes to adjust the threshold value curve SWK as a function of the previously measured ultrasonic echoes (ec1, ec2, ec3). To this end, the reception circuit RC predicts, for example based on the three last measurements of the time point of the arrival of the first ultrasonic echo ec1, a probable time window for the arrival of the first ultrasonic echo ec1 during the next measurement. In this time range of the time window for the probable arrival of the first ultrasonic echo ec1 during the next measurement, the reception circuit RC can temporarily lower the value of the threshold value curve, while the value of the threshold value curve in the range immediately before and after this time range of the time window for the probable arrival of the first ultrasonic echo ec1 is preferably higher in value than in the time range of the time window for the probable arrival of the first ultrasonic echo ec1. For example, the reception circuit RC can use the temporal positions of, for example, the last three receptions of the first ultrasonic echo ec1 and determine therefrom, by means of a polynomial approximation, the time point of the next reception of the first ultrasonic echo ec1. Filtering is recommended here in order to avoid abrupt changes due to erroneously received ultrasonic echoes. Particularly recommended is the prediction of the reception time point on the basis of the results of the overall method. The overall method provides the likely position of obstacles. By means of an ultrasonic measurement simulation, the ultrasonic sensor system can predict, for each ultrasonic sensor, the likely arrival of the ultrasonic echoes for the respective ultrasonic sensor and adapt the threshold value curve SWK thereto, wherein the value of the threshold value curve is preferably lowered at least in the direct temporal surroundings in the time range of the likely arrival of the reflected ultrasonic wave of the ultrasonic burst compared to other time periods.

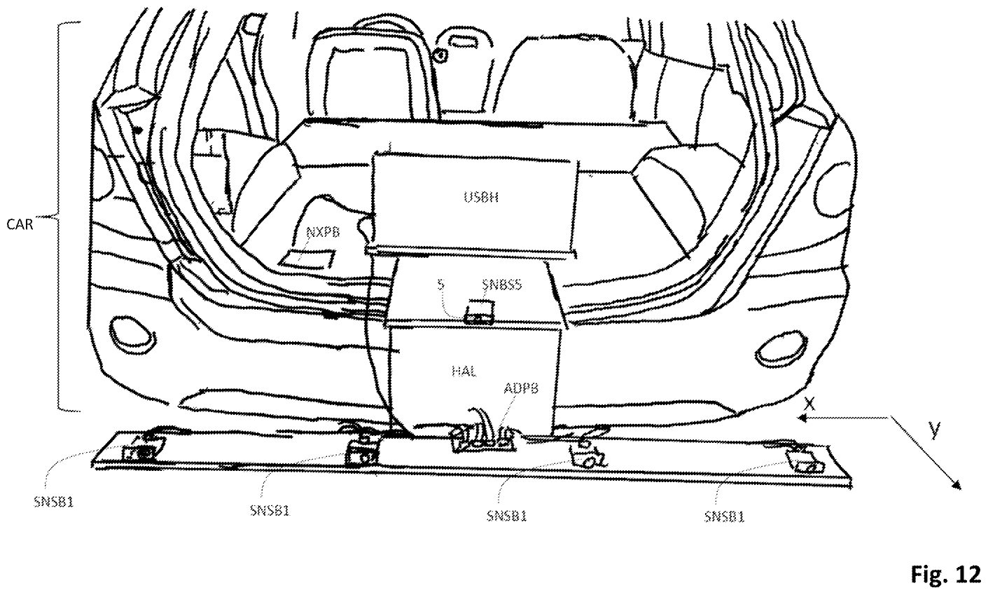

FIG. 12

FIG. 12 shows a rough outline of the exemplary test set-up as the proposers of the document presented herein used for a laboratory prototype of the proposed parking system in the course of the development of the technical teaching of this document. The test set-up included a vehicle CAR. The vehicle CAR was an estate car in the example of FIG. 12. A bracket HAL was mounted on the loading surface of the vehicle CAR. A laptop formed the USB host USBH. The USB host USBH was mounted on the bracket on the loading surface of the vehicle CAR. The bracket HAL was shaped such that four sensor boards (SNSB1, SNSB2, SNSB3, SNSB4) were mounted outside the vehicle CAR approximately at the height of the position of the bumper bar. The respective ultrasonic sensors of the respective sensor boards of the sensor boards (SNSB1, SNSB2, SNSB3, SNSB4) radiated their respective ultrasonic waves into the rear space of the vehicle CAR in the temporal transmission phase of the respective ultrasonic sensor. The respective ultrasonic sensors of the respective sensor boards of the sensor boards (SNSB1, SNSB2, SNSB3, SNSB4) received, in the receiving phase of the respective ultrasonic sensor, reflected ultrasonic waves USR from this rear space of the vehicle CAR. The adapter board ADPB was attached to the bracket HAL together with the necessary wiring.

In addition, the experimental apparatus had a fifth sensor board SNSB5 that was used to generate interference signals.

According to the proposal, it may be provided that the proposed ultrasonic sensor system emits interference signals by means of this fifth ultrasonic transmitter of the fifth sensor board SNSB5. The fifth sensor board SNSB5 may thus comprise an ultrasonic transmitter or an ultrasonic transducer UST for this purpose. As a function of the effect of the interference signal of the fifth ultrasonic transmitter of the fifth sensor board SNSB5, it can be provided to change the filter behaviour of the reception circuit RC of the respective ultrasonic sensor and/or the filter behaviour of the ultrasonic sensor system as a whole by changing parameters of the ultrasonic sensor system. For example, it is conceivable to raise the threshold value curve SWK of one or more ultrasonic sensors.

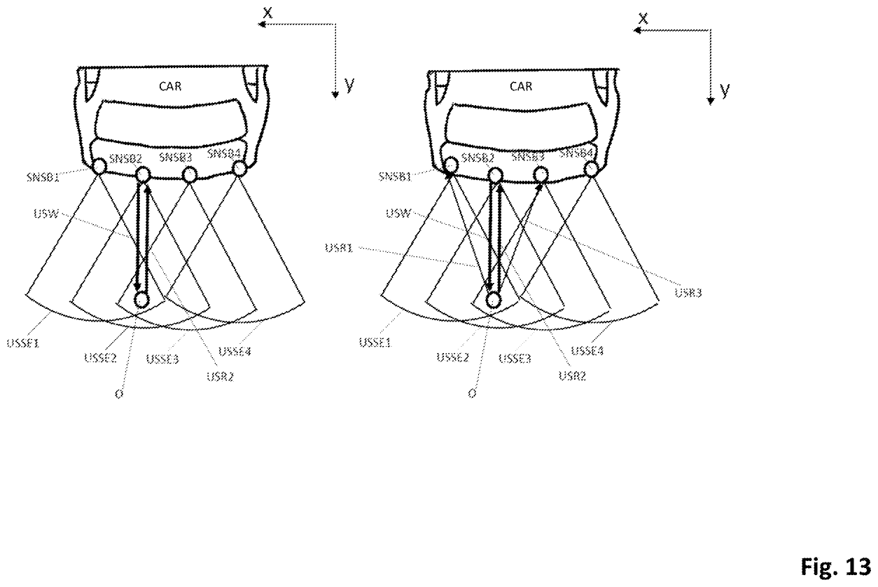

FIG. 13

illustrates a situation in which the ultrasonic sensor 2 of the second ultrasonic sensor board SNSB2 emits an ultrasonic burst signal in the form of an ultrasonic wave USW from, by way of example, four ultrasonic sensors on four ultrasonic sensor boards SNSB1, SNSB2, SNSB3, SNSB4 in the exemplary bumper bar of an exemplary vehicle CAR. The, by way of example, other three ultrasonic sensors 1, 2 and 3 of the other ultrasonic sensor boards SNSB1, SNSB3, SNSB4 operate as ultrasonic receivers in the example of FIG. 13. The first ultrasonic sensor of the first ultrasonic sensor board SNSB1 has a first ultrasonic sensor transmission and reception area USSE1. In this document, for simplified representation, we assume in the description that the ultrasonic sensor transmission area of an ultrasonic sensor board is congruent with the ultrasonic sensor reception range of this ultrasonic sensor of this ultrasonic sensor board. In reality, this may not be true. The person skilled in the art will take this into account in the implementation of the proposal presented herein. This simplification therefore does not reduce the claimed scope.

The second ultrasonic sensor of the second ultrasonic sensor board SNSB2 comprises a second ultrasonic sensor transmission and reception area USSE2.

The third ultrasonic sensor of the third ultrasonic sensor board SNSB3 comprises a third ultrasonic sensor transmission and reception area USSE3.

The fourth ultrasonic sensor of the fourth ultrasonic sensor board SNSB4 comprises a fourth ultrasonic sensor transmission and reception area USSE4.

In the example of FIG. 13, the object O partially reflects the ultrasonic wave of the second ultrasonic sensor of the second ultrasonic sensor board SNSB2 as a first reflected ultrasonic wave USR1, which runs from the object O to the first ultrasonic sensor of the first ultrasonic sensor board SNSB1 as the first reflected ultrasonic wave USR1.

In the example of FIG. 13, the object O partially reflects the ultrasonic wave of the second ultrasonic sensor of the second ultrasonic sensor board SNSB2 as a second reflected ultrasonic wave USR2, which runs back from the object O to the second ultrasonic sensor of the second ultrasonic sensor board SNSB2 as the second reflected ultrasonic wave USR2.

In the example of FIG. 13, the object O partially reflects the ultrasonic wave of the second ultrasonic sensor of the second ultrasonic sensor board SNSB2 as a third reflected ultrasonic wave USR3, which runs from the object O to the third ultrasonic sensor of the third ultrasonic sensor board SNSB3 as the third reflected ultrasonic wave USR3.

In the example of FIG. 13, the object O does not sufficiently reflect the ultrasonic wave of the second ultrasonic sensor of the second ultrasonic sensor board SNSB2 toward the fourth ultrasonic sensor of the fourth ultrasonic sensor board SNSB4. The exemplary situation of FIG. 13 therefore does not show a fourth reflected ultrasonic wave USR4.

Since no fourth reflected ultrasonic wave USR4 reaches the fourth ultrasonic sensor of the fourth ultrasonic sensor board SNSB4, the fourth ultrasonic sensor of the fourth ultrasonic sensor board SNSB4 does not receive an ultrasonic echo of the object O. Thus, only the first ultrasonic sensor of the first ultrasonic sensor board SNSB1 and the second ultrasonic sensor of the second ultrasonic sensor board SNSB2 and the third ultrasonic sensor of the third ultrasonic sensor board SNSB3 receive information about the existence and the distance of the object O. The fourth ultrasonic sensor of the fourth ultrasonic sensor board SNSB4 does not receive information about the existence and the distance of the object O during this measurement.

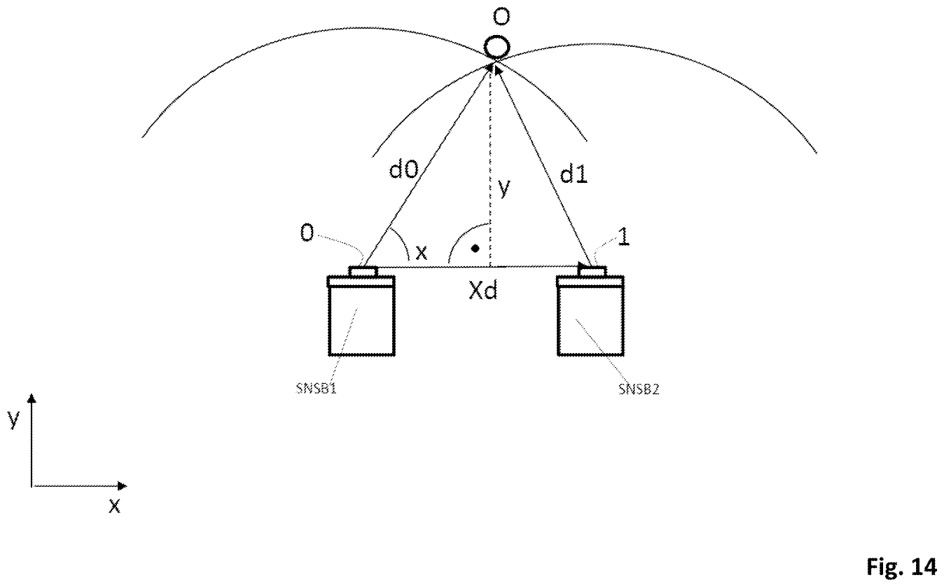

FIG. 14

FIG. 14 illustrates the simplest way of finding a 2D point by interpreting, by means of trilateration, the first ultrasonic echoes (ec1) recognized by two ultrasonic sensors.

For example, the first ultrasonic sensor of the first ultrasonic sensor board SNSB1 generates a first envelope signal HK from its first ultrasonic sensor reception signal of its first ultrasonic transducer UST. Said envelope signal is associated with this first ultrasonic sensor on a first ultrasonic sensor board SNSB1. For example, with the aid of a threshold value curve associated with this first ultrasonic sensor on the first ultrasonic sensor board SNSB1, it generates a first signalling on the sensor data bus SDB of this first ultrasonic sensor board SNSB1. For example, this signalling of the first ultrasonic sensor of the first sensor board SNSB1 shows in a chronological order a first ultrasonic echo ec1 and a second ultrasonic echo ec2 and a third ultrasonic echo ec3, etc. This first ultrasonic echo ec1 is referred to in this document as the first ultrasonic echo ec1 of the first ultrasonic sensor of the first ultrasonic sensor board SNSB1. This second ultrasonic echo ec2 is referred to in this document as the second ultrasonic echo ec2 of the first ultrasonic sensor of the first ultrasonic sensor board SNSB1. This third ultrasonic echo ec3 is referred to in this document as the third ultrasonic echo ec3 of the first ultrasonic sensor of the first ultrasonic sensor board SNSB1. The time period between the emission of the ultrasonic wave USW and the respective arrival of the respective ultrasonic echo ec1, ec2, ec3 depends on the distance between this first ultrasonic sensor of the first ultrasonic sensor board SNSB1 and the object O and the distance between the ultrasonic sensor emitting the ultrasonic wave and the object O.

Analogously, for example, the second ultrasonic sensor of the second ultrasonic sensor board SNSB2 generates a second envelope signal HK from its second ultrasonic sensor reception signal of its second ultrasonic transducer UST, said envelope signal being associated with this second ultrasonic sensor on a second ultrasonic sensor board SNSB2. For example, using a threshold value curve associated with this second ultrasonic sensor on the second ultrasonic sensor board SNSB2, it generates a second signalling on the sensor data bus SDB of this second ultrasonic sensor board SNSB2. For example, this signalling of the second ultrasonic sensor of the second sensor board SNSB2 likewise shows in a chronological order a first ultrasonic echo ec1 and a second ultrasonic echo ec2 and a third ultrasonic echo ec3, etc. This first ultrasonic echo ec1 is referred to in this document as the first ultrasonic echo ec1 of the second ultrasonic sensor of the second ultrasonic sensor board SNSB2. This second ultrasonic echo ec2 is referred to in this document as the second ultrasonic echo ec2 of the second ultrasonic sensor of the second ultrasonic sensor board SNSB2. This third ultrasonic echo ec3 is referred to in this document as the third ultrasonic echo ec3 of the second ultrasonic sensor of the second ultrasonic sensor board SNSB1. The time period between the emission of the ultrasonic wave USW and the respective arrival of the respective ultrasonic echo ec1, ec2, ec3 depends on the distance between this second ultrasonic sensor of the second ultrasonic sensor board SNSB2 and the object O and the distance between the ultrasonic sensor emitting the ultrasonic wave and the object O.

In the example of FIG. 14, the first ultrasonic sensor of the first ultrasonic sensor board SNSB1 has an exemplary distance Xd from the second ultrasonic sensor of the second ultrasonic sensor board SNSB2.

From the temporal position of the arrival of the first ultrasonic echo ec1 of the first ultrasonic sensor of the first ultrasonic sensor board SNSB1 after the emission of the ultrasonic burst, the ultrasonic sensor system can deduce a first distance d0 between the first ultrasonic sensor of the first ultrasonic sensor board SNSB1 from the object O. If a faulty measurement is present, the object O should be roughly on a circle around the first ultrasonic sensor of the first ultrasonic sensor board SNSB1 with a radius corresponding to the first distance d0 between the first ultrasonic sensor of the first ultrasonic sensor board SNSB1 and the object O. More specifically, since the transmitting ultrasonic sensor is not necessarily identical to the receiving ultrasonic sensor, the object O must be on a first ellipse, wherein the transmitting ultrasonic sensor is in a first focal point of the first ellipse, and wherein the receiving ultrasonic sensor is in the other focal point of the first ellipse.

From the temporal position of the arrival of the first ultrasonic echo ec1 of the second ultrasonic sensor of the second ultrasonic sensor board SNSB2 after the emission of the ultrasonic burst, the ultrasonic sensor system can deduce a second distance d0 between the second ultrasonic sensor of the second ultrasonic sensor board SNSB2 from the object O. If a faulty measurement is present, the object O should be roughly on a circle around the second ultrasonic sensor of the second ultrasonic sensor board SNSB2 with a radius corresponding to the second distance d1 between the second ultrasonic sensor of the second ultrasonic sensor board SNSB2 and the object O. More specifically, since the transmitting ultrasonic sensor is not necessarily identical to the receiving ultrasonic sensor, the object O must be on a second ellipse, wherein the transmitting ultrasonic sensor is in a first focal point of the second ellipse, and wherein the receiving ultrasonic sensor is in the other focal point of the second ellipse.

In order to satisfy the condition that the object is on both the first ellipse and the second ellipse, the object should be on the intersection point of the first ellipse and the second ellipse. Unfortunately, this approximation only applies to ideal, point-shaped objects without diameter and non-uniformly reflecting surfaces, etc.

Via simple trigonometric assumptions, the distance y from the line of connection between the first ultrasonic sensor and the second ultrasonic sensor can be determined.

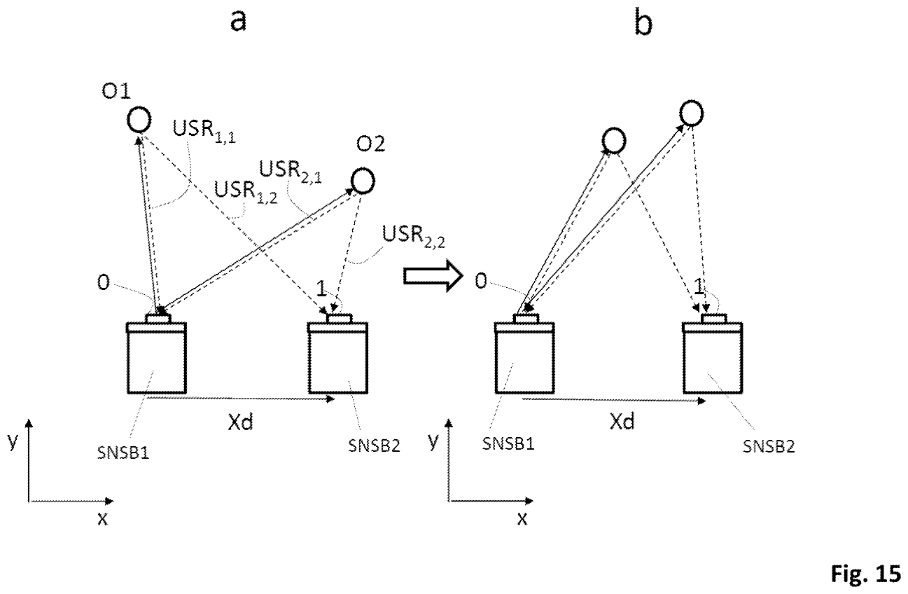

FIG. 15

shows a possible scenario for the trilateration of two ultrasonic sensors for calculating the position of an object O, wherein a plurality of objects O1, O2 in the example of FIG. 15 are however located in the area of the two ultrasonic sensors, which can result in misinterpretations of the ultrasonic echoes and thus in false solutions.

In the example of FIG. 15, the first ultrasonic sensor of the first sensor board SNSB1 emits an ultrasonic burst in the form of a first ultrasonic wave toward the first object O1 and the second object O2. The two solid arrows symbolize this emission of the first ultrasonic wave.

The first object O1 reflects, toward the first ultrasonic sensor of the first sensor board SNSB1, the ultrasonic wave as the first reflected ultrasonic wave USR_{1,1} of the first object O1 toward the first ultrasonic sensor.

The first object O1 reflects, toward the second ultrasonic sensor of the second sensor board SNSB2, the ultrasonic wave as the second reflected ultrasonic wave USR_{1,2} of the first object O1 toward the second ultrasonic sensor.

The second object O2 reflects, toward the first ultrasonic sensor of the first sensor board SNSB1, the ultrasonic wave as the first reflected ultrasonic wave USR_{2,1} of the second object O2 toward the first ultrasonic sensor.

The second object O2 reflects, toward the second ultrasonic sensor of the second sensor board SNSB2, the ultrasonic wave as the second reflected ultrasonic wave USR_{2,2} of the second object O2 toward the second ultrasonic sensor.

In the example of FIG. 15, the first ultrasonic echo ec1 of the first ultrasonic sensor of the first ultrasonic sensor board SNSB1 is then the ultrasonic echo of the first object O1, which the first ultrasonic sensor of the first ultrasonic sensor board SNSB1 sensed temporally first after the emission of the ultrasonic wave by the sensor system.

In the example of FIG. 15, the second ultrasonic echo ec2 of the first ultrasonic sensor of the first ultrasonic sensor board SNSB1 is then the ultrasonic echo of the second object O2, which the first ultrasonic sensor of the first ultrasonic sensor board SNSB1 sensed temporally second after the emission of the ultrasonic wave by the sensor system.

In the example of FIG. 15, the first ultrasonic echo ec1 of the second ultrasonic sensor of the second ultrasonic sensor board SNSB2 is then the ultrasonic echo of the first object O1, which the second ultrasonic sensor of the second ultrasonic sensor board SNSB2 sensed temporally second after the emission of the ultrasonic wave by the sensor system.

In the example of FIG. 15, the second ultrasonic echo ec2 of the second ultrasonic sensor of the second ultrasonic sensor board SNSB2 is then the ultrasonic echo of the second object O2, which the second ultrasonic sensor of the second ultrasonic sensor board SNSB2 sensed temporally first after the emission of the ultrasonic wave by the sensor system.

The ultrasonic sensor system thus has the choice to form two different pairings of time of flights of the ultrasonic echoes of the two ultrasonic sensors. With more objects, the situation becomes even more complicated.

Firstly, as option I, the ultrasonic system may assume that the first ultrasonic echo ec1 of the first ultrasonic sensor and the first ultrasonic echo ec1 of the second ultrasonic sensor were caused by a hypothetical object A, and that the second ultrasonic echo ec2 of the first ultrasonic sensor and the second ultrasonic echo ec2 of the second ultrasonic sensor were caused by a hypothetical object B.

Firstly, as option II, the ultrasonic system may assume that the first ultrasonic echo ec1 of the first ultrasonic sensor and the second ultrasonic echo ec2 of the second ultrasonic sensor were caused by a hypothetical object a, and that the second ultrasonic echo ec2 of the first ultrasonic sensor and the first ultrasonic echo ec1 of the second ultrasonic sensor were caused by a hypothetical object b.

Obviously, option b is the right one here. However, if the ultrasonic system assumes, for example due to a preference for the first ultrasonic echo ec1, that option I is the right one, the ultrasonic sensor system concludes that the situation shown in FIG. 15b is present and not the original situation shown in FIG. 15a. This is an unacceptable state for safety-relevant systems.

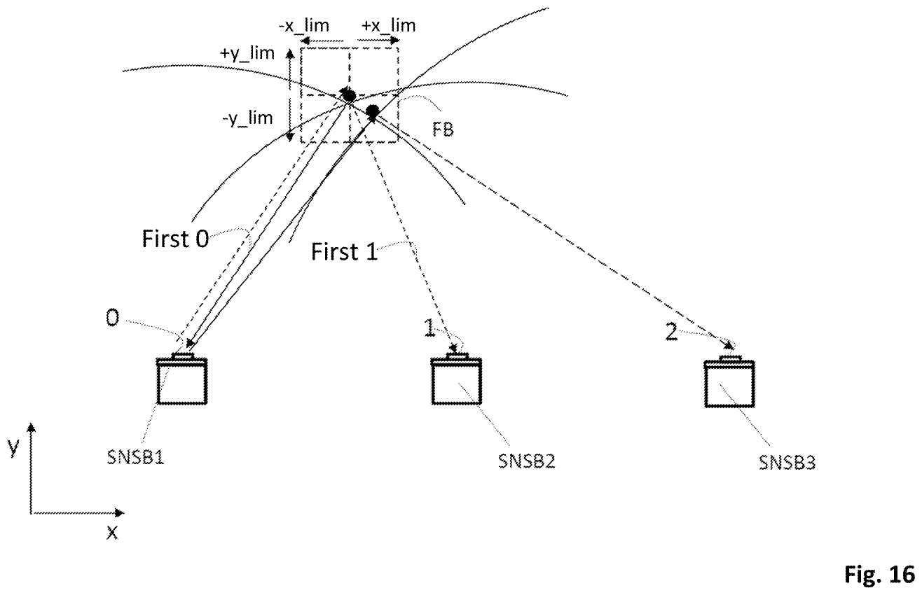

FIG. 16

illustrates the idea of the proposed trilateration method. The proposed trilateration method comprised a method step for recognising an impermissible pairing between an ultrasonic echo of an ultrasonic sensor and a further ultrasonic echo of another ultrasonic echo. Here, this pairing means that the ultrasonic sensor system pairs a value based on the time of flight from the emission of the ultrasonic wave until the arrival of the ultrasonic echo at the ultrasonic sensor with a further value based on the further time of flight from the emission of the ultrasonic wave until the arrival of the further ultrasonic echo at the further ultrasonic sensor, different from the ultrasonic sensor, to a value pair.

For the sake of simplicity, the example of FIG. 16 shows only one object O, which is to be located in the centre of the dashed square. The first ultrasonic sensor of the first ultrasonic sensor board SNSB1 emits the ultrasonic wave. The solid arrows symbolize this. The ultrasonic sensor system now pairs a time-of-flight value of an ultrasonic echo of an ultrasonic sensor with a time-of-flight value of another ultrasonic echo of another ultrasonic sensor. If the ultrasonic sensor system selects, for each of the ultrasonic sensors, the correct ultrasonic echo of this ultrasonic sensor for these three possible pairings, two intersection points of the associated ellipses of the receiving ultrasonic sensors with the ellipse of the transmitting and receiving ultrasonic sensor result, which are close enough together within a fault tolerance. In the example of FIG. 16, the intersection point of the ellipse of the pairing of the ellipse of the first ultrasonic sensor of the first ultrasonic sensor board SNSB1 and the ellipse of the third ultrasonic sensor of the third ultrasonic sensor board SNSB3 is within the fault tolerance range FB around the intersection point of the ellipse of the pairing of the ellipse of the first ultrasonic sensor of the first ultrasonic sensor board SNSB1 and the ellipse of the second ultrasonic sensor of the second ultrasonic sensor board SNSB2. In the example of FIG. 16, the fault tolerance range FB is a, by way of example, square fault tolerance range FB, which permits a deviation in the X direction of +/−an X deviation value x_lim in the X direction and in the Y direction of +/−a Y deviation value y_lim from the coordinates of the first-mentioned intersection point to the coordinates of the second-mentioned intersection point.

For example, the ultrasonic sensor system may then combine the two coordinate pairs by averaging.

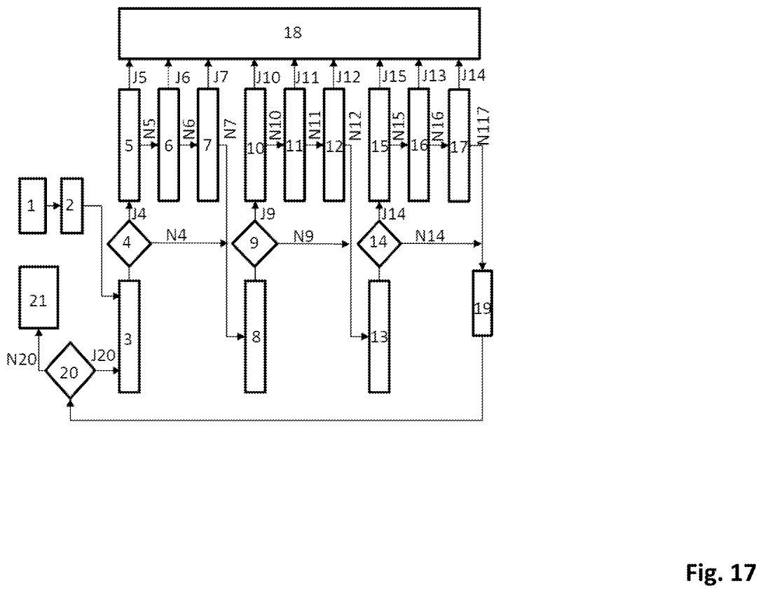

FIG. 17

FIG. 17 illustrates the flow of the proposed trilateration method.

The method is based on the method described for FIGS. 16 and 15 and is an embodiment of the basic principle.

The proposed method starts with the ultrasonic sensor system first performing a measurement. Then, the method according to FIG. 17 starts at the Start point, reference sign 1.

Initially, the method starts with a first magnitude of the fault tolerance range FB of FIG. 16. The basis of the method of FIG. 17 is that the allowed deviation in the X direction of +/−an X deviation value x_lim and in the Y direction of +/−a Y deviation value y_lim is the same in both directions and corresponds to a diff value.

In the exemplary initialisation step, the ultrasonic sensor system initially sets this magnitude to an initial value i-step. (reference sign 2)

Then, the ultrasonic sensor system performs a first trilateration based on the first ultrasonic echo ec1 of the first ultrasonic sensor and the first ultrasonic echo of the second ultrasonic sensor (reference sign 3). The result is a first trilateration point.

The ultrasonic sensor system then compares whether the ascertained first trilateration point is within a permissible coordinates range. (reference sign 4)

If this is not the case (reference sign N4), the method jumps directly to a trilateration of the first ultrasonic echo of the first ultrasonic sensor with the second ultrasonic echo of the second ultrasonic sensor. (reference sign 8)

If this is the case (reference sign J4), the method carries out a second trilateration between the first echo of the first ultrasonic sensor and the first echo of the third ultrasonic sensor and thus ascertains a second trilateration result. (reference sign 5)

If the second trilateration result is within the fault tolerance range FB of the first trilateration result (reference sign J5), it is a valid result and the ultrasonic sensor system ascertains a final trilateration result from the first trilateration result and the second trilateration result, thus completing the trilateration method (reference sign 18).

If the second trilateration result is outside of the fault tolerance range FB of the first trilateration result (reference sign N5), it is an invalid result and the ultrasonic sensor system carries out a second trilateration based on the first echo of the first ultrasonic sensor and the second ultrasonic echo of the third ultrasonic sensor and thus ascertains the second trilateration result again on the basis of different data. (reference sign 6)

If the second trilateration result is within the fault tolerance range FB of the first trilateration result (reference sign J6), it is a valid result and the ultrasonic sensor system ascertains a final trilateration result from the first trilateration result and the second trilateration result, thus completing the trilateration method (reference sign 18).

If the second trilateration result is again outside of the fault tolerance range FB of the first trilateration result (reference sign N6), it is an invalid result and the ultrasonic sensor system carries out a second trilateration based on the first echo of the first ultrasonic sensor and the third ultrasonic echo of the third ultrasonic sensor and thus ascertains the second trilateration result again on the basis of different data. (reference sign 7)

If the second trilateration result is then within the fault tolerance range FB of the first trilateration result (reference sign J7), it is a valid result and the ultrasonic sensor system ascertains a final trilateration result from the first trilateration result and the second trilateration result, thus completing the trilateration method (reference sign 18).

If the second trilateration result is again outside of the fault tolerance range FB of the first trilateration result (reference sign N7), it is an invalid result and the ultrasonic sensor system discards the first trilateration result.

If the first trilateration result was outside of a permissible range (reference sign N4) or if the ultrasonic sensor system has discarded the first trilateration result (reference sign N7), the ultrasonic sensor system now carries out the first trilateration based on the first ultrasonic echo ec1 of the first ultrasonic sensor and the second ultrasonic echo of the second ultrasonic sensor. The result is again a first trilateration point. (reference sign 8)

The ultrasonic sensor system then again compares whether the first trilateration point now ascertained for a second time is now within a permissible coordinates range. (reference sign 9) If this is not the case (reference sign N9), the method jumps directly to a trilateration of the first ultrasonic echo of the first ultrasonic sensor with the third ultrasonic echo of the second ultrasonic sensor (reference sign 13).

If this is the case (reference sign J9), the method carries out a second trilateration between the first echo of the first ultrasonic sensor and the first echo of the third ultrasonic sensor and thus ascertains a second trilateration result. (reference sign 10)

If the second trilateration result is within the fault tolerance range FB of the first trilateration result (reference sign J10), it is a valid result and the ultrasonic sensor system ascertains a final trilateration result from the first trilateration result and the second trilateration result, thus completing the trilateration method (reference sign 18).

If the second trilateration result is outside of the fault tolerance range FB of the first trilateration result (reference sign N10), it is an invalid result and the ultrasonic sensor system carries out a second trilateration based on the first echo of the first ultrasonic sensor and the second ultrasonic echo of the third ultrasonic sensor and thus ascertains the second trilateration result again on the basis of different data. (reference sign 11)

If the second trilateration result is within the fault tolerance range FB of the first trilateration result (reference sign J11), it is a valid result and the ultrasonic sensor system ascertains a final trilateration result from the first trilateration result and the second trilateration result, thus completing the trilateration method (reference sign 18).

If the second trilateration result is again outside of the fault tolerance range FB of the first trilateration result (reference sign N11), it is an invalid result and the ultrasonic sensor system carries out a second trilateration based on the first echo of the first ultrasonic sensor and the third ultrasonic echo of the third ultrasonic sensor and thus ascertains the second trilateration result again on the basis of different data. (reference sign 12)

If the second trilateration result is then within the fault tolerance range FB of the first trilateration result (reference sign J12), it is a valid result and the ultrasonic sensor system ascertains a final trilateration result from the first trilateration result and the second trilateration result, thus completing the trilateration method (reference sign 18).

If the second trilateration result is again outside of the fault tolerance range FB of the first trilateration result (reference sign N12), it is an invalid result and the ultrasonic sensor system discards the first trilateration result.

If the first trilateration result was outside of a permissible range (reference sign N9) or if the ultrasonic sensor system has discarded the first trilateration result (reference sign N12), the ultrasonic sensor system now carries out the first trilateration based on the first ultrasonic echo ec1 of the first ultrasonic sensor and the third ultrasonic echo of the second ultrasonic sensor. The result is again a first trilateration point. (reference sign 13)

The ultrasonic sensor system then again compares whether the first trilateration point now ascertained for a third time is now within a permissible coordinates range. (reference sign 14)

If this is not the case (reference sign N14), the method jumps directly to changing the fault tolerance range FB. (reference sign 19)

If this is the case (reference sign J14), the method carries out a second trilateration between the first echo of the first ultrasonic sensor and the first echo of the third ultrasonic sensor and thus ascertains a second trilateration result. (reference sign 15)

If the second trilateration result is within the fault tolerance range FB of the first trilateration result (reference sign J15), it is a valid result and the ultrasonic sensor system ascertains a final trilateration result from the first trilateration result and the second trilateration result, thus completing the trilateration method. (reference sign 18)

If the second trilateration result is outside of the fault tolerance range FB of the first trilateration result (reference sign N15), it is an invalid result and the ultrasonic sensor system carries out a second trilateration based on the first echo of the first ultrasonic sensor and the second ultrasonic echo of the third ultrasonic sensor and thus ascertains the second trilateration result again on the basis of different data. (reference sign 16)

If the second trilateration result is within the fault tolerance range FB of the first trilateration result (reference sign J16), it is a valid result and the ultrasonic sensor system ascertains a final trilateration result from the first trilateration result and the second trilateration result, thus completing the trilateration method (reference sign 18).

If the second trilateration result is again outside of the fault tolerance range FB of the first trilateration result (reference sign N16), it is an invalid result and the ultrasonic sensor system carries out a second trilateration based on the first echo of the first ultrasonic sensor and the third ultrasonic echo of the third ultrasonic sensor and thus ascertains the second trilateration result again on the basis of different data. (reference sign 17)

If the second trilateration result is then within the fault tolerance range FB of the first trilateration result (reference sign J17), it is a valid result and the ultrasonic sensor system ascertains a final trilateration result from the first trilateration result and the second trilateration result, thus completing the trilateration method (reference sign 18).

If the second trilateration result is again outside of the fault tolerance range FB of the first trilateration result (reference sign N17), it is an invalid result and the ultrasonic sensor system again discards the first trilateration result.

If the first trilateration result was outside of a permissible range (reference sign N14) or if the ultrasonic sensor system discarded the first trilateration result (reference sign N17), the ultrasonic system increases the fault tolerance range FB (reference sign 19) unless it has reached or exceeded a maximum size.

If the fault tolerance range FB has reached or exceeded a maximum size (reference sign 20), the ultrasonic sensor system aborts the method (reference sign 21).

If the fault tolerance range FB has not yet reached or exceeded a maximum size, the ultrasonic sensor system again performs the method with an increased fault tolerance range FB and, for this purpose, again starts by performing the first trilateration based on the first ultrasonic echo ec1 of the first ultrasonic sensor and the first ultrasonic echo of the second ultrasonic sensor. (reference sign 3) The result is again a first trilateration point. The ultrasonic sensor system continues the method from this point, as described above. (reference sign 4)

In this way, the trilateration of individual objects is generally successful.

Preferably, the method always uses three ultrasonic sensors placed next to one another.

If the method does not produce a result or if the method has ended in some other way, the ultrasonic system selects three other, preferably adjacent ultrasonic sensors for the method and performs the method for these three new ultrasonic sensors.

It may happen that the ultrasonic system also selects other triple combinations of three ultrasonic sensors from the set of ultrasonic sensors and applies the method to the data of the ultrasonic echoes of these ultrasonic sensors. If a large number of ultrasonic sensors were used, the number of possible combinations would explode. It has therefore been established to in each case use only predetermined combinations of three ultrasonic sensors for each method pass.

After applying the method with a sufficient number of method passes, the ultrasonic sensor system has ascertained a certain set of hypothetical object locations by means of this proposed trilateration of the ultrasonic echoes of the ultrasonic sensors, which are the basis of the further overall method.

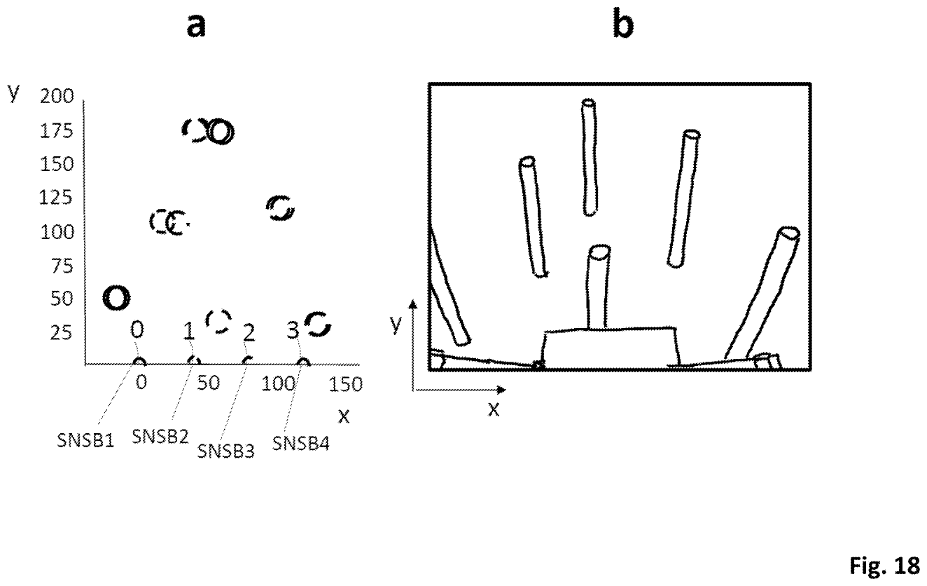

FIG. 18

FIG. 18 shows an example of how, using the trilateration method described above by way of example, the ultrasonic sensor system can recognize a maximum of three obstacles in each channel in that the ultrasonic sensor system applies the trilateration method proposed in FIG. 17 to the first, second and third ultrasonic echoes of each ultrasonic sensor, wherein FIG. 18 shows, by way of example, exemplary solutions of the method in the measurement of six different, exemplary posts on a paved surface.

FIG. 18a shows the ascertained two-dimensional coordinates of a 2D map of the surroundings. For better guidance, the ultrasonic sensors are drawn as semicircles at Y coordinate 0 on the X axis as semicircles. The coding of the position name of the semicircles corresponds to the coding of the ascertained points.

FIG. 18b shows a graphical representation of the arrangement of the posts used in the development of the proposal. It shows the view from the rear of the vehicle of FIG. 12 onto the six posts, which are set up on an asphalt surface.

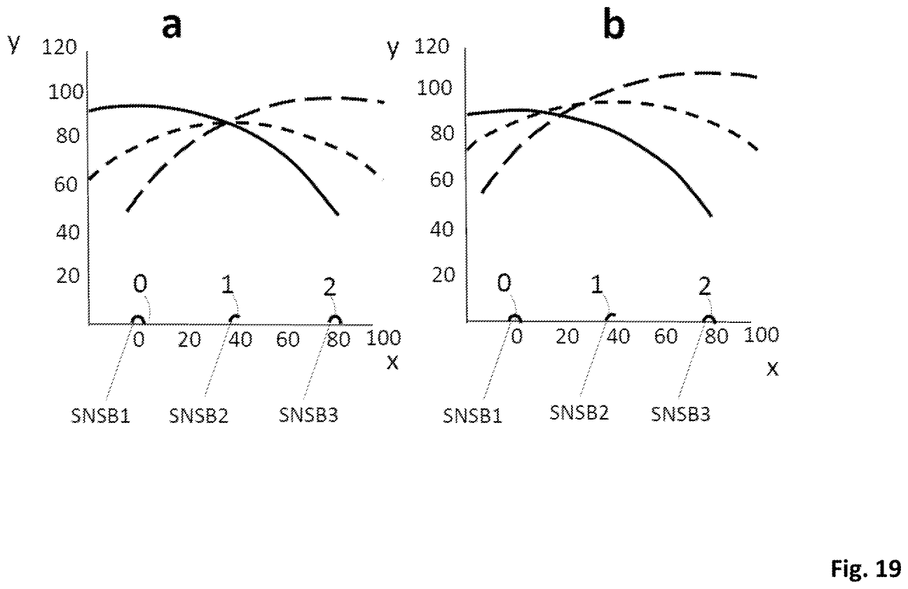

FIG. 19

illustrates that the recognition of a wide surface, such as a wall, requires, for example, more iterations than the recognition of a small post. FIG. 19a shows the ellipses of the ultrasonic sensors of the ultrasonic sensor boards SNSB1, SNSB2 and SNSB3 for one post, which all n three ultrasonic sensors sense. FIG. 19a shows the ellipses for a wall. It is clear that the prerequisite for trilateration of the reflecting object being point-shaped results in problems since the three ellipses of FIG. 19a do not intersect in one point. In the figure, the first ultrasonic sensor of the first ultrasonic sensor board SNSB1 emits the ultrasonic burst as an ultrasonic wave USW. The other ultrasonic sensors of the other ultrasonic sensor boards only receive the reflections of this ultrasonic burst.

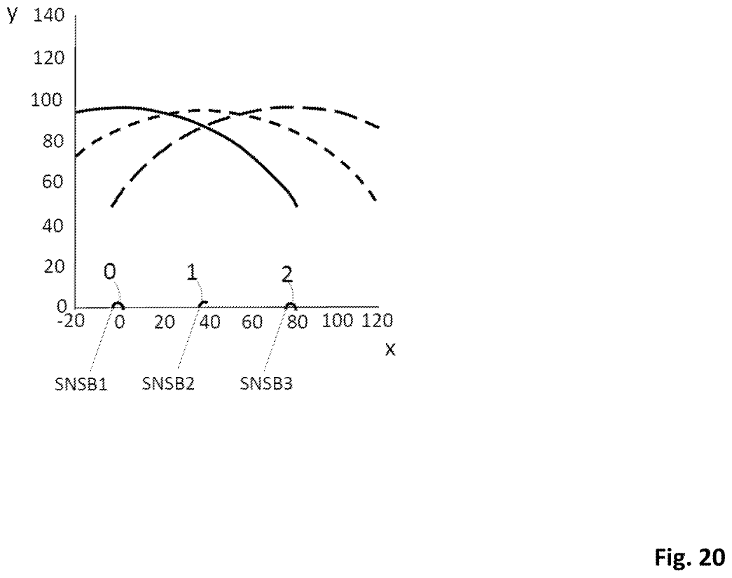

FIG. 20

visualizes the three exemplary distance values sensed using, by way of example, three ultrasonic sensors of the three ultrasonic sensor boards SNSB1, SNSB2 and SNSB3, via associated ultrasonic echoes of a wall measurement. In the case of FIG. 20, the ultrasonic sensor system worked with the same test environment as in FIG. 19b. However, the ultrasonic sensor of the second ultrasonic sensor board SNSB2, and not that of the first ultrasonic sensor board SNSB1, was sending now. In this configuration, the situation has deteriorated compared to the situation in FIG. 19b.

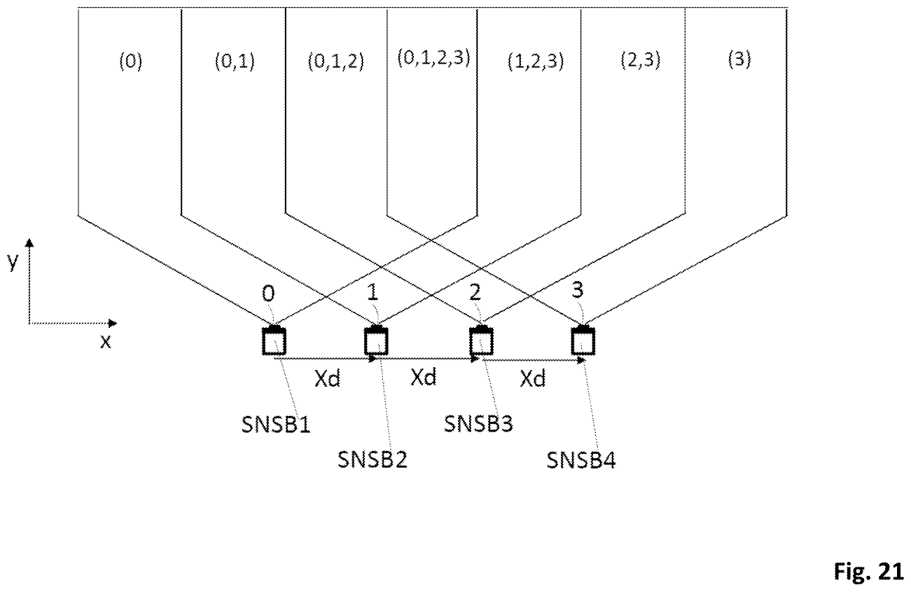

FIG. 21

shows exemplary ranges of, by way of example, four exemplary ultrasonic sensors.

FIG. 21 shows the exemplary ranges of the four exemplary ultrasonic sensors of the four ultrasonic sensor boards SNSB1, SNSB2, SNSB3, SNSB4. Each ultrasonic sensor recognizes the post object about 80 cm to the left and 80 cm to the right in front of the respective ultrasonic sensor, taking into account the respective viewing angle. This limit is not absolute in practical measurements. Objects beyond this range of the respectively relevant ultrasonic sensor can likewise be perceived by this relevant ultrasonic sensor. However, the likelihood of such perception by the respective relevant ultrasonic sensor decreases as a function of the surface of the object and of the angle to the radiating and/or reception axis of the radiation lobe or of the reception lobe of the relevant ultrasonic sensor. The method used by the proposed ultrasonic sensor system operates at these angle limits in order to minimize incorrect positions that may not belong to an object. Objects that are outside of allowable maximum reception angles are ignored by the proposed ultrasonic sensor system. Moreover, it is not necessary to extend the areas because if the solution of one channel is very far away, another channel will recognize this object.

The trilaterations of each channel require three ultrasonic sensors per channel in the proposed method. The association is defined by the construction. Preferably, the three ultrasonic sensors are adjacent one another along a line. Preferably, three ultrasonic sensors of three ultrasonic sensor boards of the exemplary four ultrasonic sensor boards SNSB1, SNSB2, SNSB3 and SNSB4 must thus in each case sense an object O. The objects O should thus preferably be placed between the first and fourth ultrasonic sensors. The numbers in FIG. 21 show which ultrasonic sensor receives ultrasonic echoes from this area.

Here, the number 0 represents the first ultrasonic sensor of the first ultrasonic sensor board SNSB1.

Here, the number 1 represents the first ultrasonic sensor of the first ultrasonic sensor board SNSB2.

Here, the number 2 represents the first ultrasonic sensor of the first ultrasonic sensor board SNSB3.

Here, the number 3 represents the first ultrasonic sensor of the first ultrasonic sensor board SNSB4.

In the sense of this document, the ultrasonic sensors are arranged on the ultrasonic sensor boards SNSB1, SNSB2, SNSB3 and SNSB4 along a line from left to right. In this document, we consider this line as the X axis. The zero point of the X axis is to be at the location of the first ultrasonic sensor of the first ultrasonic sensor board SNSB1. The X axis is to be parameterized from the 0 point at the first ultrasonic sensor of the first ultrasonic sensor board SNSB1 to the fourth ultrasonic sensor SNSB4 of the fourth ultrasonic sensor board SNSB4. The counting of the ultrasonic sensor boards preferably here takes place from left to right along the X axis on said line. The first two channels now preferably recognize objects in the x range of the X axis between 0 and 80 cm in the example used for the development of this document. The second two channels recognize obstacles with an x position between 40 cm and 120 cm. The ultrasonic sensors may not sense every y position in the x range between 0 cm and 120 cm. If objects are too close to the ultrasonic sensor system, the outer ultrasonic sensor does not receive an echo of this object. The same problem occurs for objects with an x position more or less directly adjacent to the four ultrasonic sensors. Both problems could result in some unfavourable scenarios in parking situations. The word “fallback” in this document is meant as a make-shift solution, which represents a non-optimal but, in practical reality, alternatively useful workaround for such problems. The following fallback is a preferably implemented part of the method in order to prevent these bad scenarios. The test set-up used by the development of the technical teaching of this document utilized these fallbacks.

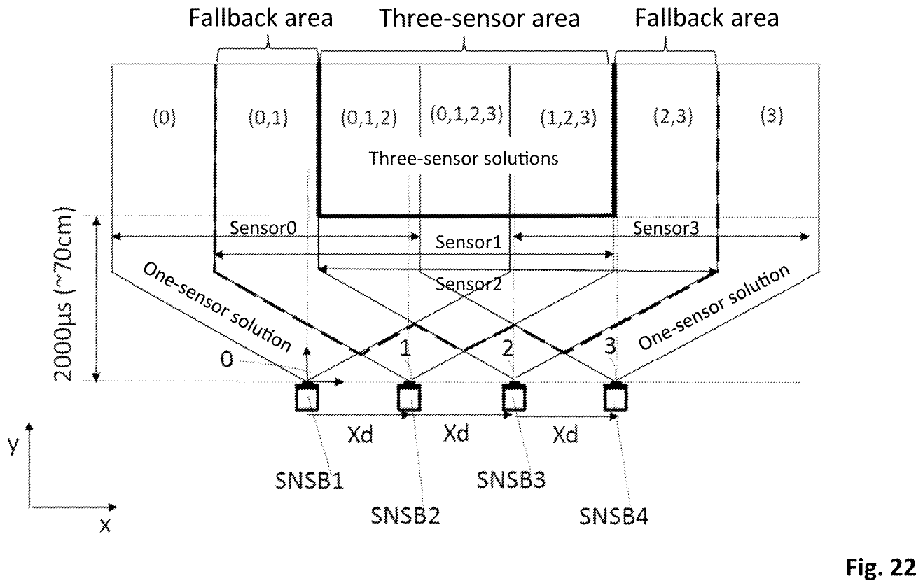

FIG. 22

shows various exemplary operating ranges for the, by way of example, four exemplary ultrasonic sensors of FIG. 21.

Fallback

As explained above, various issues occur in the generation of the map of the surroundings by means of ultrasonic sensors. The proposed method therefore preferably contains a fallback in order to recognize objects with a smaller number of receiving ultrasonic sensors in the outer and the closer areas of the vehicle surroundings examined. Fallback here means that the method cannot compare the solution of two ultrasonic sensors to a third sensor solution and therefore uses the measurement data of a correspondingly smaller number of ultrasonic sensors. Generally, these are the measurement data of the ultrasonic sensors that receive ultrasonic echoes. The ultrasonic sensor system then accepts a solution of two ultrasonic sensors without further proof. Accordingly, such solutions have a smaller confidence value than solutions on the basis of measured values of three ultrasonic sensors. In the laboratory prototype of the ultrasonic sensor system used for the development of the technical teaching of this document, this fallback is implemented only for near and outer field recognition. This exemplary fallback takes into account only the first ultrasonic echoes of the ultrasonic sensors. Taking into account second and third ultrasonic echoes could result in false solutions due to incorrect echo mappings. Multiple object recognition is also possible in the fallback area. Each channel may recognize an object by the first ultrasonic echo and two further objects by the second and third ultrasonic echoes. The fallback increases the detection range and reliable object recognition at small distances. As already described with FIG. 21 above, FIG. 22 shows the various operating ranges.

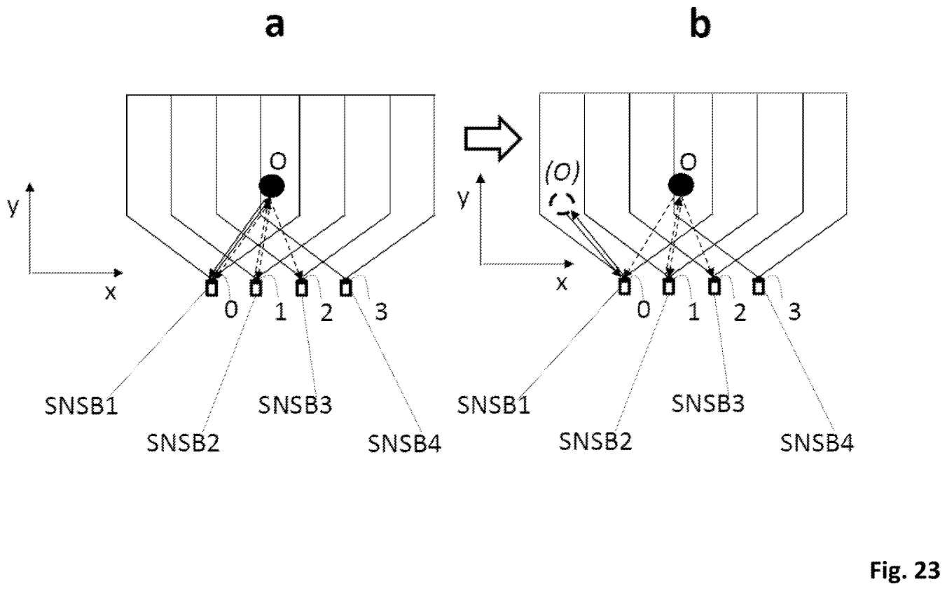

The bold rectangle of FIG. 23 shows the range of the sensor solutions on the basis of three ultrasonic sensors without utilising a fallback. The bold rectangle is open in the positive y direction since FIG. 23 focuses on near-field recognition and does not show the full range in the y direction. The solid line symbolizes that the boundary of the rectangle is rigid. The ultrasonic sensor apparatus only accepts solutions within this bold rectangle based on the measured values of three ultrasonic sensors, without utilising the fallback. In contrast, the ultrasonic sensor apparatus also accepts solutions around the bold rectangle based on measured values of two ultrasonic sensors. This area is the fallback area. Therefore the word “fallback”. It means that solutions resulting from fewer than three ultrasonic sensors can result in accepted points in this area. Two-sensor solutions are generally accepted anywhere in the fallback area. A two-sensor solution is an ascertained object coordinate that the ultrasonic sensor system ascertained based on the measurement data of only two ultrasonic sensors. A three-sensor solution is an ascertained object coordinate that the ultrasonic sensor system ascertained based on the measurement data of three ultrasonic sensors. A one-sensor solution are the ascertained object coordinates of the distance ellipse that the ultrasonic sensor system ascertained based on the measurement data of only one ultrasonic sensor. The acceptance of two-sensor solutions in the fallback area by the ultrasonic sensor system depends on the currently transmitting ultrasonic sensor.

Here, we distinguish between the channels 0, 1, 2 and 3.

The channels 1 and 2 of the two middle ultrasonic sensors calculate points by means of their first ultrasonic echo and the first ultrasonic echo of the two ultrasonic sensors next to them on the left and the right in each case.

For channel 1, the ultrasonic sensor system accepts three-sensor solutions having an x position between the first ultrasonic sensor 0 of the first ultrasonic sensor board SNSB1 and the third ultrasonic sensor 2 of the third ultrasonic sensor board SNSB2, wherein, for example, in channel 1, the second ultrasonic sensor 1 of the second ultrasonic sensor board SNSB2 transmits and the first ultrasonic sensor 0 of the first ultrasonic sensor board SNSB1 receives, and the second ultrasonic sensor 1 of the second ultrasonic sensor board SNSB2 receives after the ultrasonic burst has been emitted as an ultrasonic wave USW, and the third ultrasonic sensor 2 of the third ultrasonic sensor board SNSB3 receives.

For channel 2, the ultrasonic sensor system accepts three-sensor solutions having an x position between the second ultrasonic sensor 1 of the second ultrasonic sensor board SNSB2 and the fourth ultrasonic sensor 3 of the fourth ultrasonic sensor board SNSB4, wherein, for example, in channel 2, the third ultrasonic sensor 2 of the third ultrasonic sensor board SNSB3 transmits and the second ultrasonic sensor 1 of the second ultrasonic sensor board SNSB2 receives, and the third ultrasonic sensor 2 of the third ultrasonic sensor board SNSB3 receives after the ultrasonic burst has been emitted as an ultrasonic wave USW, and the fourth ultrasonic sensor 3 of the fourth ultrasonic sensor board SNSB4 receives.

For the evaluation, channel 1 calculates, for example, first a trilateral with the first ultrasonic echo of the second ultrasonic sensor 1 of the second ultrasonic sensor board SNSB2 and the first ultrasonic echo of the first ultrasonic sensor 0 of the first ultrasonic sensor board SNSB1. If this does not result in a solution, the ultrasonic sensor system carries out a trilateration of the first ultrasonic echo of the second ultrasonic sensor 1 of the second ultrasonic sensor board SNSB2 with the first ultrasonic echo of the third ultrasonic sensor 2 of the first ultrasonic sensor board SNSB3.

For the evaluation, channel 2 calculates, for example, first a trilateral with the first ultrasonic echo of the third ultrasonic sensor 2 of the third ultrasonic sensor board SNSB3 and the first ultrasonic echo of the second ultrasonic sensor 1 of the second ultrasonic sensor board SNSB2. If this does not result in a solution, the ultrasonic sensor system carries out a trilateration of the first ultrasonic echo of the third ultrasonic sensor 2 of the third ultrasonic sensor board SNSB3 with the first ultrasonic echo of the fourth ultrasonic sensor 3 of the fourth ultrasonic sensor board SNSB4.

The ultrasonic sensor system thereby always recognizes objects that are located in front of the four ultrasonic sensors 0,1,2,3 of the four sensor boards SNSB1, SNSB2, SNSB3 and SNSB4 in two channels, namely the channels 1 and 2. This results in greater safety in the close range.

Channel 0 and channel 3 measure obstacles in the lateral range. Redundant object recognition is not possible since only the two outer ultrasonic sensors can receive ultrasonic echoes from objects next the ultrasonic sensors.

For channel 0, the ultrasonic sensor system accepts two-sensor solutions having an x position to the left of the first ultrasonic sensor 0 of the first ultrasonic sensor board SNSB1 and from there to the right up to the second ultrasonic sensor 1 of the second ultrasonic sensor board SNSB2, wherein, for example, in channel 0, the first ultrasonic sensor 0 of the first ultrasonic sensor board SNSB1 transmits and the first ultrasonic sensor 0 of the first ultrasonic sensor board SNSB1 receives after the ultrasonic burst has been emitted as an ultrasonic wave USW, and the second ultrasonic sensor 1 of the second ultrasonic sensor board SNSB2 receives.

For channel 3, the ultrasonic sensor system accepts two-sensor solutions having an x position to the right of the fourth ultrasonic sensor 3 of the fourth ultrasonic sensor board SNSB4 and from there to the left up to the third ultrasonic sensor 2 of the third ultrasonic sensor board SNSB3, wherein, for example, in channel 4, the fourth ultrasonic sensor 3 of the fourth ultrasonic sensor board SNSB4 transmits and the fourth ultrasonic sensor 3 of the fourth ultrasonic sensor board SNSB4 receives after the ultrasonic burst has been emitted as an ultrasonic wave USW, and the third ultrasonic sensor 2 of the third ultrasonic sensor board SNSB3 receives.

The ultrasonic sensor system therefore preferably ascertains only one trilateration of the two first ultrasonic echoes of the respective ultrasonic sensor in each case in each channel of these two outer channels, i.e., the channels 0 and 3. If this trilateration does not result in a solution, the method that the ultrasonic sensor system carries out also contains a fallback to a single ultrasonic sensor.

The method thus detects an obstacle or another object in these outer areas only if the respectively transmitting ultrasonic sensor receives an ultrasonic echo of the ultrasonic wave USW radiated by it. Preferably, the ultrasonic sensor system first checks whether the ultrasonic echo received from the outer ultrasonic sensor, here an ultrasonic sensor of the ultrasonic sensors 0 and 3, does not belong to another object, by comparing the distance that the received ultrasonic echo represents to the distances, calculated on the basis of the measured values of other channels by the ultrasonic sensor system, to objects already recognized.

FIG. 23

illustrates why the use of a fallback method to first two and then one ultrasonic sensor is necessary if the ultrasonic sensor system detects an obstacle in the form of an object in one of the outer areas and if only the transmitting ultrasonic sensor receives an ultrasonic echo of its ultrasonic burst emitted as an ultrasonic wave USW. The method that the ultrasonic sensor system preferably applies preferably first checks whether the ultrasonic echo does not belong to another object, by the ultrasonic sensor system comparing, within this method, the ultrasonic echo of the relevant outer ultrasonic sensor with the distances, calculated by other channels, to objects.

The left side of FIG. 23 (FIG. 23a) shows the ultrasonic echoes of channel 0 and channel 1.

In the case of channel 0, the first ultrasonic sensor 0 of the first ultrasonic sensor board SNSB1 emits an ultrasonic burst as an ultrasonic wave USW. In FIG. 23, this emission is drawn as an arrow with a solid line from the first ultrasonic sensor 0 of the first ultrasonic sensor board SNSB1 to the object O. In the exemplary case of FIG. 23, however, the object O reflects the ultrasonic wave USW of the first ultrasonic sensor 0 of the first ultrasonic board SNSB1 only to a sufficient extent back to the first ultrasonic sensor 0 of the first ultrasonic board SNSB1. This reflection of the ultrasonic wave USW from the object O back to the first ultrasonic sensor 0 of the first ultrasonic sensor board SNSB1 is drawn in FIG. 23 as a black solid arrow from the object O to the first ultrasonic sensor 0 of the first ultrasonic sensor board SNSB1. Since the other ultrasonic sensors in the example of FIG. 23 do not receive anything in channel 0, no solid arrows are drawn from the object O to these ultrasonic sensors.

In the case of channel 1, the second ultrasonic sensor 1 of the second ultrasonic sensor board SNSB2 emits an ultrasonic burst as an ultrasonic wave USW. This logically preferably takes place in the time division multiplex with channel 0. In FIG. 23, this emission is drawn as an arrow with a dashed line from the second ultrasonic sensor 2 of the second ultrasonic sensor board SNSB2 to the object O. In the exemplary case of FIG. 23, however, the object O reflects the ultrasonic wave USW of the second ultrasonic sensor 1 of the second ultrasonic board SNSB2 to a sufficient extent back to the first ultrasonic sensor 0 of the first ultrasonic board SNSB1 and to the second ultrasonic sensor 1 of the second ultrasonic board SNSB2 and to the third ultrasonic sensor 2 of the third ultrasonic board SNSB3. The reflection of the ultrasonic wave USW from the object O back to the first ultrasonic sensor 0 of the first ultrasonic sensor board SNSB1 is drawn in FIG. 23 as a black dashed arrow from the object O to the first ultrasonic sensor 0 of the first ultrasonic sensor board SNSB2. The reflection of the ultrasonic wave USW from the object O back to the second ultrasonic sensor 1 of the second ultrasonic sensor board SNSB2 is drawn in FIG. 23 as a black dashed arrow from the object O to the second ultrasonic sensor 1 of the second ultrasonic sensor board SNSB2. The reflection of the ultrasonic wave USW from the object O to the third ultrasonic sensor 2 of the third ultrasonic sensor board SNSB3 is drawn in FIG. 23 as a black dashed arrow from the object O to the third ultrasonic sensor 2 of the third ultrasonic sensor board SNSB3. Since the other ultrasonic sensors, the first ultrasonic sensor 0 and the fourth ultrasonic sensor 3, in the example of FIG. 23 do not receive anything in channel 1, no solid arrows are drawn from the object O to these ultrasonic sensors.

Channel 1 detects an obstacle by means of three first ultrasonic echoes. Channel 1 detects a first ultrasonic echo via the first ultrasonic sensor 0 of the first ultrasonic sensor board SNSB1. Channel 1 detects a first ultrasonic echo via the second ultrasonic sensor 1 of the second ultrasonic sensor board SNSB2. Channel 1 detects a first ultrasonic echo via the third ultrasonic sensor 2 of the third ultrasonic sensor board SNSB3.

In contrast, the reflection of the ultrasonic transmit burst of the ultrasonic sensor 0 is received only by ultrasonic sensor 0 of the first ultrasonic sensor board SNSB1. According to the fallback to one ultrasonic sensor, the method would accept as a solution the reflection of the ultrasonic transmit burst of the ultrasonic sensor 0 of the first ultrasonic sensor board SNSB1, which reflection is measured by the first ultrasonic sensor 0 of the first ultrasonic sensor board SNSB1. The ultrasonic sensor system calculates in channel 1 the distance between the first ultrasonic sensor 0 of the first ultrasonic sensor board SNSB1 and the object O. The ultrasonic sensor system compares this newly calculated distance with the distance calculated by the ultrasonic sensor system in channel 0, in order to prevent a false solution. If the value of the newly calculated distance is close to the distance value of the distance calculated in channel 0, the ultrasonic sensor system does not evaluate the ultrasonic echo as a permissible one-sensor solution and discards this one-sensor solution. The one-sensor solution is drawn as an object (O) in FIG. 23, wherein the O is set in parentheses and is italicized in order to mark it as a fraudulent object. The background is that the ultrasonic sensor system assumes that this ultrasonic echo is to be attributed to the object already sensed in channel 1. In this way, the ultrasonic sensor system reduces the likelihood of false solutions due to misinterpretation of ultrasonic echoes. In particular in the case of objects with irregular and angled surfaces, scenarios may occur as shown in FIG. 23.

The sensor system thus applies a method to identify the ultrasonic echoes from fraudulent objects in the measured values of the ultrasonic echoes of the ultrasonic sensors and to remove them. This document refers to these ultrasonic echoes as fraudulent echoes. The method is thus a method for identifying fraudulent ultrasonic echoes and for removing the measurement data of these fraudulent ultrasonic echoes from the measurement data.

The ultrasonic sensor system preferably also applies the fallback to one ultrasonic sensor in channels 1 and 2 in order to recognize, in the very close range, obstacles that can only be sensed by one ultrasonic sensor. FIG. 22 symbolizes this area by the dashed bold line.

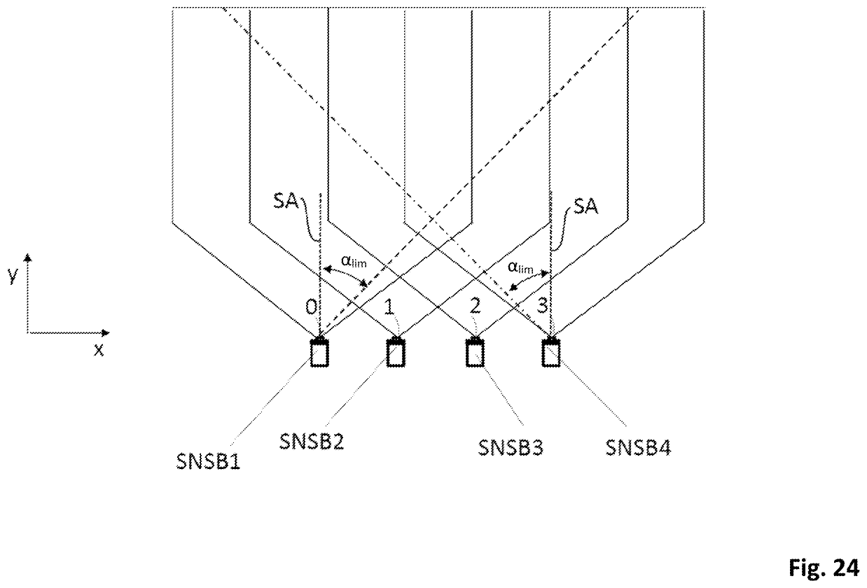

FIG. 24

FIG. 24 illustrates the prevention of false solutions without limiting the solution range for the outer channels, herein, by way of example, channels 0 and 3. The ultrasonic sensor system checks solutions based on measured values of the corresponding channels 0 and 3 for an angle α to the viewing axis SA of the associated ultrasonic sensor of the relevant channel.

The ultrasonic sensor system thus ascertains a possible position of an object O as solutions, for example based on measured values of the channel 0. The ultrasonic sensor system then determines, based on the possible position of the object O and the known position of the first ultrasonic sensor 0 of the first ultrasonic sensor board SNSB1, an angle α between the line from the known position of the first ultrasonic sensor 0 of the first ultrasonic sensor board SNSB1 to the possible position of said object O and the viewing axis SA of the first ultrasonic sensor 0 of the first ultrasonic sensor board SNSB1. If the value of this angle α between the line from the known position of the first ultrasonic sensor 0 of the first ultrasonic sensor board SNSB1 to the possible position of said object O and the viewing axis SA of the first ultrasonic sensor 0 of the first ultrasonic sensor board SNSB1 is less than the value of an angle αₗᵢₘ to this viewing axis SA of the associated ultrasonic sensor of the relevant channel, the ultrasonic sensor system does not discard the data of this possible position of the object O. If the value of this angle α between the line from the known position of the first ultrasonic sensor 0 of the first ultrasonic sensor board SNSB1 to the possible position of said object O and the viewing axis SA of the first ultrasonic sensor 0 of the first ultrasonic sensor board SNSB1 is greater than the value of an angle αₗᵢₘ to this viewing axis SA of the associated ultrasonic sensor of the relevant channel, the ultrasonic sensor system discards the data of this possible position of the object O.

The ultrasonic sensor system thus ascertains a possible position of an object O as solutions, for example based on measured values of the channel 3. The ultrasonic sensor system then determines, based on the possible position of the object O and the known position of the fourth ultrasonic sensor 3 of the fourth ultrasonic sensor board SNSB4, an angle α between the line from the known position of the fourth ultrasonic sensor 3 of the fourth ultrasonic sensor board SNSB4 to the possible position of said object O and the viewing axis SA of the fourth ultrasonic sensor 3 of the fourth ultrasonic sensor board SNSB4. If the value of this angle α between the line from the known position of the fourth ultrasonic sensor 3 of the fourth ultrasonic sensor board SNSB4 to the possible position of said object O and the viewing axis SA of the fourth ultrasonic sensor 3 of the fourth ultrasonic sensor board SNSB4 is greater than the value of a limit angle αₗᵢₘ to this viewing axis SA of the associated ultrasonic sensor of the relevant channel, the ultrasonic sensor system does not discard the data of this possible position of the object O. If the value of this angle α between the line from the known position of the fourth ultrasonic sensor 3 of the fourth ultrasonic sensor board SNSB4 to the possible position of said object O and the viewing axis SA of the fourth ultrasonic sensor 3 of the fourth ultrasonic sensor board SNSB4 is less than the value of an angle αₗᵢₘ to this viewing axis SA of the associated ultrasonic sensor of the relevant channel, the ultrasonic sensor system discards the data of this possible position of the object O.

The value of the angle α is thus signed in this sense. We assume a clockwise system here.

The motivation for this procedure is that practical measurements resulted in some false solutions without limiting the solution range for the channels 0 and 3. The laboratory prototype of the ultrasonic sensor system used in the development of the technical teaching of the document presented herein uses a value of 450 for the limit angle αₗᵢₘ.

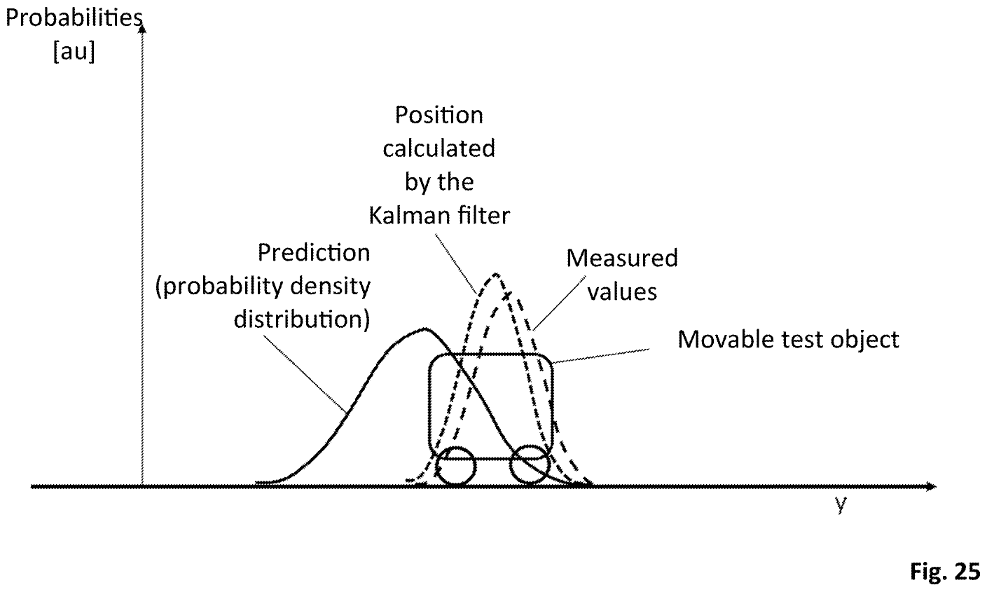

FIG. 25

visualizes how, according to the prior art, the Kalman filter and predicts the next state through the influence of the two parameters, the covariance R of the measurement noise and the variance value Q of the process noise.

FIG. 25 shows, by way of example, the measurement of a position of a vehicle or movable object. The solid curve in FIG. 25 symbolizes the probability density function (PDF) of the prediction by the ultrasonic sensor system carrying out the method for calculating a Kalman filter function. The long-dashed curve in FIG. 25 represents the probability density function (PDF) of the measurement by means of the ultrasonic sensors. In this scenario, the standard deviation of the measurement is lower compared to the prediction. This means that the parameter Q is higher than R. The short-dashed curve describes the resulting position that the ultrasonic sensor system calculates in the proposed method by calculating a Kalman filter function. As input parameters of the Kalman filter function, the ultrasonic sensor system uses the trilateration positions, calculated by trilateration, of the objects detected as potentially present. The curve results by multiplying the two other bell curves. Preferably, the ultrasonic echo system scales up this curve in order to obtain the integral value one as the standard value. The following two formulae describe the exact relationship between the parameter and the standard deviations of the bell curves:

$$R = {σ}_{meas}^{2} , Q = {σ}_{pred}^{2} - {P}_{k - 1}$$

R represents the square of the standard deviation, the variance. An iteration ascertains the coherence between Q and the prediction variance. A further iteration ascertains the resulting variance of the short-dashed curve of the calculated position using the following formula:

$${σ}_{result =}^{2} {σ}_{pred}^{2} - K * {σ}_{pred}^{2} .$$

FIG. 25 shows that the variance of the measurement and the prediction determine the filter behaviour. The filter output is closer to the value with a smaller distribution. This reduces the influence of interfering processes, such as wind or other ultrasound sources of other cars, or of complex surfaces on the measurement result. The Kalman filter of the ultrasonic sensor system obtains the information about the distributions through the parameters. A good choice of R and Q is therefore essential for the ultrasonic sensor system to function well /15/, /16/.

For the 1D system, the process noise variance Q could be equal to zero since there is no prediction through a system relationship. However, if Q is set to zero, the flexibility of “tuning” the filter decreases. One possible solution is therefore to set Q to a small value, such as 10⁻⁵, and to adjust R in order to obtain the desired filter performance. The behaviour of the Kalman filter of the ultrasonic sensor system, and in particular the method for ascertaining the amplification factor, depends on the ratio between Q and R. Therefore, the document presented herein recommends setting the measurement noise variance R first. The subsequent setting of the filter preferably uses the parameter Q.

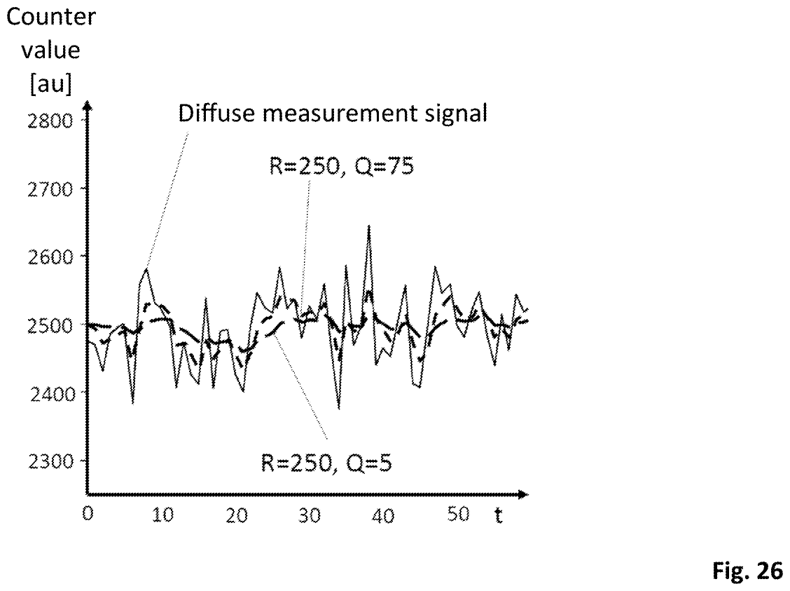

FIG. 26

FIG. 26 is used to compare two different exemplary filter parameters of the Kalman filter, which the ultrasonic sensor system typically realizes by carrying out a Kalman filter function.

FIG. 26 compares two different exemplary filter parameters. The solid line in FIG. 26 represents a distance measurement. The x axis is the time axis. The Y axis is the measured distance value of an object. The real distance signal for simulating the system is an object O in front of the ultrasonic sensor system with a constant real distance value of 2.5 meters between the object and the ultrasonic sensor system. This distance value is superimposed with a normally distributed noisy signal portion. The exemplary standard deviation of the noise signal is meas=50. R in this example is therefore defined as meas²=250. FIG. 26 shows the output of the exemplary Kalman filter of the ultrasonic sensor system for two different, exemplarily selected values of the Kalman filter parameter Q. The higher value of the Kalman filter parameter, here a value of 75 by way of example, results in a higher confidence of the ultrasonic sensor system in the values of the ultrasonic measurement. The short-dashed line with Q=75 and R=250 is therefore less smooth in comparison to the long-dashed line with Q=5 and R=250. In this example, a smaller value of the Kalman filter parameter Q is therefore preferably better for smoothing a measured value during a static measurement.

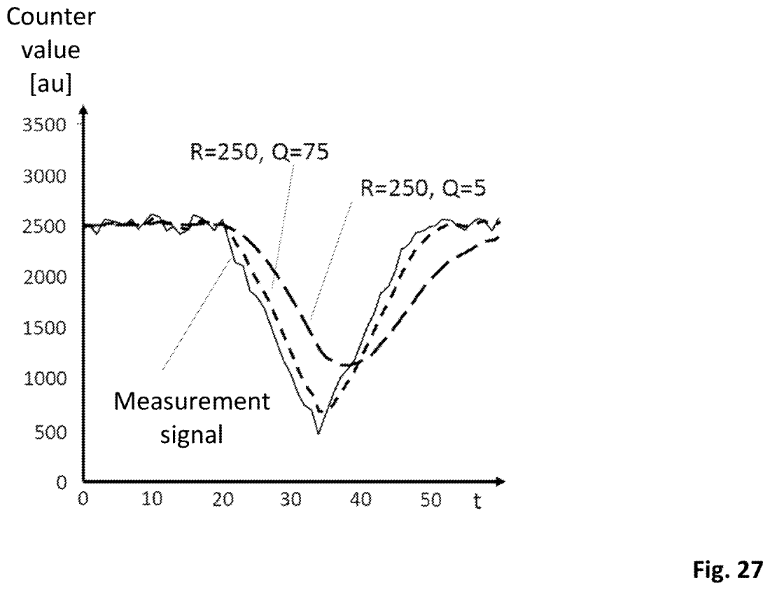

FIG. 27

FIG. 27 shows that the Kalman filter with the smaller Q cannot follow the dynamic portion of the measurement. However, FIG. 27 now applies the same parameters as FIG. 26 to a dynamic measurement. The standard deviation of the measurement signal is again 50 by way of example. The movement between the 20th and 50th iteration corresponds in the example of FIG. 27 to a velocity of ±2.67 m/s with an iteration increment of 50 ms.

FIG. 27 shows that the Kalman filter with the smaller Kalman filter parameter value Q cannot follow the dynamic portion of the measurement. The smaller the value of the Kalman filter parameter Q that the ultrasonic sensor system uses, the more iterations are necessary for the Kalman filter of the ultrasonic sensor system to follow the movements of the object whose position the ultrasonic sensor system is to ascertain. The Kalman filter requires information about the movements of the object in order to improve the filter behaviour in dynamic measurements. In the case of a parking system as an ultrasonic sensor system, the velocity of the car comprising the ultrasonic sensor system is to be included in the Kalman filter. For one-dimensional filtering, the speed of the car is configured as the input signal of the Kalman filter.

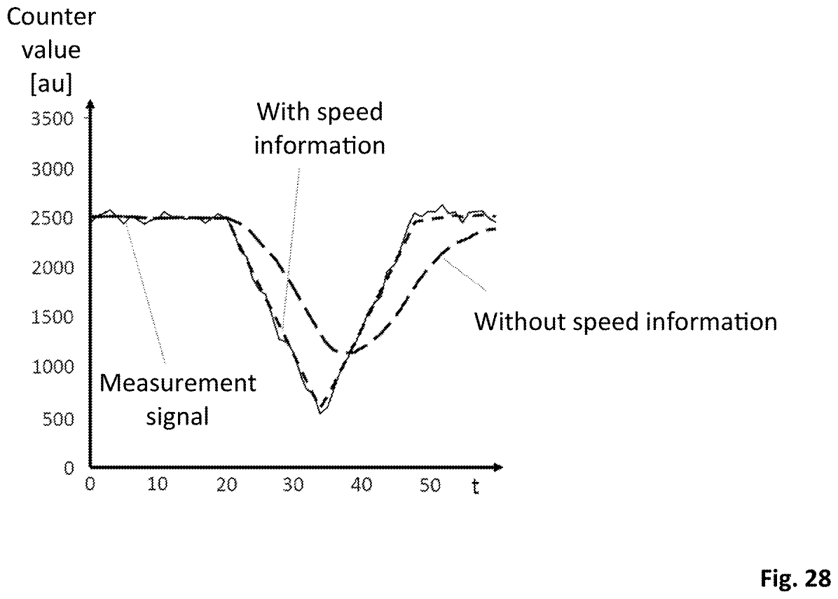

FIG. 28

FIG. 28 compares the output of the Kalman filter of the proposed ultrasonic sensor system with and without speed information. At this point, it is only mentioned for the sake of completeness that the Kalman filter in the sense of this document means a Kalman filter function that the ultrasonic sensor system, viz., preferably one of the aforementioned computers, carries out.

The long-dashed curve in FIG. 28 illustrates the Kalman filter without speed information. The short-dashed curve in FIG. 28 demonstrates the advantage of the speed input. By taking into account the speed information of the car, the exemplary Kalman filter of the ultrasonic sensor system does not require any iterations in order to follow the value, because the speed of the vehicle directly affects the calculation of the next state.

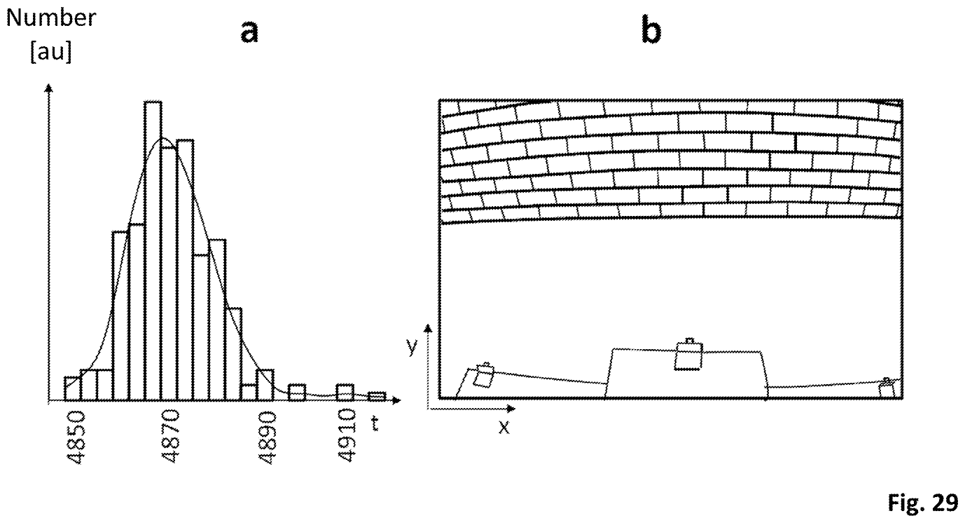

FIG. 29

FIG. 29 shows the distribution of the first ultrasonic echo of the first ultrasonic sensor 0 of the first ultrasonic sensor board SNSB1 during measurements of the ultrasonic sensor system via the channel 0 of the ultrasonic sensor system during an exemplary wall measurement.

The tests during the development of this document used the ultrasonic sensor system as an ultrasonic parking system. In this respect, the terms “ultrasonic sensor system” and “ultrasonic parking system” in this document are to be understood as being synonymous with one another. The exemplary laboratory system of the proposed ultrasonic sensor system used the Kalman filter to filter the ultrasonic echo signals of the ultrasonic sensor system after successful trilateration of the ultrasonic echoes and discarding of the apparently false positions of the recognized fraudulent objects. The input signals of the Kalman filter are thus the recognized object positions and the speed of the vehicle. Each cycle of the measurement consisted, by way of example, of 36 ultrasonic echoes:
1. The first ultrasonic echo of the first ultrasonic sensor 0 in the measurement by channel 0.
2. The second ultrasonic echo of the first ultrasonic sensor 0 in the measurement by channel 0.
3. The third ultrasonic echo of the first ultrasonic sensor 0 in the measurement by channel 0.
4. The first ultrasonic echo of the second ultrasonic sensor 1 in the measurement by channel 0.
5. The second ultrasonic echo of the second ultrasonic sensor 1 in the measurement by channel 0.
6. The third ultrasonic echo of the second ultrasonic sensor 1 in the measurement by channel 0.
7. The first ultrasonic echo of the third ultrasonic sensor 2 in the measurement by channel 0.
8. The second ultrasonic echo of the third ultrasonic sensor 2 in the measurement by channel 0.
9. The third ultrasonic echo of the third ultrasonic sensor 2 in the measurement by channel 0.
10. The first ultrasonic echo of the first ultrasonic sensor 0 in the measurement by channel 1.
11. The second ultrasonic echo of the first ultrasonic sensor 0 in the measurement by channel 1.
12. The third ultrasonic echo of the first ultrasonic sensor 0 in the measurement by channel 1.
13. The first ultrasonic echo of the second ultrasonic sensor 1 in the measurement by channel 1.
14. The second ultrasonic echo of the second ultrasonic sensor 1 in the measurement by channel 1.
15. The third ultrasonic echo of the second ultrasonic sensor 1 in the measurement by channel 1.
16. The first ultrasonic echo of the third ultrasonic sensor 2 in the measurement by channel 1.
17. The second ultrasonic echo of the third ultrasonic sensor 2 in the measurement by channel 1.
18. The third ultrasonic echo of the third ultrasonic sensor 2 in the measurement by channel 1.
19. The first ultrasonic echo of the second ultrasonic sensor 1 in the measurement by channel 2.
20. The second ultrasonic echo of the second ultrasonic sensor 1 in the measurement by channel 2.
21. The third ultrasonic echo of the second ultrasonic sensor 1 in the measurement by channel 2.
22. The first ultrasonic echo of the third ultrasonic sensor 2 in the measurement by channel 2.
23. The second ultrasonic echo of the third ultrasonic sensor 2 in the measurement by channel 2.
24. The third ultrasonic echo of the third ultrasonic sensor 2 in the measurement by channel 2.
25. The first ultrasonic echo of the fourth ultrasonic sensor 3 in the measurement by channel 2.
26. The second ultrasonic echo of the fourth ultrasonic sensor 3 in the measurement by channel 2.
27. The third ultrasonic echo of the fourth ultrasonic sensor 3 in the measurement by channel 2.
28. The first ultrasonic echo of the second ultrasonic sensor 1 in the measurement by channel 3.
29. The second ultrasonic echo of the second ultrasonic sensor 1 in the measurement by channel 3.
30. The third ultrasonic echo of the second ultrasonic sensor 1 in the measurement by channel 3.
31. The first ultrasonic echo of the third ultrasonic sensor 2 in the measurement by channel 3.
32. The second ultrasonic echo of the third ultrasonic sensor 2 in the measurement by channel 3.
33. The third ultrasonic echo of the third ultrasonic sensor 2 in the measurement by channel 3.
34. The first ultrasonic echo of the fourth ultrasonic sensor 3 in the measurement by channel 3.
35. The second ultrasonic echo of the fourth ultrasonic sensor 3 in the measurement by channel 3.
36. The third ultrasonic echo of the fourth ultrasonic sensor 3 in the measurement by channel 3.

The ultrasonic sensor system therefore filters these exemplary 36 ultrasonic echoes in separate Kalman filters. Since the ultrasonic sensor system generally executes these Kalman filters as programmes of a processor MCU of the ultrasonic sensor system, the ultrasonic sensor system thus typically carries out a plurality of methods, here, by way of example, 36 methods, executing a Kalman filter function.

According to the proposal, each of these Kalman filter functions that the ultrasonic sensor system carries out is to be associated with exactly one ultrasonic echo, for example the first ultrasonic echo or the second ultrasonic echo or the third ultrasonic echo, which is an input signal of the respective Kalman filter function from the set of the Kalman filter functions, here, by way of example, 36 filter functions, executed by the ultrasonic sensor system. 12 of the 36 ultrasonic echoes are first ultrasonic echoes.

The proposal presented herein is to limit filtering to these 12 first ultrasonic echoes in order to facilitate the evaluation and the testing of the Kalman filter functions. For example, prior to using the respective Kalman filter function of these 12 Kalman filter functions, the ultrasonic sensor system should check whether the ultrasonic echoes are normally distributed.

FIG. 29a shows the distribution of the first ultrasonic echo of the ultrasonic sensor 0 in a measurement via the channel 0 during an exemplary wall measurement.

The exemplary distribution of FIG. 29a contains 225 ultrasonic echoes. The mean value of the time between the emission of the ultrasonic burst by the first ultrasonic sensor 0 of the first ultrasonic sensor board SNSB1 is 4871 μs, corresponding to a distance of approximately 1.67 meters. The standard deviation is about 10 μs. FIG. 29a illustrates that the arrival times of the first ultrasonic echo of the first ultrasonic sensor 0 of the first ultrasonic sensor board SNSB1 in the ultrasonic echo signal are substantially normally distributed. In the course of the development of the technical teaching of this document, other measurements also revealed that the arrival times of the various ultrasonic echoes of the various ultrasonic sensors in the respective ultrasonic echo signals of the respective ultrasonic sensors are likewise substantially normally distributed. The ultrasonic sensor system can therefore generally apply the Kalman filter functions for filtering the object coordinates. By the way, it is not absolutely necessary for the ultrasonic sensor system to check the normal distribution of these data. The ultrasonic sensor system can but does not have to do this during operation. Experiments have shown that the quality gain is very low.

FIG. 29b shows the measurement situation underlying FIG. 29a.

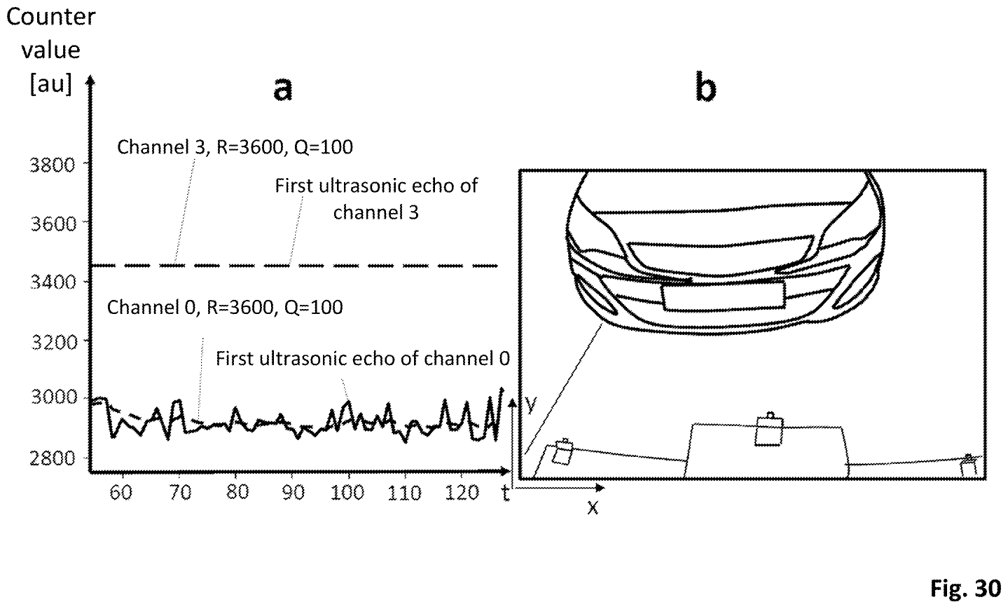

FIG. 30

FIG. 30 illustrates that the configuration of the parameters for the Kalman filter function depends on the ultrasonic echo signal because the standard deviation of the ultrasonic echoes differs in the case of different surfaces and different environments, wherein the exemplary illustration in this document takes place using the example of a simulation of a parking situation, which results in significant differences in the standard deviation, for example. FIG. 30 shows the first ultrasonic echo of the second ultrasonic sensor 1 during a measurement via channel 1 and the first ultrasonic echo of the fourth ultrasonic sensor 3 during a measurement via channel 3. The ultrasonic sensor system filters the first ultrasonic echo of the second ultrasonic sensor 1 by means of a first Kalman filter function. The ultrasonic sensor system filters the first ultrasonic echo of the fourth ultrasonic sensor 3 by means of a second Kalman filter function. The parameters of the first Kalman filter function and of the second Kalman filter function are, by way of example, the same in the example of FIG. 30.

The arrival times for the ultrasonic echo that the ultrasonic sensor system ascertains by means of a measurement and trilateration via the channel 3 have a standard deviation of 10 μs.

The arrival times for the ultrasonic echo that the ultrasonic sensor system ascertains by means of a measurement and trilateration via the channel 0 have a standard deviation of 63 μs.

The example of FIG. 30, by way of example, uses the Kalman filter parameter Q with the value 100.

The example of FIG. 30, by way of example, uses the Kalman filter parameter R with the value 3600. Such a high Kalman filter parameter R of R=3600 corresponds to about a variance in the arrival time of the first ultrasonic echo via channel 0 of 0. FIG. 30 shows that the distributions of the arrival times of the ultrasonic echoes differ in the same scenario. For static measurements, the Kalman filter parameters could, for example, be selected parameters taking into account the ultrasonic echo with the greatest spread. In comparison, filtering dynamic measurements have the already explained problem of following the measured value. The integration of the speed of the vehicle would improve the behaviour of the dynamic filter. However, this integration would not provide the proper ultrasonic echo signal in many parking situations. One problem is that the speed of the vehicle does not represent the change of the echo path in every situation. For example, if the car parks at a slow speed and the driver quickly steers in one direction. In this case, the signal would change very quickly because it would get ultrasonic echoes from obstacles that were previously not within the range of the ultrasonic sensor. The same problem occurs when the vehicle measures a wall and a pedestrian walks between the wall and the vehicle. The parameters of the Kalman filter functions must be adjusted in order to correctly recognize dynamic ultrasonic echoes.

In the example of FIG. 30, channel 3 spreads so little that the authors have drawn only one common line for the sake of simplicity.

FIG. 30b shows the intake situation of the measurement data.

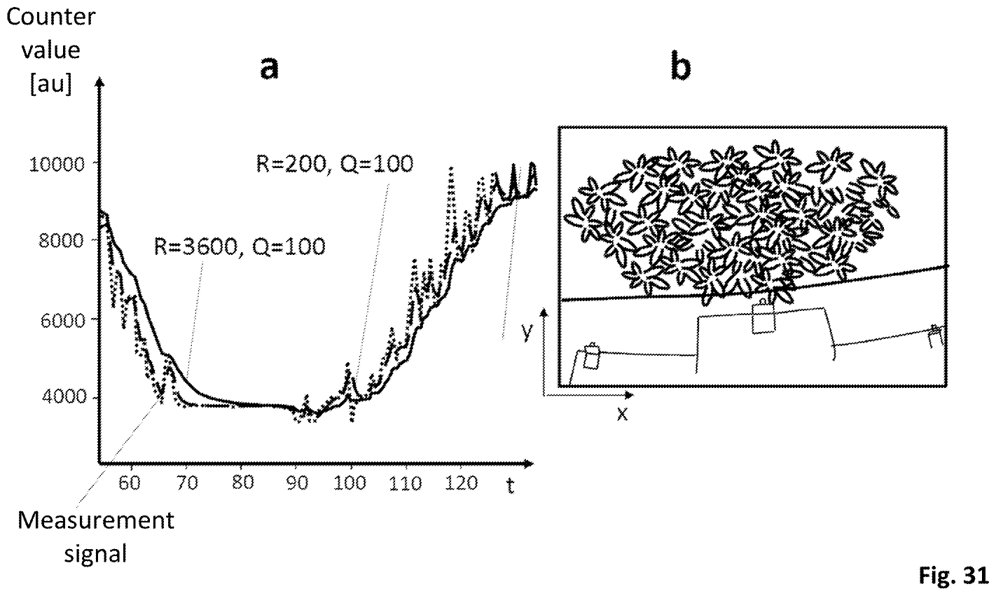

FIG. 31

FIG. 31 compares two different Kalman filter parameters R by a dynamic measurement using the example of a plant as the object O. The recognized obstacle in this scenario of FIG. 31 is the plant depicted. The drawing is based on an image taken in the 100th cycle. The irregular surface of the plant results in very high spread of the ultrasonic echo signal. As a result of the measurement set-up, the speed of the vehicle was not available. It was therefore not integrated into the system description for this measurement.

The diagram shows two different choices for parameter R. The first Kalman filter (solid line) smoothes the curve better. In comparison, the second Kalman filter (dashed line) follows the measurement faster. The maximum speed of the measurement shown is about 0.3 m/s. A measurement at a higher speed would increase the difference between the two curves. The fact that parking situations are dynamic measurements resulted in the application of the exemplary parameters Q=100 and R=200 in the preliminary tests in the development of the technical teaching of this document. The quick response to a changing environment is more important than the smoothing of the curve.

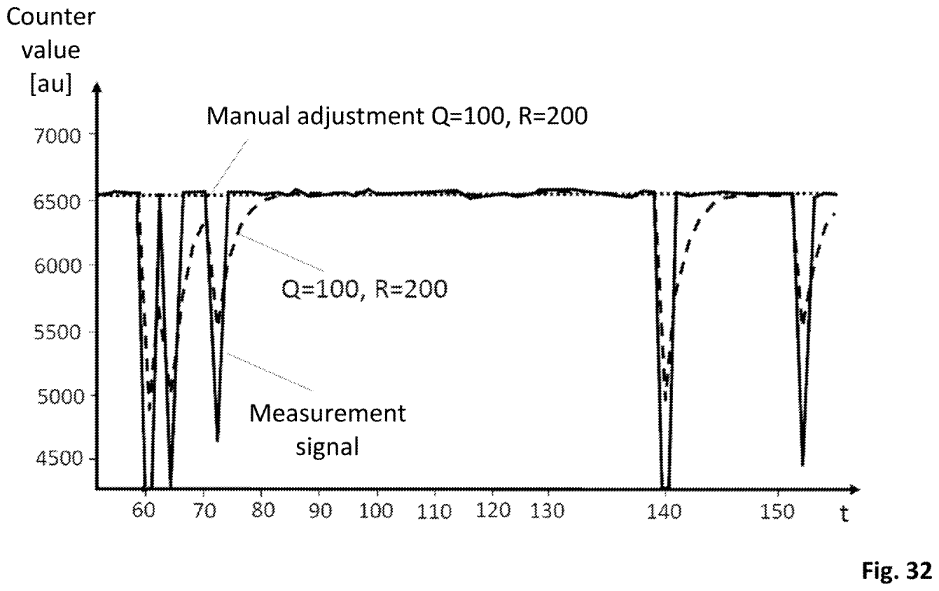

FIG. 32

FIG. 32 shows an exemplary ultrasonic echo signal of an exemplary static measurement in which the Kalman filter is extended by a manual query in order to improve the noise behaviour.

A manually defined query extends the Kalman filter functions used by the ultrasonic sensor system. The aim is to improve the noise behaviour. FIG. 32 illustrates this. FIG. 32 shows an ultrasonic echo signal of a static measurement. A noise sensor of a fifth ultrasonic sensor board SNSB5 (see FIG. 12) operates as a noise sensor and affects the measured value (solid line) via radiated noise in the ultrasonic range. The dashed line represents the output of the standard Kalman filter of FIG. 31. Due to the Kalman filter parameters, the Kalman filter function modified by the manual query responds quickly to refreshed values. The dotted line in FIG. 32 shows the result of such a manually inserted query in the Kalman filter function.

The ultrasonic sensor system carries out this manually introduced query when executing the Kalman filter function immediately prior to the start of the execution of the Kalman filter function. This is essentially a plausibility check of the input data of the Kalman filter, i.e., of the Kalman filter function. The ultrasonic sensor system preferably performs this plausibility check. For example, the plausibility check may be an “if” instruction that the ultrasonic sensor system executes with trilateration values prior to supplying the Kalman filter with trilateration data. Preferably, the ultrasonic sensor system uses this plausibility check, for example, to eliminate a noise value in the data stream of the trilateration values. For example, the exemplary “if” instruction serving as a plausibility check cannot accept a value for the arrival time of the relevant ultrasonic echo and feed it into the Kalman filter that is higher than the last value plus 1400 μs. The limit for this query results from the assumption of the maximum system dynamics and must be ascertained empirically through tests in an application-specific manner. According to this assumption, the maximum speed of an object in the parking space or the speed of the car is 2 m/s. Speeds above this limit can therefore be eliminated. Using the proposed ultrasonic sensor system, the parking system should be able to recognize obstacles at lower speeds. The plausibility check in the form of the manual query can be calculated by the ultrasonic sensor system as follows:

$$Δ {e}_{max} = {\underbrace{120 ms}}_{cycle time} * {\underbrace{2 \frac{m}{s}}}_{{v}_{max}} * {\underbrace{\frac{1}{343 \frac{m}{s}}}}_{{v}_{us}} * {\underbrace{2}}_{ways} = 1400 µs .$$

The formula calculates the maximum difference of an ultrasonic echo signal per cycle. If the measured value for the speed is greater than the last measured value for the speed plus 1400 μs, the current value for the arrival time of the ultrasonic echo is replaced by the last valid value for the arrival time of the ultrasonic echo of the relevant channel of the relevant ultrasonic sensor since the ultrasonic sensor system must assume that it is a faulty measurement. That is to say, the proposed ultrasonic sensor system is characterized in that it firstly uses a Kalman filter in the form of a Kalman filter function executed by the ultrasonic sensor system, in order to filter at least the ultrasonic reception signal of at least one ultrasonic sensor, and in that the ultrasonic sensor system performs a plausibility check of the input values of the Kalman filter, and in that the ultrasonic sensor system replaces input values of the Kalman filter that are not plausible with old, plausible values.

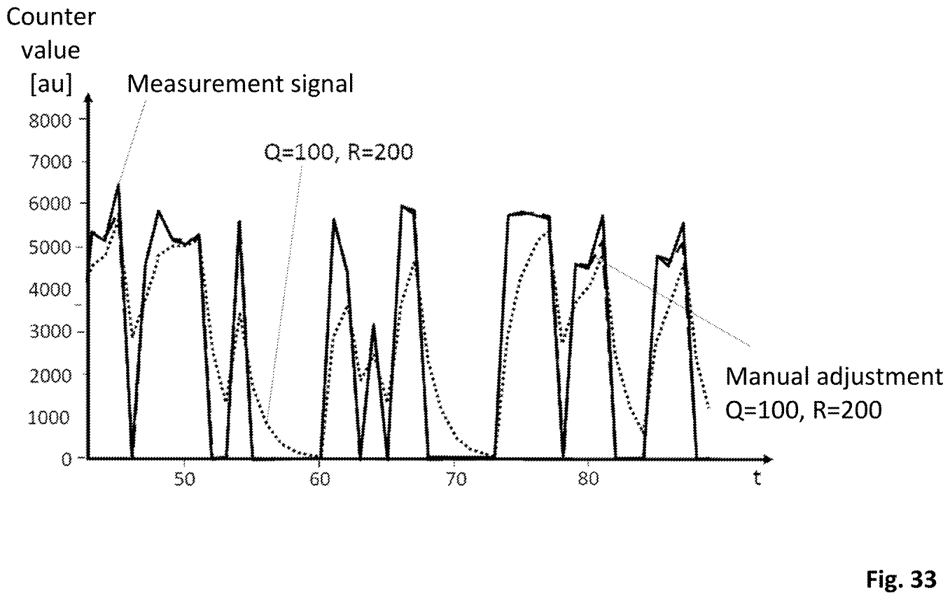

FIG. 33

FIG. 33 shows, by way of example, an unstable echo during a dynamic measurement of the plant obstacle of FIG. 31. Optimisation is also necessary here. A further manual query in the plausibility check to improve the filter behaviour can prevent the jump of the value of the arrival time of the ultrasonic echo between a valid temporally preceding ultrasonic echo value and a subsequent missing ultrasonic echo value, i.e., no recognized ultrasonic echo. Obstacles, such as the plant object (FIG. 31), can result in very unstable echoes. The ultrasonic sensor is then not able to recognize an ultrasonic echo in each cycle. One way to handle this situation is for the ultrasonic sensor system to set the current value to the maximum measurement time of the profile. In the tests for the development of the technical teaching of this document, this value was, by way of example, 14.58 ms for profile A. However, this would result in additional solutions by such a method with such a plausibility check. Each cycle without solution would provide solutions through the maximum values of the echoes. In order to enable these additional solutions, the laboratory prototype of the proposed ultrasonic sensor system set the echo values to zero.

The solid line shows the measurement signal in FIG. 33. The dotted line shows the signal of the Kalman filter without plausibility check. The dashed line shows the signal with plausibility check. The difference of the measurement signal to the Kalman filter output signal with plausibility check is very small.

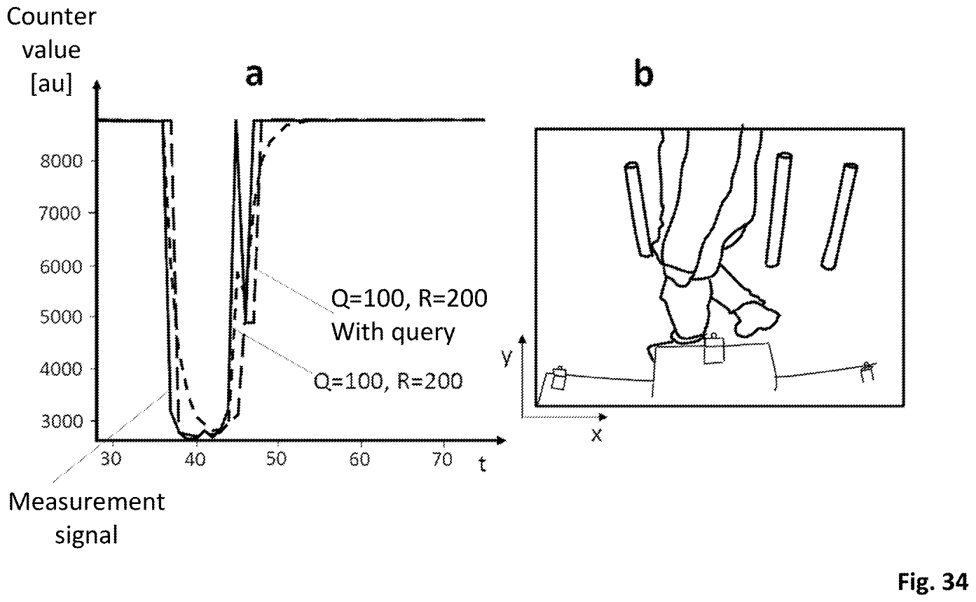

FIG. 34

FIG. 34 illustrates a scenario in which the ultrasonic sensors measure four post obstacles and a pedestrian passes between the posts and the sensors while the vehicle does not move, wherein FIG. 34a shows the 40th cycle of the measurement and the first ultrasonic echo of the second ultrasonic sensor 1 in a measurement via channel 1, and FIG. 34b illustrates the measurement situation.

A further manual adjustment of the Kalman filter is thus preferably a further query for jumping values for the arrival time of the ultrasonic echo. The problem of jumping between echo values and zero also occurs between two echo values.

The value of the ultrasonic echo signal jumps in the time curve in the time period between approximately 9000 μs and 3000 μs. The regular Kalman filter (short-dashed line) requires a plurality of iterations in order to follow the measurement. In comparison, the Kalman filter with a suitable query jumps to the measured value after a delay of one iteration. (long-dashed line) This delay occurs due to the noise filtering. The first value with a greater change than Δeₘₐₓ(1400 μs) is interpreted as noise. After a noise value, the manual query checks whether the current measured value deviates by more than Δeₘₐₓ relative to the last predicted value. If this is true, the current measured value replaces the current predicted value. If this is not true, the Kalman filter outputs the value predicted by the Kalman filter. The query is activated three times during the example of this scenario of FIG. 34. The first time in the 38th iteration when the echo signal drops to a lower value. The second and third times in the 46th and 48th iterations. The query is activated two times as the pedestrian leaves the sensor area. This happens because the echo switches twice between the posts and the pedestrian. Two measured values belonging to the posts are thus interpreted as noise. This ultimately causes two accepted jump values.

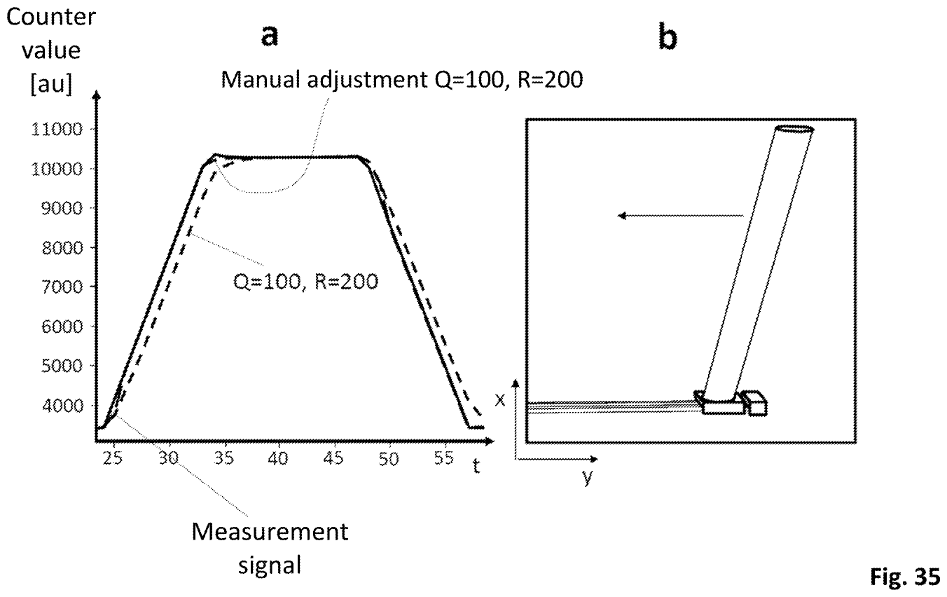

FIG. 35

FIG. 35a shows the ultrasonic echo of the second ultrasonic sensor 1 in channel 1 during the measurement of a post moving on a rail by means of a controllable carriage (FIG. 35b).

The last manual part of the Kalman filter implemented in the preliminary tests with a query for the plausibility check of the trilateration data is switching off and working around the Kalman filter if the dynamics are too high. In comparison to echo jumps as a result of object changes, this part deals with rapid echo changes without object change. These changes may be caused by a high speed during parking or by obstacles that move in the area of the ultrasonic sensor. In order to simulate this scenario at a defined speed, the ultrasonic echoes were measured in an ultrasonic laboratory during the preliminary tests. A post mounted on a rail could be moved at constant speeds. The maximum speed was 1 m/s. FIG. 35 shows the ultrasonic echo of the ultrasonic sensor 1 in a measurement via channel 1 during the measurement of a moving post. The post moved at a constant speed of 1 m/s toward the viewing axis SA of the ultrasonic sensors, the viewing axis being vertical relative to the respective ultrasonic sensor board on which the respective ultrasonic sensors were mounted.

First, the post moves away from the sensors. Thereafter, the position remains constant for approximately 15 cycles. At the end, the post returns to the start position. FIG. 35a compares the normal Kalman filter to a manual Kalman filter with an adjusted upstream plausibility check as the manual filter. The manual Kalman filter deactivates the filtering of the echo signal if the speed is greater than v_{filter_max}. Based on the measurements of the exemplary posts and other dynamic measurements, the choice of the maximum speed was v_{filter_max}=0.75 m/s in the preliminary tests for the development of the technical teaching of this document.

In this example, the selected maximum speed results in a maximum echo difference of:

$$Δ {e}_{filter \_ max} = {\underbrace{120 ms}}_{cycle time} * {\underbrace{0.75 \frac{m}{s}}}_{{v}_{filter \_ max}} * {\underbrace{\frac{1}{343 \frac{m}{s}}}}_{{v}_{us}} * {\underbrace{2}}_{ways} = 525 µs \approx 500 µs$$

The plausibility check performed by the ultrasonic sensor apparatus deactivated the Kalman filter if the signal of the value of the arrival time of the relevant ultrasonic echo changed by more than Δe_{filter_max} or by Δe_{filter_max} in two consecutive iterations.

A first jump therefore does not result in a deactivation since it could also be a noise signal. If the signal of the value of the arrival time of the relevant ultrasonic echo jumps in the second iteration, the current predictive value is replaced with the current measured value of the value of the arrival time of the relevant ultrasonic echo.

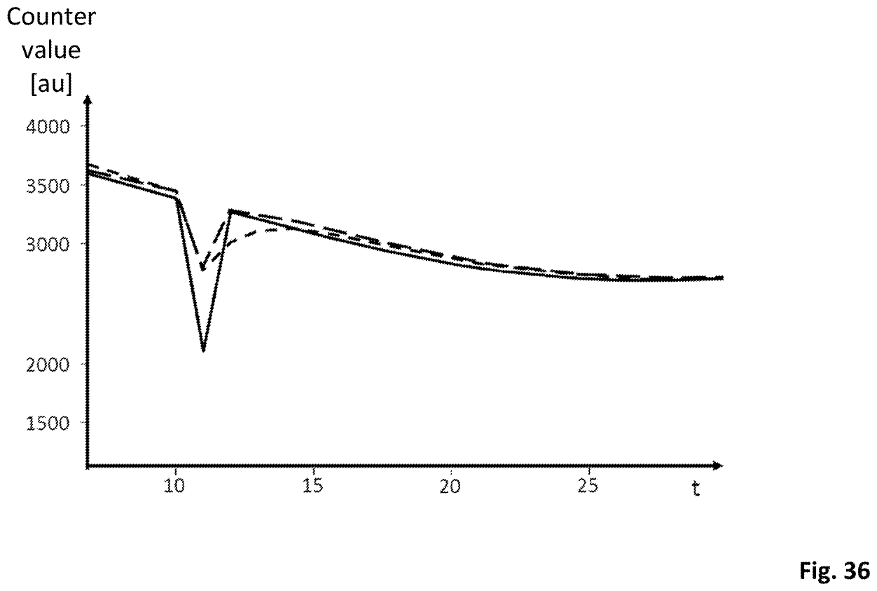

FIG. 36

shows the improvement of the noise behaviour as a result of a speed query.

A further positive effect of the query of FIG. 35 is improved robustness against a noisy interferer. In the example of FIG. 36, a noise sensor affects the measured signal of the values of the arrival times of the ultrasonic echoes. This noise sensor causes a signal jump of the measurement signal of the values of the arrival times of the ultrasonic echoes of an ultrasonic sensor in the 11th cycle. The difference between the noise value and the actual value is less than Δeₘₐₓ(1400 μs). The plausibility check of the Kalman filter therefore does not interpret the value as noise. The regular Kalman filter responds to this jump and requires some iterations in order to return to the real value. In comparison, the manual filter jumps directly back to the real measured value. This happens because the signal jumps in the first iteration to the noise and returns to the real value in the next iteration. As a result, the plausibility check of FIG. 35 registers two jumps, and the ultrasonic sensor system deactivates the relevant Kalman filter of the relevant ultrasonic sensor in the second iteration.

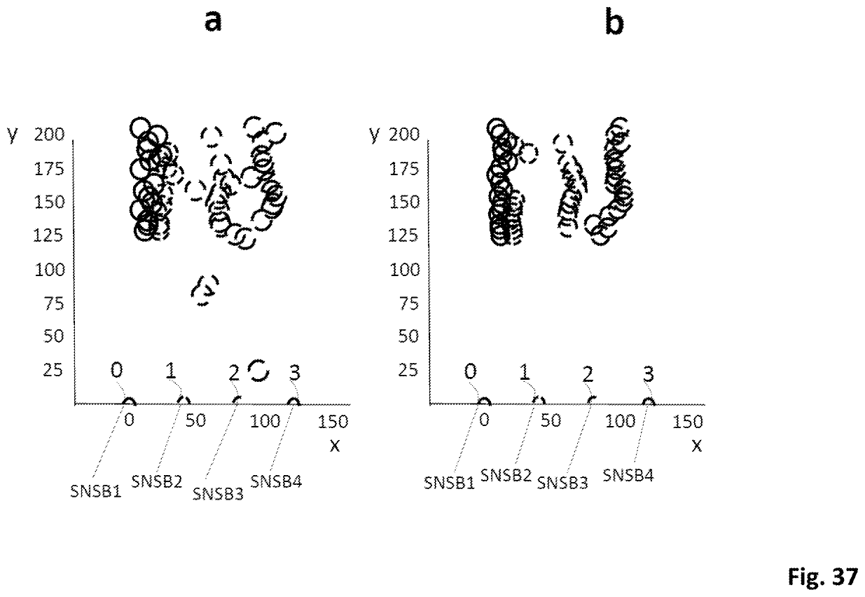

FIG. 37

compares the solutions without and with Kalman filtering. The aim of filtering echo signals is to positively influence the resulting 2D positions. Better noise behaviour and smoother positions with lower spread are intended. All manual parts of the Kalman filter, i.e., the functions that serve the plausibility check, are activated. The parameters are set to their default values (Q=100, R=200). The solutions are among the first echoes of the dynamic wall measurement. An additional noise sensor intentionally interferes with the measurement in order to demonstrate the performance capability of the system. FIG. 37 shows the last 25 solutions of each channel in order to illustrate the course of the solutions. It is clear that the path of the solutions is smoothed by the application of the Kalman filter. Moreover, two interference values of channel 2 and one interference value of channel 3 are eliminated.

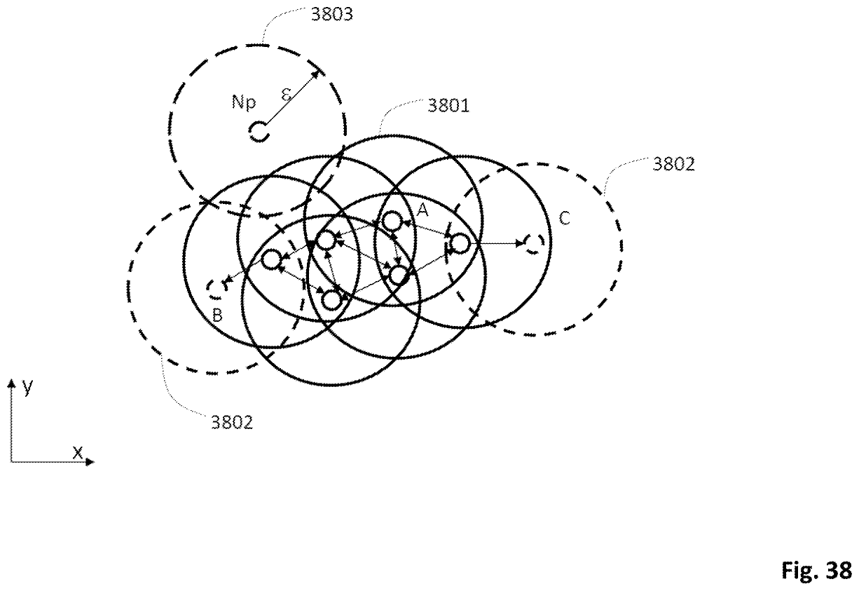

FIG. 38

shows the difference between “core values” and “non-core values” of the DBSCAN method. The DBSCAN method determines, in the 2D plane of the map of the surroundings of the vehicle, the clusters by taking into account the density of the 2D data points. The distances between the data points are calculated for this purpose. The data points are typically present as x/y coordinates from the trilateration of the ultrasonic echoes of the ultrasonic sensors for the measurements via the various channels, here, by way of example, four channels. The method distinguishes between “core values” and “non-core values”. They could also be referred to as core-object positions and non-core-object positions. FIG. 38 shows the difference between these two. The points A in FIG. 38 with uninterrupted circles represent the core values of an exemplary cluster serving only for explanation purposes. By way of example, one point is provided with reference sign A. For the sake of clarity, reference sign A is omitted for the other points with a solid circular line. The points B with short-dashed circles belong to the cluster but not to the core of the cluster. One such point B is, by way of example, provided with reference sign B. For the sake of clarity, reference sign B is omitted for the other dots with a short-dashed circular line. The exemplary single point Np with a long-dashed circle is interpreted by the ultrasonic sensor system as noise. One such point Np is, by way of example, provided with the reference sign Np. The respective circle 3801, 3802, 3803 around an associated respective data point A, B, Np as the circle centre point of this respective circle 3801, 3802, 3803 visualizes a threshold distance E which is a parameter of the method. In the example of the figure, this threshold value distance E is drawn once, by way of example, for the point with reference sign N and not drawn for the other points A, B for the sake of clarity. All points A, B having a distance less than this threshold distance s from a point are neighbouring points of this point to which their distance is less than this threshold value distance s. All points having a distance greater than this threshold distance s to this point are not neighbouring points of this point. The circle with the distance threshold value s as the radius around a point is hereinafter referred to as the distance circle of this point. The other parameter is the inPts parameter. This parameter defines the minimum number of data points of a cluster that should be within the distance circle of a point in order to interpret this point as a member of this cluster. FIG. 38 shows a scenario with the parameter minPts=3 or minPts=4. Each data point, i.e., each point A, with a solid circular line as a border has three different values within its distance circle 3801. The distance circle 3801 is also referred to as the neighbourhood of the data point A. The points B, C with a short-dashed circular line as the distance circle 3802, 3803 have only one further point in their neighbourhood. They are therefore not a core value of the cluster. However, these points B, C still belong to the cluster as non-core values since the neighbours of the points B, C with a short-dashed circular line belong to the core values. The point Np with the long-dashed circular line and the distance circle 3803 has no points A, B, C neighbours in its neighbourhood in the form of its distance circle 3803 and is interpreted as a noise value /19/. The arrows between the points symbolize the distances that are relevant for evaluating whether the point pairs have a distance from one another of less than or greater than the threshold value distance E.

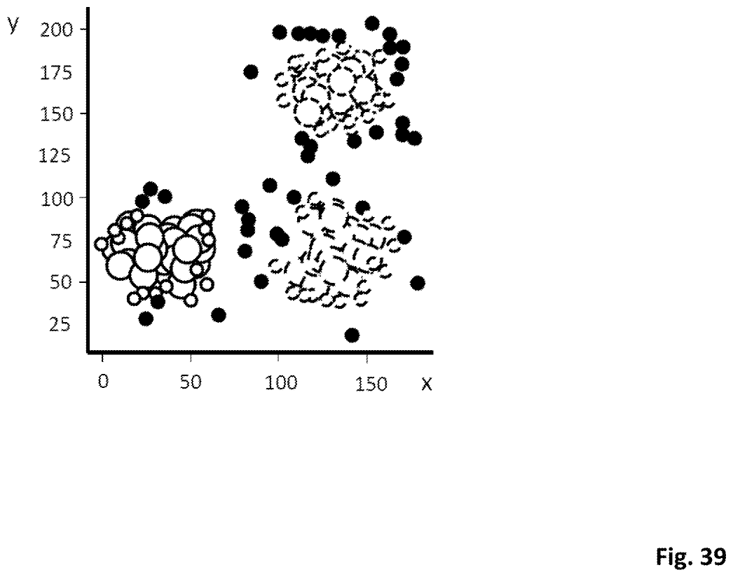

FIG. 39

shows an exemplary output of the DBSCAN method based on generated data, in order to illustrate the provision of different clusters as a function of the selected parameters. The DBSCAN method uses the trilateration data as input values. The DBSCAN method provides different clusters depending on the parameters selected. FIG. 39 illustrates the output of the method based on the data generated by way of example. The method divides the exemplary data into three exemplary clusters. It DBSCAN method associates the values with a cluster by storing them with a cluster label. Furthermore, the method distinguishes between core and non-core values. Core values are visualized with larger points than non-core values are.

The parameters of this representation were set to minPts=10 and E=0.3. The black points visualize the noise values /19/.

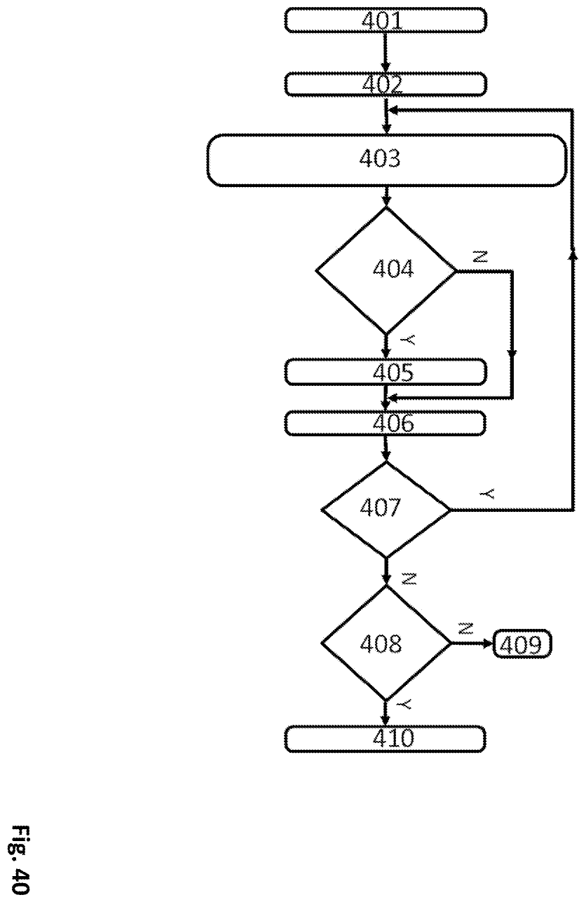

FIG. 40

shows the flow chart of the new, proposed clustering method. The method steps of this clustering function are performed after the trilaterations.

In step 401, whenever there is a solution of trilateration in the form of an x/y location coordinate (sol) of a solution point in a channel, the ultrasonic sensor system calls the function of the clustering method with this solution as the parameter (sol). In step 402, the ultrasonic sensor system first initializes the cluster index k with, for example, 0 and the counter of the number of neighbouring points within the neighbourhood of the solution point with 0. Thereafter, in step 403, the ultrasonic sensor system calculates the square of the distance between the solution and the first element of the cluster array, i.e., a first solution point already known. The cluster array contains the last solutions in the form of the x/y coordinates of the solution points. Each of the already known solution points is preferably associated with a cluster index, which indicates to which cluster it belongs. Preferably, there is an index value for such solution points that could not yet be associated with a cluster. The default value used in the development of the method for the array size is 25, which means that the method forms clusters based on the last 25 points. However, this value is arbitrary and may therefore deviate. However, it has proven to be expedient. In step 403, using the method, the ultrasonic sensor system calculates the square of the distance between the current solution in the form of a current x/y coordinate and the x/y coordinate of the element of the cluster array just set via the index k. Thereafter, in step 404, the ultrasonic sensor system compares the thus ascertained distance square with the square 2 of the threshold value distance ε defining the neighbourhood. The idea of using the square of the distance and the square² of the threshold value distance s is that there is thus no need to elaborately calculate a square root in order to ascertain the correct distance. The square² of the threshold value distance s may be pre-calculated here prior to applying the method. If the distance between the current solution and the cluster array element is less than the threshold value distances, the method that the ultrasonic sensor system performs follows the path marked “Y” and the ultrasonic sensor system increments the counter of the number of neighbours in step 405. Then, the ultrasonic sensor system increments the index in step 406, and the calculation starts again with step 403 with the next element of the cluster array. For this purpose, in step 407, the ultrasonic sensor system checks whether all distances between the current solution and each element of the cluster array have been checked. If this is the case, the method follows the path marked with an “N”. If this is not the case, as already described, the ultrasonic sensor system starts the calculation again with step 403 with the next element of the cluster array. However, if the distances between the current solution and each element have been checked, the ultrasonic sensor system compares the number of neighbours with the exemplary threshold value parameter minPts in step 408. For example, for minPts=3 in the laboratory prototype used for the development of the proposal, the exemplary ultrasonic sensor system accepts the solution in step 408 if there are two or more neighbours as two or more solutions having a distance less than the threshold value distance s. Such a solution is an accepted solution. Where applicable, the ultrasonic sensor system marks such an accepted solution within the cluster array in step 410 as an accepted solution, for example by means of a flag. If there is only one neighbour, the ultrasonic sensor system again follows the path marked “N” to step 409 and, using the method, preferably generates a boolean true-noise value, which is associated with this solution currently being processed and which marks this solution as noise. Before the ultrasonic sensor system generates this boolean as part of the method, the ultrasonic sensor system adds the current value to the cluster array for the next call of this sub-method of the clustering.

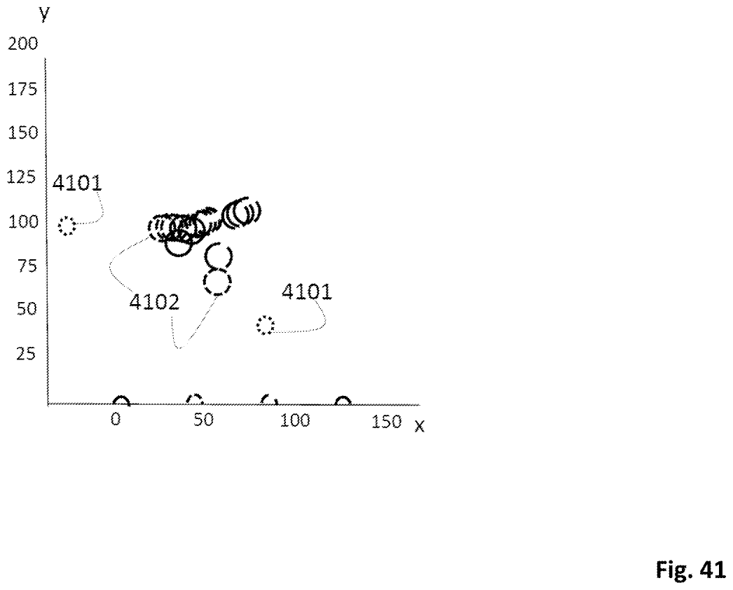

FIG. 41

FIG. 41 shows an exemplary output of the clustering method, wherein the visualized solutions belong to a static vehicle measurement (FIG. 30) and a fifth noise sensor interferes with the measurement. The clustering method carried out by the ultrasonic sensor system used a neighbourhood with a threshold value distance of ε=50 cm in the development of the proposal in order to be able to handle high speeds. The size of the cluster array here was, by way of example, 25 entries of solutions, i.e., x/y coordinates. In the example of FIG. 41, the minimum number of solutions for forming a cluster was 3 (minPts=3) as a possible exemplary value. The noise values of the method are marked by dotted circles 4101. In FIG. 41, two noise values 4101 are shown by way of example for the sake of clarity. Two other false solutions 4102 (channel 1 and channel 3) represented by circles with dashed circular lines are not filtered by the clustering method.

In static scenarios, similarly to the Kalman filter, the filter operates without delay. In dynamic scenarios, the filter requires iterations in order to accept new solutions. The scenario of the moving pedestrian (FIG. 34) is only one example in this respect. Depending on the minPts parameter, the method interprets the first values of new objects as noise. For minPts=3, the first two solutions, which can be attributed to the entry of the pedestrian, are not accepted since the cluster requires three solutions. The worst case for minPts=3 is when only one channel recognizes the pedestrian. This causes a delay of two cycles.

FIG. 42

FIG. 42 illustrates the reduction in the spread of the 2D positions by the Kalman filter, which may still provide incorrect 2D positions, and that the manual parts enable the filtering of noise values and the rapid following of the measurement. FIG. 42 visualizes an exemplary dynamic wall measurement in which the method applies a Kalman filtering and then a clustering to the ultrasonic echoes of the trilateration. The left visualisation (FIG. 42a) shows solutions during the exemplary measurement, wherein an exemplary false solution is produced by the application of the Kalman filter and the clustering method filters out this solution.

FIG. 42 illustrates, by way of example, that there are also scenarios resulting in false solutions through the Kalman filter.

Both visualisations FIG. 42a and FIG. 42b belong to of a dynamic wall measurement. The ultrasonic sensor system first applies a Kalman filtering to the ultrasonic echoes from the preceding trilateration. In the example of the implementation in the development of the proposal, the exemplary ultrasonic sensor system used the 36 combinations of a) first, second, or third ultrasonic echo of b) the first, second, third, or fourth ultrasonic sensor, wherein c) the first, second, third, or fourth ultrasonic sensor transmitted, and wherein two further ultrasonic sensors, which only received, were associated with each of these four channels. In a third processing stage, the exemplary ultrasonic sensor system of the laboratory prototype applied the clustering described above. The left visualisation in the form of FIG. 42a shows solutions during the measurement. A false solution (dotted circle at the bottom right) is created by the application of the Kalman filter. The clustering method filters this solution. It is therefore drawn as a dotted circle at the bottom right. FIG. 42b shows a few cycles of the first ultrasonic echo of the ultrasonic sensor 3 in channel 3, which is the reason for the false solution of the Kalman filter (dotted circle in FIG. 41a). The measured ultrasonic echo has two noise signals in three consecutive cycles. The ultrasonic sensor system does not interpret the first jump (cycle=174) as noise because the jump is less than Δeₘₐₓ=1400 μs. However, the return jump (cycle=175) to the real value is misunderstood by the ultrasonic sensor system as noise. The ultrasonic sensor system therefore interprets the third jump (cycle=176) to the noise signal as a valid event and the jump back to the measurement (cycle=177) as noise. This misinterpretation of the ultrasonic sensor system results in the 2D point drawn as a dotted circle in FIG. 42a at the bottom right. The solution results from the fallback to a one-sensor scenario. The trilateration finds no solution for the first ultrasonic echo in cycles 176 and 177. The example illustrates the advantage of applying the clustering method to 2D solutions. The disadvantage of applying the method is that the solutions are delayed in rapidly changing environments. Selecting the parameter minPts=2 could result in a delay of one cycle.

In general, three reasons for a delayed filter output are to be distinguished. The first is the delay produced by the trilateration method. For example, if a pedestrian moves from the right to the left side. Channel 3 would recognize the pedestrian in the first cycles. However, if the pedestrian moves into the area of channel 3 after ultrasonic sensor 3 has transmitted and received its echoes, the first solution for the pedestrian would be delayed by the runtime of the first three channels. With a cycle time of 120 ms and a channel delay of 30 ms, this delay would be about 90 ms. The second delay that would occur in the pedestrian scenario is the delay caused by the Kalman filter. The first jump would be interpreted as noise in the first cycle. The third delay is caused by clustering, depending on the selection of the parameters minPts. The following equation summarizes the three different delays:

$${Delay}_{max} = {\underbrace{{t}_{ch}}}_{trilateration} + {\underbrace{{t}_{cycle}}}_{Kalman} + {\underbrace{( min Pts - 1 ) * {t}_{cycle}}}_{clustering}$$

Assuming the worst timing of the pedestrian and a clustering parameter minPts=2, the delay would be 330 ms. The requirement of the system for a maximum response time of 500 ms is thus ensured.

The practical measurements taken in the preliminary tests to develop this proposal demonstrate the best filter behaviour when, in the signal path, the ultrasonic sensor system first applies a Kalman filter to the results of the trilateration method and thereafter, in the signal path, the ultrasonic sensor system applies the clustering method, in particular with the parameters of FIG. 42.

### LIST OF REFERENCE SIGNS

0 first ultrasonic sensor;
1 second ultrasonic sensor;
2 third ultrasonic sensor;
3 fourth ultrasonic sensor;
401 starting the clustering method with a solution of the trilateration in the form of an x/y location coordinate (sol) of a solution point as input parameter;
402 initialising, by the ultrasonic sensor system, the cluster index k and the counter of the neighbours of the solution point;
403 distance calculation. For example, the distance calculation may take place using the simple formula of Pythagoras:

$${distance [ k ]}^{2} = {( {x}_{sol} - {x}_{cluster [ k ]} )}^{2} + {( {y}_{sol} - {y}_{cluster [ k ]} )}^{2}$$

Here, k is the index of the already known solution points, distance[k] is the distance of the relevant, already known solution point from the solution point now being assessed, x_{cluster}[k] is the x coordinate of the relevant, already known solution point, y_{cluster}[k] is the y coordinate of the relevant, already known solution point, xₛₒₗ is the x coordinate of the solution point being assessed, yₛₒₗ is the y coordinate of the solution point being assessed;
404 comparison, by the ultrasonic sensor system, of the ascertained distance square to the square² of the threshold value distance s defining the neighbourhood;
405 incrementing, by the ultrasonic sensor system, of the counter of the number of neighbours of the considered solution point;
406 incrementing, by the ultrasonic sensor system, of the index;
407 checking, by the ultrasonic sensor system, whether all distances between the current solution and each element of the cluster array have been checked.
408 checking, by the ultrasonic sensor system, whether the number of neighbours of the considered solution is too low, and evaluating, by the ultrasonic sensor apparatus, of the solution as noise if the number is too low, and accepting, by the ultrasonic sensor apparatus, of the solution if the number is sufficient;
409 possibly marking, by the ultrasonic sensor apparatus, of the considered solution as noise;
410 possibly marking, by the ultrasonic sensor apparatus, of the relevant solution as an accepted solution;
3801 distance circle with a threshold radius s around a point A with at least three neighbouring points in FIG. 38. The distance circle is also synonymously referred to in this document as the neighbourhood or threshold circle of this point A;
3802 distance circle with a threshold radius s around a point B, C with at least one neighbouring point in FIG. 38. The distance circle is also synonymously referred to in this document as a neighbourhood or threshold circle of this point B, C;
3803 distance circle with a threshold radius s around a point Np without a neighbouring point in FIG. 38. The distance circle is also synonymously referred to in this document as the neighbourhood or threshold circle of this point Np;
4101 exemplary noise values of the method in FIG. 41, which the ultrasonic sensor system USSS does not take into account;
4102 exemplary solutions of the method in FIG. 41, which the ultrasonic sensor system USSS does not take into account for other reasons;
A point having at least three neighbouring points in its distance circle 3801 with a threshold radius 6 around this point in FIG. 38;
ADPB adapter board;
au arbitrary units;
B point having at least one neighbouring point in its distance circle 3802 with a threshold radius s around this point in FIG. 38;
C point having at least one neighbouring point in its distance circle 3802 with a threshold radius s around this point in FIG. 38;
CAR vehicle;
CRA CHnCaptureResult array that comprises the data of the resulting frame (data frame) of echo and status information and is stored in the data storage of the microcomputer MCU of the NXP board NXPB;
d spatial distance between ultrasonic transducer UST and object;
DB1 first data bus;
diff diffusion process;
drv1 first ultrasonic transducer connection line;
drv2 second ultrasonic transducer connection line;
DUSW diffuse ultrasonic wave;
ε threshold value distance for assessing whether the distance between two points ascertained as potential solutions is small enough for clustering by a clustering method;
ec1 first ultrasonic echo of this ultrasonic sensor;
ec2 second ultrasonic echo of this ultrasonic sensor;
ec3 third ultrasonic echo of this ultrasonic sensor;
ec4 fourth ultrasonic echo of this ultrasonic sensor;
ec5 fifth ultrasonic echo of this ultrasonic sensor;
ec6 sixth ultrasonic echo of this ultrasonic sensor;
ECU control device of the exemplary experimental ultrasonic sensor system of FIG. 3;
erm echo signalling (actual ultrasonic measurement). In this phase, the signal changes from 1 to 0 if the ultrasonic sensor detects an echo in that the interface of the ultrasonic sensor connects the line to earth. The transceiver in the adapter board otherwise pulls the bus to a high level in this phase by means of a pull-up stage if no bus subscriber overwrites this pull-up stage.
FB fault tolerance range;
FTM0 in a further timer module;
FTM1 output comparison timer;
GPIO input/output line;
HAL bracket;
HK envelope signal of the ultrasonic reception signal RXL. The control circuit and the reception circuit RC form the envelope signal from the value of the output signal of the ultrasonic transducer UST by determining the amplitude curve of the signal;
MCU microcomputer of the NXP board NXPB;
MSDBL mass storage boot loader;
N number of the ultrasonic sensors in the ultrasonic sensor system with n as a positive whole number;
Np point without a neighbouring point in its distance circle 3803 with a threshold radius s around this point in FIG. 38;
nRESET reset line;
NXPB NXP board;
object;
O1 first object;
O2 second object;
OF1 first surface;
OF2 second surface;
OSDAAP OpenSDA applications;
OTF outTimeFrame event array;
P₀ reference sound pressure (SPL) at a 0° angle to the radiation axis of the ultrasonic sensor;
PosUS position of the ultrasonic sensor;
RC reception circuit;
ref diffraction process;
refl reflection process;
RUSW reflected ultrasonic wave;
Rx reception line of the UART interface UART between the microcomputer MCU of the NXP board NXPB and the adapter board ADPB;
RXB received reflected ultrasonic burst;
RxC reception code “00”;
RXL ultrasonic reception signal;
RxM receive mode;
SA viewing axis of an ultrasonic sensor;
SB synchronisation bits;
SDB sensor data bus;
SMCU sensor processor SMCU of the respective ultrasonic sensor;
SMCU1 sensor processor of the first ultrasonic sensor on the first ultrasonic sensor board SNSB1;
SMCU2 sensor processor of the second ultrasonic sensor on the first ultrasonic sensor board SNSB2;
SMCUj sensor processor of the j-th ultrasonic sensor on the j-th ultrasonic sensor board SNSBj with 1≤j≤n and j as a positive whole number;
SMCUn sensor processor of the first ultrasonic sensor on the first ultrasonic sensor board SNSBn with n as a positive whole number;
SNSB1 first sensor board;
SNSB2 second sensor board;
SNSB3 third sensor board;
SNSB4 fourth sensor board;
SNSB5 fifth sensor board;
SNSBj j-th sensor board with 1≤j≤n and j as a positive whole number;
SNSBn n-th sensor board, wherein n is a positive whole number;
SPI SPI interface;
std status+1 echo high.
SWK threshold value curve;
l angle of the radiating direction to the axis of the radiation lobe of the ultrasonic transducer of the ultrasonic sensor;
θ₁ angle of incidence;
θ₂ angle of emergence;
t time;
t₀ start time point;
   time duration of the high phase on the sensor data bus after the initialisation time T_{MEAS} has elapsed;
t_{damp} dead time t_{damp} between the end of the emission of the ultrasonic burst in the ultrasonic burst transmission time tₜₓ and the sufficient decrease of the amplitude of the continued vibration of the piezoelectric vibrating element of the ultrasonic transducer UST;
   initialisation time, the adapter board ADPB pulls the sensor data bus to earth for initialisation in the event of use of a LIN data bus as the sensor data bus;
tᵣ reflection time; tₜₓ ultrasonic burst transmission time;
t_{ref} reference time point, at which the drive of the vibrating element of the ultrasonic transducer is switched off and the decay phase, and thus the dead time t_{damp}, starts;
tᵣₓ reception time;
TUSW transmitted ultrasonic wave;
Tx transmission line of the UART interface UART between the microcomputer MCU of the NXP board NXPB and the adapter board ADPB;
TxC transmission code “10”;
TXL transmission signal;
TxM receive mode;
UART serial interface;
USB USB data bus;
USBH USB host;
USR reflected ultrasonic wave;
USR1 first reflected ultrasonic wave;
USR2 second reflected ultrasonic wave;
USR3 third reflected ultrasonic wave;
USR4 fourth reflected ultrasonic wave;
USSB pulse or burst on the transmission signal TXL;
USSE1 first ultrasonic sensor transmission and reception area;
USSE2 second ultrasonic sensor transmission and reception area;
USSE3 third ultrasonic sensor transmission and reception area;
USSE4 fourth ultrasonic sensor transmission and reception area;
USSS ultrasonic sensor system;
UST ultrasonic transducer;
USW ultrasonic wave. In FIG. 1, the incident ultrasonic wave;
VAS processing and evaluation steps;
x X coordinate;
Xd distance between an ultrasonic sensor and a further ultrasonic sensor;
x_lim X deviation value;
y Y coordinate;
y_lim y deviation value;
Z1 first acoustic wave resistance;
Z2 first acoustic wave resistance;

### LIST OF CITED DOCUMENTS

[1] J. F. Hallie Clark, “Semi-Autonomous Vehicles: Examining Driver Performance during the Take-Over”, 2016. [online]. Available: https://journals.sagepub.com/doi/abs/10.1177/1541931215591241.
[2] “Experiencing Autonomous Vehicles”: Crossing the Boundaries between a Drive and a Ride” [Online]. Available: https://dl.acm.org/doi/abs/10.1145/2702613.2702661.
[3] A. S. I. R. Jean-François Bonnefon, “The social dilemma of autonomous vehicles”, [Online]. Available: https://science.sciencemag.org/content/352/6293/1573.abstract.
[4] S. Suherman, R. A. Putra and M. Pinem, “Ultrasonic Sensor Assessment for Obstacle Avoidance in Quadcopter-based Drone System”, [Online]. Available: https://ieeexplore.ieee.org/abstract/document/9166607.
[5] “Obstacle avoidance design for a humanoid intelligent robot with ultrasonic sensors [Online]. Available: https://journals.sagepub.com/doi/abs/10.1177/1077546310381101.
[6] K. Reif, “12.2 Umgebungserfassung” [12.2 Environment Detection], in
[7] D. L. (BARTYLLA, “Ultraschallsensor sowie Vorrichtung und Verfahren zur Messung eines Abstands zwischen einem Fahrzeug und einem Hindernis” [Ultrasonic Sensor and Apparatus and Method for Measuring a Distance between a Vehicle and an Obstacle].
[8] E. Semiconductor, “Ultraschallprinzip, Prasentation” [Ultrasonic Principle, Presentation].
[9] ARM Cortex M4 Processor”, [Online]. Available: https://developer.arm.com/ip-products/processors/cortex-m/cortex-m4.
[10] “NXP Open SDA User's Guide”, [Online]. Available: https://www.nxp.com/docs/en/user-guide/OPENSDAUG.pdf.
[11] E. Semiconductor, “Datasheet E524.09”.
[12] G. B. J. M. T. A. B Cook, “Indoor Location Using Trilateration Characteristics”, [Online]. Available: http://citeseerx.ist.psu.edu/viewdoc/download?doi=10.1.1.505.7750&rep=rep1&type=pdf.
[13] “Modified unscented Kalman filtering and its application in autonomous satellite navigation”, [Online]. Available: https://www.sciencedirect.com/science/article/abs/pii/S127096380900011X.
[14] “A Kalman filtering tutorial for undergraduate students”, [Online]. Available: https://scholar.google.de/scholar?hl=de&as_sdt=0%2C5&q=A+Klaman+Filtering+tutorila+for+undergratuated+&btnG=.
[15] “Understanding the Basis of the Kalman Filter Via a Simple and Intuitive Derivation”, [Online]. Available: https://courses.engr.illinois.edu/ece420/sp2017/UnderstandingKalmanFilter.pdf.
[16] “DBSCAN Wikipedia”, [Online]. Available: https://de.wikipedia.org/wiki/DBSCAN.
[17] “Corona-Cluster und Infektionsketten” [Corona Cluster and Infection Chains], [Online]. Available:
[18] M. McGregor, “8 Clustering Algorithms in Machine Learning that All Data Scientists Should Know”, [Online]. Available: https://www.freecodecamp.org/news/8-clustering-algorithms-in-machine-learning-that-all-data-scientists-should-know/
[19] “DBSCAN”, [Online]. Available: https://scikit-learn.org/stable/modules/clustering.html#dbscan.
[20] “KalmanFilter.Net”, [Online]. Available: https://www.kalmanfilter.net/alphabeta.html.

1. Ultrasonic sensor system (USSS) for a vehicle or for a mobile apparatus for ascertaining a map of the surroundings with coordinates of objects in the environment of the ultrasonic sensor system (USSS), which
ultrasonic sensor system (USSS) comprises at least n ultrasonic sensors (0,1,2,3), wherein
n is a positive whole number with 3<n, and wherein
the ultrasonic sensors (0,1,2,3) are arranged along an intersection-free, straight or curved line, and wherein
the ultrasonic sensors can be numbered consecutively by counting according to their position along this line such that ultrasonic sensors directly adjacent to one another on the line differ in number by a value of exactly 1, and wherein
each of the n ultrasonic sensors (0,1,2,3) comprises at least one ultrasonic transmitter or one ultrasonic transducer (UTR) for emitting ultrasonic bursts as ultrasonic waves (USW), and
wherein
each of the ultrasonic sensors (0,1,2,3) comprises at least one ultrasonic receiver or the ultrasonic transducer (UTR) for receiving the reflected ultrasonic burst as reflected ultrasonic waves (USR), and wherein
each of the n ultrasonic sensors (0,1,2,3) is configured to generate a respective ultrasonic reception signal with a respective echo signalling (erm), and wherein
the respective echo signalling (erm) of an r-th ultrasonic sensor of the n ultrasonic sensors (0,1,2,3) with 1≤r≤n comprises, in each case, temporally consecutive signalling from 0 to kr ultrasonic echoes (ec1, ec2, ec3, ec4, ec5, ec6) after the emission of the ultrasonic burst by the ultrasonic sensor system (USSS), wherein kr is a positive whole number greater than or equal to 0, and wherein
the ultrasonic sensor system (USSS) is configured to generate measured values of its surroundings via at least 2 channels, viz., at least via a u-th channel and a u+1-th channel, wherein 1<u<n−1 and u is a positive whole number, and wherein,
for the respective generation of measured values via a j-th channel of n−2 possible channels with j>1 and j<n,
a j-th ultrasonic sensor (1,2) of the n ultrasonic sensors (0,1,2,3) is configured to emit an ultrasonic burst into surroundings of a vehicle,
a (j−1)-th ultrasonic sensor (0,1) of the n ultrasonic sensors (0,1,2,3) is configured to receive the reflected ultrasonic burst,
the j-th ultrasonic sensor (1,2) is configured to receive the reflected ultrasonic burst after the emission of the ultrasonic burst,
a (j+1)-th ultrasonic sensor (2,3) of the n ultrasonic sensors (0,1,2,3) is configured to receive the reflected ultrasonic burst,
the (j−1)-th ultrasonic sensor (0,1) is configured to signal a first distance value corresponding to a first ultrasonic echo (ec1) of the (j−1)-th ultrasonic sensor (0,1) if such an ultrasonic echo occurs,
the (j−1)-th ultrasonic sensor (0,1) is configured to signal a second distance value corresponding to a second ultrasonic echo (ec2) of the (j−1)-th ultrasonic sensor (0,1) if such an ultrasonic echo occurs,
the (j−1)-th ultrasonic sensor (0,1) is configured to signal a third distance value corresponding to a third ultrasonic echo (ec3) of the (j−1)-th ultrasonic sensor (0,1) if such an ultrasonic echo occurs,
the j-th ultrasonic sensor (1,2) is configured to signal a first distance value corresponding to a first ultrasonic echo (ec1) of the j-th ultrasonic sensor (1,2) if such an ultrasonic echo occurs,
the j-th ultrasonic sensor (1,2) is configured to signal a second distance value corresponding to a second ultrasonic echo (ec2) of the j-th ultrasonic sensor (1,2) if such an ultrasonic echo occurs,
the j-th ultrasonic sensor (1,2) is configured to signal a third distance value corresponding to a third ultrasonic echo (ec3) of the j-th ultrasonic sensor (1,2) if such an ultrasonic echo occurs,
the (j+1)-th ultrasonic sensor (2,3) is configured to signal a first distance value corresponding to a first ultrasonic echo (ec1) of the (j+1)-th ultrasonic sensor (2,3) if such an ultrasonic echo occurs,
the (j+1)-th ultrasonic sensor (2,3) is configured to signal a second distance value corresponding to a second ultrasonic echo (ec2) of the (j+1)-th ultrasonic sensor (2,3) if such an ultrasonic echo occurs, and
the (j+1)-th ultrasonic sensor (2,3) is configured to signal a third distance value corresponding to a third ultrasonic echo (ec3) of the (j+1)-th ultrasonic sensor (2,3) if such an ultrasonic echo occurs,
characterized in that
the ultrasonic sensor system (USSS) is configured to
ascertain, after the emission and reception of the ultrasonic burst, from a first ultrasonic echo (ec1) of a (u−1)-th ultrasonic sensor in the generation of measured values via the u-th channel if present, a distance value of the first ultrasonic echo (ec1) of the (u−1)-th ultrasonic sensor of the u-th channel,
ascertain, after the emission and reception of the ultrasonic burst, from a first ultrasonic echo (ec1) of a u-th ultrasonic sensor in the generation of measured values via the u-th channel if present, a distance value of the first ultrasonic echo (ec1) of the u-th ultrasonic sensor of the u-th channel,
ascertain, after the emission and reception of the ultrasonic burst, from a first ultrasonic echo (ec1) of a (u+1)-th ultrasonic sensor in the generation of measured values via the u-th channel if present, a distance value of the first ultrasonic echo (ec1) of the (u+1)-th ultrasonic sensor of the u-th channel,
ascertain, after the emission and reception of the ultrasonic burst, from the first ultrasonic echo (ec1) of the u-th ultrasonic sensor in the generation of measured values via the (u+1)-th channel if present, a distance value of the first ultrasonic echo (ec1) of the u-th ultrasonic sensor of the (u+1)-th channel,
ascertain, after the emission and reception of the ultrasonic burst, from the first ultrasonic echo (ec1) of a (u+1)-th ultrasonic sensor in the generation of measured values via the (u+1)-th channel if present, a distance value of the first ultrasonic echo (ec1) of the (u+1)-th ultrasonic sensor of the (u+1)-th channel,
ascertain, after the emission and reception of the ultrasonic burst, from a first ultrasonic echo (ec1) of a (u+2)-th ultrasonic sensor in the generation of measured values via the (u+1)-th channel if present, a distance value of the first ultrasonic echo (ec1) of the (u+2)-th ultrasonic sensor of the (u+1)-th channel,
ascertain, by means of a trilateration method,
from the possibly ascertained distance value of the first ultrasonic echo (ec1) of the (u−1)-th ultrasonic sensor of the u-th channel and
from the possibly ascertained distance value of the first ultrasonic echo (ec1) of the u-th ultrasonic sensor of the u-th channel and
from the possibly ascertained distance value of the first ultrasonic echo (ec1) of the (u+1)-th ultrasonic sensor of the u-th channel,
u-th solutions in the form of Y/Y coordinates of potential objects (0) in the surroundings of the vehicle,
ascertain, by means of a trilateration method,
from the possibly ascertained distance value of the first ultrasonic echo (ec1) of the u-th ultrasonic sensor of the (u+1)-th channel and
from the possibly ascertained distance value of the first ultrasonic echo (ec1) of the (u+1)-th ultrasonic sensor of the (u+1)-th channel and
from the possibly ascertained distance value of the first ultrasonic echo (ec1) of the (u+2)-th ultrasonic sensor of the (u+1)-th channel,
(u+1)-th solutions in the form of Y/Y coordinates of potential objects (0) in the surroundings of the vehicle,
filter, by means of a respective Kalman filtering method and/or estimation filtering method, each of the u-th solutions to form filtered u-th solutions,
filter, by means of a respective Kalman filtering method and/or estimation filtering method, each of the (u+1)-th solutions to form filtered (u+1)-th solutions, and
cluster, by means of a clustering method, the u-th solutions and the (u+1)-th solutions to form accepted solutions, and discard unaccepted u-th solutions and unaccepted (u+1)-th solutions.

2. Ultrasonic sensor system (USSS) according to claim 1, characterized in
that the ultrasonic sensor system (USSS) is configured to
ascertain, after the emission and reception of the ultrasonic burst, from a second ultrasonic echo (ec2) of the (u−1)-th ultrasonic sensor in the generation of measured values via the u-th channel if present, a distance value of the second ultrasonic echo (ec2) of the (u−1)-th ultrasonic sensor of the u-th channel, and/or
ascertain, after the emission and reception of the ultrasonic burst, from a second ultrasonic echo (ec2) of the u-th ultrasonic sensor in the generation of measured values via the u-th channel if present, a distance value of the second ultrasonic echo (ec2) of the u-th ultrasonic sensor of the u-th channel, and/or
ascertain, after the emission and reception of the ultrasonic burst, from a second ultrasonic echo (ec2) of the (u+1)-th ultrasonic sensor in the measurement via the u-th channel if present, a distance value of the second ultrasonic echo (ec2) of the (u+1)-th ultrasonic sensor of the (u-th channel, and/or
ascertain, after the emission and reception of the ultrasonic burst, from the second ultrasonic echo (ec2) of the u-th ultrasonic sensor in the generation of measured values via the (u+1)-th channel if present, a distance value of the second ultrasonic echo (ec2) of the u-th ultrasonic sensor of the (u+1)-th channel, and/or
ascertain, after the emission and reception of the ultrasonic burst, from the second ultrasonic echo (ec2) of the (u+1)-th ultrasonic sensor in the generation of measured values via the (u+1)-th channel if present, a distance value of the second ultrasonic echo (ec2) of the (u+1)-th ultrasonic sensor of the (u+1)-th channel, and/or
ascertain, after the emission and reception of the ultrasonic burst, from a second ultrasonic echo (ec2) of the (u+2)-th ultrasonic sensor in the generation of measured values via the (u+1)-th channel if present, a distance value of the second ultrasonic echo (ec2) of the (u+2)-th ultrasonic sensor of the (u+1)-th channel,
and
ascertain, by means of a trilateration method,
from the possibly ascertained distance value of the first ultrasonic echo (ec1) of the (u−1)-th ultrasonic sensor of the u-th channel and
from the possibly ascertained distance value of the first ultrasonic echo (ec1) of the u-th ultrasonic sensor of the u-th channel and
from the possibly ascertained distance value of the first ultrasonic echo (ec1) of the (u+1)-th ultrasonic sensor of the u-th channel and
from the possibly ascertained distance value of the second ultrasonic echo (ec2) of the (u−1)-th ultrasonic sensor of the u-th channel and
from the possibly ascertained distance value of the second ultrasonic echo (ec2) of the u-th ultrasonic sensor of the u-th channel and
from the possibly ascertained distance value of the second ultrasonic echo (ec2) of the (u+1)-th ultrasonic sensor of the u-th channel,
u-th solutions in the form of Y/Y coordinates of potential objects (0) in the surroundings of the vehicle, and
ascertain, by means of a trilateration method,
from the possibly ascertained distance value of the first ultrasonic echo (ec1) of the u-th ultrasonic sensor of the (u+1)-th channel and
from the possibly ascertained distance value of the first ultrasonic echo (ec1) of the (u+1)-th ultrasonic sensor of the (u+1)-th channel and
from the possibly ascertained distance value of the first ultrasonic echo (ec1) of the (u+2)-th ultrasonic sensor of the (u+1)-th channel and
from the possibly ascertained distance value of the second ultrasonic echo (ec2) of the u-th ultrasonic sensor of the (u+1)-th channel and
from the possibly ascertained distance value of the second ultrasonic echo (ec2) of the (u+1)-th ultrasonic sensor of the (u+1)-th channel and
from the possibly ascertained distance value of the second ultrasonic echo (ec2) of the (u+2)-th ultrasonic sensor of the (u+1)-th channel,
(u+1)-th solutions in the form of Y/Y coordinates of potential objects (0) in the surroundings of the vehicle, and
cluster, by means of a clustering method, the u-th solutions and the (u+1)-th solutions to form accepted solutions, and discard unaccepted u-th solutions and unaccepted (u+1)-th solutions.

3. Ultrasonic sensor system (USSS) according to claim 2, characterized in
that the ultrasonic sensor system (USSS) is configured to
ascertain, after the emission and reception of the ultrasonic burst, from a third ultrasonic echo (ec3) of the (u−1)-th ultrasonic sensor in the generation of measured values via the u-th channel if present, a distance value of the third ultrasonic echo (ec3) of the (u−1)-th ultrasonic sensor of the u-th channel, and
ascertain, after the emission and reception of the ultrasonic burst, from a third ultrasonic echo (ec3) of the u-th ultrasonic sensor in the generation of measured values via the u-th channel if present, a distance value of the third ultrasonic echo (ec3) of the u-th ultrasonic sensor of the u-th channel, and
ascertain, after the emission and reception of the ultrasonic burst, from a third ultrasonic echo (ec3) of the (u+1)-th ultrasonic sensor in the generation of measured values via the u-th channel if present, a distance value of the third ultrasonic echo (ec3) of the (u+1)-th ultrasonic sensor of the u-th channel, and
ascertain, after the emission and reception of the ultrasonic burst, from a third ultrasonic echo (ec3) of the u-th ultrasonic sensor in the generation of measured values via the (u+1)-th channel if present, a distance value of the third ultrasonic echo (ec3) of the u-th ultrasonic sensor of the (u+1)-th channel, and
ascertain, after the emission and reception of the ultrasonic burst, from a third ultrasonic echo (ec3) of the (u+1)-th ultrasonic sensor in the generation of measured values via the (u+1)-th channel if present, a distance value of the third ultrasonic echo (ec3) of the (u+1)-th ultrasonic sensor of the (u+1)-th channel, and
ascertain, after the emission and reception of the ultrasonic burst, from a third ultrasonic echo (ec3) of the (u+2)-th ultrasonic sensor in the measurement via the (u+1)-th channel if present, a distance value of the third ultrasonic echo (ec3) of the (u+2)-th ultrasonic sensor of the (u+1)-th channel, and
ascertain, by means of a trilateration method,
from the possibly ascertained distance value of the first ultrasonic echo (ec1) of the (u−1)-th ultrasonic sensor of the u-th channel and
from the possibly ascertained distance value of the first ultrasonic echo (ec1) of the u-th ultrasonic sensor of the u-th channel and
from the possibly ascertained distance value of the first ultrasonic echo (ec1) of the (u+1)-th ultrasonic sensor of the u-th channel and
from the possibly ascertained distance value of the second ultrasonic echo (ec2) of the (u−1)-th ultrasonic sensor of the u-th channel and
from the possibly ascertained distance value of the second ultrasonic echo (ec2) of the u-th ultrasonic sensor of the u-th channel and
from the possibly ascertained distance value of the second ultrasonic echo (ec2) of the (u+1)-th ultrasonic sensor of the u-th channel and
from the possibly ascertained distance value of the third ultrasonic echo (ec3) of the (u−1)-th ultrasonic sensor of the u-th channel and
from the possibly ascertained distance value of the third ultrasonic echo (ec3) of the u-th ultrasonic sensor of the u-th channel and
from the possibly ascertained distance value of the third ultrasonic echo (ec3) of the (u+1)-th ultrasonic sensor of the u-th channel,
u-th solutions in the form of Y/Y coordinates of potential objects (0) in the surroundings of the vehicle, and
ascertain, by means of a trilateration method,
from the possibly ascertained distance value of the first ultrasonic echo (ec1) of the u-th ultrasonic sensor of the (u+1)-th channel and
from the possibly ascertained distance value of the first ultrasonic echo (ec1) of the (u+1)-th ultrasonic sensor of the (u+1)-th channel and
from the possibly ascertained distance value of the first ultrasonic echo (ec1) of the (u+2)-th ultrasonic sensor of the (u+1)-th channel and
from the possibly ascertained distance value of the second ultrasonic echo (ec2) of the u-th ultrasonic sensor of the (u+1)-th channel and
from the possibly ascertained distance value of the second ultrasonic echo (ec2) of the (u+1)-th ultrasonic sensor of the (u+1)-th channel and
from the possibly ascertained distance value of the second ultrasonic echo (ec2) of the (u+2)-th ultrasonic sensor of the (u+1)-th channel and
from the possibly ascertained distance value of the third ultrasonic echo (ec3) of the u-th ultrasonic sensor of the (u+1)-th channel and
from the possibly ascertained distance value of the third ultrasonic echo (ec3) of the (u+1)-th ultrasonic sensor of the (u+1)-th channel and
from the possibly ascertained distance value of the third ultrasonic echo (ec3) of the (u+2)-th ultrasonic sensor of the (u+1)-th channel,
(u+1)-th solutions in the form of Y/Y coordinates of potential objects (0) in the surroundings of the vehicle, and
cluster, by means of a clustering method, the u-th solutions and the (u+1)-th solutions to form accepted solutions, and discard unaccepted u-th solutions and unaccepted (u+1)-th solutions.

4. Ultrasonic sensor system (USSS) according to one of the preceding claims 1 to 3, characterized in
that the ultrasonic sensor system (USSS) is configured to
filter or discard, by means of a method for plausibility checking, each of the u-th solutions to form plausibility-checked u-th solutions, and
filter or discard, by means of a method for plausibility checking, each of the (u+1)-th solutions to form plausibility-checked (u+1)-th solutions, and
filter, by means of a respective Kalman filtering method and/or by means of a respective estimation filtering method, now each of the plausibility-checked u-th solutions to form filtered u-th solutions, and
filter, by means of a respective Kalman filtering method and/or estimation filtering method, now each of the plausibility-checked (u+1)-th solutions to form filtered (u+1)-th solutions, and
cluster, by means of a clustering method, the filtered u-th solutions and the filtered (u+1)-th solutions to form accepted solutions, and discard unaccepted filtered u-th solutions and unaccepted filtered (u+1)-th solutions.

5. Ultrasonic system (USSS) according to claim 4, characterized in
that the ultrasonic sensor system (USSS) is configured to
replace the u-th solutions, discarded by means of the method for plausibility checking, with the respective, most recently accepted u-th solutions and then use them further as plausibility-checked u-th solutions, and
replace the (u+1)-th solutions, discarded by means of the method for plausibility checking, with the respective, most recently accepted (u+1)-th solutions and then use them further as plausibility-checked (u+1)-th solutions.

6. Ultrasonic sensor system (USSS) according to one of claims 4 or 5, characterized in that the ultrasonic sensor system (USSS) is configured, for carrying out the method for plausibility checking, to
discard those of the u-th solutions that correspond to a time of flight of the ultrasonic burst from its emission to the reception by at least one of the ultrasonic sensors that is greater than a maximum allowed time of flight tₘₐₓ, in particular greater than a time of flight of tₘₐₓ>1.4 ms, and/or
discard those of the (u+1)-th solutions that correspond to a time of flight of the ultrasonic burst from its emission to the reception by at least one of the ultrasonic sensors that is greater than the maximum allowed time of flight Δeₘₐₓ, in particular greater than a time of flight of Δeₘₐₓ>1.4 ms.

7. Ultrasonic sensor system (USSS) according to one of claims 4 to 6, characterized in that the ultrasonic sensor system (USSS) is configured, for carrying out the method for plausibility checking, to discard those of the (u+1)-th solutions or u-th solutions that cannot be attributed to at least exactly one ultrasonic echo of an associated ultrasonic sensor and exactly one further ultrasonic echo of an associated further ultrasonic sensor and exactly one additional ultrasonic echo of an associated additional ultrasonic sensor, thus to three ultrasonic echoes of three different ultrasonic sensors.

8. Ultrasonic sensor system (USSS) according to one of claims 4 to 7, characterized in that the ultrasonic sensor system (USSS) is configured, for carrying out the method for plausibility checking, to deactivate the Kalman filtering method and/or estimation filtering method if the signal of the value of the arrival time of the relevant ultrasonic echo, i.e., a u-th solution or a (u+1)-th solution, changes by more than Δe_{filter_max} or by Δe_{filter_max} in two consecutive iterations, wherein Δe_{filter_max} is preferably Δe_{filter_max}≥500 μs, and wherein “deactivate” means
that the ultrasonic sensor system (USSS) uses all or several or individual ones of the plausibility-checked u-th solutions as filtered u-th solutions and/or directly uses all or several or individual ones of the plausibility-checked (u+1)-th solutions as filtered (u+1)-th solutions for the time of the deactivation.

9. Ultrasonic sensor system (USSS) according to claim 8, characterized in that the ultrasonic sensor system (USSS) is configured to cancel a deactivation after a predetermined number of measurement cycles.

10. Ultrasonic sensor system (USSS) according to one of claims 4 to 9, characterized in that the ultrasonic sensor system (USSS) is configured, for carrying out the method for plausibility checking, to discard such u-th solutions for which a line from a location of the possibly filtered u-th solution to a location of the u-th ultrasonic sensor has an angle α to a viewing axis (SA) of the u-th ultrasonic sensor whose magnitude is greater than the magnitude of a maximum angle αₗᵢₘ.

11. Ultrasonic sensor system according to one of claims 1 to 10, wherein the ultrasonic sensors are configured to extract, in each case, a respective envelope signal (HV) from the signal of the reflected ultrasonic wave (USW) and to extract, using a respective threshold value curve (SWK), from this respective envelope signal (HV), the respective ultrasonic echoes (ec1, ec2, ec3, ec4, ec5, ec6) of the respectively relevant ultrasonic sensor, characterized in that the threshold value curve (SWK) of a respective ultrasonic sensor depends on the clustered and accepting solutions that the ultrasonic sensor system (USSS) previously ascertained.

12. Ultrasonic sensor system according to one of claims 1 to 11, wherein the ultrasonic sensor system (USSS) is configured to then cluster, by means of a clustering method, the u-th solutions and the (u+1)-th solutions or the filtered u-th solutions and the filtered (u+1)-th solutions to form accepted solutions and to discard unaccepted, possibly filtered u-th solutions or unaccepted, possibly filtered (u+1)-th solutions if the distances between at least one of the solutions of the cluster and at least e other solutions of the cluster are less than a threshold value distance (6), wherein e is a positive whole number greater than 0, or better greater than 1 or better greater than 2, and wherein e=3 is particularly preferred.

13. Ultrasonic sensor system according to one of claims 1 to 11 or 12, wherein
the ultrasonic sensor system (USSS) is configured to then cluster, by means of a clustering method, the u-th solutions and the (u+1)-th solutions or the filtered u-th solutions and the filtered (u+1)-th solutions to form accepted solutions and to discard unaccepted, possibly filtered u-th solutions or unaccepted, possibly filtered (u+1)-th solutions if the number of the u-th solutions and the (u+1)-th solutions of a cluster is at least three.

14. Ultrasonic sensor system according to claim 13, wherein
the ultrasonic sensor system (USSS) is configured to then cluster, by means of a clustering method, u-th solutions and (u+1)-th solutions or filtered u-th solutions and filtered (u+1)-th solutions into an already existing cluster as accepted solutions and to discard unaccepted, possibly filtered u-th solutions or unaccepted, possibly filtered (u+1)-th solutions if the number of the u-th solutions and the (u+1)-th solutions of the cluster that are in the neighbourhood of such a possibly filtered u-th solution or possibly filtered (u+1)-th solution is at least one.

15. Ultrasonic sensor system (USSS) according to one of claims 1 to 14, wherein
one of the ultrasonic sensors (5) emits an ultrasonic noise signal having an at least partially random modulation at least in one parameter.

16. Ultrasonic sensor system (USSS), wherein the ultrasonic sensor system (USSS) is configured to
ascertain distance values on the basis of ultrasonic echoes sensed by at least four ultrasonic sensors, and
ascertain solutions from these distance values by means of a trilateration method, and
filter, by means of a respective Kalman filtering method and/or by means of a respective estimation filtering method, each of these solutions to form filtered solutions, and
cluster, by means of a clustering method, the filtered solutions to form accepted solutions and to discard unaccepted filtered solutions.

17. Ultrasonic sensor system (USSS) according to one or more of claims 1 to 16, wherein the ultrasonic sensor system (USSS) is configured to
first determine, in the execution of the trilateration method, a solution on the basis of two ultrasonic echoes of two different ultrasonic sensors, and
accept the solution if it is a solution from the fallback area, and
not accept the solution on the basis of two ultrasonic echoes of two different ultrasonic sensors if it is a solution from a three-sensor area, and
then determine, in the execution of the trilateration method, a solution on the basis of three ultrasonic echoes of three different ultrasonic sensors.

18. Ultrasonic sensor system (USSS) according to one or more of claims 1 to 17, wherein the ultrasonic sensor system (USSS) is configured, in the execution of the trilateration method, to use each ultrasonic echo only once for determining a solution in a measurement cycle.

19. Ultrasonic sensor system (USSS) according to one or more of claims 1 to 18,
wherein the clustering depends on a threshold value distance (E), and
wherein the threshold value distance (E) depends on the change in accepted solutions of the clustering between at least two measurement cycles.

20. Ultrasonic sensor system (USSS) according to one or more of claims 1 to 19, wherein the reception circuit (RC) of each ultrasonic sensor of the ultrasonic sensor system (USSS) and/or the ultrasonic sensor system (USSS) itself is configured to
ascertain the temporal changes of the reception of an ultrasonic echo of this ultrasonic sensor from the reception data of this ultrasonic echo of this ultrasonic sensor of the last v measurement cycles, with v as a positive whole number greater than 1, and to determine therefrom, by means of a polynomial approximation, the time point of the next reception of the ultrasonic echo, and
modify the threshold value curve (SWK) of this ultrasonic sensor as a function of the result of the next reception expected for a time range around the time point.

21. Ultrasonic sensor system (USSS) according to one or more of claims 1 to 20, wherein the ultrasonic sensor system (USSS) is configured to
ascertain the temporal changes of the accepted solutions from data of the accepted solutions of the last v measurement cycles, with v as a positive whole number greater than 1, and
determine therefrom, in particular by means of a polynomial approximation, for one or more ultrasonic sensors of the ultrasonic sensor system (USSS), the respective time point of the expected next reception of the ultrasonic echoes belonging to the relevant solution, for these ultrasonic sensors, and
modify the threshold value curve (SWK) of one or more of these ultrasonic sensors as a function of the result of this prediction, in particular for a time range around the respective time point of the respectively expected next reception of the respective ultrasonic echoes belonging to the relevant solution, for these respective ultrasonic sensors.

22. Ultrasonic sensor system (USSS) according to one or more of claims 1 to 21, wherein the ultrasonic sensor system (USSS) is configured to apply a method that identifies ultrasonic echoes of fraudulent objects in the measured values of the ultrasonic echoes of the ultrasonic sensors and to remove them from the measurement data.

23. Ultrasonic sensor system (USSS) according to one or more of claims 1 to 22, wherein the input signals of the Kalman filter or of the estimation filter or of the Kalman filtering method of the Kalman filter or of the estimation filtering method of the estimation filter are the recognized object positions in the form of the accepted solutions and/or the rate of change of the recognized object positions in the form of the accepted solutions on the one hand and the speed of the vehicle on the other hand.

24. Ultrasonic sensor system (USSS) according to one or more of claims 1 to 23, wherein the ultrasonic sensor system (USSS) is configured to set measured values with a time of flight that is greater than a maximum allowed time of flight tₘₐₓ or Δeₘₐₓ to zero or a very small number of equal effect.

25. Method for operating an ultrasonic sensor system (USSS) for a vehicle or mobile apparatus, for ascertaining a map of the surroundings with coordinates of objects in the environment of the ultrasonic sensor system (USSS) in the form of accepted solutions, wherein
the ultrasonic sensor system (USSS) comprises at least n ultrasonic sensors (0,1,2,3), where n is a positive whole number with 3<n, and
the ultrasonic sensors (0,1,2,3) are arranged along an intersection-free, straight or curved line, and
the ultrasonic sensors (0,1,2,3) can be numbered consecutively according to their position along this line by counting such that the numbers of directly adjacent ultrasonic sensors (0,1,2,3) on the line differ by a value of exactly 1, and
a (u−1)-th ultrasonic sensor and a u-th ultrasonic sensor and a (u+1)-th ultrasonic sensor form a u-th channel, with 1<u<n, wherein
the method comprises the following steps:
starting a measurement cycle of the u-th channel with the emission of an ultrasonic burst as an ultrasonic wave (USW) by the u-th ultrasonic sensor;
receiving, by the (u−1)-th ultrasonic sensor, the ultrasonic burst reflected by one or more objects, in the form of k₍ᵤ₋₁₎ ultrasonic echoes with k₍ᵤ₋₁₎ as a positive whole number, which may also be zero, wherein these ultrasonic echoes of the (u−1)-th ultrasonic sensor in the sense of this claim are numbered consecutively from 1 to k₍ᵤ₋₁₎ according to the order of their detection by the (u−1)-th ultrasonic sensor;
receiving, by the u-th ultrasonic sensor, the ultrasonic burst reflected by one or more objects, in the form of kᵤ ultrasonic echoes with kᵤ as a positive whole number, which may also be zero, wherein these ultrasonic echoes of the u-th ultrasonic sensor in the sense of this claim are numbered consecutively from 1 to kᵤ according to the order of their detection by the u-th ultrasonic sensor;
receiving, by the (u+1)-th ultrasonic sensor, the ultrasonic burst reflected by one or more objects, in the form of k₍ᵤ₊₁₎ ultrasonic echoes with k₍ᵤ₊₁₎ as a positive whole number, which may also be zero, wherein these ultrasonic echoes of the (u+1)-th ultrasonic sensor in the sense of this claim are numbered consecutively from 1 to k₍ᵤ₊₁₎ according to the order of their detection by the (u+1)-th ultrasonic sensor;
determining, in each case, a respective distance value of the ultrasonic echo of the (u−1)-th ultrasonic sensor from the respective time of flight of the respective ultrasonic echo of m₍ᵤ₋₁₎ first arriving ultrasonic echoes of the (u−1)-th ultrasonic sensor between the emission of the ultrasonic burst by the u-th ultrasonic sensor on the one hand and the detection by the (u−1)-th ultrasonic sensor on the other hand, wherein m₍ᵤ₋₁₎ is a positive whole number, which may also be zero, and wherein m₍ᵤ₋₁₎≤k₍ᵤ₋₁₎;
determining, in each case, a respective distance value of the ultrasonic echo of the u-th ultrasonic sensor from the respective time of flight of the respective ultrasonic echo of mᵤ first arriving ultrasonic echoes of the u-th ultrasonic sensor between the emission of the ultrasonic burst by the u-th ultrasonic sensor on the one hand and the detection by the u-th ultrasonic sensor on the other hand, wherein mᵤ is a positive whole number, which may also be zero, and wherein mᵤ≤kᵤ;
determining, in each case, a respective distance value of the ultrasonic echo of the (u+1)-th ultrasonic sensor from the respective time of flight of the respective ultrasonic echo of m₍ᵤ₊₁₎ first arriving ultrasonic echoes of the (u+1)-th ultrasonic sensor between the emission of the ultrasonic burst by the u-th ultrasonic sensor on the one hand and the detection by the (u+1)-th ultrasonic sensor on the other hand, wherein m₍ᵤ₋₁₎ is a positive whole number, which may also be zero, and wherein m₍ᵤ₊₁₎←k₍ᵤ₊₁₎;
associating, in each case, usage information with each determined distance value, wherein this usage information initially marks this distance value as unused in its usage information;
initialising a (u−1)-th echo counter p₍ᵤ₋₁₎ with 1;
initialising a u-th echo counter pᵤ with 1;
initialising a (u+1)-th echo counter p₍ᵤ₊₁₎ with 1;
Jump point 1:
If a p₍ᵤ₋₁₎-th distance value of the (u−1)-th ultrasonic sensor for its p₍ᵤ₋₁₎-th ultrasonic echo is not marked as used in its usage information, and
if a pᵤ-th distance value of the u-th ultrasonic sensor for its pᵤ-th ultrasonic echo is not marked as used in its usage information:
trilateration of the distance value of the (u−1)-th ultrasonic sensor for its p₍ᵤ₋₁₎-th ultrasonic echo with the distance value of the u-th ultrasonic sensor for its pᵤ-th ultrasonic echo and ascertainment of a first trilateration point in the form of a first x/y coordinate;
If the p₍ᵤ₋₁₎-th distance value of the (u−1)-th ultrasonic sensor for its p₍ᵤ₋₁₎-th ultrasonic echo is marked as used in its usage information, or
if the pᵤ-th distance value of the u-th ultrasonic sensor for its pᵤ-th ultrasonic echo is marked as used in its usage information:
treating trilateration as if the first trilateration point and a second trilateration point are not both within a fault tolerance range (FB) and skipping jump point 2 and continuing with jump point 3;
Jump point 2:
If a p₍ᵤ₊₁₎-th distance value of the (u+1)-th ultrasonic sensor for its p₍ᵤ₊₁₎-th ultrasonic echo is marked as not used in its usage information:
trilateration of the distance value of the (u+1)-th ultrasonic sensor for its p₍ᵤ₊₁₎-th ultrasonic echo with the distance value of the u-th ultrasonic sensor for its pᵤ-th ultrasonic echo and ascertainment of the second trilateration point in the form of a second x/y coordinate;
If the p₍ᵤ₊₁₎-th distance value of the (u+1)-th ultrasonic sensor for its p₍ᵤ₊₁₎-th ultrasonic echo is marked as used in its usage information:
treating trilateration as if the first trilateration point and the second trilateration point are not both within the fault tolerance range (FB) and continuing with jump point 3;
comparing the first trilateration point to the second trilateration point;
Jump point 3: If the first trilateration point and the second trilateration point are not both within a fault tolerance range (FB) and p₍ᵤ₊₁₎<k₍ᵤ₊₁₎ and p₍ᵤ₋₁₎≤k₍ᵤ₋₁₎ and pᵤ≤kᵤ apply: increasing p₍ᵤ₊₁₎ by 1 and repeating the steps from jump point 2;
If the first trilateration point and the second trilateration point are not both within a fault tolerance range (FB) and p₍ᵤ₊₁₎≥k₍ᵤ₊₁₎ and p₍ᵤ₋₁₎<k₍ᵤ₋₁₎ and pᵤ<kᵤ apply: initialising p₍ᵤ₊₁₎ with 1 and increasing p₍ᵤ₋₁₎ by 1 and repeating the steps from jump point 1;
If the first trilateration point and the second trilateration point are not both within a fault tolerance range (FB) and p₍ᵤ₊₁₎<k₍ᵤ₊₁₎ and p₍ᵤ₋₁₎≥k₍ᵤ₋₁₎ and pᵤ<kᵤ apply: increasing p₍ᵤ₊₁₎ by 1 and repeating the steps from jump point 2;
If the first trilateration point and the second trilateration point are not both within a fault tolerance range (FB) and p₍ᵤ₊₁₎≥k₍ᵤ₊₁₎ and p₍ᵤ₋₁₎≥k₍ᵤ₋₁₎ and pᵤ<kᵤ apply: initialising p₍ᵤ₊₁₎ with 1 and initialising p₍ᵤ₋₁₎ with 1 and increasing pᵤ by 1 and repeating the steps from jump point 1;
If the first trilateration point and the second trilateration point are not both within a fault tolerance range (FB) and p₍ᵤ₊₁₎<k₍ᵤ₊₁₎ and p₍ᵤ₋₁₎≤k₍ᵤ₋₁₎ and pᵤ≥kᵤ apply: increasing p₍ᵤ₊₁₎ by 1 and repeating the steps from jump point 2;
If the first trilateration point and the second trilateration point are not both within a fault tolerance range (FB) and p₍ᵤ₊₁₎≥k₍ᵤ₊₁₎ and p₍ᵤ₋₁₎≤k₍ᵤ₋₁₎ and pᵤ≥kᵤ apply: initialising p₍ᵤ₊₁₎ with 1 and increasing p₍ᵤ₋₁₎ by 1 and repeating the steps from jump point 1;
If the first trilateration point and the second trilateration point are not both within a fault tolerance range (FB) and p₍ᵤ₊₁₎<k₍ᵤ₊₁₎ and p₍ᵤ₋₁₎≥k₍ᵤ₋₁₎ and pᵤ≥kᵤ apply: increasing p₍ᵤ₊₁₎ by 1 and repeating the steps from jump point 2;
If the first trilateration point and the second trilateration point are both within the fault tolerance range (FB): ascertaining a solution from the first trilateration point and the second trilateration point and adding the thus ascertained solution to the set of solutions of this u-th channel of this measurement cycle, and marking the p₍ᵤ₋₁₎-th distance value of the (u−1)-th ultrasonic sensor for its p₍ᵤ₋₁₎-th ultrasonic echo as used in its usage information, and marking the pᵤ-th distance value of the u-th ultrasonic sensor for its pᵤ-th ultrasonic echo as used, and marking the p₍ᵤ₊₁₎-th distance value of the (u+1)-th ultrasonic sensor for its p₍ᵤ₊₁₎-th ultrasonic echo as used in its usage information, and initialising the (u−1)-th echo counter p₍ᵤ₋₁₎ with 1 and initialising the u-th echo counter pᵤ with 1 and initialising the (u+1)-th echo counter p₍ᵤ₊₁₎ with 1, and repeating the three steps from jump point 3;
If the first trilateration point and the second trilateration point are not both within a fault tolerance range (FB) and p₍ᵤ₊₁₎≥k₍ᵤ₊₁₎ and p₍ᵤ₋₁₎≥k₍ᵤ₋₁₎ and pᵤ≥kᵤ apply: ending the measurement cycle and influencing the vehicle as a function of the solutions in the set of the solutions of this u-th channel of this measurement cycle.

26. Method according to claim 25, with the additional step of:
clustering solutions in the set of the solutions of this u-th channel of one or more measurement cycles to form accepted u-th solutions; and
discarding unaccepted solutions of this u-th channel of these measurement cycles.

27. Method according to claim 26, wherein
the method according to claim 25 is carried out for a u-th channel in order to obtain u-th solutions, with u<n−1;
the method according to claim 25 is carried out for a (u+1)-th channel in order to obtain (u+1)-th solutions;
carrying out the clustering according to claim 25, now in the form of clustering solutions in the union of the set of the solutions of this u-th channel and the set of the solutions of this (u+1)-th channel of one or more measurement cycles to form u-th solutions, and
discarding unaccepted u-th solutions of this u-th channel and unaccepted (u+1)-th solutions of this (u+1)-th channel of these measurement cycles.

28. Method according to one of claims 25 to 26, comprising the additional step of:
plausibility checking each of the u-th solutions to form plausibility-checked u-th solutions, in particular by filtering and discarding u-th solutions.

29. Method according to claim 27 and 28, comprising the additional step of:
plausibility checking each of the (u+1)-th solutions to form plausibility-checked u-th solutions, in particular by filtering and discarding.

30. Method according to claim 26 or 28, comprising the additional steps of:
Kalman filtering a u-th solution and/or a plausibility-checked u-th solution of the u-th channel to form filtered u-th solutions, and/or
filtering a u-th solution and/or a plausibility-checked u-th solution of the u-th channel by means of an estimation filtering method to form filtered u-th solutions.

31. Method according to claim 27 or 29, comprising the additional steps of:
Kalman filtering a (u+1)-th solution and/or a plausibility-checked (u+1)-th solution of the (u+1)-th channel to form filtered (u+1)-th solutions, and/or
filtering a (u+1)-th solution and/or a plausibility-checked (u+1)-th solution of the (u+1)-th channel by means of an estimation filtering method to form filtered (u+1)-th solutions.

32. Method according to claim 30, wherein the clustering now takes place such that
the clustering of filtered u-th solutions in the set of filtered u-th solutions of this u-th channel of one or more measurement cycles to form accepted u-th solutions takes place, and
the discarding of unaccepted filtered u-th solutions of this u-th channel of these measurement cycles takes place.

33. Method according to claim 31 and claim 30, wherein the clustering now takes place such that
the clustering of filtered u-th solutions in the union of the set of filtered u-th solutions of this u-th channel and the set of filtered (u+1)-th solutions of this (u+1)-th channel of one or more measurement cycles to form accepted u-th solutions takes place, and
the discarding of unaccepted filtered u-th solutions of this u-th channel and of unaccepted filtered (u+1)-th solutions of this (u+1)-th channel of these measurement cycles takes place.

34. Method according to claim 25 to 34, comprising the step of:
replacing, by means of the plausibility check, discarded u-th solutions with the respective, most recently accepted u-th solutions, and then further using these most recently accepted u-th solutions as plausibility-checked u-th solutions.

35. Method according to claim 25 to 34, comprising the step of:
replacing, by means of the plausibility check, discarded (u+1)-th solutions with the respective, most recently accepted (u+1)-th solutions, and then further using these most recently accepted (u+1)-th solutions as plausibility-checked (u+1)-th solutions.

36. Method according to one of claims 25 to 35, wherein
the plausibility check discards those of the u-th solutions that correspond to a time of flight of the ultrasonic burst from its emission to the reception by at least one of the ultrasonic sensors that is greater than a maximum allowed time of flight tₘₐₓ, in particular greater than a time of flight of tₘₐₓ>1.4 ms, and/or
the plausibility check discards those of the (u+1)-th solutions that correspond to a time of flight of the ultrasonic burst from its emission to the reception by at least one of the ultrasonic sensors that is greater than the maximum allowed time of flight Δeₘₐₓ, in particular greater than a time of flight of Δeₘₐₓ>1.4 ms.

37. Method according to claim 25 to 36, wherein
the plausibility check discards those of the (u+1)-th solutions or u-th solutions that cannot be attributed to at least exactly one ultrasonic echo of an associated ultrasonic sensor and exactly one further ultrasonic echo of an associated further ultrasonic sensor and exactly one additional ultrasonic echo of an associated additional ultrasonic sensor, thus to three ultrasonic echoes of three different ultrasonic sensors.

38. Method according to one of claims 25 to 37, wherein
the plausibility check deactivates the Kalman filtering method or estimation filtering method if the signal of the value of the arrival time of the relevant ultrasonic echo, i.e., a u-th solution or a (u+1)-th solution, changes by more than Δe_{filter_max} or by Δe_{filter_max} in two consecutive iterations, wherein Δe_{filter_max} is preferably Δe_{filter_max}≥500 μs, and wherein “deactivate” means that the method uses all or several or individual ones of the plausibility-checked u-th solutions as filtered u-th solutions and/or directly uses all or several or individual ones of the plausibility-checked (u+1)-th solutions as filtered (u+1)-th solutions for the time of the deactivation.

39. Method according to claim 38, wherein the method cancels the deactivation again after a predetermined number of measurement cycles.

40. Method according to one of claims 25 to 39, wherein
the plausibility check discards such u-th solutions or (u+1)-th solutions for which the line from the location of the possibly filtered u-th solution or (u+1)-th solutions to the location of the u-th ultrasonic sensor or (u+1)-th ultrasonic sensor has an angle α to this viewing axis (SA) of the u-th ultrasonic sensor or (u+1)-th ultrasonic sensor whose magnitude is greater than the magnitude of a maximum angle αₗᵢₘ.

41. Method according to claim 25 to 40, comprising the steps
of extracting a respective envelope signal (HK) per ultrasonic sensor, in each case from a respective signal of a reflected ultrasonic wave (USW) of the respective ultrasonic sensor, and
of extracting respective ultrasonic echoes (ec1, ec2, ec3, ec4, ec5, ec6) of the respective ultrasonic sensor using a respective threshold value curve (SWK) of the respective ultrasonic sensor from this respective envelope signal (HK) of the respective ultrasonic sensor, wherein the threshold value curve (SWK) of an ultrasonic sensor depends on the clustered and accepting solutions that the method previously ascertained.

42. Method according to claim 25 to 41, wherein
the method then clusters, by means of the clustering method, the u-th solutions and the (u+1)-th solutions or the filtered u-th solutions and the filtered (u+1)-th solutions to form accepted solutions and discards unaccepted, possibly filtered u-th solutions or unaccepted, possibly filtered (u+1)-th solutions if the distances between at least one of the solutions of the cluster and at least e other solutions of the cluster are less than a threshold value distance (s), wherein e is a positive whole number greater than 0, or better greater than 1 or better greater than 2, and wherein e=3 is particularly preferred.

43. Method according to claim 25 to 42, wherein
the method then clusters, by means of the clustering method, the u-th solutions and the (u+1)-th solutions or the filtered u-th solutions and the filtered (u+1)-th solutions to form accepted solutions and discards unaccepted, possibly filtered u-th solutions or unaccepted, possibly filtered (u+1)-th solutions if the number of the u-th solutions and the (u+1)-th solutions of the cluster is at least three.

44. Method according to claim 25 to 43, wherein
the method then clusters, by means of the clustering method, u-th solutions and (u+1)-th solutions or filtered u-th solutions and filtered (u+1)-th solutions into an already existing cluster as accepted solutions and discards unaccepted, possibly filtered u-th solutions or unaccepted, possibly filtered (u+1)-th solutions if the number of the u-th solutions and the (u+1)-th solutions of the cluster that are in the neighbourhood of such a possibly filtered u-th solution or possibly filtered (u+1)-th solution is at least one.

45. Method according to claim 25 to 44, comprising the additional step of emitting an ultrasonic noise signal having an at least partially random modulation at least in one parameter.

46. Method, in particular according to claim 25 to 45, wherein the method
ascertains distance values on the basis of ultrasonic echoes sensed by at least four ultrasonic sensors, and
ascertains solutions from these distance values by means of a trilateration method, and
filters, by means of the respective Kalman filtering method or by means of a respective estimation filtering method, each of these solutions to form filtered solutions, and
clusters, by means of the clustering method, the filtered solutions to form accepted solutions and discards unaccepted filtered solutions.

47. Method according to one or more of claims 25 to 46, wherein the method
first determines a solution on the basis of two ultrasonic echoes of two different ultrasonic sensors, and
accepts the solution if it is a solution from a fallback area, and
does not accept the solution on the basis of two ultrasonic echoes of two different ultrasonic sensors if it is a solution from a three-sensor area, and wherein the method that the ultrasonic sensor system (USSS) carries out then determines a solution on the basis of three ultrasonic echoes of three different ultrasonic sensors.

48. Method according to one or more of claims 25 to 47, wherein
the clustering depends on a threshold value distance (E), and
the threshold value distance (E) depends on the change in accepted solutions of the clustering between at least two measurement cycles.

49. Method according to one or more of claims 25 to 48, wherein the method
ascertains temporal changes of a reception of an ultrasonic echo of each ultrasonic sensor from the reception data of this ultrasonic echo of the respective ultrasonic sensor of the last v measurement cycles, with v as a positive whole number greater than 1, and determines therefrom, by means of a polynomial approximation, the time point of the next reception of the ultrasonic echo by this ultrasonic sensor, and
modifies the threshold value curve (SWK) of this ultrasonic sensor as a function of the result of the next reception expected for a time range around the time point.

50. Method according to one or more of claims 25 to 49, wherein the method
ascertains changes of the accepted solutions from data of the accepted solutions of the last v measurement cycles, with v as a positive whole number greater than 1, and
determines therefrom, in particular by means of a polynomial approximation, for one or more ultrasonic sensors, a respective time point of an expected next reception of the ultrasonic echoes belonging to the relevant solution, for these ultrasonic sensors, and
modifies the threshold value curve (SWK) of one or more of these ultrasonic sensors as a function of the result of this prediction, in particular for a time range around a respective time point of the respectively expected next reception of the respective ultrasonic echoes belonging to the relevant solution, for these respective ultrasonic sensors.

51. Method according to one or more of claims 25 to 50, wherein the method applies a sub-method that identifies ultrasonic echoes of fraudulent objects in the distance values of the ultrasonic echoes of the ultrasonic sensors and removes them from the measurement data.

52. Method according to one or more of claims 25 to 51, wherein the input values of the Kalman filtering method or of the estimation filtering method are recognized object positions in the form of the solutions of the trilateration method and/or the rate of change of the recognized object positions in the form of the solutions of the trilateration method on the one hand and the speed of the vehicle on the other hand.

53. Method according to one or more of claims 25 to 52, wherein
the input values of the estimation filtering or of an estimation filtering are the recognized object positions in the form of the solutions of the trilateration method and/or the rate of change of the recognized object positions in the form of the solutions of the trilateration method on the one hand and the speed of the vehicle on the other hand.

54. Method according to one or more of claims 25 to 53, wherein
the method sets distance values according to measured values of a time of flight that is greater than a maximum allowed time of flight tₘₐₓ or Δeₘₐₓ to zero or a very small number of equal effect.

55. Method for operating an ultrasonic sensor system (USSS) for a vehicle or mobile apparatus, for ascertaining a map of the surroundings with coordinates of objects in the environment of the ultrasonic sensor system (USSS) in the form of accepted solutions, wherein
the method emits an ultrasonic burst, and
ultrasonic sensors of the at least four ultrasonic sensors receive this ultrasonic burst as reflected ultrasonic bursts and convert them into ultrasonic echoes, and
the method ascertains distance values on the basis of ultrasonic echoes sensed by the at least four ultrasonic sensors, and
the method ascertains solutions by means of a trilateration method from these distance values originating from at least three different ultrasonic sensors, and
the method filters, by means of a respective Kalman filtering method or by means of a respective estimation filtering method, each of these solutions to form filtered solutions, and
the method clusters, by means of a clustering method, the filtered solutions to form accepted solutions and discards unaccepted unaccepted filtered solutions.

56. Method according to claim 55, wherein
the ultrasonic sensor system (USSS) comprises at least n ultrasonic sensors (0,1,2,3), wherein n is a positive whole number with 3<n; and
the ultrasonic sensors (0,1,2,3) are arranged along an intersection-free, straight or curved line, and
the ultrasonic sensors can be numbered consecutively according to their position along this line by counting such that the numbers of directly adjacent ultrasonic sensors on the line differ by a value of exactly 1, and
a (u−1)-th ultrasonic sensor and a u-th ultrasonic sensor and a (u+1)-th ultrasonic sensor form a u-th channel, with 1<u<n, and
wherein the method comprises the following steps:
starting a measurement cycle of the u-th channel with the emission of an ultrasonic burst as an ultrasonic wave (USW) by the u-th ultrasonic sensor;
receiving, by the (u−1)-th ultrasonic sensor, the ultrasonic burst reflected by one or more objects, in the form of k₍ᵤ₋₁₎ ultrasonic echoes with k₍ᵤ₋₁₎ as a positive whole number, which may also be zero, wherein these ultrasonic echoes of the (u−1)-th ultrasonic sensor are numbered consecutively from 1 to k₍ᵤ₋₁₎ according to the order of their detection by the (u−1)-th ultrasonic sensor;
receiving, by the u-th ultrasonic sensor, the ultrasonic burst reflected by one or more objects, in the form of kᵤ ultrasonic echoes with kᵤ as a positive whole number, which may also be zero, wherein these ultrasonic echoes of the u-th ultrasonic sensor in the sense of this claim are numbered consecutively from 1 to k, according to the order of their detection by the u-th ultrasonic sensor;
receiving, by the (u+1)-th ultrasonic sensor, the ultrasonic burst reflected by one or more objects, in the form of k₍ᵤ₊₁₎ ultrasonic echoes with k₍ᵤ₊₁₎ as a positive whole number, which may also be zero, wherein these ultrasonic echoes of the (u+1)-th ultrasonic sensor are numbered consecutively from 1 to k₍ᵤ₊₁₎ according to the order of their detection by the (u+1)-th ultrasonic sensor;
determining, in each case, a respective distance value of the ultrasonic echo of the (u−1)-th ultrasonic sensor from a respective time of flight of the respective ultrasonic echo of m₍ᵤ₋₁₎ first arriving ultrasonic echoes of the (u−1)-th ultrasonic sensor between the emission of the ultrasonic burst by the u-th ultrasonic sensor on the one hand and the detection by the (u−1)-th ultrasonic sensor on the other hand, wherein m₍ᵤ₋₁₎ is a positive whole number, which may also be zero, and wherein m₍ᵤ₋₁₎≤k₍ᵤ₋₁₎;
determining, in each case, a respective distance value of the ultrasonic echo of the u-th ultrasonic sensor from the respective time of flight of the respective ultrasonic echo of the mᵤ first arriving ultrasonic echoes of the u-th ultrasonic sensor between the emission of the ultrasonic burst by the u-th ultrasonic sensor on the one hand and the detection by the u-th ultrasonic sensor on the other hand, wherein mᵤ is a positive whole number, which may also be zero, and wherein mᵤ≤kᵤ;
determining, in each case, a respective distance value of the ultrasonic echo of the (u+1)-th ultrasonic sensor from the respective time of flight of the respective ultrasonic echo of the m₍ᵤ₊₁₎ first arriving ultrasonic echoes of the (u+1)-th ultrasonic sensor between the emission of the ultrasonic burst by the u-th ultrasonic sensor on the one hand and the detection by the (u+1)-th ultrasonic sensor on the other hand, wherein m₍ᵤ₊₁₎ is a positive whole number, which may also be zero, and wherein m₍ᵤ₊₁₎≤k₍ᵤ₊₁₎;
associating, in each case, usage information with each determined distance value, wherein this usage information initially marks this distance value as unused in its usage information;
initialising a (u−1)-th echo counter p₍ᵤ₋₁₎ with 1;
initialising a u-th echo counter pᵤ with 1;
initialising a (u+1)-th echo counter p₍ᵤ₊₁₎ with 1;
Jump point 1:
If a p₍ᵤ₋₁₎-th distance value of the (u−1)-th ultrasonic sensor for its p₍ᵤ₋₁₎-th ultrasonic echo is not marked as used in its usage information, and
if a pᵤ-th distance value of the u-th ultrasonic sensor for its pᵤ-th ultrasonic echo is not marked as used in its usage information:
trilateration of the distance value of the (u−1)-th ultrasonic sensor for its p₍ᵤ₋₁₎-th ultrasonic echo with the distance value of the u-th ultrasonic sensor for its pᵤ-th ultrasonic echo and ascertainment of a first trilateration point in the form of a first x/y coordinate;
If a p₍ᵤ₋₁₎-th distance value of the (u−1)-th ultrasonic sensor for its p₍ᵤ₋₁₎-th ultrasonic echo is marked as used in its usage information, or
if the pᵤ-th distance value of the u-th ultrasonic sensor for its pᵤ-th ultrasonic echo is marked as used in its usage information:
treating trilateration as if the first trilateration point and a second trilateration point are not both within a fault tolerance range (FB) and skipping jump point 2 and continuing with jump point 3;
Jump point 2:
If a p₍ᵤ₊₁₎-th distance value of the (u+1)-th ultrasonic sensor for its p₍ᵤ₊₁₎-th ultrasonic echo is marked as not used in its usage information:
trilateration of the distance value of the (u+1)-th ultrasonic sensor for its p₍ᵤ₊₁₎-th ultrasonic echo with the distance value of the u-th ultrasonic sensor for its pᵤ-th ultrasonic echo and ascertainment of the second trilateration point in the form of a second x/y coordinate;
If the p₍ᵤ₊₁₎-th distance value of the (u+1)-th ultrasonic sensor for its p₍ᵤ₊₁₎-th ultrasonic echo is marked as used in its usage information:
treating trilateration as if the first trilateration point and the second trilateration point are not both within the fault tolerance range (FB) and continuing with jump point 3;
comparing the first trilateration point to the second trilateration point;
Jump point 3: If the first trilateration point and the second trilateration point are not both within a fault tolerance range (FB) and p₍ᵤ₊₁₎<k₍ᵤ₊₁₎ and p₍ᵤ₋₁₎≤k₍ᵤ₋₁₎ and pᵤ≤kᵤ apply: increasing p₍ᵤ₊₁₎ by 1 and repeating the steps from jump point 2;
If the first trilateration point and the second trilateration point are not both within a fault tolerance range (FB) and p₍ᵤ₊₁₎≥k₍ᵤ₊₁₎ and p₍ᵤ₋₁₎<k₍ᵤ₋₁₎ and pᵤ≤kᵤ apply: initialising p₍ᵤ₊₁₎ with 1 and increasing p₍ᵤ₋₁₎ by 1 and repeating the steps from jump point 1;
If the first trilateration point and the second trilateration point are not both within a fault tolerance range (FB) and p₍ᵤ₊₁₎<k₍ᵤ₊₁₎ and p₍ᵤ₋₁₎≥k₍ᵤ₋₁₎ and pᵤ≤kᵤ apply: increasing p₍ᵤ₊₁₎ by 1 and repeating the steps from jump point 2;
If the first trilateration point and the second trilateration point are not both within a fault tolerance range (FB) and p₍ᵤ₊₁₎≥k₍ᵤ₊₁₎ and p₍ᵤ₋₁₎≥k₍ᵤ₋₁₎ and pᵤ<kᵤ apply: initialising p₍ᵤ₊₁₎ with 1 and initialising p₍ᵤ₋₁₎ with 1 and increasing pᵤ by 1 and repeating the steps from jump point 1;
If the first trilateration point and the second trilateration point are not both within a fault tolerance range (FB) and p₍ᵤ₊₁₎<k₍ᵤ₊₁₎ and p₍ᵤ₋₁₎≤k₍ᵤ₋₁₎ and pᵤ≥kᵤ apply: increasing p₍ᵤ₊₁₎ by 1 and repeating the steps from jump point 2;
If the first trilateration point and the second trilateration point are not both within a fault tolerance range (FB) and p₍ᵤ₊₁₎<k₍ᵤ₊₁₎ and p₍ᵤ₋₁₎≤k₍ᵤ₋₁₎ and pᵤ≥kᵤ apply: initialising p₍ᵤ₊₁₎ with 1 and increasing p₍ᵤ₋₁₎ by 1 and repeating the steps from jump point 1;
If the first trilateration point and the second trilateration point are not both within a fault tolerance range (FB) and p₍ᵤ₊₁₎<k₍ᵤ₊₁₎ and p₍ᵤ₋₁₎≥k₍ᵤ₋₁₎ and pᵤ≥kᵤ apply: increasing p₍ᵤ₊₁₎ by 1 and repeating the steps from jump point 2;
If the first trilateration point and the second trilateration point are both within the fault tolerance range (FB): ascertaining a solution from the first trilateration point and the second trilateration point and adding the thus ascertained solution to the set of solutions of this u-th channel of this measurement cycle, and marking the p₍ᵤ₋₁₎-th distance value of the (u−1)-th ultrasonic sensor for its p₍ᵤ₋₁₎-th ultrasonic echo as used in its usage information, and marking the pᵤ-th distance value of the u-th ultrasonic sensor for its pᵤ-th ultrasonic echo as used, and marking the p₍ᵤ₊₁₎-th distance value of the (u+1)-th ultrasonic sensor for its p₍ᵤ₊₁₎-th ultrasonic echo as used in its usage information, and initialising the (u−1)-th echo counter p₍ᵤ₋₁₎ with 1 and initialising the u-th echo counter pᵤ with 1 and initialising the (u+1)-th echo counter p₍ᵤ₊₁₎ with 1, and repeating the three steps from jump point 3;
If the first trilateration point and the second trilateration point are not both within a fault tolerance range (FB) and p₍ᵤ₊₁₎≥k₍ᵤ₊₁₎ and p₍ᵤ₋₁₎≥k₍ᵤ₋₁₎ and pᵤ≥kᵤ apply: ending the measurement cycle and influencing the vehicle as a function of the solutions in the set of the solutions of this u-th channel of this measurement cycle.

57. Method according to one of claim 56, wherein the method furthermore comprises the following steps:
carrying out the method according to claim 56 for the u-th channel in order to obtain u-th solutions, wherein now u<n−1 applies here;
carrying out the method according to claim 56 for a (u+1)-th channel in order to obtain (u+1)-th solutions;
carrying out the clustering according to claim 55, now in the form of clustering solutions in the union of the set of the solutions of this u-th channel and the set of the solutions of this (u+1)-th channel of one or more measurement cycles to form u-th solutions, and
discarding unaccepted u-th solutions of this u-th channel and unaccepted (u+1)-th solutions of this (u+1)-th channel of these measurement cycles.

58. Method according to claim 55 to 57, comprising the step of:
replacing, by means of a plausibility check, discarded solutions with the respective, most recently accepted solutions, and then further using these most recently accepted solutions as plausibility-checked solutions.

59. Method according to claim 55 to 58, wherein the plausibility check
discards those of the u-th solutions that correspond to a time of flight of the ultrasonic burst from its emission to the reception by at least one of the ultrasonic sensors that is greater than a maximum allowed time of flight tₘₐₓ, in particular greater than a time of flight of tₘₐₓ>1.4 ms, and/or
discards those of the (u+1)-th solutions that correspond to a time of flight of the ultrasonic burst from its emission to the reception by at least one of the ultrasonic sensors that is greater than the maximum allowed time of flight Δeₘₐₓ, in particular greater than a time of flight of Δeₘₐₓ>1.4 ms.

60. Method according to claim 55 to 59, wherein
the plausibility check discards those of the solutions that cannot be attributed to at least exactly one ultrasonic echo of an associated ultrasonic sensor and exactly one further ultrasonic echo of an associated further ultrasonic sensor and exactly one additional ultrasonic echo of an associated additional ultrasonic sensor, thus to three ultrasonic echoes of three different ultrasonic sensors.

61. Method according to claim 55 to 60 on the one hand and at the same time claim 28 and/or claim 29, on the other hand, wherein
the plausibility check deactivates the Kalman filtering method or estimation filtering method if the signal of the value of the arrival time of the relevant ultrasonic echo, i.e., a solution, changes by more than Δe_{filter_max} or by Δe_{filter_max} in two consecutive iterations, wherein Δe_{filter_max} is preferably Δe_{filter_max}≥500 μs, and wherein “deactivate” means that the method directly uses all or several or individual ones of the plausibility-checked solutions as filtered solutions for the time of the deactivation.

62. Method according to claim 61, wherein the method cancels a deactivation again after a predetermined number of measurement cycles.

63. Method according to claim 55 to 62, wherein the plausibility check discards such solutions for which a line from a location of the possibly filtered u-th solution to a location of the relevant ultrasonic sensor has an angle α to a viewing axis (SA) of the ultrasonic sensor whose magnitude is greater than the magnitude of a maximum angle αₗᵢₘ.

64. Method according to claim 55 to 63, comprising the steps of:
extracting a respective envelope signal (HK) per ultrasonic sensor, in each case from a respective signal of the reflected ultrasonic wave (USW) of the respective ultrasonic sensor, and
extracting respective ultrasonic echoes (ec1, ec2, ec3, ec4, ec5, ec6) of the respective ultrasonic sensor using a respective threshold value curve (SWK) of the respective ultrasonic sensor from this respective envelope curve signal (HK) of the respective ultrasonic sensor, wherein the threshold value curve (SWK) of an ultrasonic sensor depends on the clustered and accepted solutions that the method previously determined.

65. Method according to claim 55 to 64, wherein
the method then clusters, by means of the clustering method, the solutions or the filtered solutions to form accepted solutions and discards unaccepted, possibly filtered solutions if the distances between at least one of the solutions of the cluster and at least e other solutions of the cluster are less than a threshold value distance (s), wherein e is a positive number greater than 0, or better greater than 1 or better greater than 2, and wherein e=3 is particularly preferred.

66. Method according to claim 55 to 65, wherein
the method then clusters, by means of the clustering method, the solutions to form accepted solutions and discards unaccepted, possibly filtered solutions if the number of solutions of a cluster is at least three.

67. Method according to claim 55 to 66, wherein
the method then clusters, by means of the clustering method, solutions or filtered solutions into an already existing cluster as accepted solutions and discards unaccepted, possibly filtered solutions if the number of the solutions of the cluster that are in the neighbourhood of such a possibly filtered solution is at least one.

68. Method according to claim 55 to 67, comprising the additional step of emitting an ultrasonic noise signal having an at least partially random modulation at least in one parameter.

69. Method according to one or more of claims 55 to 68, wherein the method
first determines a solution on the basis of two ultrasonic echoes of two different ultrasonic sensors, and
accepts the solution if it is a solution from a fallback area, and
does not accept the solution on the basis of two ultrasonic echoes of two different ultrasonic sensors if it is a solution from the three-sensor area, and wherein
the method that the ultrasonic sensor system (USSS) carries out then determines a solution on the basis of three ultrasonic echoes of three different ultrasonic sensors.

70. Method according to one or more of claims 55 to 69, wherein
the clustering depends on a threshold value distance (E), and
the threshold value distance (E) depends on the change in accepted solutions of the clustering between at least two measurement cycles.

71. Method according to one or more of claims 55 to 70, wherein the method comprises the following steps:
using temporal changes of the reception of the ultrasonic echo of the ultrasonic sensor ascertained from the reception data of this ultrasonic echo of this ultrasonic sensor of the last v measurement cycles, with v as a positive whole number greater than 1, and
determining therefrom, by means of a polynomial approximation, a time point of the next reception of this ultrasonic echo by this ultrasonic sensor, and
modifying the threshold value curve (SWK) of this ultrasonic sensor as a function of the result of the next reception expected for a time range around the time point.

72. Method according to one or more of claims 55 to 71, wherein the method
ascertains temporal changes of the accepted solutions from data of the accepted solutions of the last v measurement cycles, with v as a positive whole number greater than 1, and
determines therefrom, in particular by means of the polynomial approximation, for one or more ultrasonic sensors, the respective time point of the expected next reception of the ultrasonic echoes belonging to the relevant solution, for these ultrasonic sensors, and
modifies the threshold value curve (SWK) of one or more of these ultrasonic sensors as a function of the result of this prediction, in particular for a time range around the respective time point of the respectively expected next reception of the respective ultrasonic echoes belonging to the relevant solution, for these respective ultrasonic sensors.

73. Method according to one or more of claims 55 to 72, wherein the method applies a sub-method that identifies ultrasonic echoes of fraudulent objects in the distance values of the ultrasonic echoes of the ultrasonic sensors and removes them from the measurement data.

74. Method according to one or more of claims 55 to 73, wherein
the input values of the Kalman filtering method or of the estimation filtering method are the recognized object positions in the form of the solutions of the trilateration method and/or the rate of change of the recognized object positions in the form of the solutions of the trilateration method on the one hand and the speed of the vehicle on the other hand.

75. Method according to one or more of claims 55 to 74, wherein
the input values of the estimation filtering or of an estimation filtering are the recognized object positions in the form of the solutions of the trilateration method and/or the rate of change of the recognized object positions in the form of the solutions of the trilateration method on the one hand and the speed of the vehicle on the other hand.

76. Method according to one or more of claims 55 to 75, wherein
the method sets distance values according to measured values of a time of flight that is greater than a maximum allowed time of flight tₘₐₓ or Δeₘₐₓ to zero or a very small number of equal effect.
